(19) United States
(12) Patent Application Publication
(10) Pub. No.: US 2026/0339477 A1
(43) Pub. Date: Oct. 29, 2026

(54) DEVICES, METHODS, AND GRAPHICAL USER INTERFACES FOR DISPLAYING SPATIAL CONTENT IN A THREE-DIMENSIONAL ENVIRONMENT

(71) Applicant: Apple Inc., Cupertino, CA (US)

(72) Inventors: Nathan GITTER, Cupertino, CA (US); Evgenii KRIVORUCHKO, San Francisco, CA (US); Stephen O. LEMAY, Palo Alto, CA (US); Etienne SEGONZAC, Paris (FR); Jintian WANG, Santa Clara, CA (US); Ryan S. FULLER, Gilbert, AZ (US); Chelsea E. PUGH, San Francisco, CA (US); Katherine A. POULTER, Ben Lomond, CA (US)

(21) Appl. No.: 19/652,979

(22) Filed: Apr. 20, 2026

Related U.S. Application Data
(60) Provisional application No. 63/794,220, filed on Apr. 24, 2025.
(60) Provisional application No. 63/804,505, filed on May 12, 2025.

(51) Int. Cl. G06F 3/04815; G06F 3/0485; G06T 15/50; G06T 15/60; G06T 19/00

(52) U.S. Cl. CPC G06F 3/04815; G06F 3/0485; G06T 15/506; G06T 15/60; G06T 19/003

(57) ABSTRACT

In some embodiments, a computer system changes a mode of presentation in which content is displayed. In some embodiments, a computer system displays content with a three-dimensional appearance based on two-dimensional content. In some embodiments, a computer system changes an appearance of the three-dimensional environment based on the content displayed in the three-dimensional environment. In some embodiments, a computer system displays a three-dimensional representation of a three-dimensional object in a three-dimensional environment.

### CROSS-REFERENCE TO RELATED APPLICATIONS

This application claims the benefit of U.S. Provisional Application No. 63/804,505, filed May 12, 2025, and U.S. Provisional Application No. 63/794,220, filed Apr. 24, 2025, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a user interface including a plurality of two-dimensional content. In response to detecting an input to display the content in a virtual environment, the computer system displays content including a three-dimensional appearance corresponding to the plurality of two-dimensional content. In some embodiments, while in a three-dimensional environment, the computer system automatically displays two-dimensional content as content with a three-dimensional appearance.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7OOO illustrate exemplary ways in which a computer system presents content in a three-dimensional environment in accordance with some embodiments.

FIG. 8 is a flowchart illustrating an exemplary method of transitioning from a first mode of presentation to a second mode of presentation in accordance with some embodiments.

FIG. 9 is a flowchart illustrating an exemplary method of displaying two-dimensional content as automatically generated content with a three-dimensional appearance in accordance with some embodiments.

FIG. 10 is a flowchart illustrating an exemplary method of changing an appearance of the three-dimensional environment based on content displayed in the three-dimensional environment in accordance with some embodiments.

FIG. 11 is a flowchart illustrating an exemplary method of displaying a virtual representation of a three-dimensional object in accordance with some embodiments.

FIG. 12 is a flowchart illustrating an exemplary method of displaying content in a second mode of presentation in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system changes a mode of presentation that content is displayed in. In some embodiments, while a three-dimensional environment is visible, via the one or more display generation components, from a first viewpoint of a user, the computer system displays, via the one or more display generation components, content of a respective website in a first mode of presentation in a three-dimensional environment, wherein the content is displayed in a web browser application that is capable of displaying content from multiple different websites. In some embodiments, while displaying the content in the first mode of presentation from the first viewpoint of the user, the computer system detects, via the one or more input devices, an input corresponding to a request to display the content from the respective website in a second mode of presentation. In some embodiments, in response to detecting the input, the computer system ceases displaying the content in the first mode of presentation; and displays the content in the second mode of presentation, wherein in the second mode of presentation, the content is displayed with one or more spatial elements that are related to the content and are not displayed when the content is displayed in the first mode of presentation.

In some embodiments, a computer system displays content with a three-dimensional appearance based on two-dimensional content. In some embodiments, the computer system detects, via the one or more input devices, a first input corresponding to a request to display content in a three-dimensional environment, wherein the content includes a first portion of the content including two-dimensional visual media and a second portion of the content when the first input is detected. In some embodiments, in response to detecting the first input, the computer system displays, via the one or more display generation components, the content in the three-dimensional environment including concurrently displaying three-dimensional content that corresponds to the first portion of the content, including content including a three-dimensional appearance that was automatically generated from the two-dimensional visual media, and the second portion of the content that has not been converted into three-dimensional content.

In some embodiments, the computer system changes an appearance of the three-dimensional environment based on the content displayed in the three-dimensional environment. In some embodiments, the computer system displays, in a three-dimensional environment, a first content item. In some embodiments, while displaying the first content item in the three-dimensional environment, the computer system detects a first event for displaying a second content item in place of the first content item, wherein the second content item is different from the first content item. In some embodiments, in response to detecting the first event: the computer system displays, in the three-dimensional environment, via the one or more display generation components, the second content item in place of the first content item, and the computer system changes an appearance of at least a respective portion of the three-dimensional environment outside of the second content item to an appearance that is based on the second content item.

In some embodiments, the computer system displays a three-dimensional representation of a three-dimensional object in a three-dimensional environment. In some embodiments, while a three-dimensional environment is visible via the one or more display generation components, the computer system displays, via the one or more display generation components, a user interface including a plurality of options associated with one or more appearance parameters of a three-dimensional object. In some embodiments, while displaying the user interface including the plurality of options associated with the one or more appearance parameters of the three-dimensional object, the computer system detects, via the one or more input devices, a first input corresponding to a request to display a virtual representation of the three-dimensional object. In some embodiments, in response to detecting the first input, the computer system displays, via the one or more display generation components in the three-dimensional environment, the virtual representation of the three-dimensional object and a plurality of options for adjusting the one or more appearance parameters of the virtual representation of the three-dimensional object.

In some embodiments, the computer system displays first content in a second mode of presentation. In some embodiments, while displaying the first content in the second mode of presentation, the computer system detects a request to display second content from a different content source in the three-dimensional environment. In some embodiments, in response to detecting the input, the computer system displays the second content in the second mode of presentation even if the second content does not have content with one or more spatial elements.

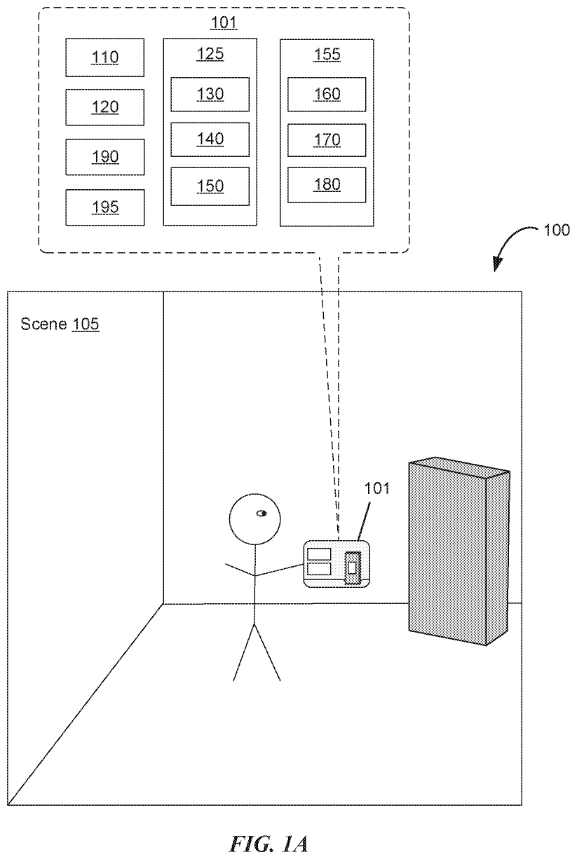

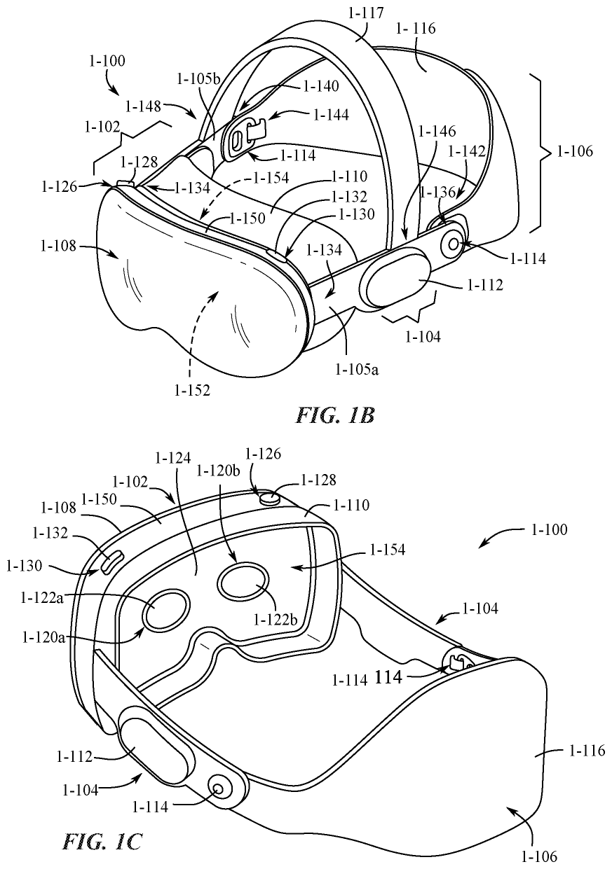

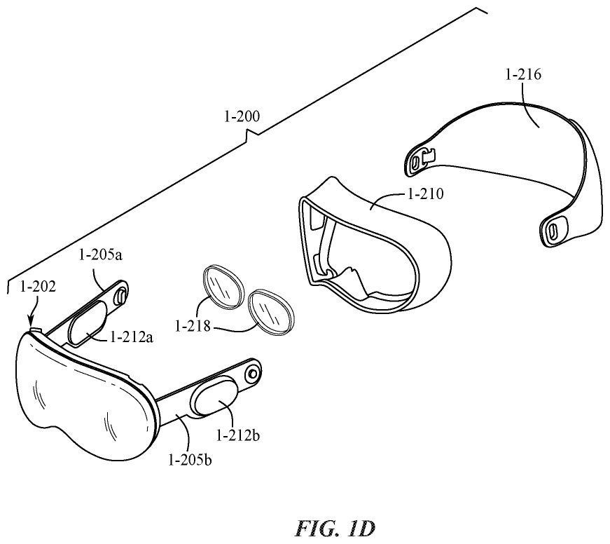

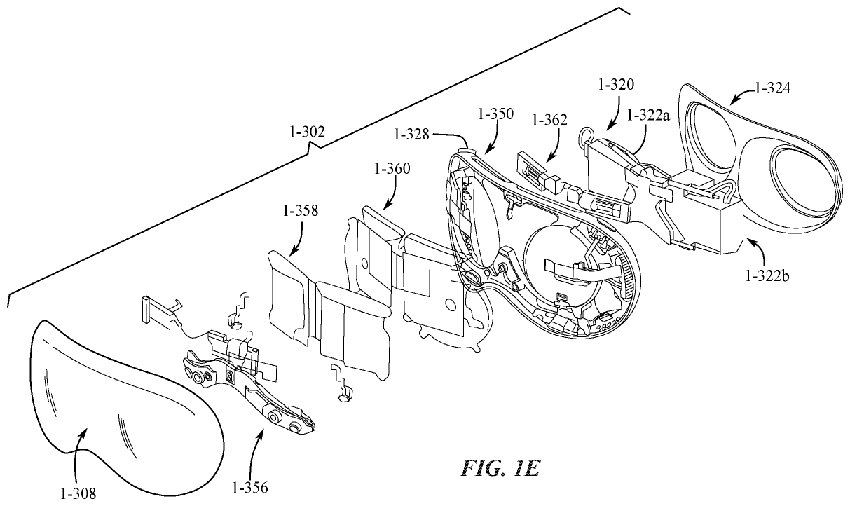

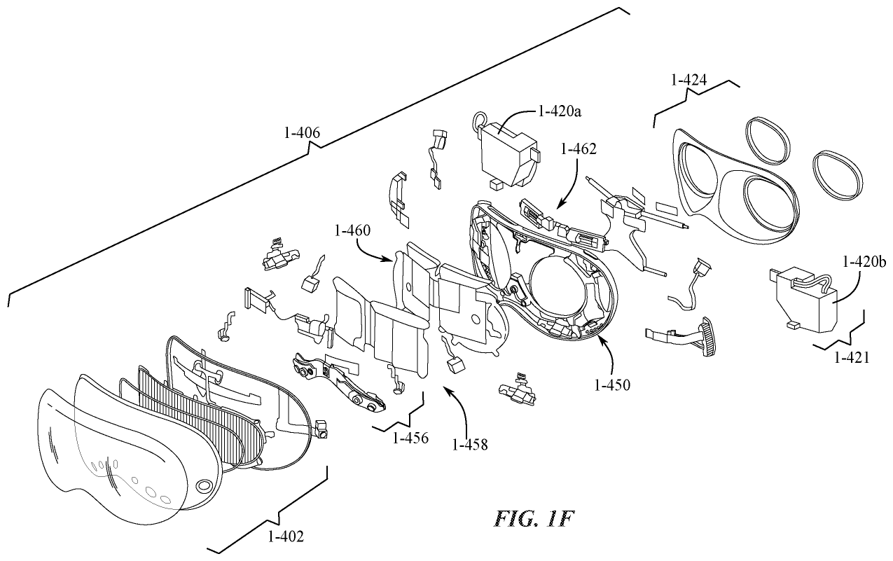

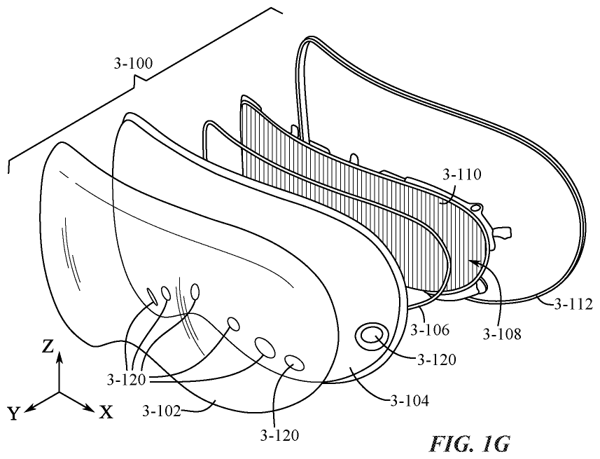

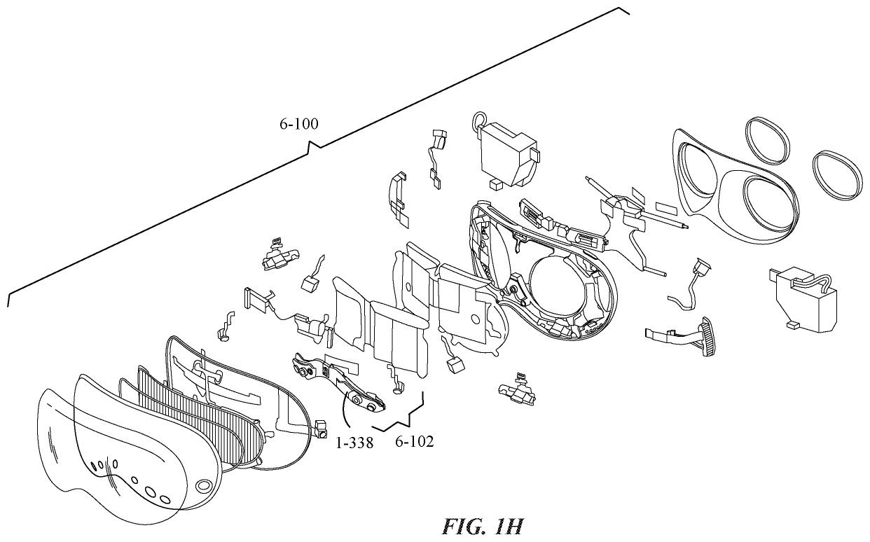

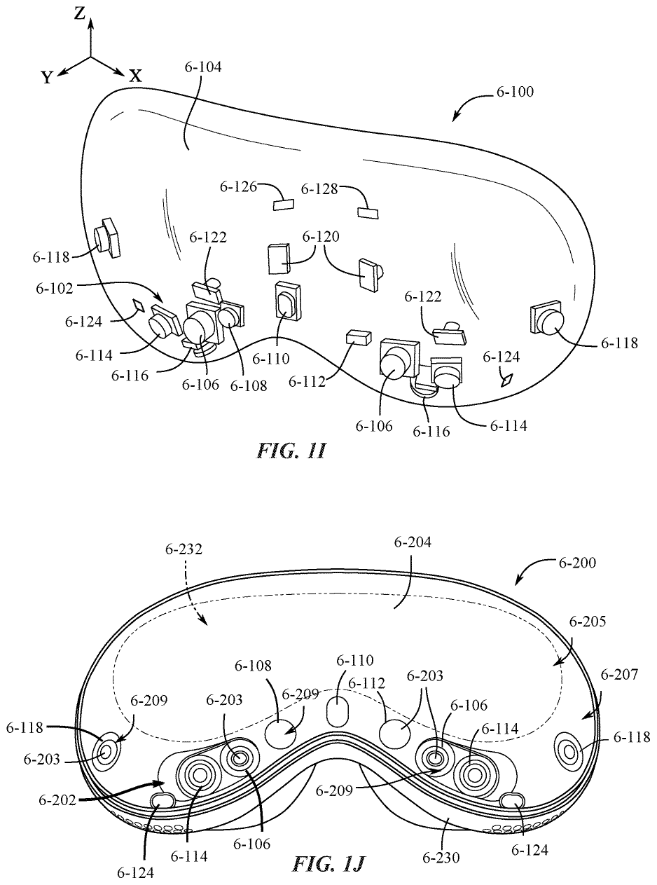

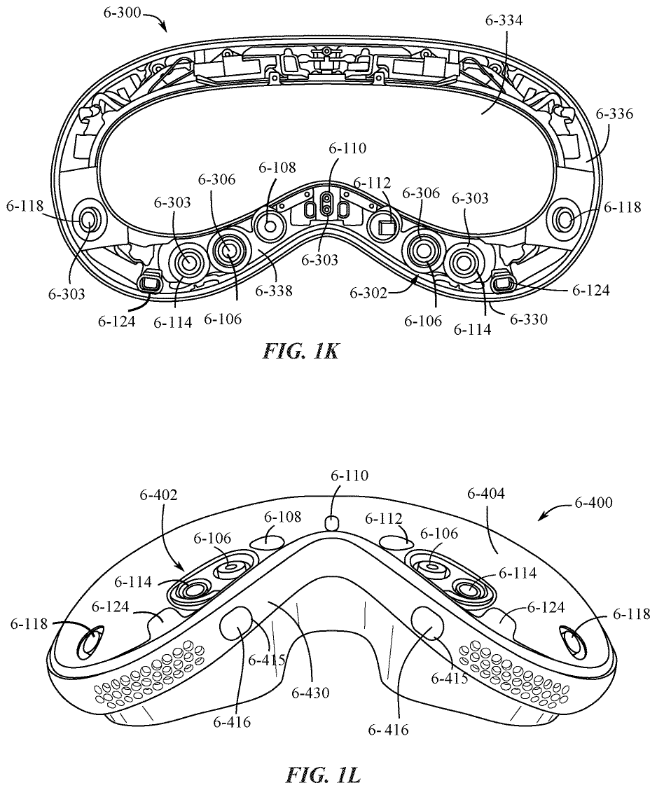

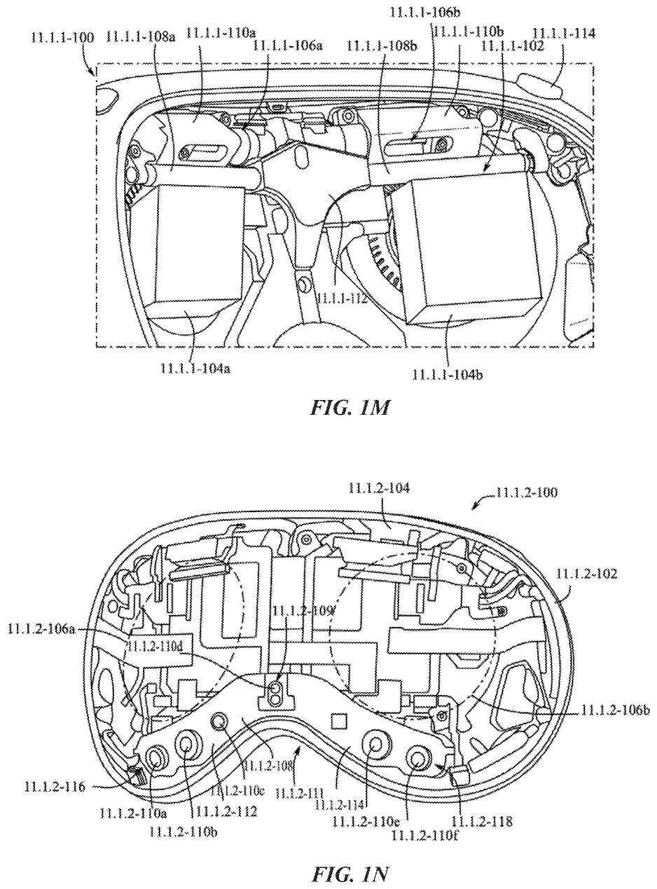

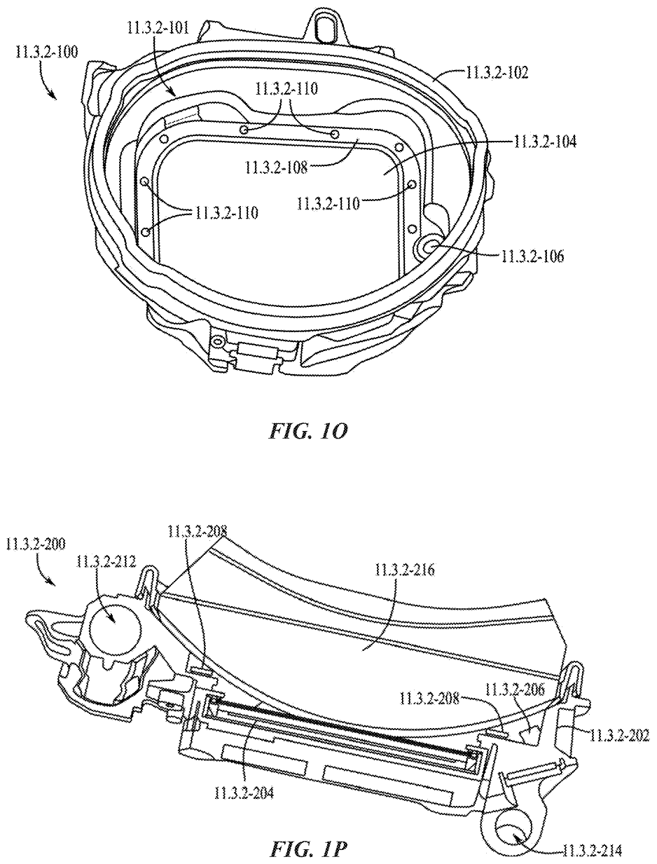

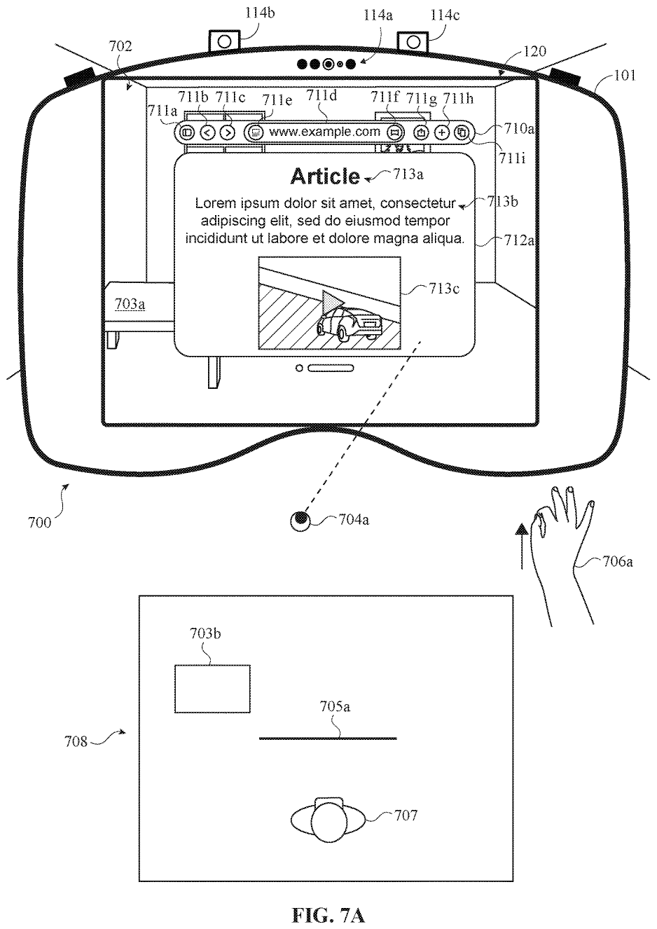

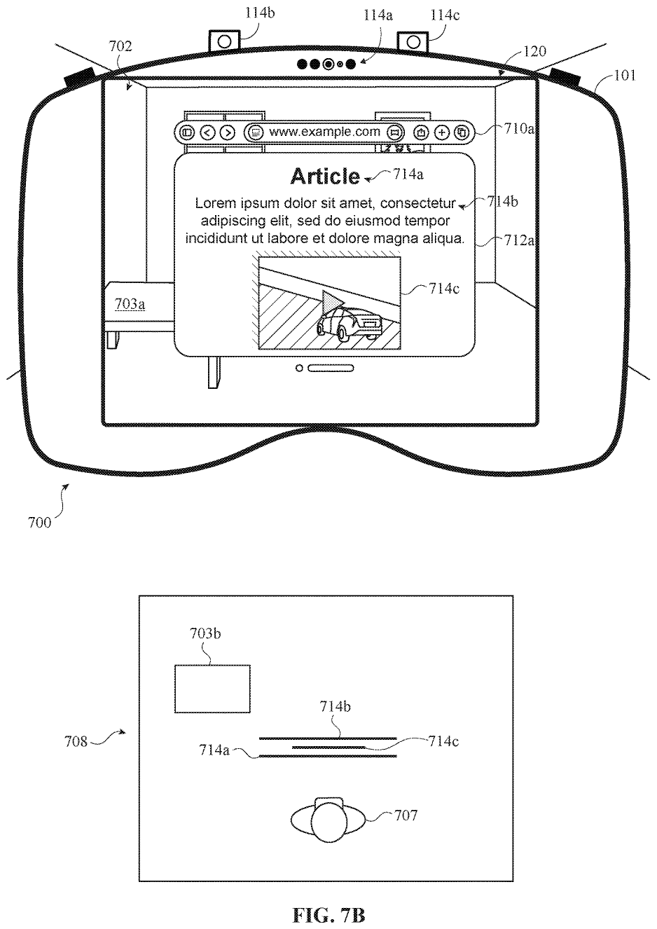

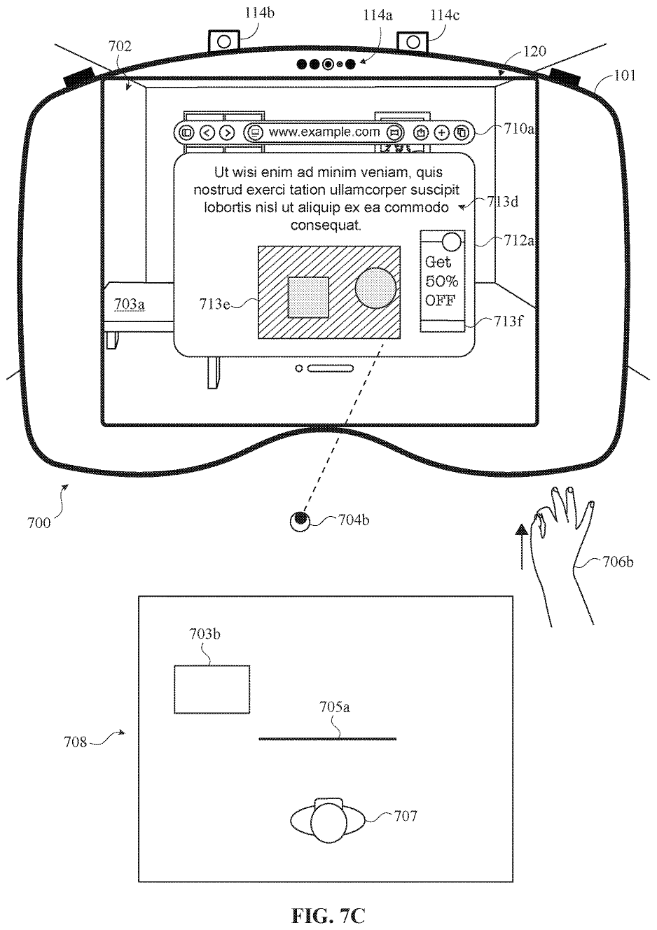

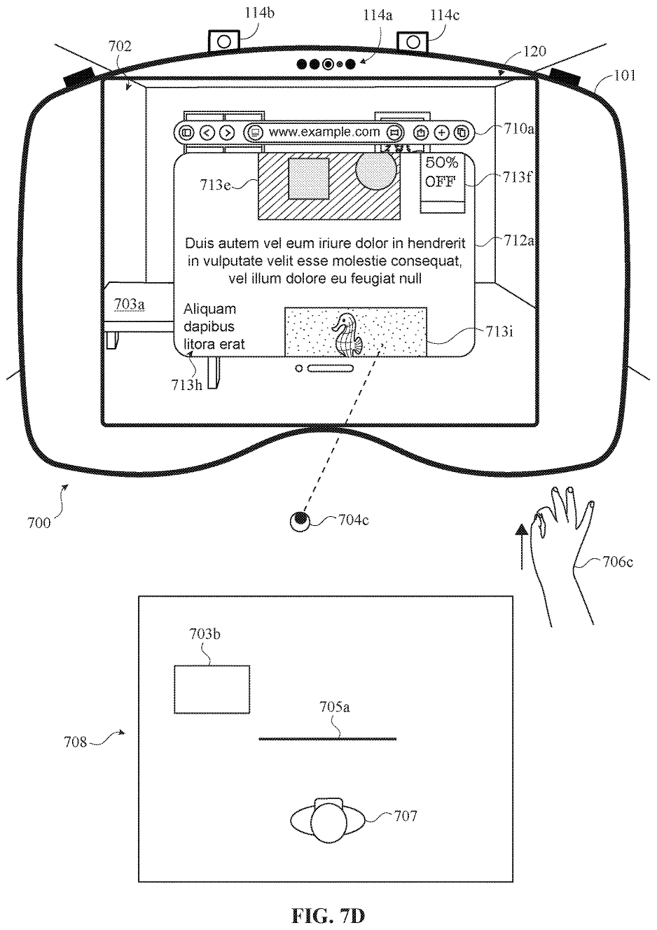

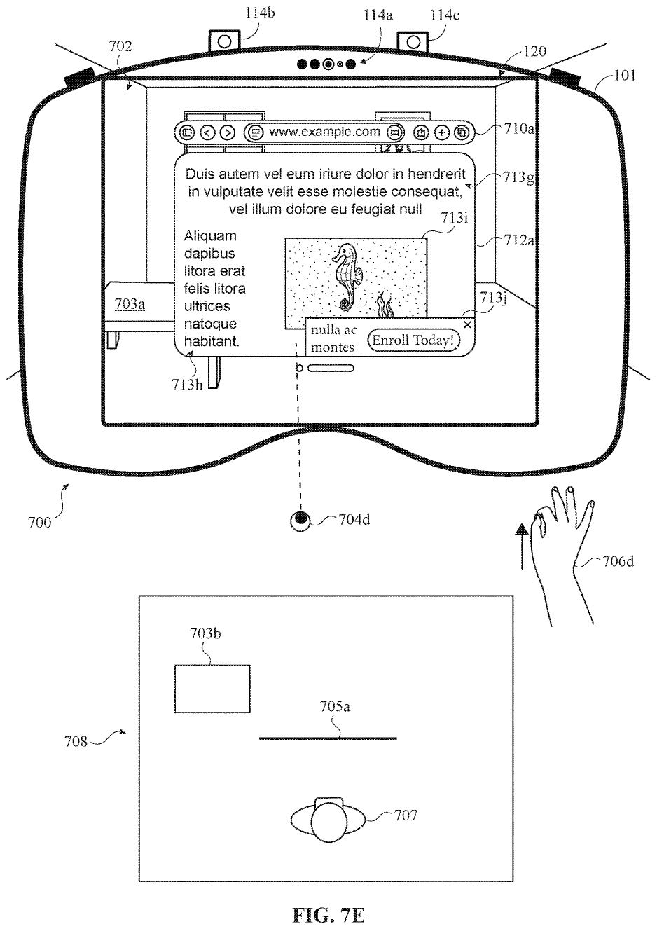

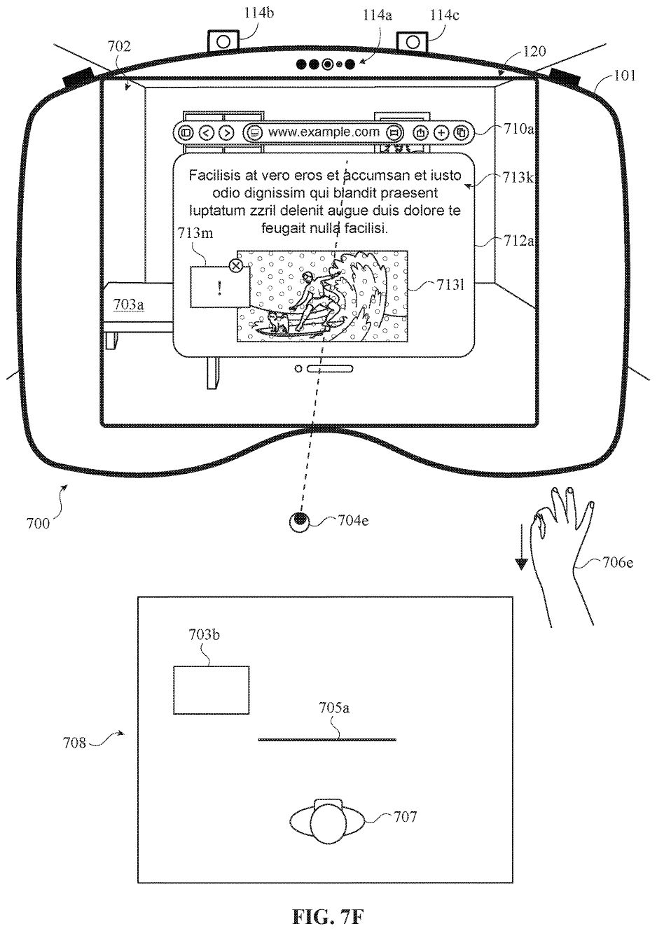

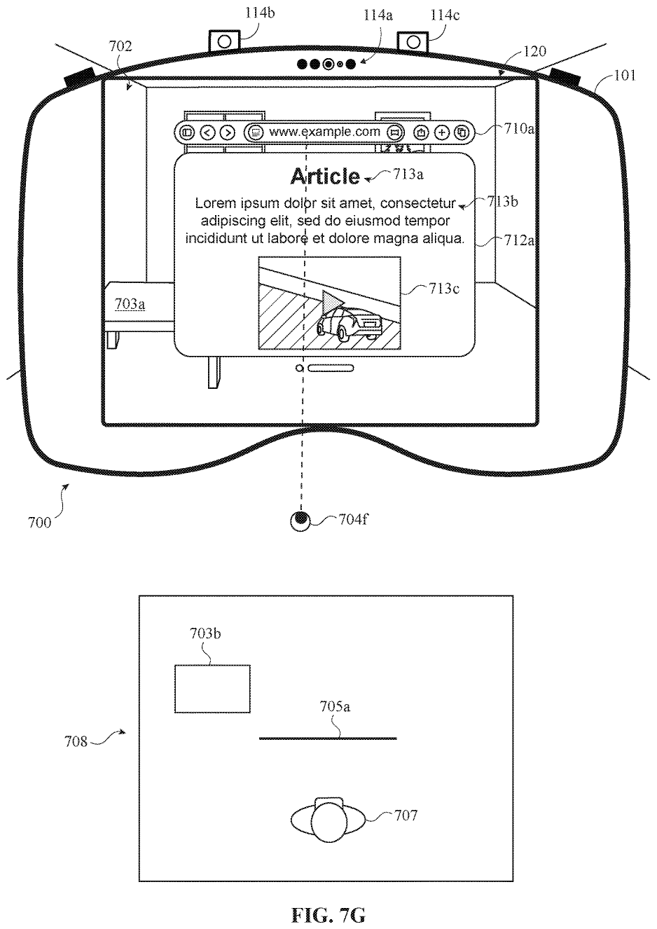

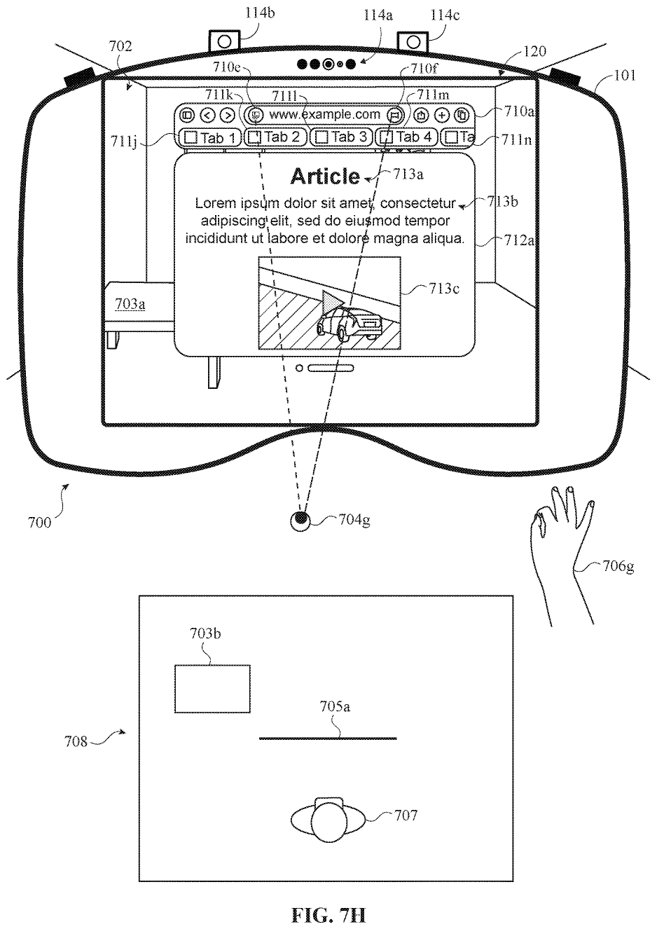

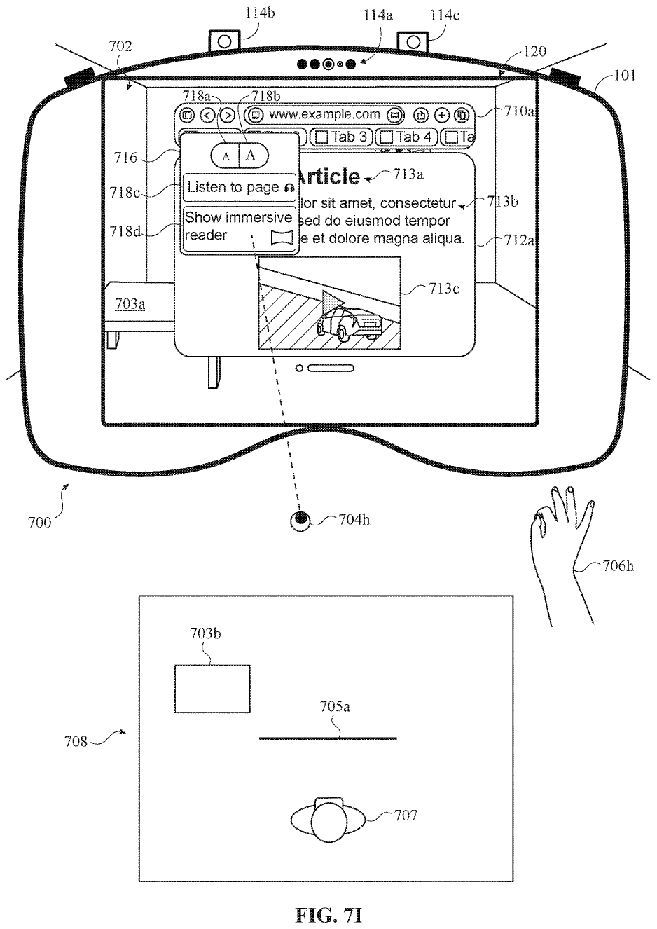

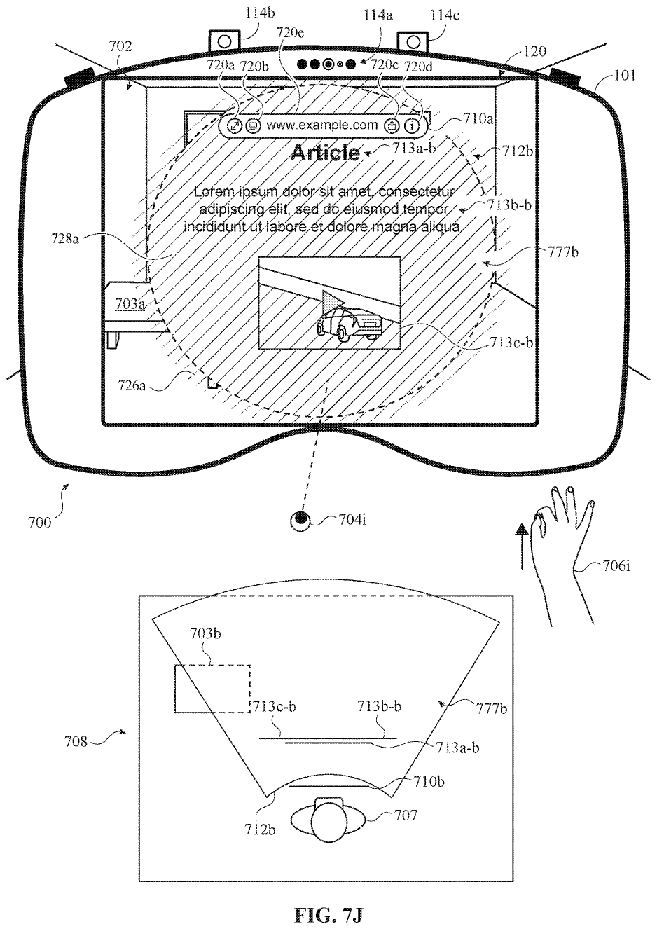

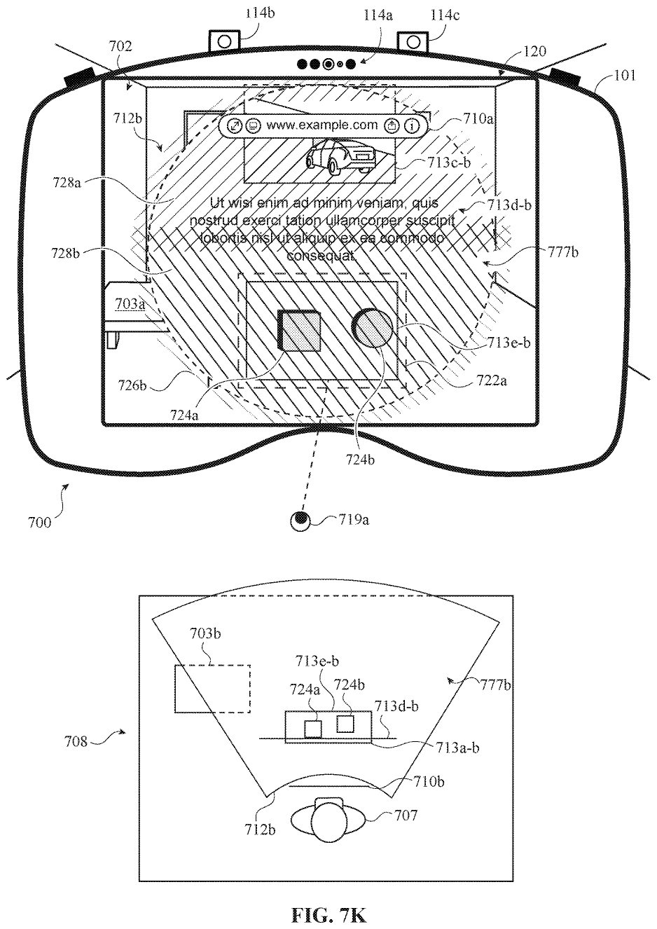

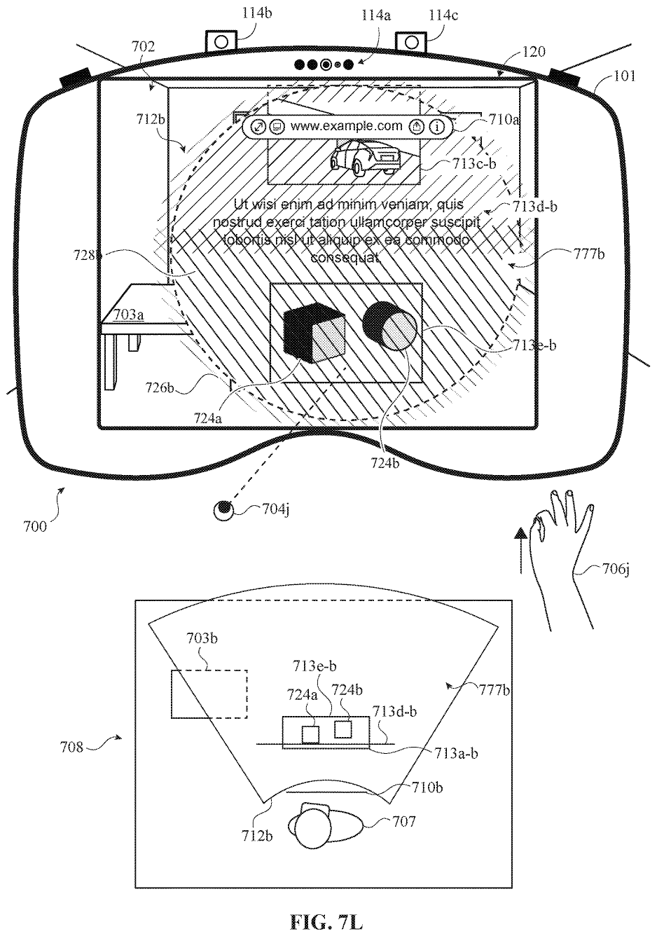

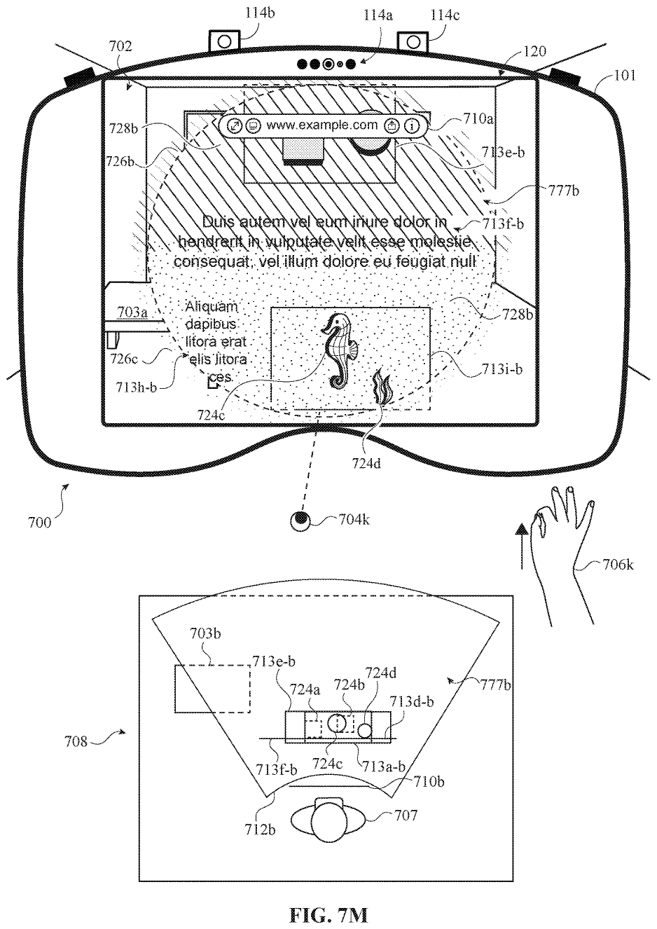

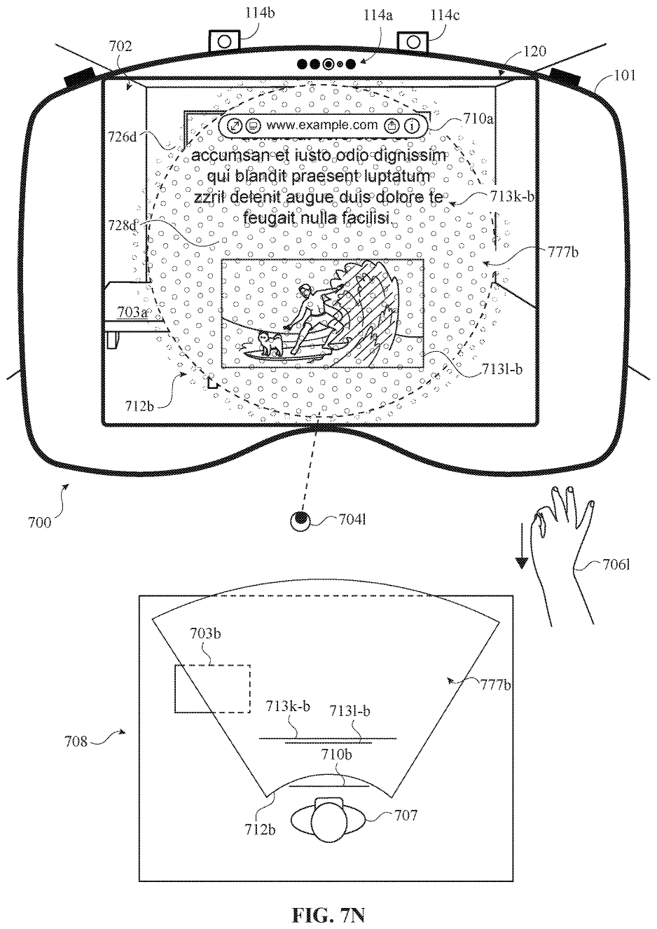

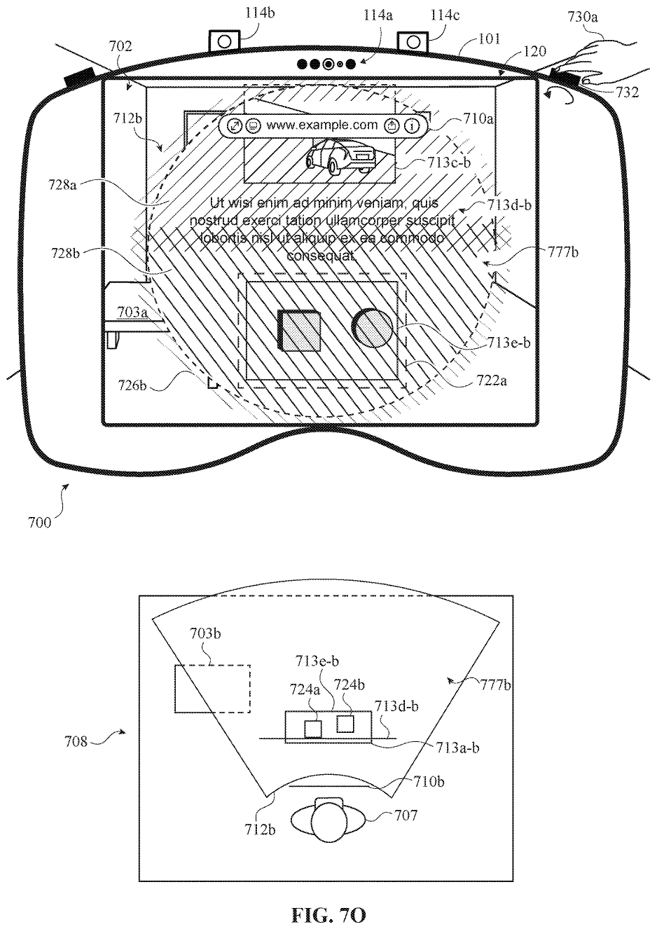

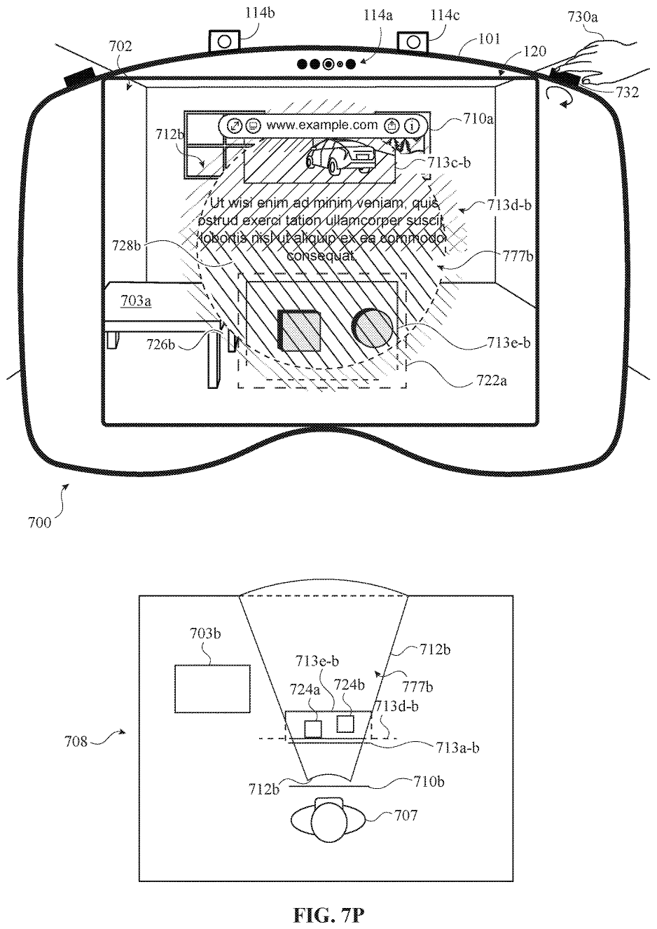

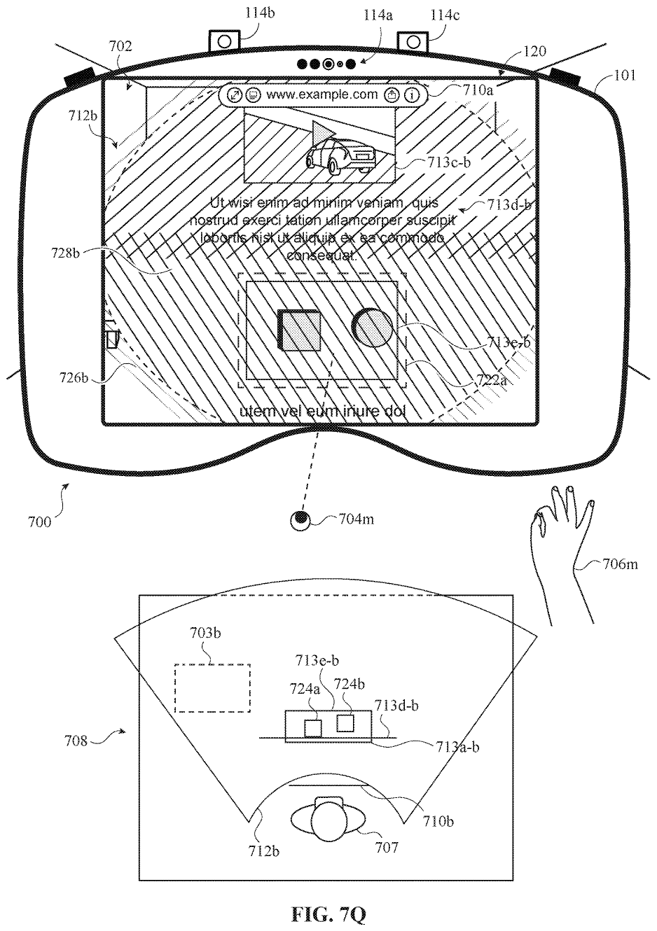

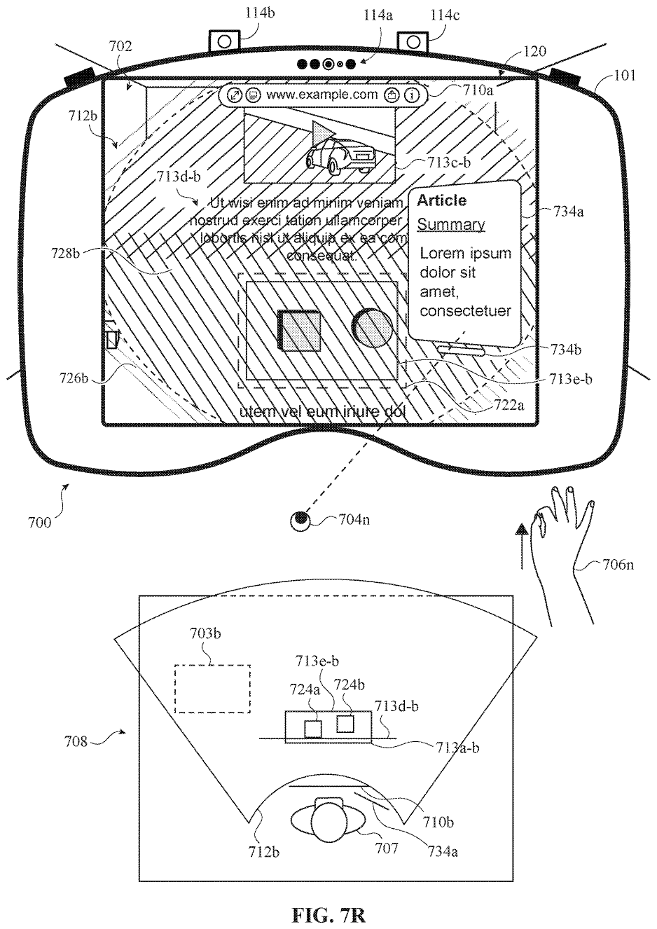

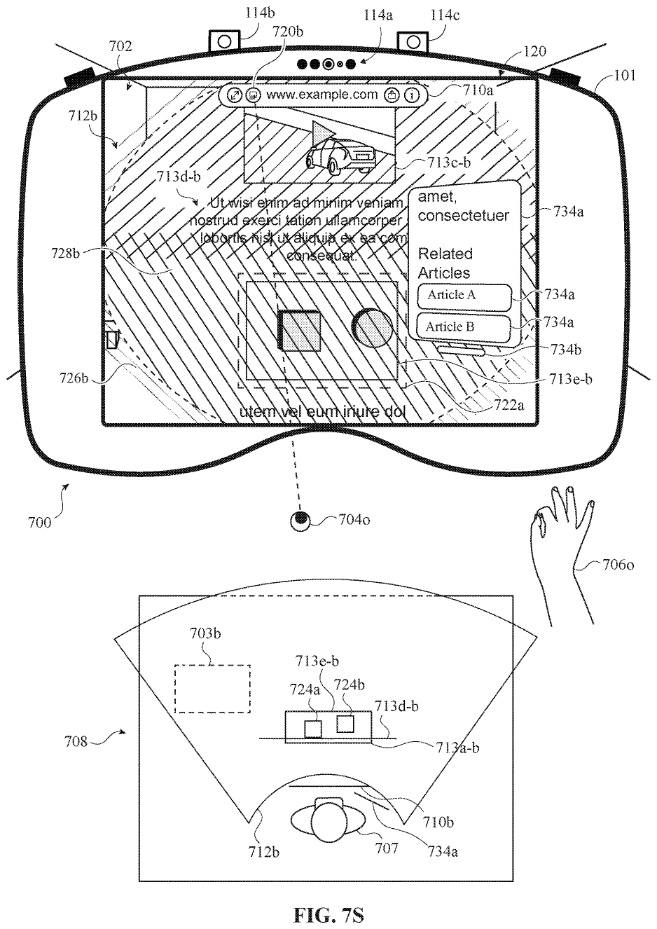

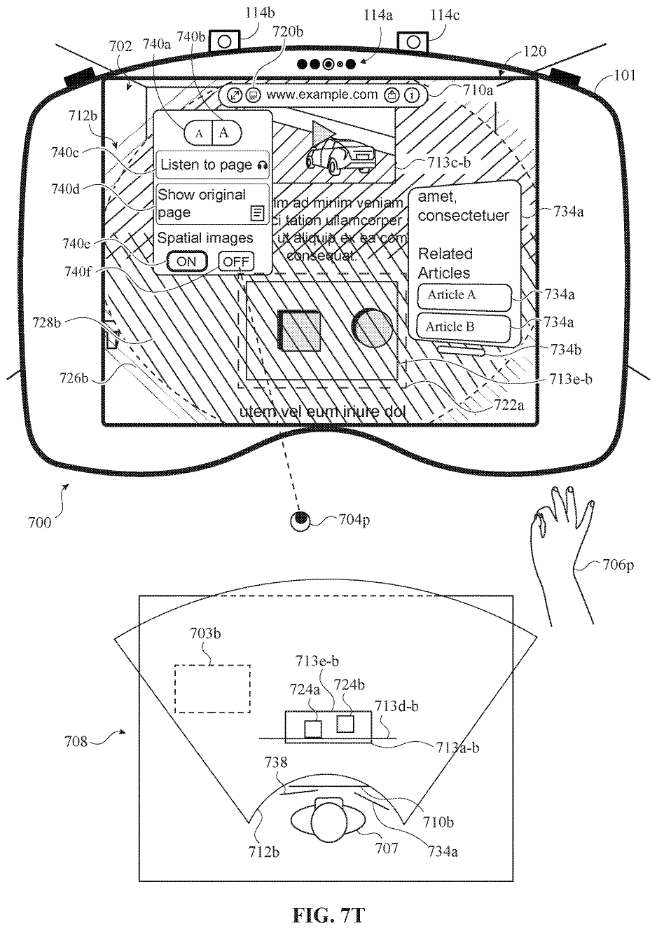

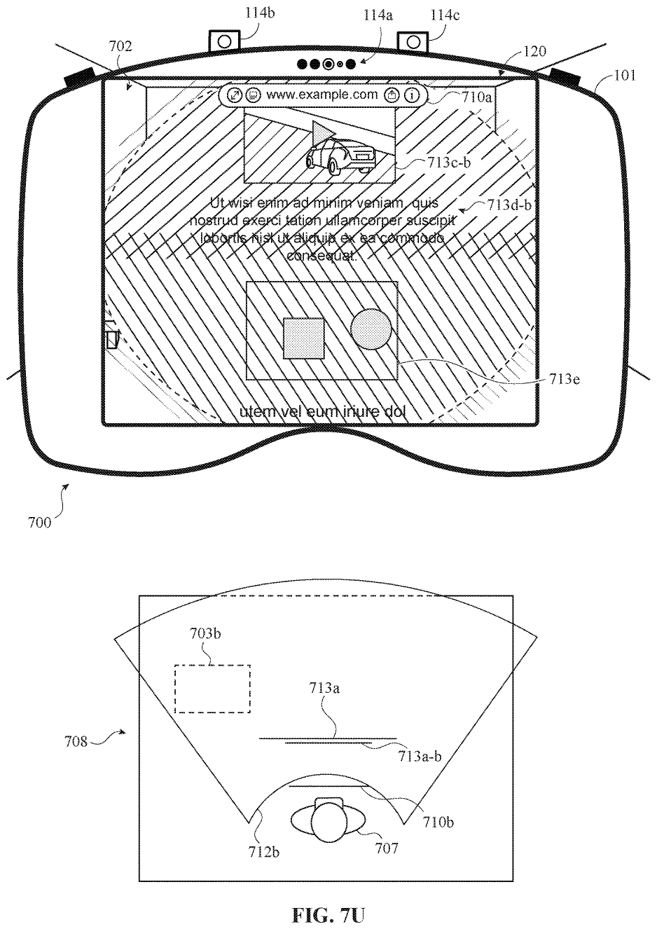

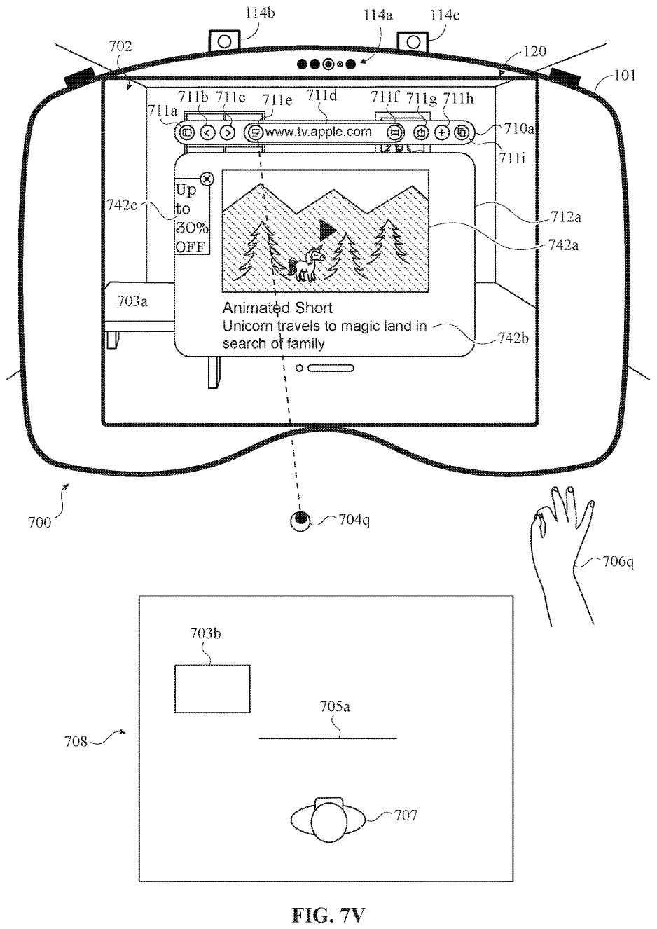

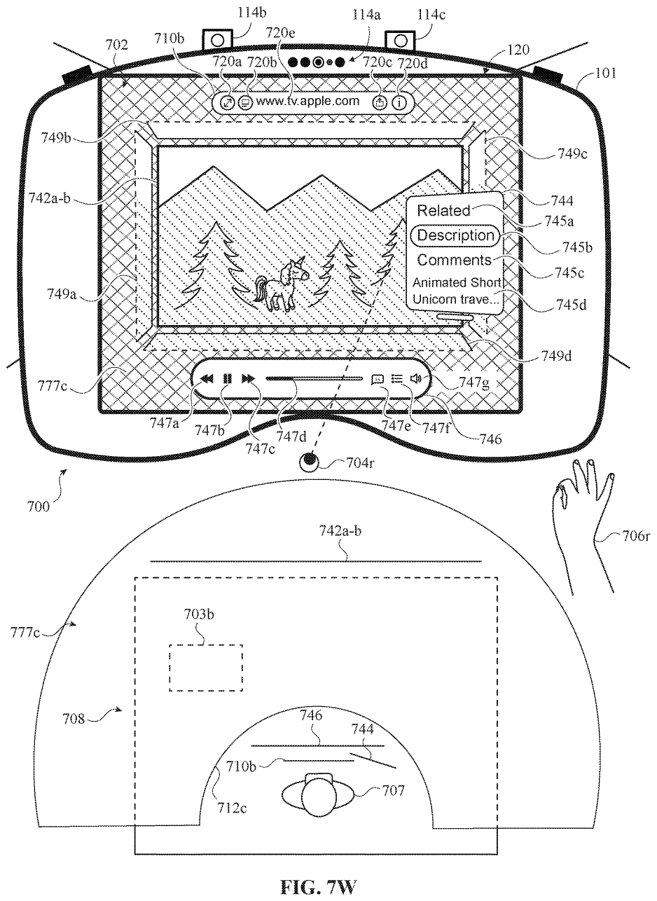

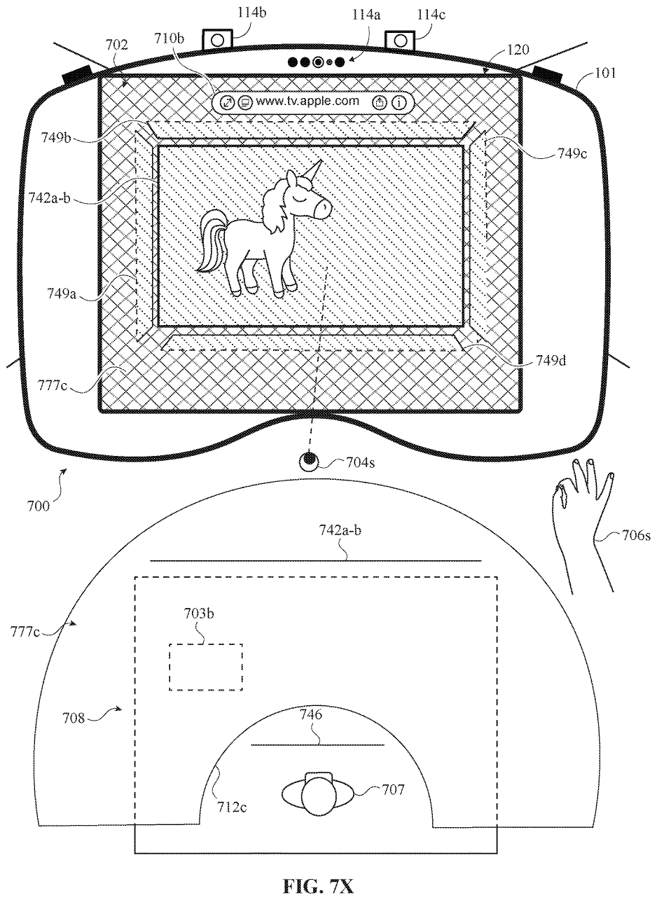

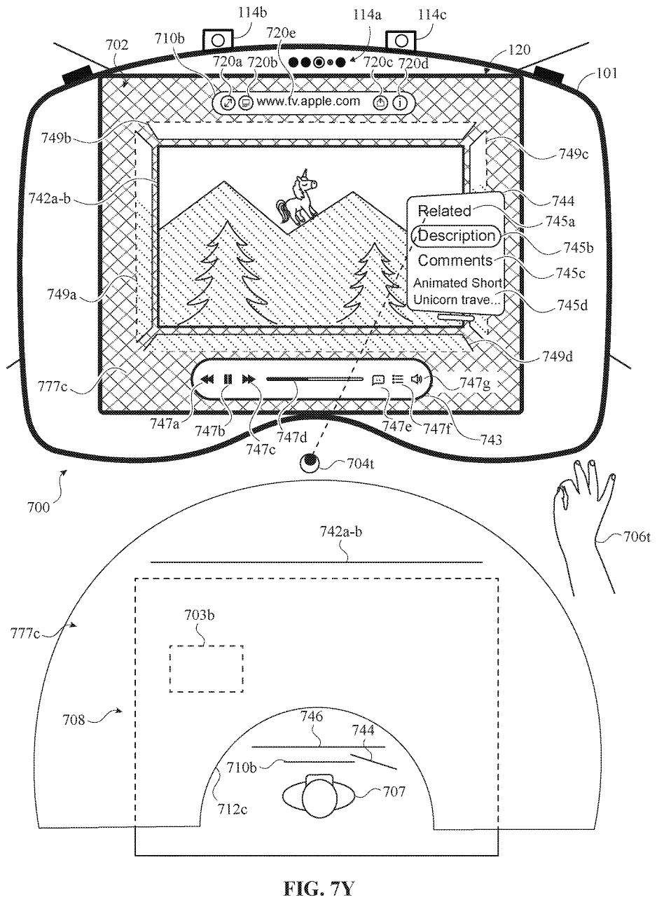

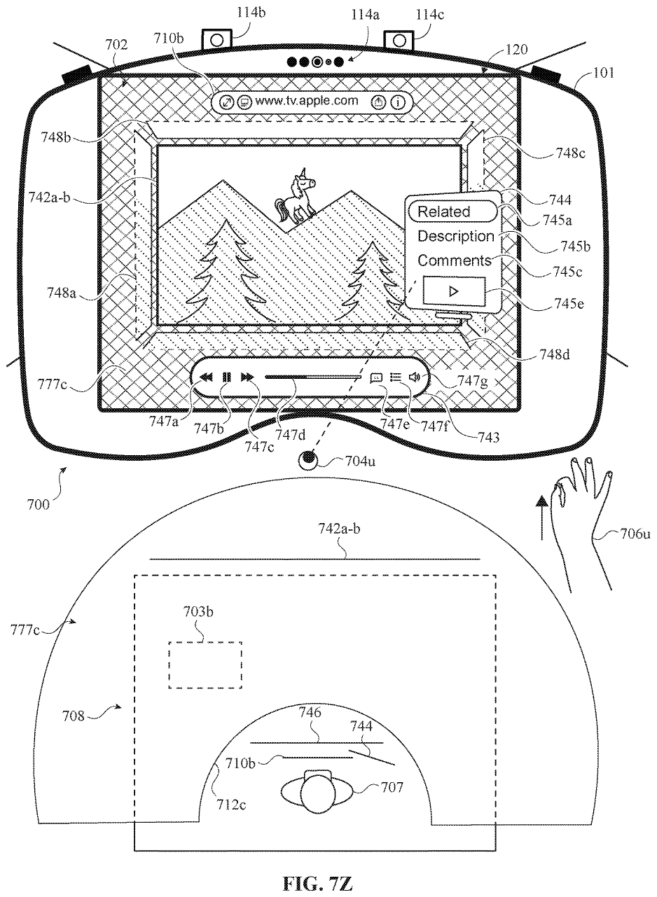

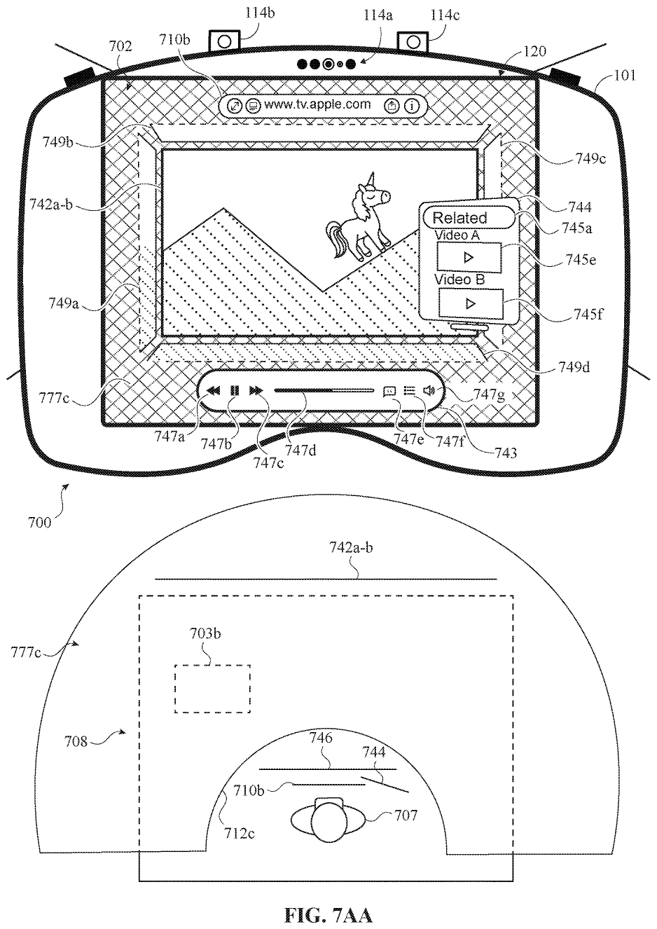

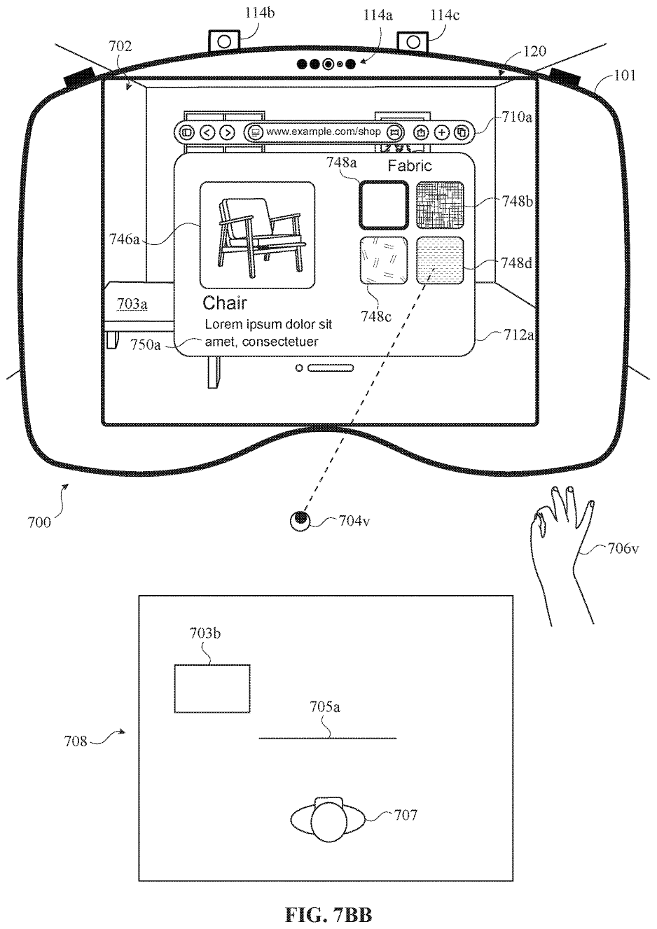

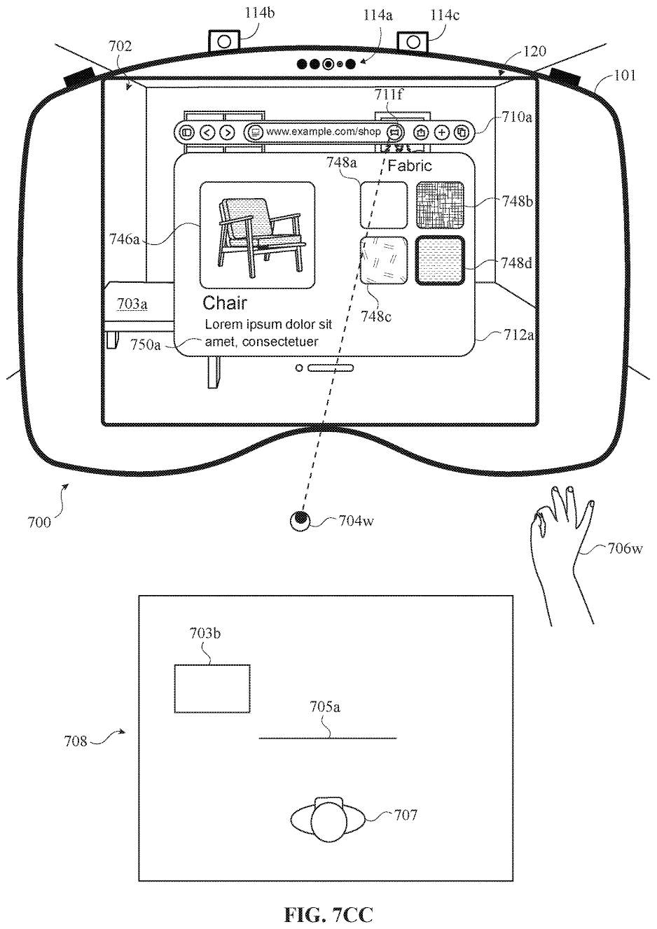

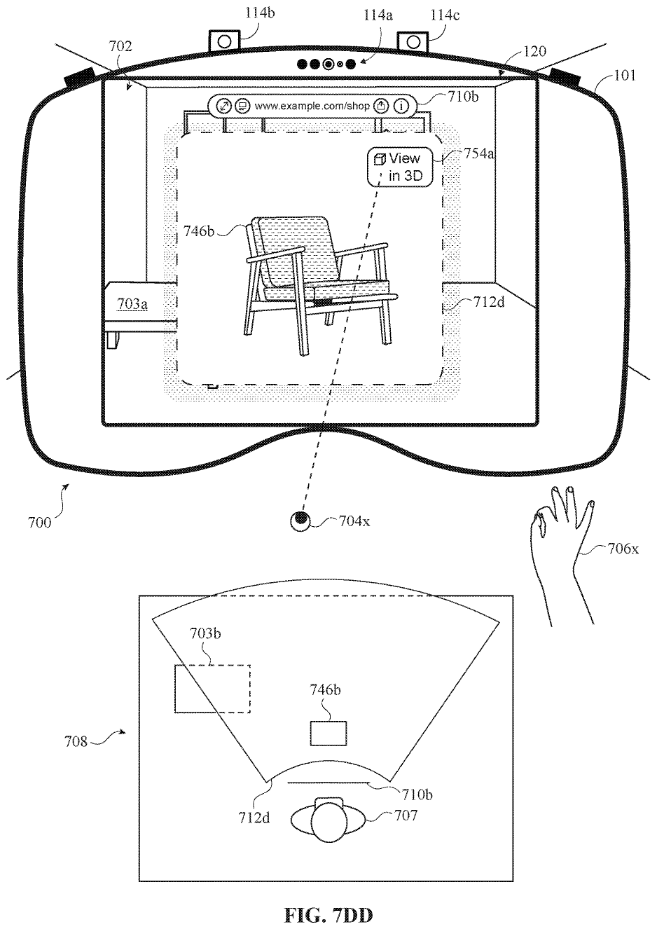

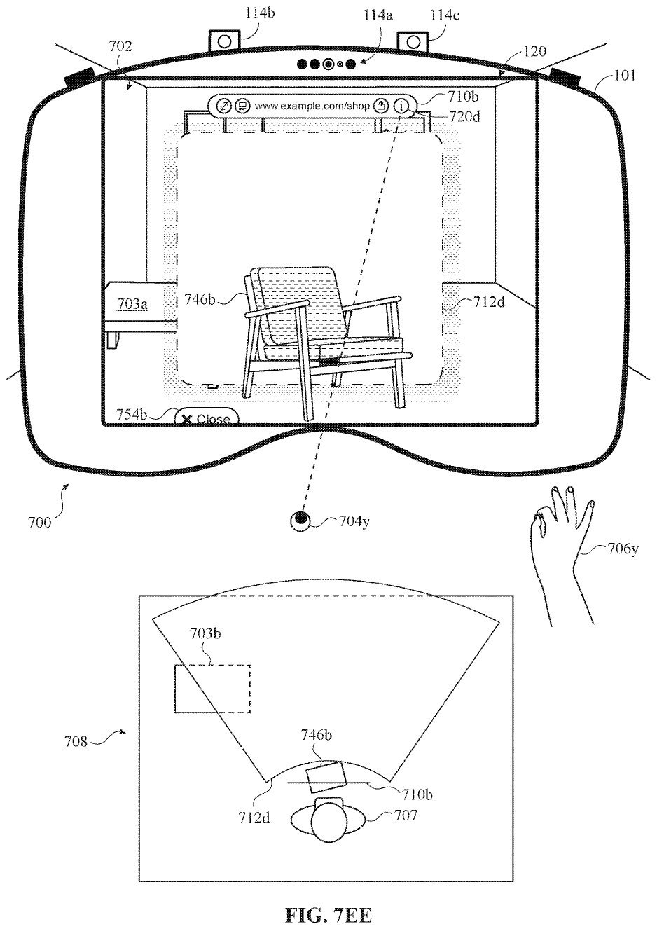

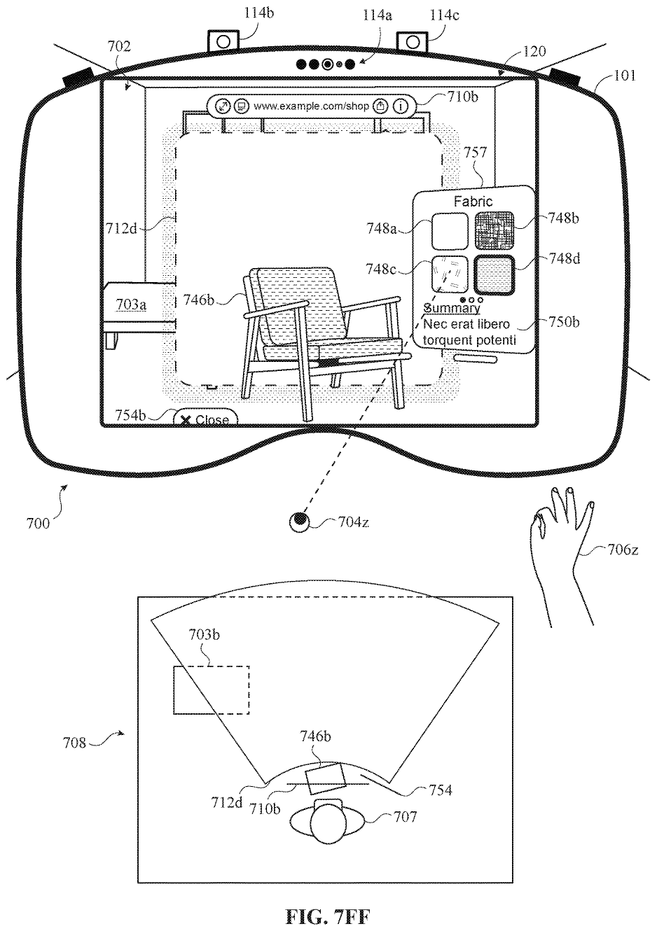

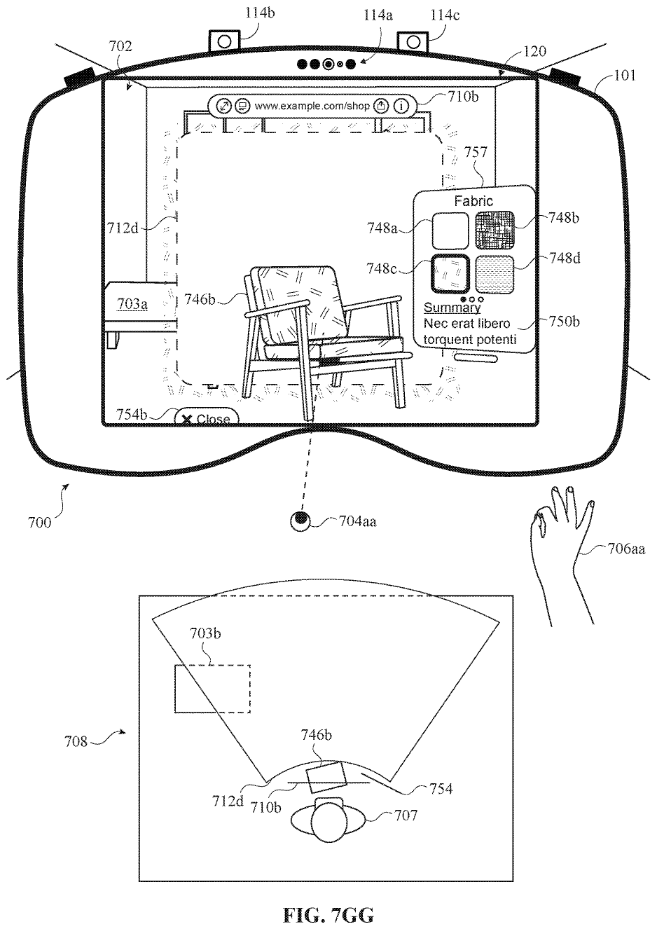

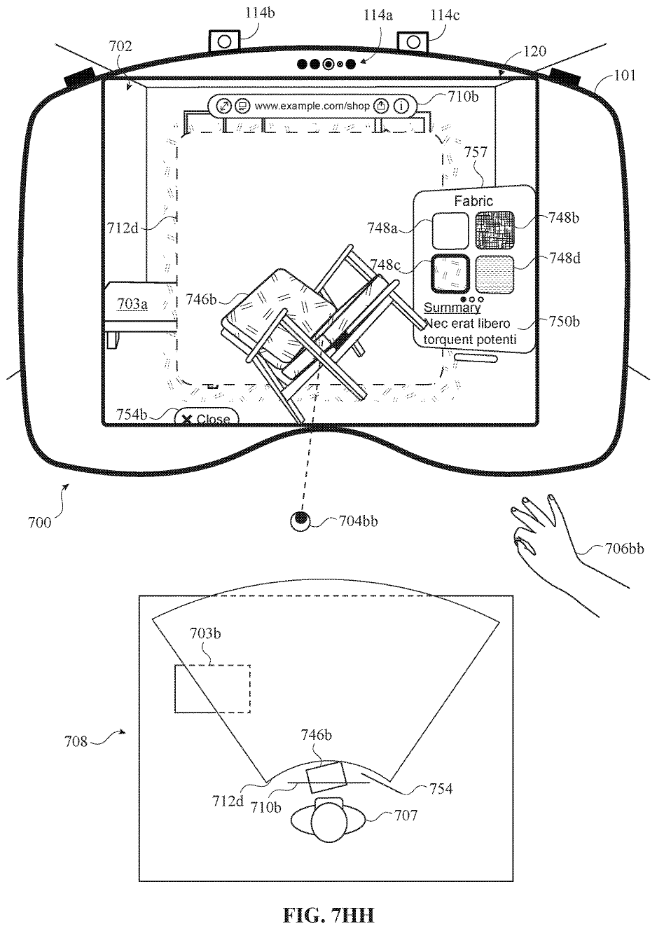

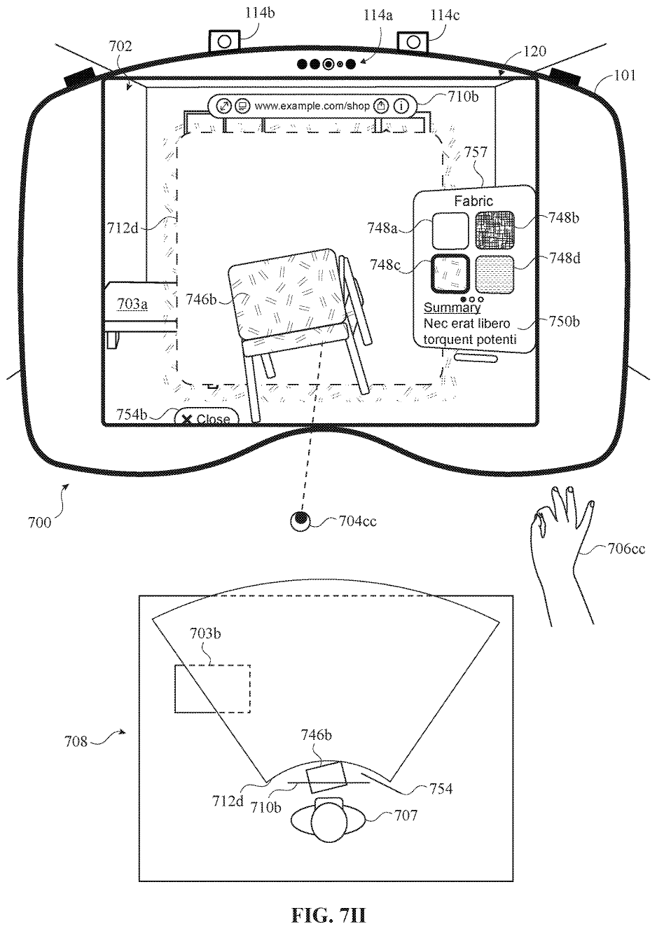

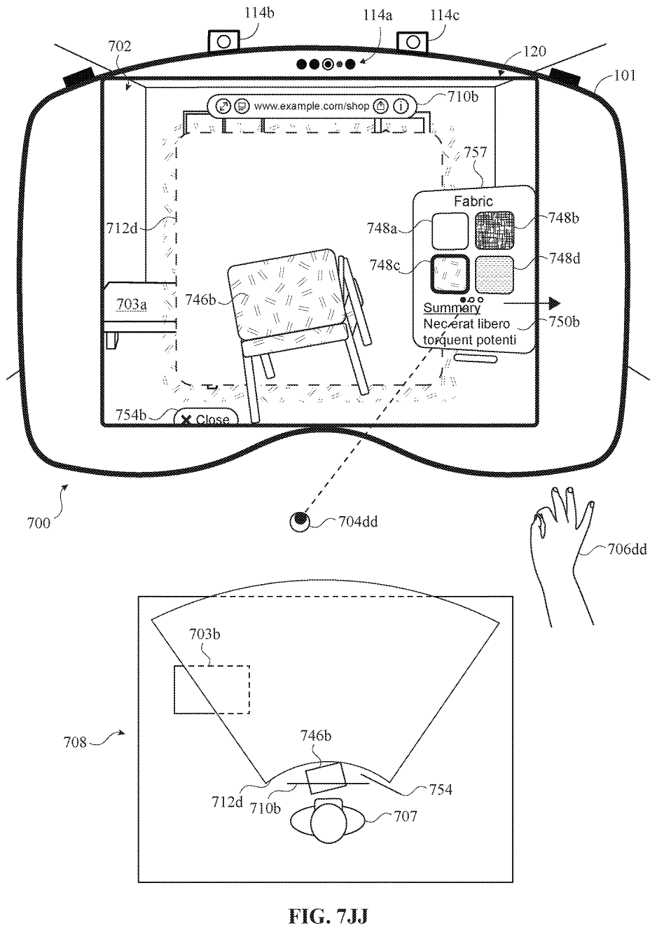

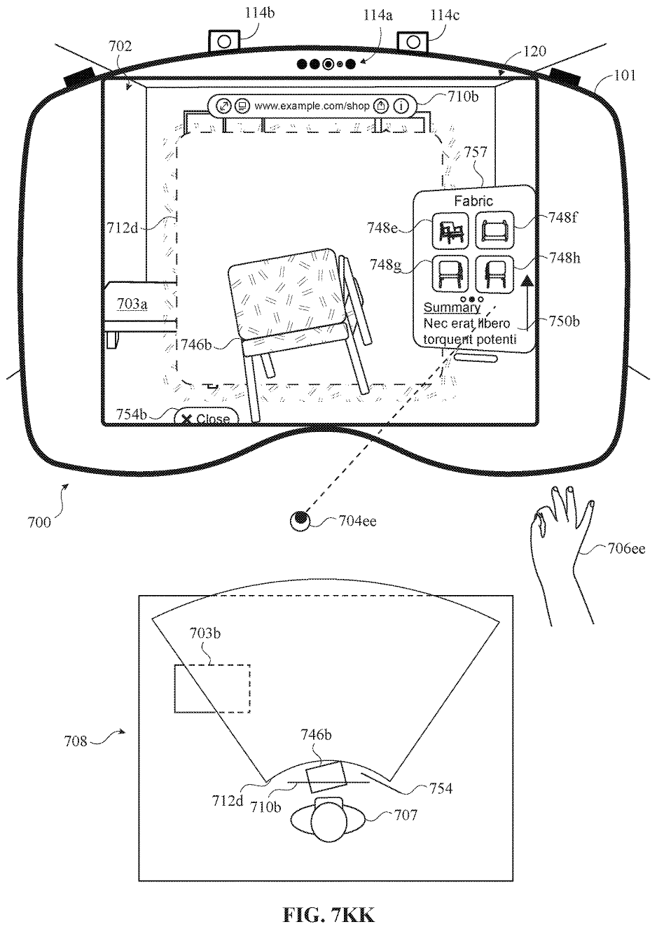

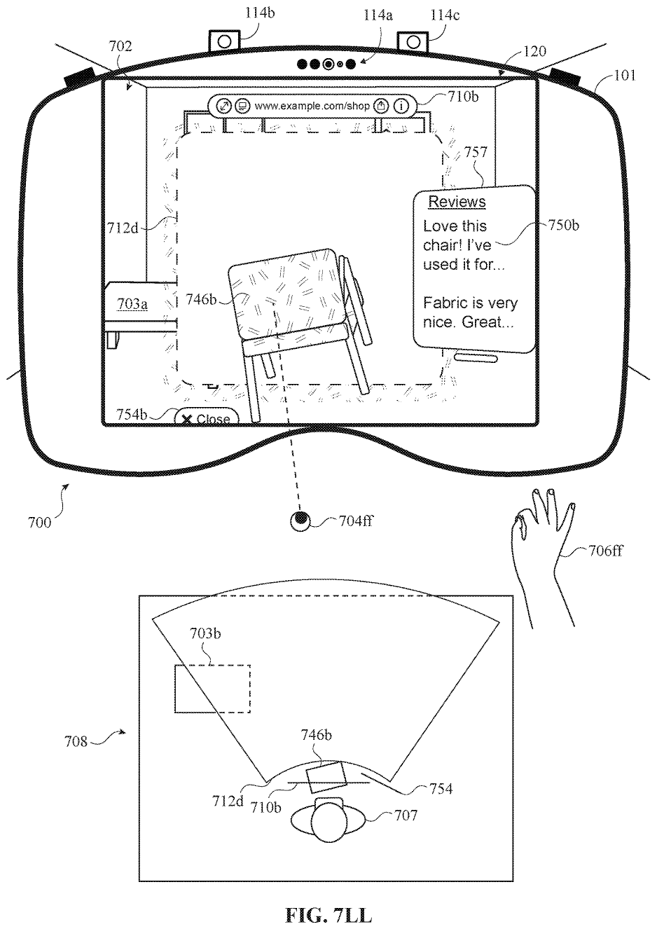

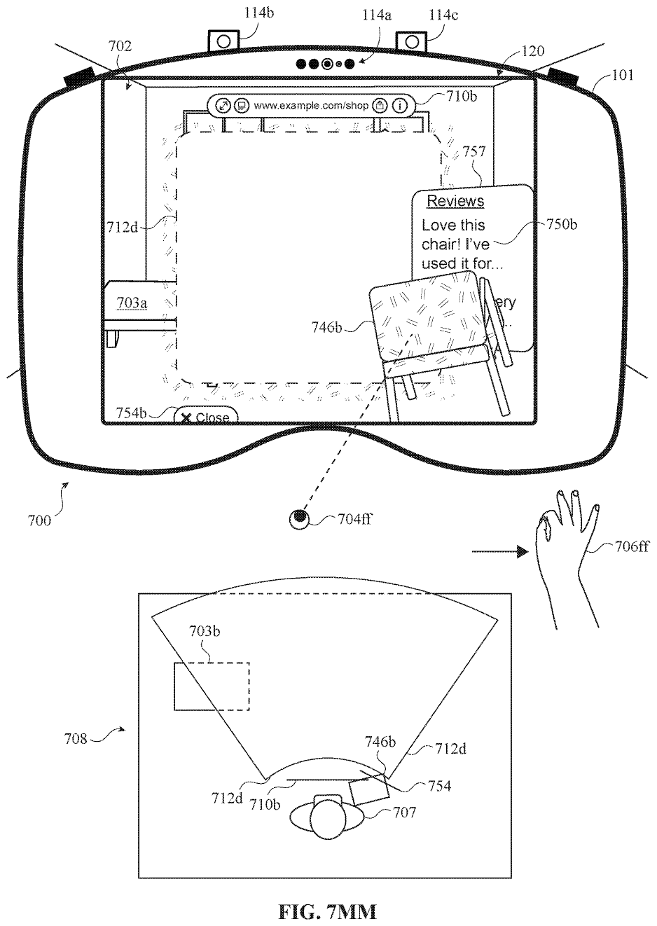

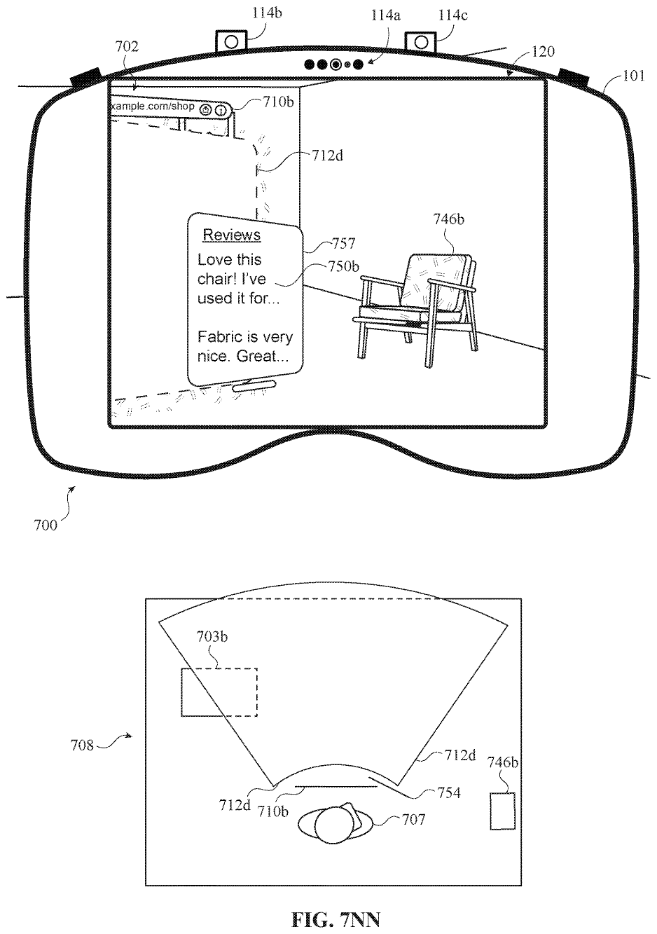

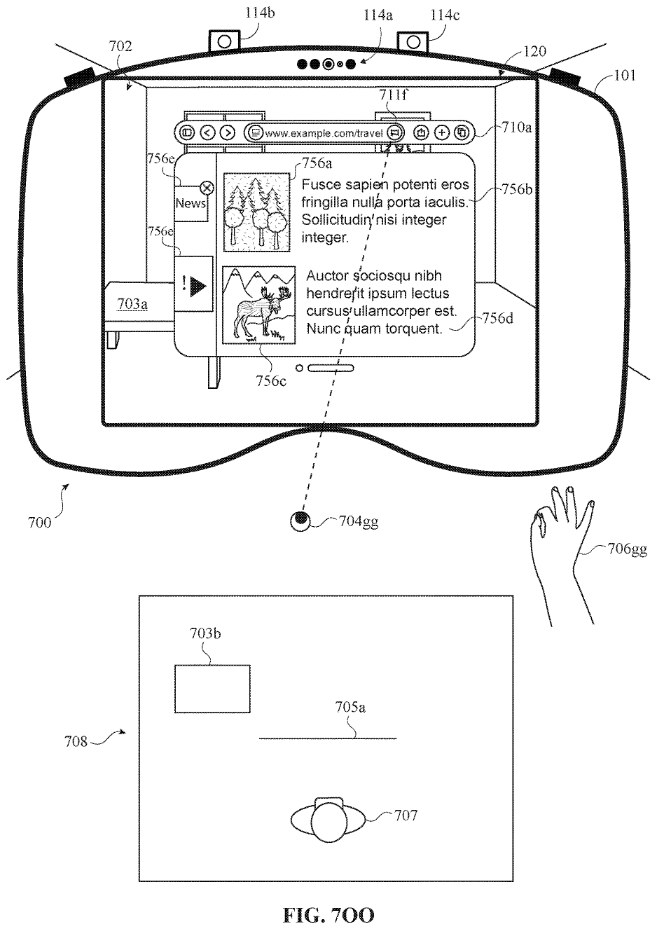

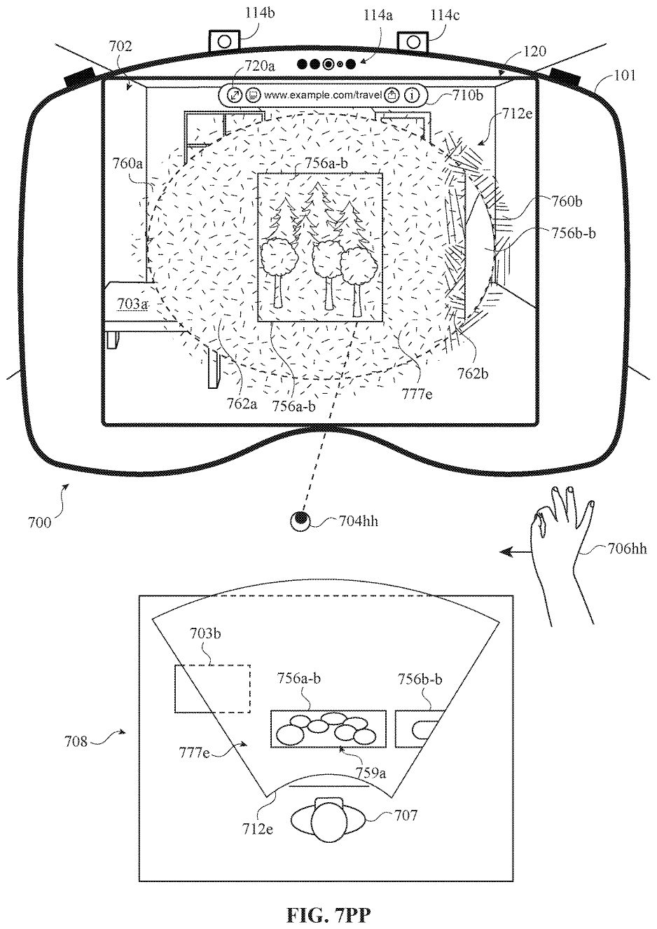

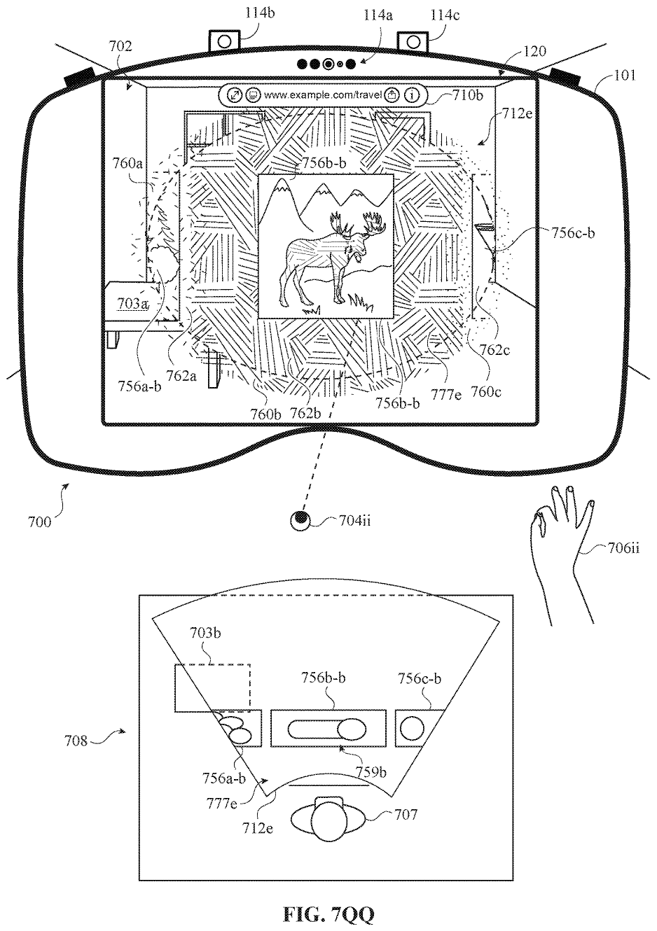

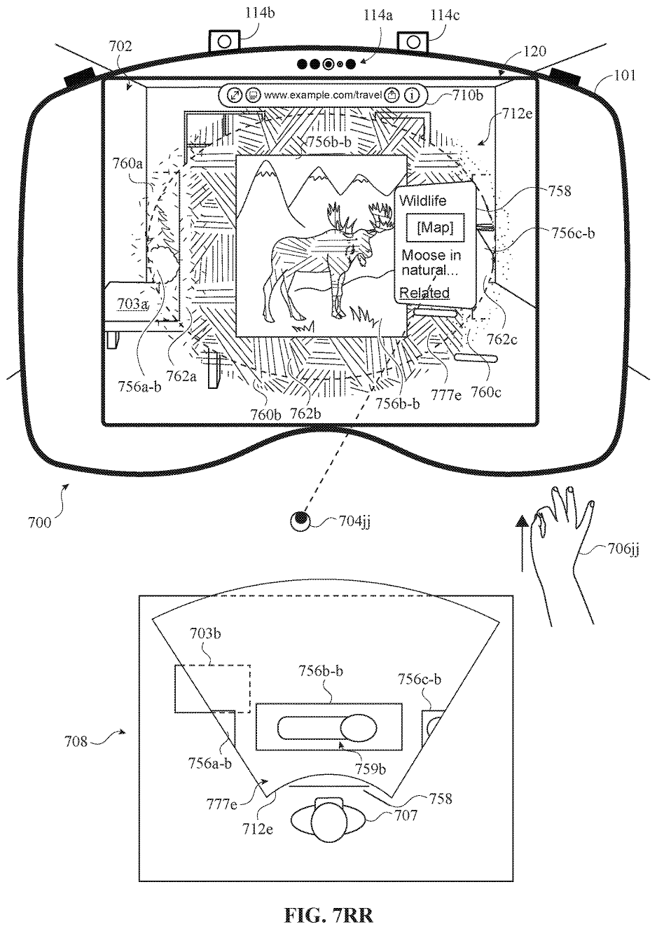

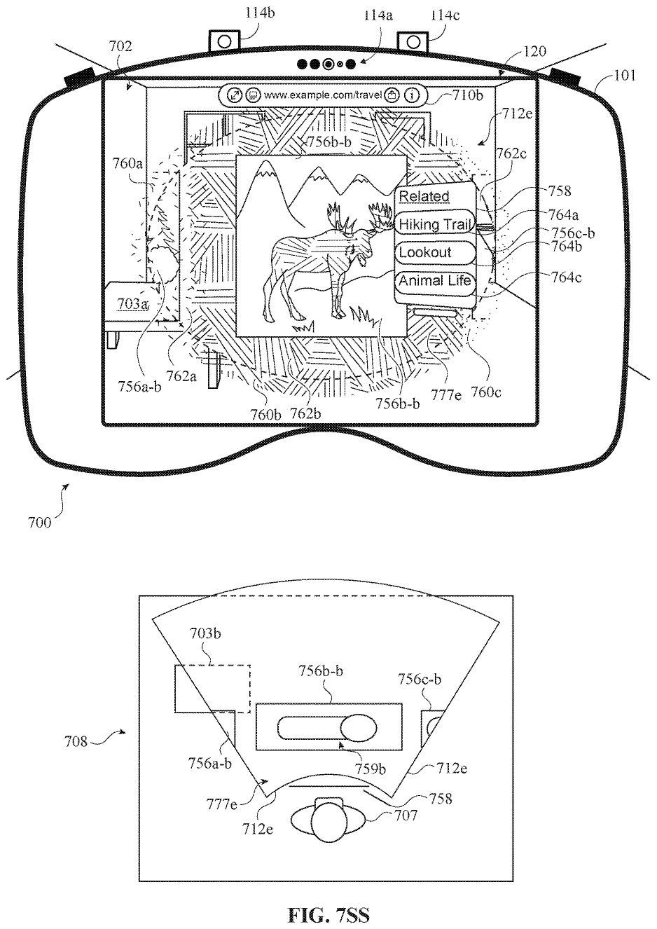

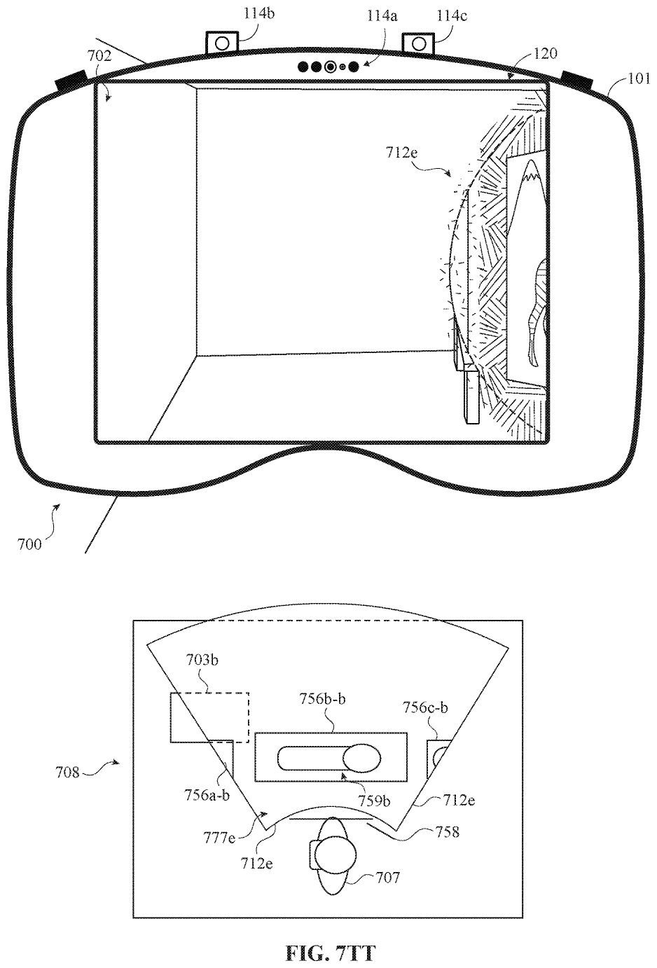

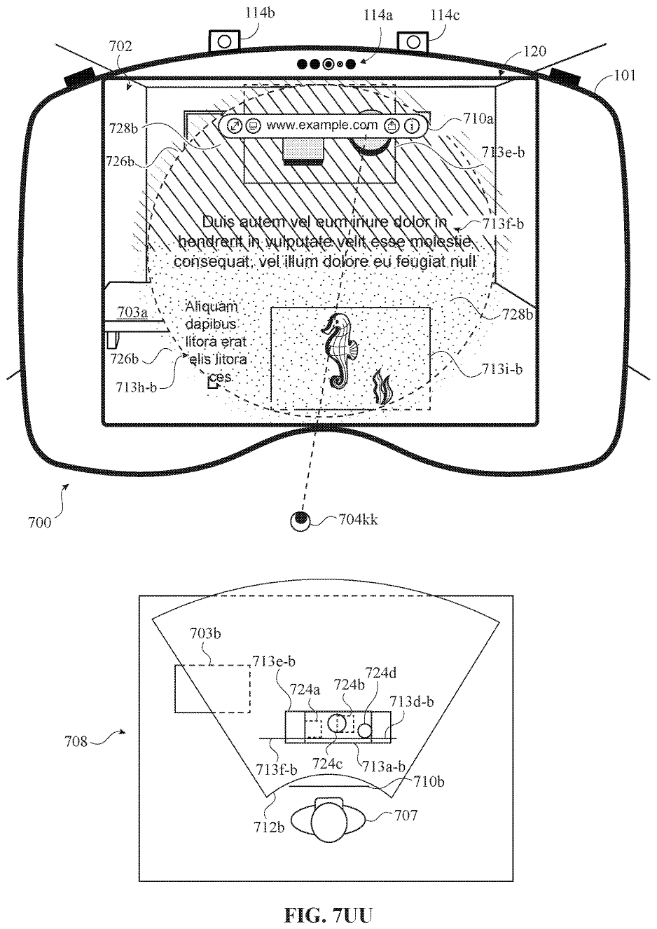

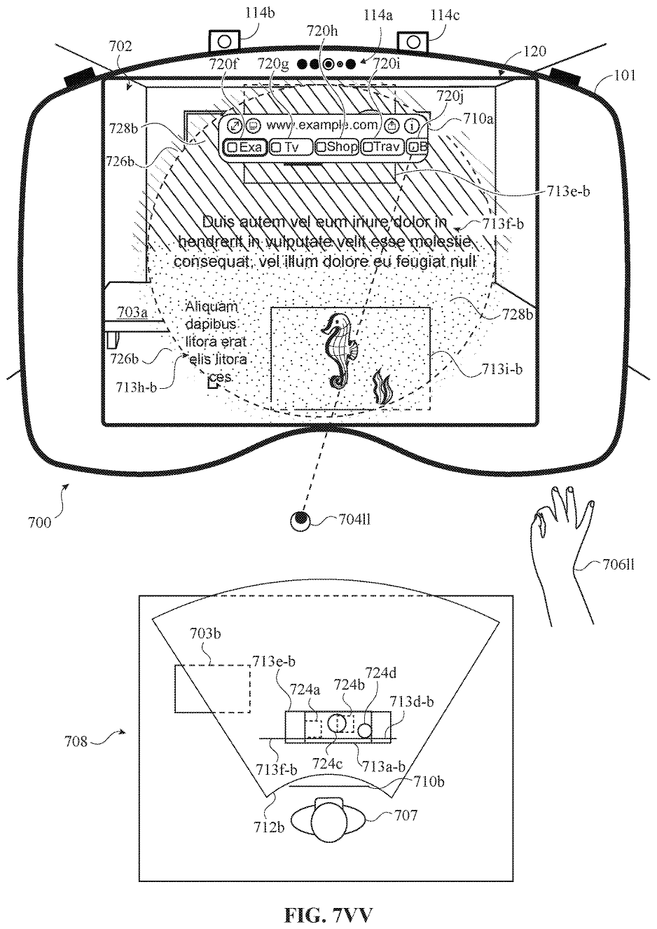

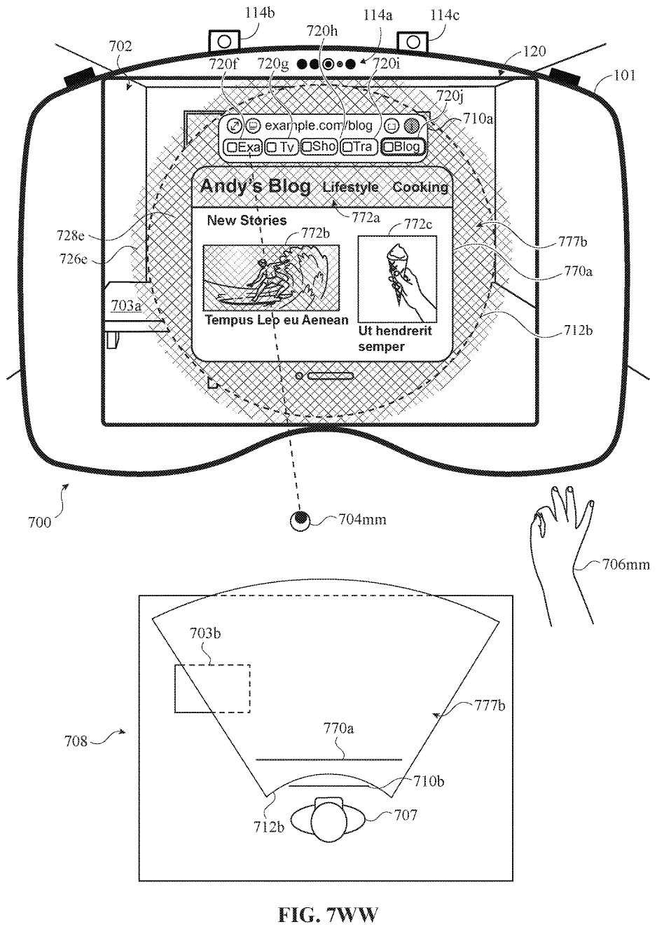

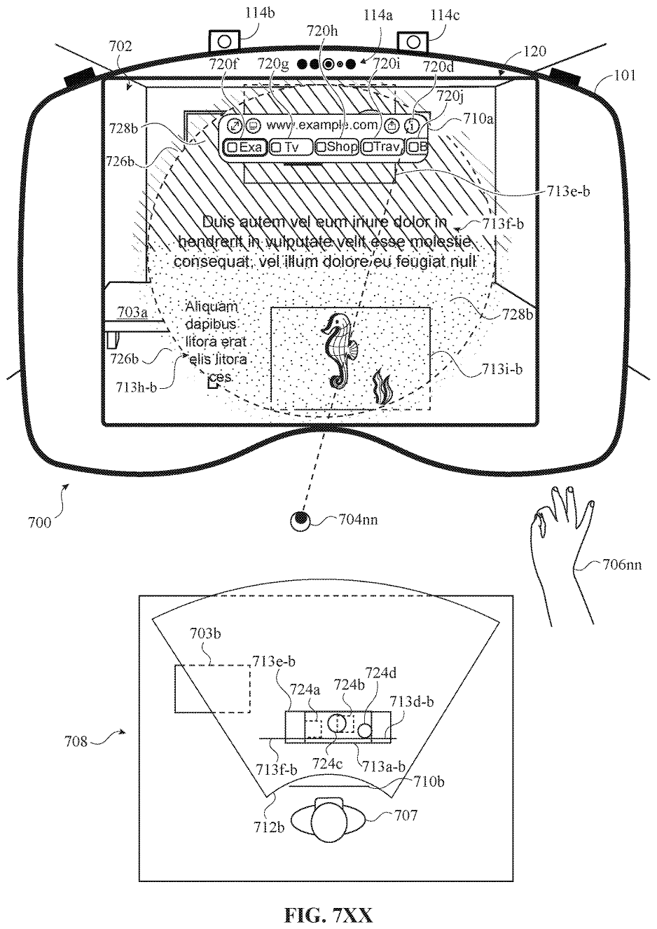

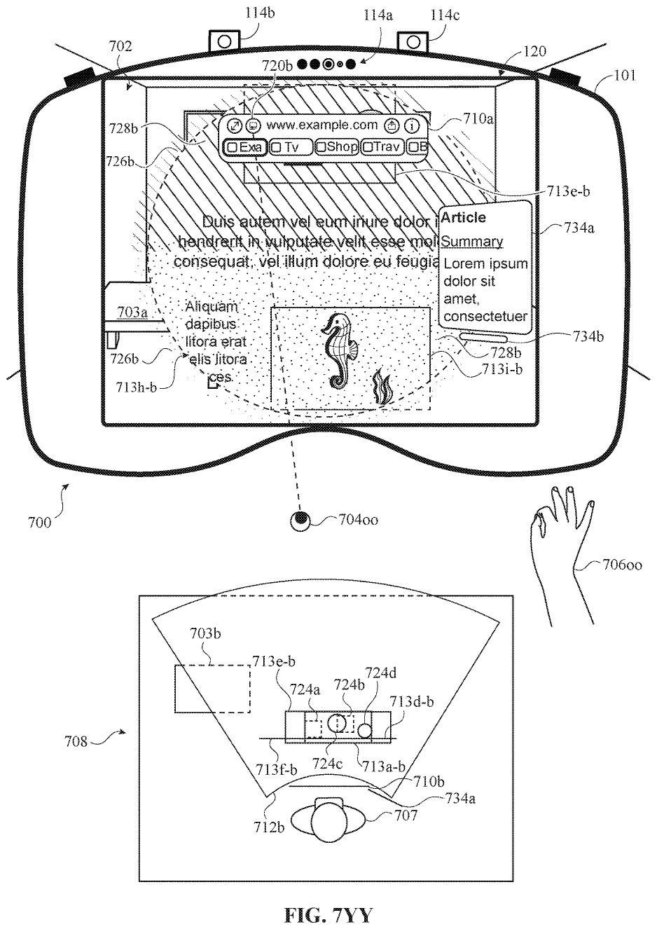

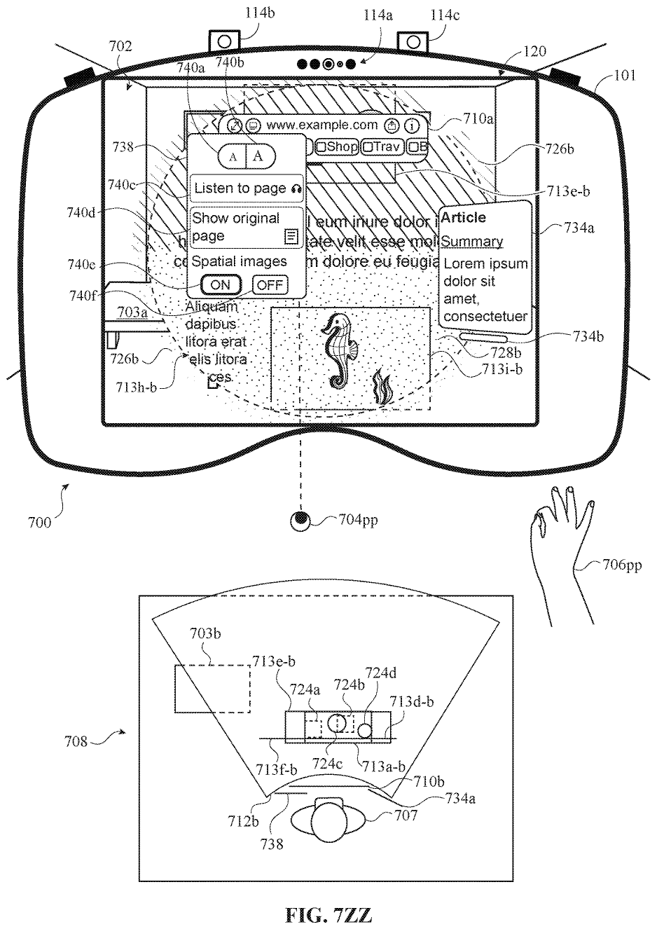

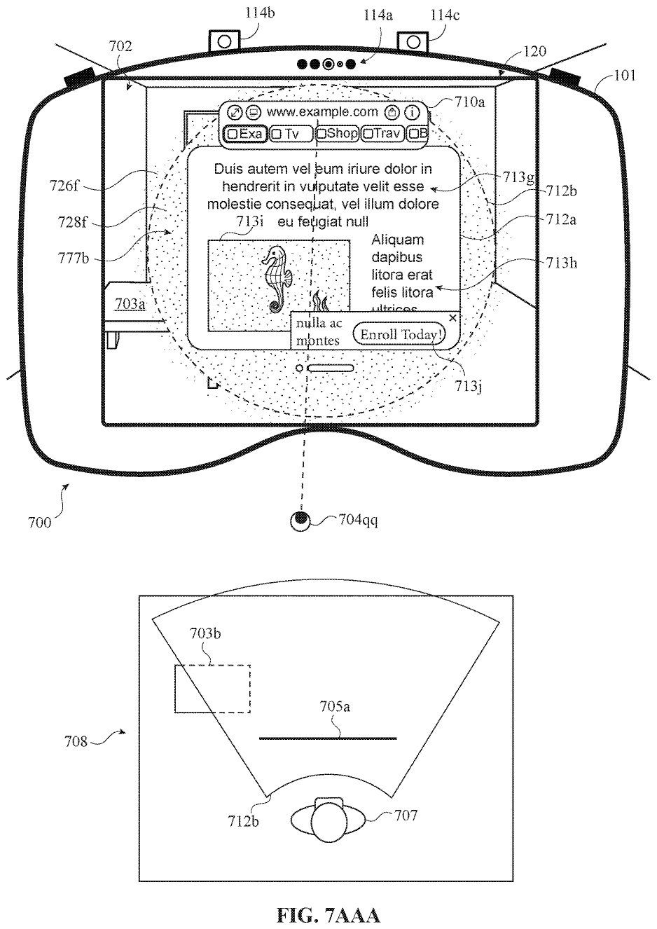

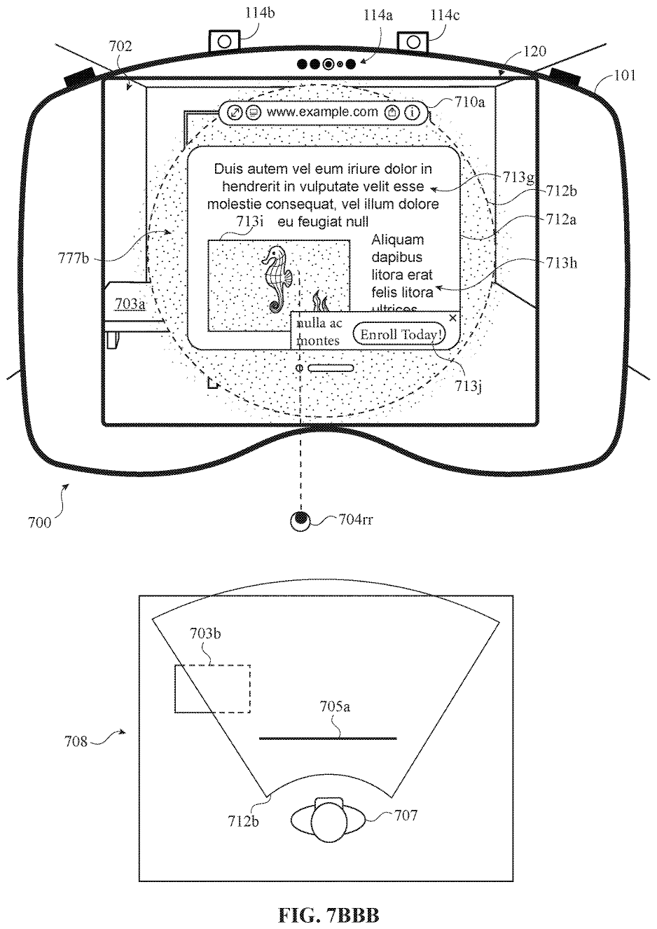

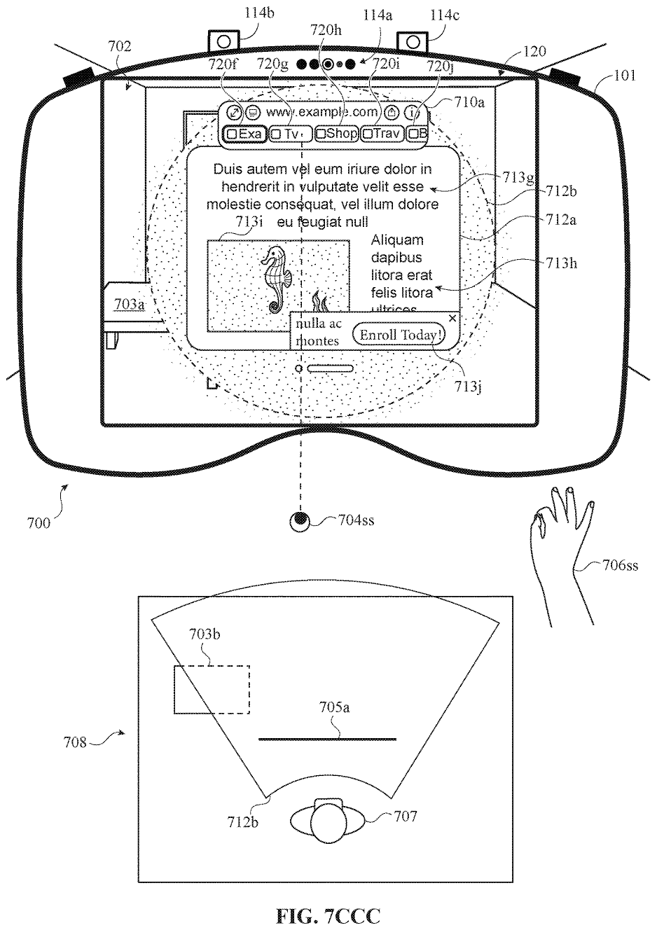

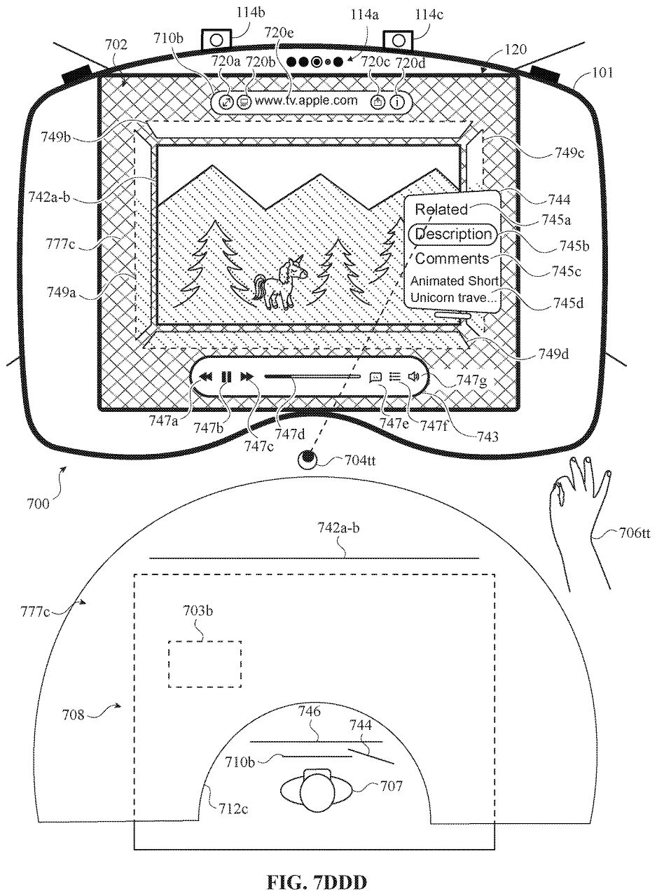

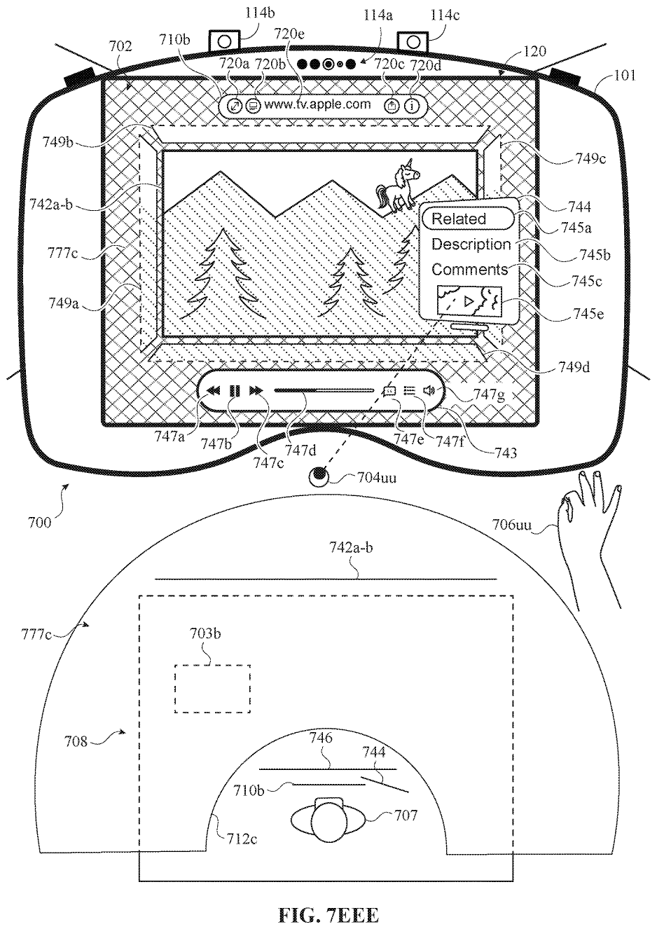

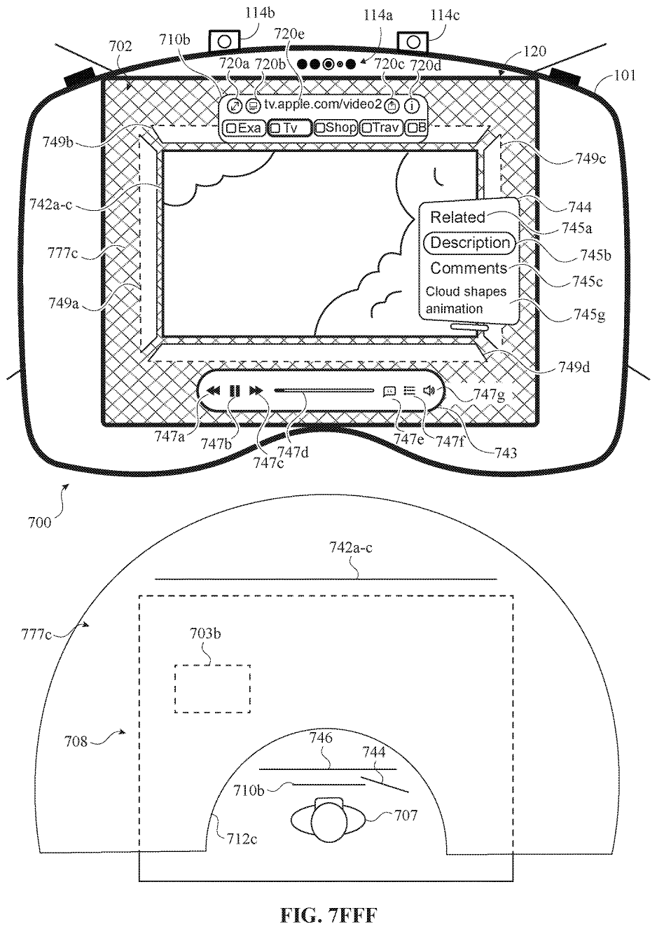

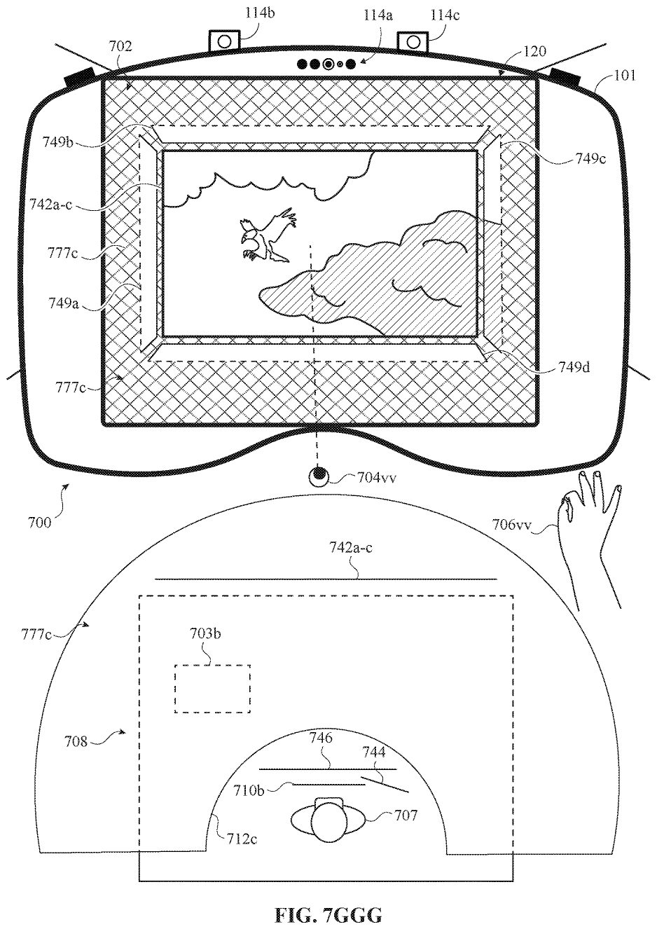

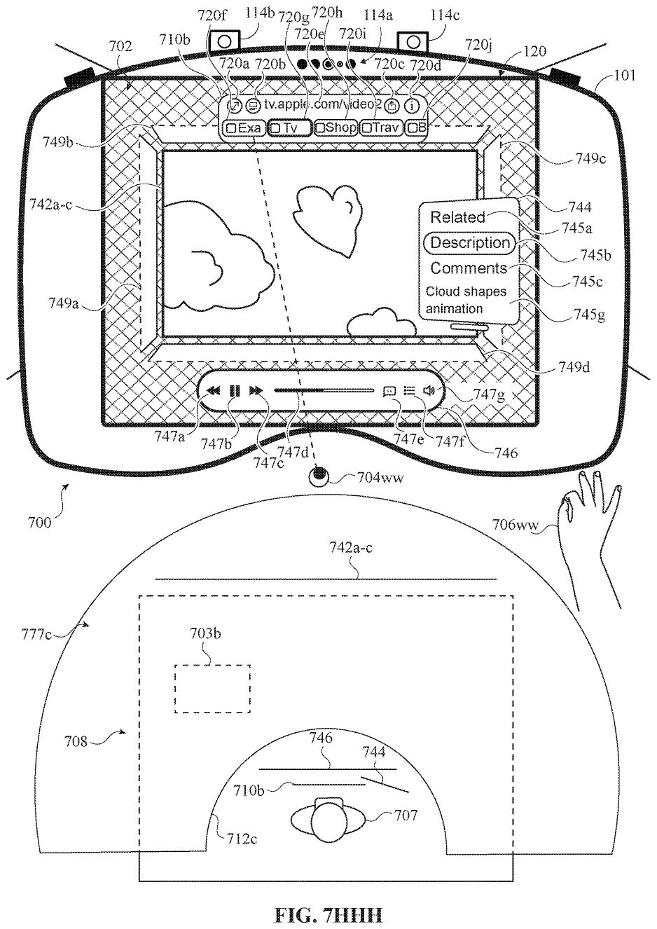

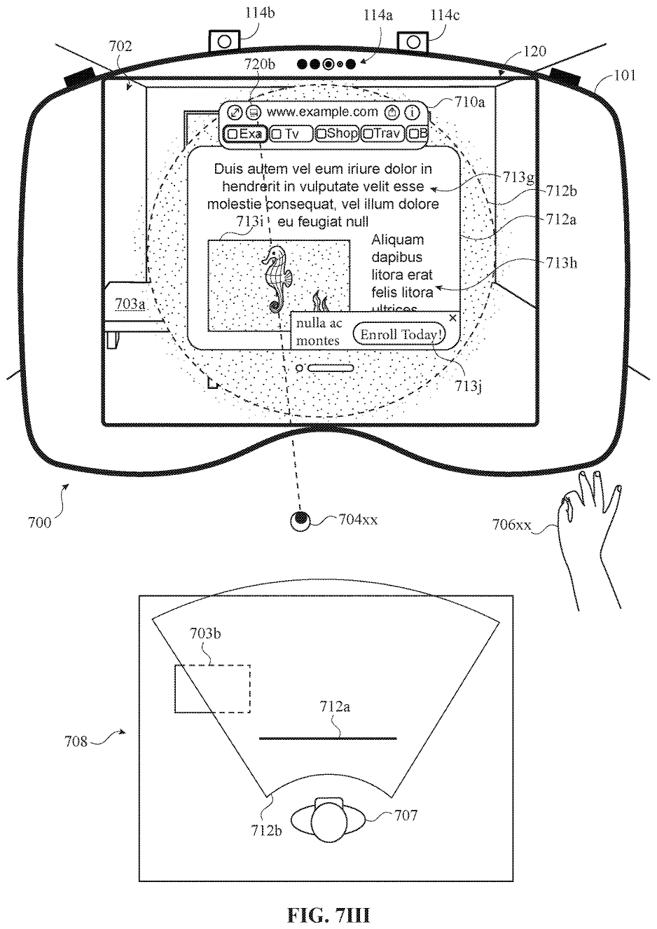

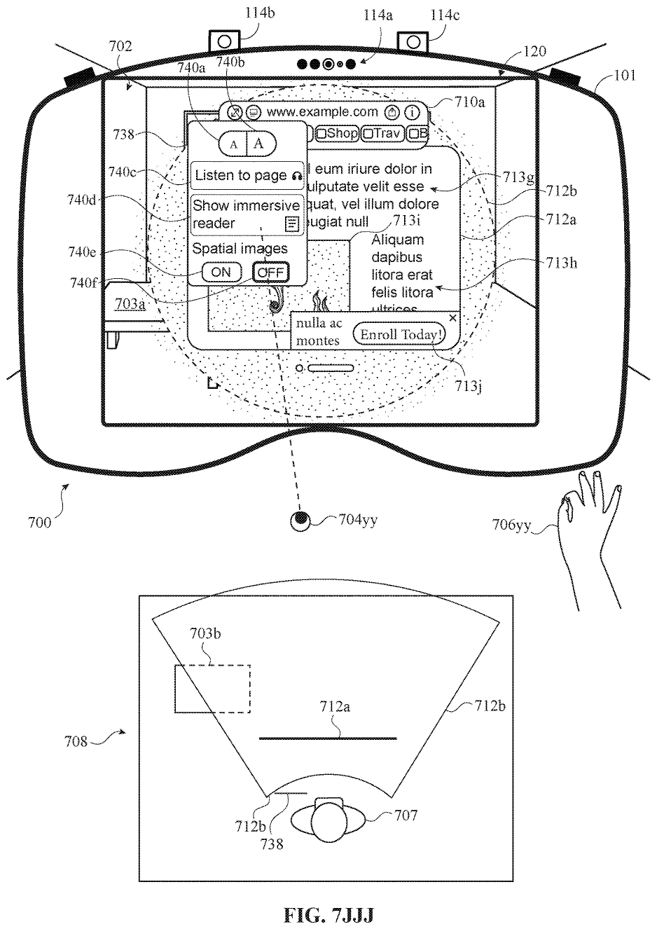

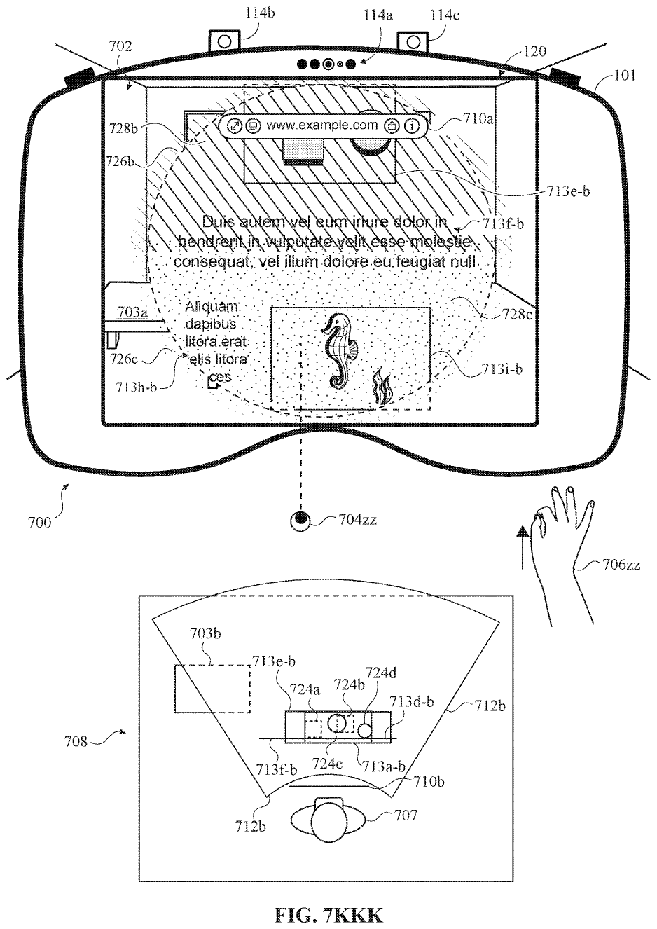

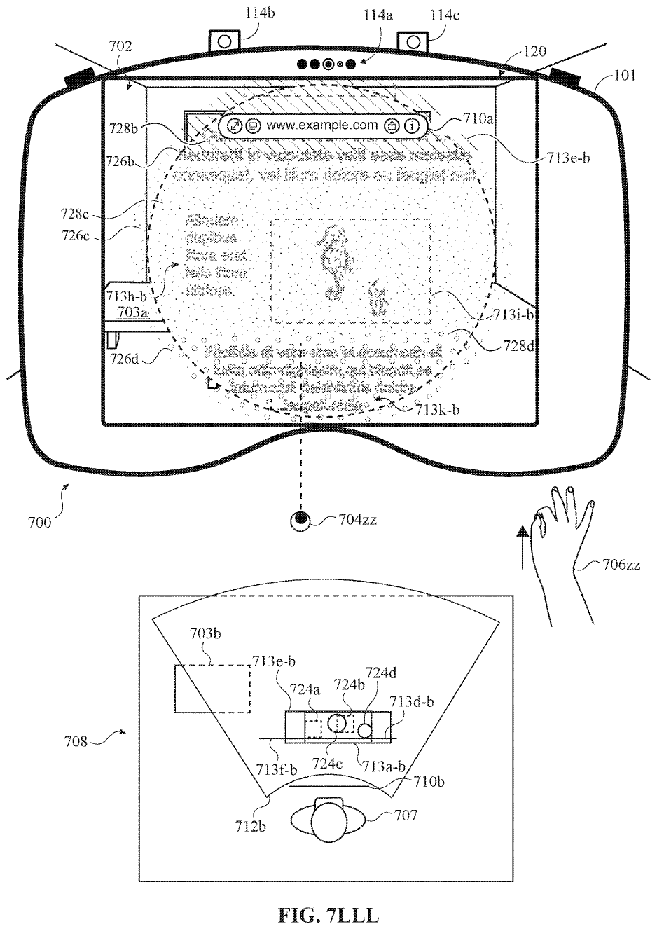

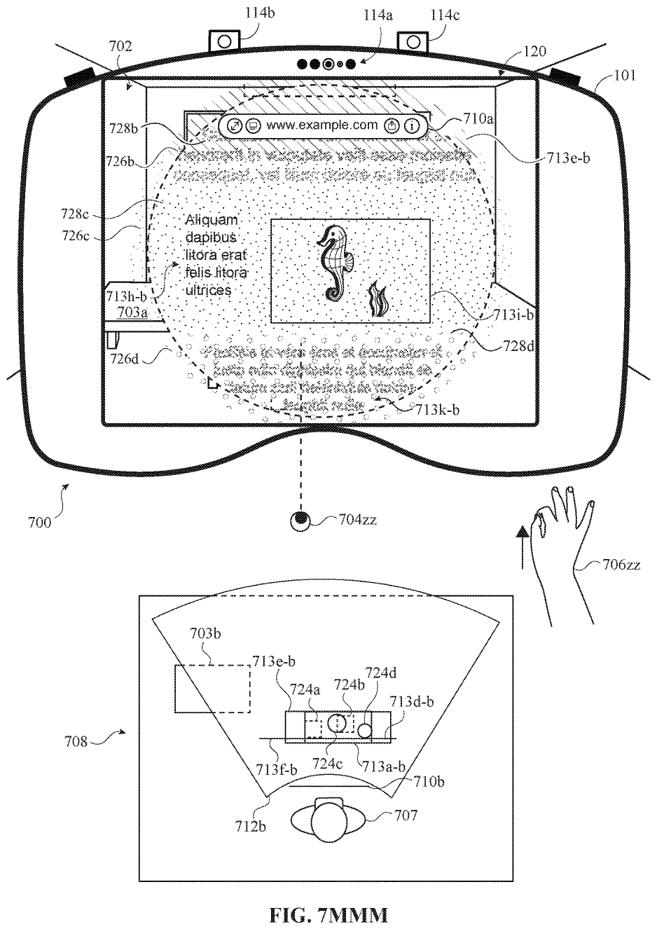

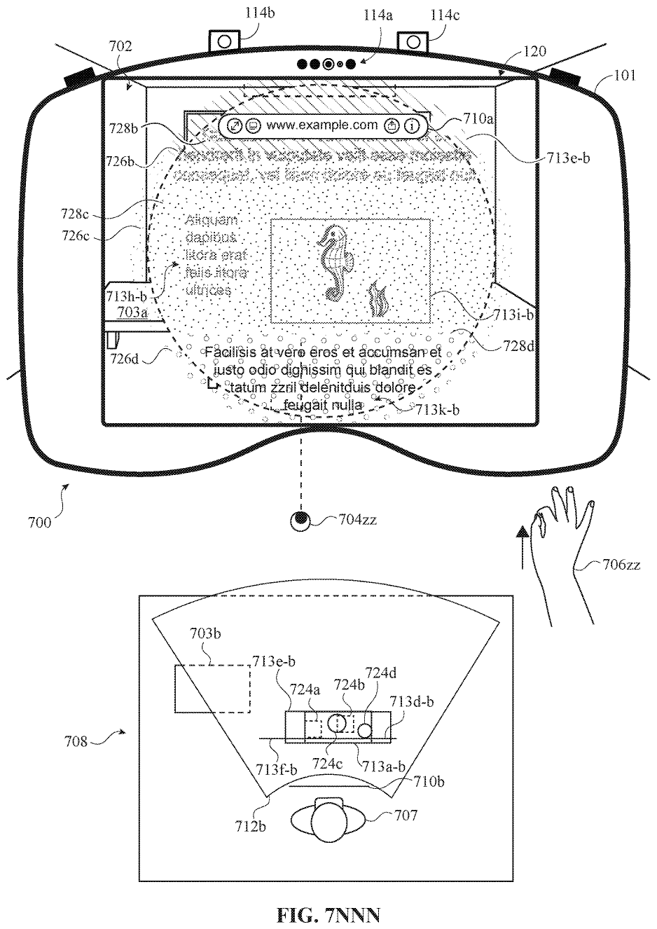

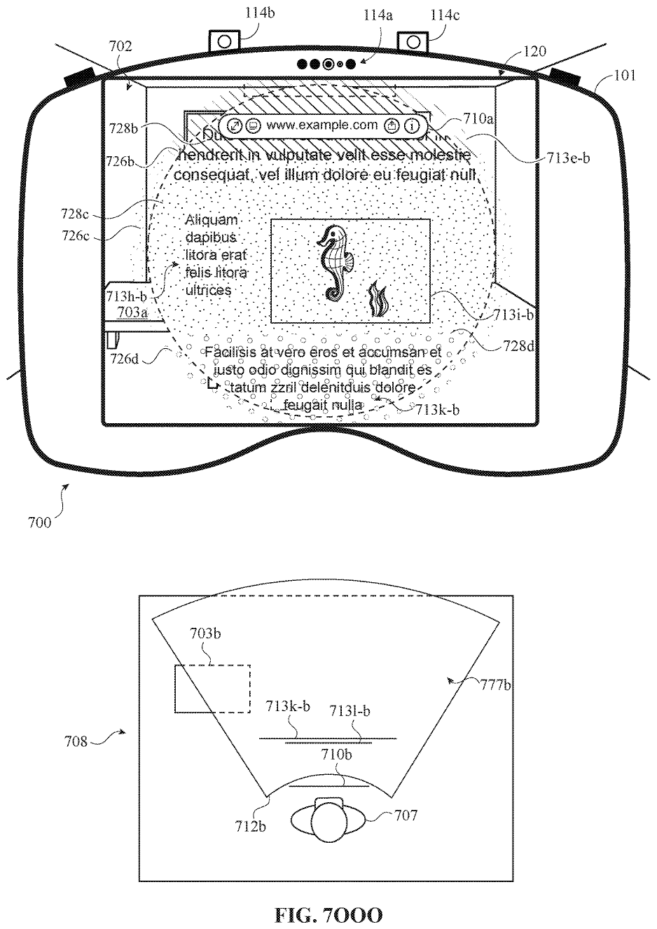

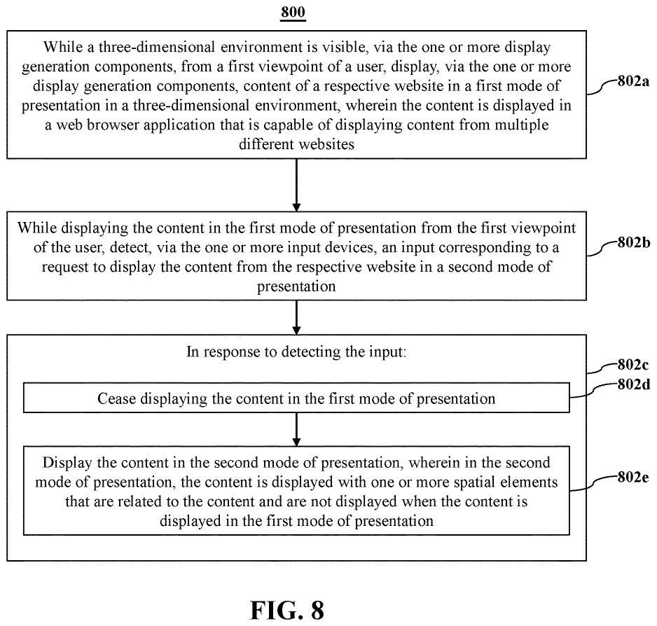

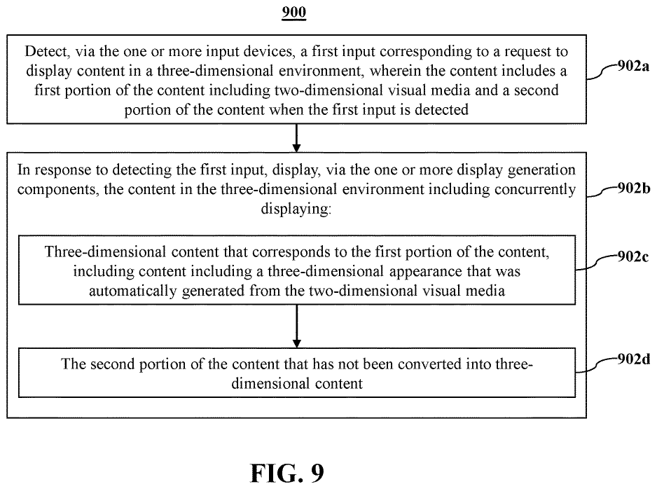

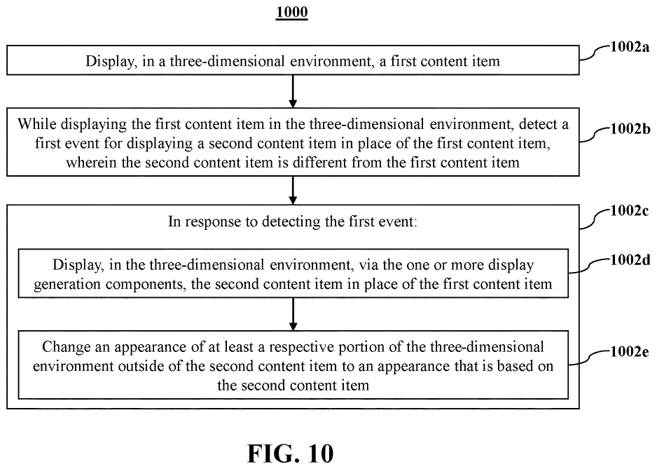

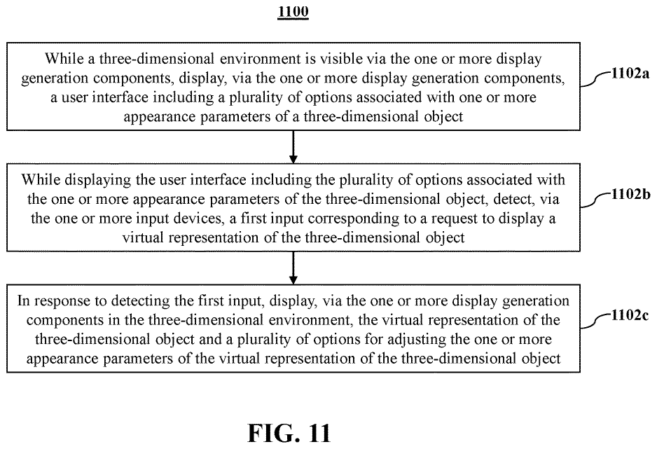

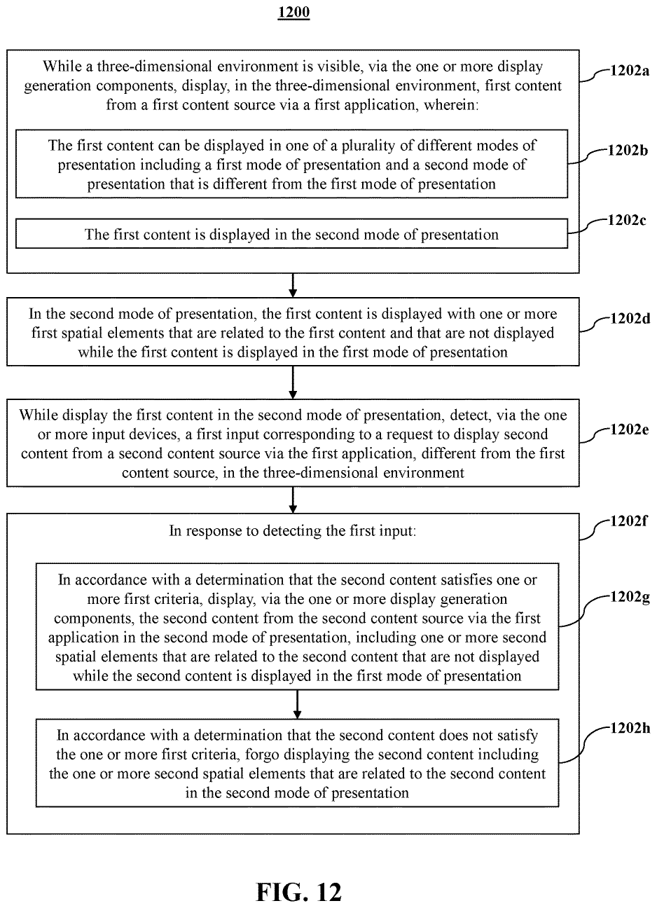

FIGS. 1A-6 provide a description of example computer systems for providing XR experiences to users (such as described below with respect to methods 800, 900, 1000, 1100, and/or 1200). FIGS. 7A-7000 illustrate various embodiments of a computer system displaying three-dimensional content or content including a three-dimensional appearance based on two-dimensional content. FIG. 8 is a flowchart illustrating an exemplary method of transitioning from a first mode of presentation to a second mode of presentation in accordance with some embodiments. The user interfaces in FIGS. 7A-7000 are used to illustrate the processes in FIG. 8. FIG. 9 is a flowchart illustrating an exemplary method of displaying two-dimensional content as automatically generated content with a three-dimensional appearance in accordance with some embodiments. The user interfaces in FIGS. 7A-7000 are used to illustrate the processes in FIG. 9. FIG. 10 is a flowchart illustrating an exemplary method of changing an appearance of the three-dimensional environment based on content displayed in the three-dimensional environment in accordance with some embodiments. The user interfaces in FIGS. 7A-7000 are used to illustrate the processes in FIG. 10. FIG. 11 is a flowchart illustrating an exemplary method of displaying a virtual representation of a three-dimensional object in accordance with some embodiments. The user interfaces in FIGS. 7A-7000 are used to illustrate the processes in FIG. 11. FIG. 12 is a flowchart illustrating an exemplary method of displaying content in a second mode of presentation in accordance with some embodiments. The user interfaces in FIGS. 7A-7000 are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, and/or a touch-screen.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, and/or velocity sensors.), and optionally one or more peripheral devices 195 (e.g., home appliances, and/or wearable devices). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

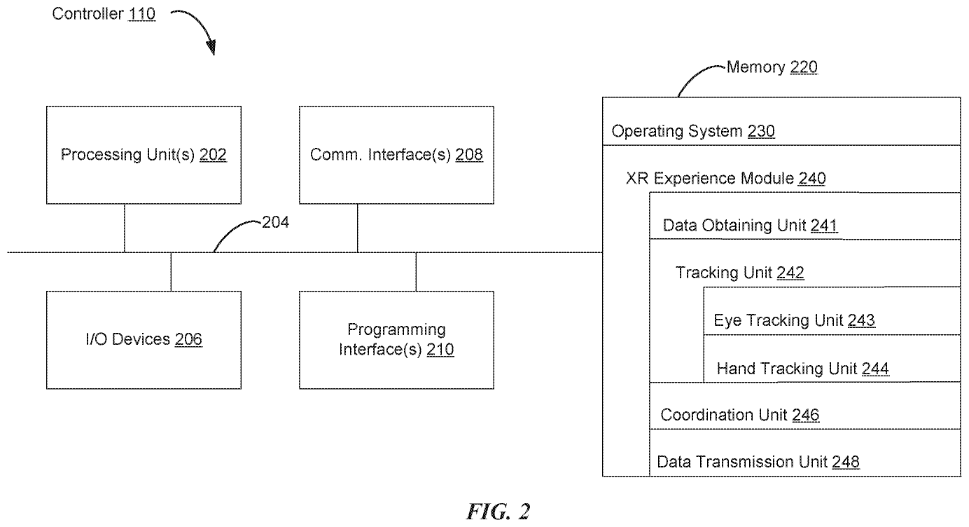

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, and/or central server). In some embodiments, the controller 110 is communicatively coupled with the display generation component 120 (e.g., an HMD, a display, a projector, and/or a touch-screen) via one or more wired or wireless communication channels 144 (e.g., BLUETOOTH, IEEE 802.11x, IEEE 802.16x, and/or IEEE 802.3x). In another example, the controller 110 is included within the enclosure (e.g., a physical housing) of the display generation component 120 (e.g., an HMD, and/or a portable electronic device that includes a display and one or more processors), one or more of the input devices 125, one or more of the output devices 155, one or more of the sensors 190, and/or one or more of the peripheral devices 195, or share the same physical enclosure or support structure with one or more of the above.

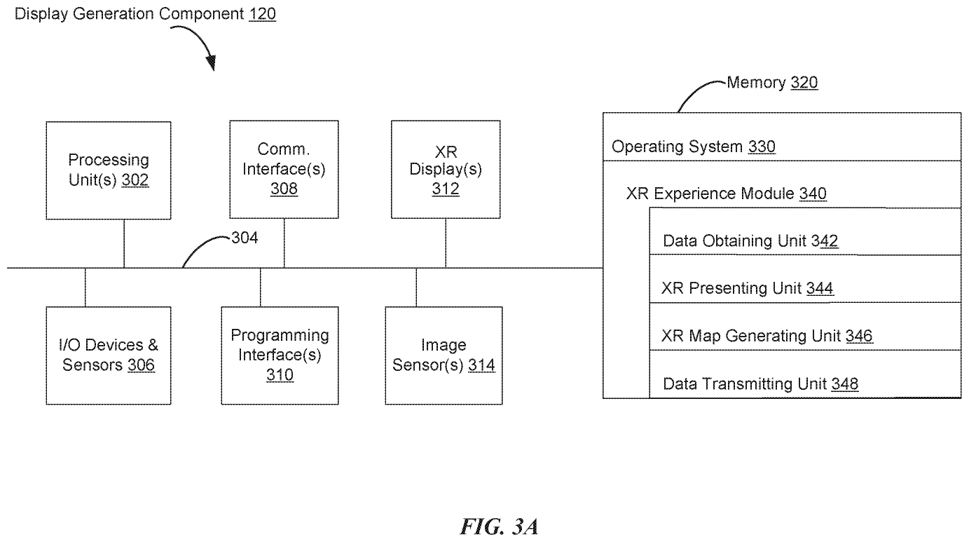

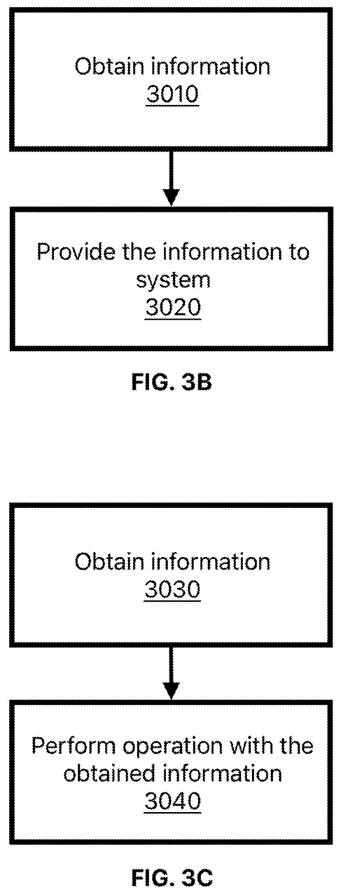

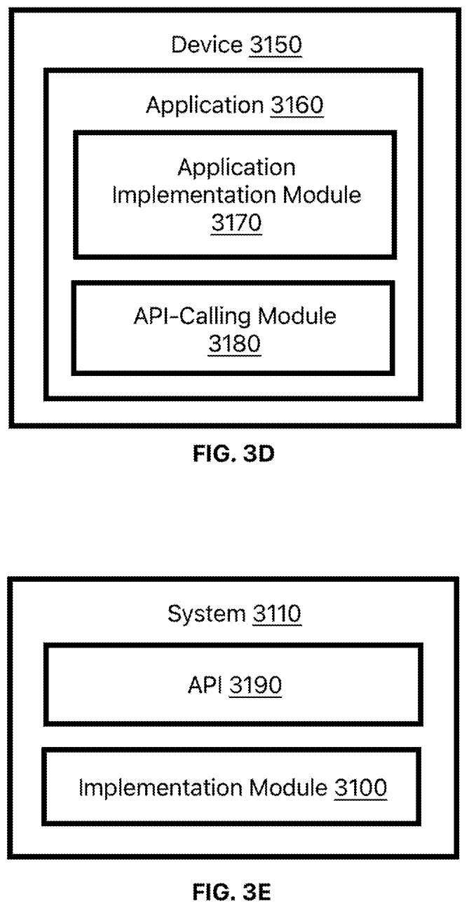

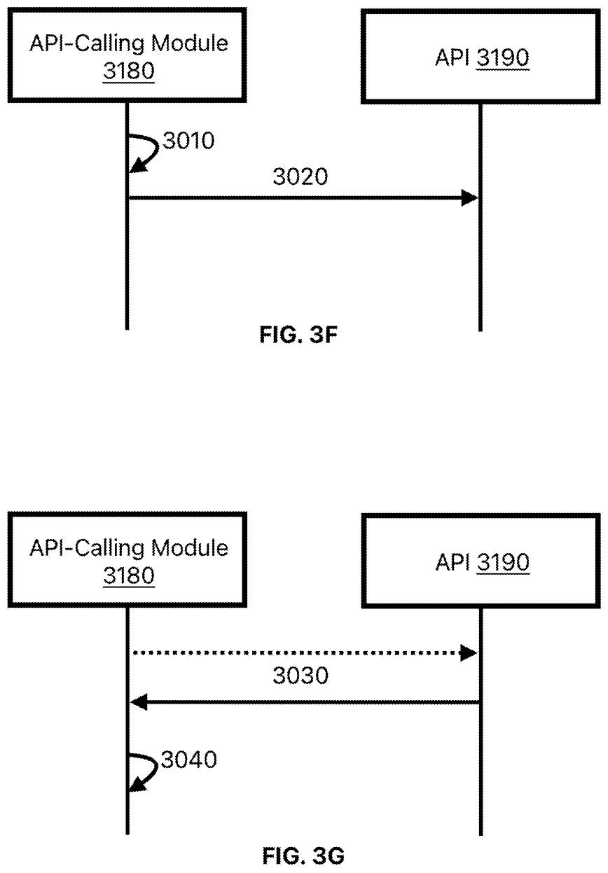

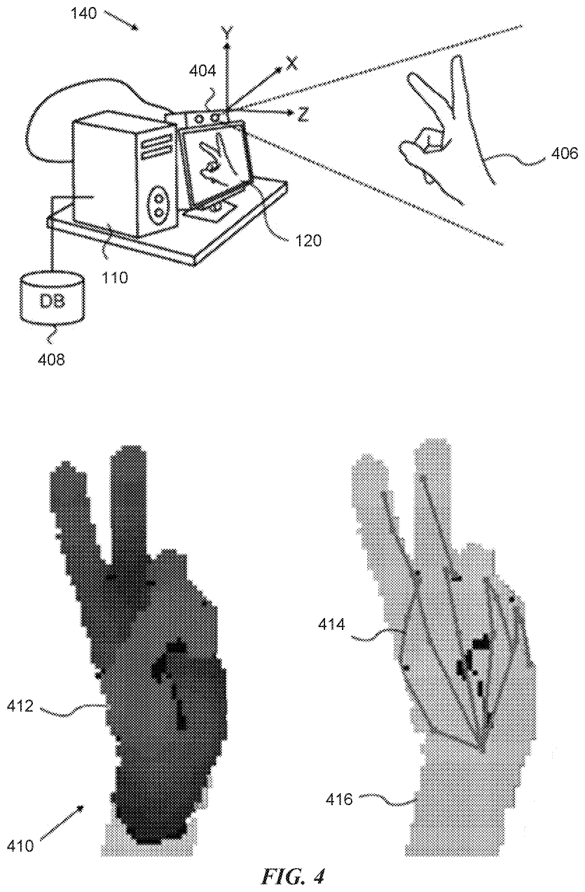

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, and/or on his/her hand). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent FIGS. referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent FIGS. and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other FIGS. shown and described herein. Likewise, any of the features, components, and/or parts, including the arrangements and configurations thereof shown and described with reference to any other FIG. shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, and/or location data) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

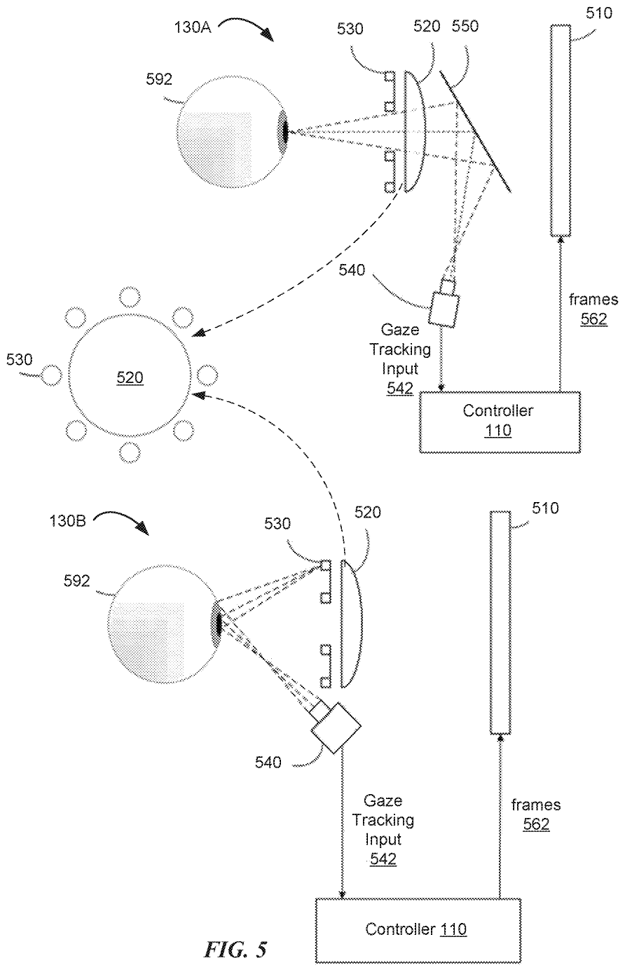

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, and/or location data) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, and/or blood glucose sensor), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, and/or holographic waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, and/or location data) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, and/or location data) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 800, 900, 1000, 1100, and/or 1200 (FIGS. 8, 9, 10, 11, and/or 12) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, and/or end of the hand connecting to wrist.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, and/or eye spacing. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, and/or a projector) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

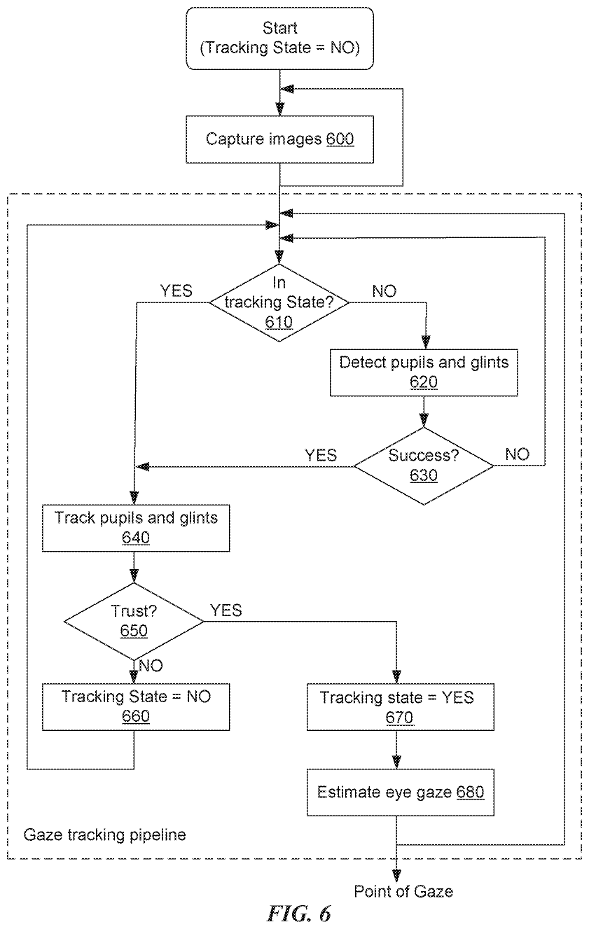

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, and/or holding a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

Users interact with electronic devices in many different manners. In some embodiments, an electronic device is in communication with one or more input devices and/or one or more display generation components. In some embodiments, the computer system displays content in a non-spatial experience in a three-dimensional environment. In some embodiments, the computer system displays one or more portions of the content using a spatial experience in the three-dimensional environment. The embodiments described below provide ways in which the computer system transitions from a non-spatial to a spatial experience when displaying content. Additionally, the embodiments below provide ways in which the computer system displays content in a spatial mode. Displaying content in a spatial mode allows the user to be immersed in the presentation experience by reducing distractions in the three-dimensional environment. It is understood that people use devices such as computer systems. When a person uses a device, that person is optionally referred to as a user of the device or user of the computer system.

FIGS. 7A-7TT illustrate exemplary ways in which a computer system presents content in a three-dimensional environment. The embodiments in these figures are used to illustrate the processes described below, including the processes described with reference to FIGS. 8-11. Although FIGS. 7A-7TT illustrate various examples of ways a computer system is able to perform the processes described below with respect to FIGS. 8-11, it should be understood that these examples are not meant to be limiting, and the computer system is able to perform one or more processes described below with reference to FIGS. 8-11 in ways not expressly described with reference to FIGS. 7A-7TT.

In some embodiments, the processes described herein to convert two-dimensional content to content with a three-dimensional appearance (“conversion process”) can be deployed as one or more generative models, where content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content. Automatically-generated content optionally includes deterministically generated content that is generated by one or more computer systems and/or non-deterministically generated content that is generated automatically by one or more computer systems.

In some embodiments, automatically-generated content that is generated using a non-deterministic process is referred to as generative content (e.g., generative images, generative graphics, generative video, generative audio, and/or generative text). Generative content is typically generated by an automated process based on a prompt that is provided to the automated process. In some embodiments, the automated process is a Machine Learning (ML) process. An ML process typically uses one or more ML models to generate an output based on an input. An ML process optionally includes one or more pre-processing steps to adjust the input before it is used by the ML model to generate an output (e.g., adjustment to a user-provided prompt, creation of a system-generated prompt, and/or ML model selection). Generative content can, in some embodiments, be generated using a non-deterministic process that generates content using one or more automatic steps that include specific rules and steps for processing a prompt including one or more non-deterministic steps that introduce novel generative elements into the content that is generated. An ML process optionally includes one or more post-processing steps to adjust the output by the ML model (e.g., passing ML model output to a different ML model, upscaling, downscaling, cropping, formatting, and/or adding or removing metadata) before the output of the ML model used for other purposes such as being provided to a different software process for further processing or being presented (e.g., visually or audibly) to a user. An ML process that generates generative content is sometimes referred to as a generative ML process.

A prompt for generating generative content can include one or more of: one or more words (e.g., a natural language prompt that is written or spoken), one or more images, one or more drawings, and/or one or more videos. ML processes can include neural networks, linear regression, decision trees, support vector machines (SVMs), Naïve Bayes, and k-nearest neighbors. Neural networks can include transformer-based deep neural networks such as large language models (LLMs) that are trained using supervised, unsupervised, reinforcement, and/or other learning techniques. Generative pre-trained transformer models are a type of LLM that can be effective at generating novel generative content based on a prompt. Some ML processes use a prompt that includes text to generate either different generative text, generative audio content, and/or generative visual content. Some ML processes use a prompt that includes visual content and/or an audio content to generate generative text (e.g., a transcription of audio and/or a description of the visual content). Some multi-modal ML processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an ML process that include phrasing, a specified style, relevant context (e.g., starting point content and/or one or more examples), and/or a role for the ML process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example when generating an image from a diffusion model, a random noise pattern is iteratively denoised based on the prompt to generate an image that is based on the prompt. While specific types of ML processes have been described herein, it should be understood that a variety of different ML processes could be used to generate generative content based on a prompt.

FIG. 7A illustrates a computer system 101 displaying, via a display generation component (e.g., display generation component 120 of FIG. 1), a three-dimensional environment 702. As described above with reference to FIGS. 1-6, the computer system 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user while the user interacts with the computer system 101. In some embodiments, the user interfaces and/or content shown below could also be implemented on a head-mounted display that includes a display generation component that displays the user interface to the user and sensors to detect the physical environment and/or movements of the user's hands (e.g., external sensors facing outwards from the user), and/or gaze of the user (e.g., internal sensors facing inwards towards the face of the user). The figures herein illustrate a three-dimensional environment that is presented and/or visible to the user by computer system 101 (e.g., and displayed by the display generation component of computer system 101) and an overhead view of the physical and/or three-dimensional environment associated with computer system 101 (e.g., such as overhead view 708 in FIG. 7A) to illustrate the relative locations of objects in the real world environment and the locations of virtual objects in the three-dimensional environment.

As shown in FIG. 7A, computer system 101 captures one or more images of the physical environment 700 around computer system 101 (e.g., operating environment 100), including one or more objects in the physical environment 700 around computer system 101. In some embodiments, computer system 101 displays representations of the physical environment (also referred to as a real world environment) in three-dimensional environment 702 and/or allows for the physical environment to be visible via the display generation component, such as via passive optical passthrough. For example, three-dimensional environment 702 includes a representation of a table 703a. Thus, three-dimensional environment 702 optionally recreates portions of physical environment 700 such that three-dimensional environment 702 appears to the user as if the user is physically located in physical environment 700 (e.g., optionally from the perspective of the user's current location in physical environment 700 and facing the direction that the user is currently facing).

As shown in overhead view 708 of physical environment 700 in FIG. 7A, table 703b is a real object in physical environment 700 which have been captured by the one or more sensors of computer system 101, representations of which are included in three-dimensional environment 702 (e.g., photorealistic representation, simplified representation, cartoon, and/or caricature,).

As shown in FIG. 7A, user 707 of computer system 101 is standing facing table 703b and is wearing computer system 101 in such a way that it is facing the other end of the room (e.g., that one or more sensors are facing towards the other end of the room), thus capturing table 703b, and displaying representations of the objects in three-dimensional environment 702. In some embodiments, computer system 101 is able to determine the geometry of at least a portion of physical environment 700 (e.g., the portion of physical environment 700 that computer system 101 is facing, and/or one or more portions of physical environment 700 that computer system 101 is not facing). In some embodiments, computer system 101 determines the geometry of physical environment 700 using one or more sensors, such as visible light sensors (e.g., cameras), depth sensors (e.g., time of flight sensor), or a combination of sensors (e.g., multiple of the same type of sensor, and/or different types of sensors).

In FIG. 7A, the computer system 101 displays a user interface 712a including a navigation bar 710a in the three-dimensional environment 702 in a first mode of presentation, described in greater detail in method 800. In some embodiments, the user interface 712a and the navigation bar 710a are part of a web browser application. In the overhead view 708, object 705a represents the top down view of the navigation bar 710a and the user interface 712a. Since both the navigation bar 710a and the user interface 712a are displayed at the same depth relative to the viewpoint of the user, they overlap in the top down view. In some embodiments, the navigation bar 710a is displayed at a depth closer to the viewpoint of the user than the user interface 712a.

The user interface 712a includes content from a website (e.g., www.example.com). The navigation bar 710a includes a plurality of selectable options 711a through 711i. In some embodiments, option 711a, when selected, causes the computer system 101 to display an additional menu that includes additional selectable options that are selectable to open different tabs and/or bookmarks. In some embodiments, option 711b, when selected, causes the computer system 101 to navigate to a previously viewed web page. In some embodiments, option 711c, when selected causes the computer system 101 to navigate to a web page viewed after the currently displayed web page. In some embodiments, option 711d includes an indication of the web address of the presently displayed web page and when selected, causes the computer system 101 to display an option to change the web address (e.g., via a voice input or a physical or virtual keyboard input). In some embodiments, option 711e, when selected, causes the computer system 101 to display an additional menu, shown in FIG. 7I. In some embodiments, option 711f, when selected, causes the computer system 101 to display the content (e.g., user interface 712a) in a second mode of presentation, described in greater detail below and with reference to method 800. In some embodiments, option 711g, when selected, causes the computer system 101 to display another menu including selectable options to share one or more portions of the user interface 712a. In some embodiments, option 711h, when selected, causes the computer system 101 to create a new tab to display content of a different web address. In some embodiments, option 711i, when selected, causes the computer system 101 to display a view of the plurality of currently open tabs (e.g., a view including currently open web pages).

In FIG. 7A, the computer system 101 displays content from the web address, www.example.com, on user interface 712a. In some embodiments, the web page includes an article including content 713a through 713c. In FIG. 7A, the web page includes content 713a, a header, content 713b, a block of text, and content 713c, an embedded video. Content 713a includes text that servers as a header (e.g., a title) for the webpage. Content 713b is text content. Content 713c is media content (e.g., an embedded video). In FIG. 7A, the computer system 101 detects a scroll input including gaze 704a directed towards user interface 712a and hand 706a performing an upward hand movement including an air pinch (or other selection input). In response to detecting the inputs in FIG. 7A, the computer system 101 updates the display of user interface 712a to include additional content such as content 713d through 713f, shown in FIG. 7C.

FIG. 7B illustrates a different embodiment of user interface 712a. In some embodiments, displaying content in the three-dimensional environment 702 includes displaying different portions of the content at different depths and/or elevations relative to a background, as described in greater detail in method 900 and 1200. In FIG. 7B, content 714a, 714b, and 714c are displayed at different depths relative to the viewpoint of the user. As shown in the overhead view 708, content 714a is displayed in front of 714c, which are both displayed in front of content 714b. In other words, content 714a is separated from content 714b and from 714c in depth relative to the viewpoint of the user, content 714b is separated from content 714a and 714c in depth relative to the viewpoint of the user, and content 714c is separated from content 714a and 714b in depth relative to the viewpoint of the user. As described in greater detail with reference to methods 900 and 1200, the computer system displays content at different depths based on the type of content. For example, a heading is displayed in front of a block of text and media such as videos and/or photos are displayed in front of a block of text and behind a heading. In some embodiments, content such as photos and or videos (e.g., content 714c, shown in FIG. 7B) cast a shadow (e.g., a simulated shadow) onto the content and/or background behind the videos and/or photos. For example, in FIG. 7B, content 714c casts a shadow on content 714b and/or on the background of the user interface 712a. In FIG. 7B, even though the computer system 101 is displaying the content in the first mode of presentation, the computer system 101 displays the content with variable depths relative to the viewpoint of the user (e.g., content 714a is separated from content 714b and from 714c in depth relative to the viewpoint of the user, content 714b is separated from content 714a and 714c in depth relative to the viewpoint of the user, and content 714c is separated from content 714a and 714b in depth relative to the viewpoint of the user). In contrast, in FIG. 7A, the content 714a, 714b, and 714c were optionally displayed at the same depth relative to the viewpoint of the user.

FIG. 7C illustrates user interface 712a after the computer system 101 detects the input directed towards user interface 712a in FIG. 7A. In response to detecting the scrolling input, the computer system 101 scrolls down the webpage and displays additional content 713d through 713f while ceasing displaying content 713a through 713c (e.g., since they have now been scrolled past on the user interface). Content 713d is a block of text, content 713e is an image, and content 713f is an advertisement. In FIG. 7C, the computer system 101 detects a scroll input including gaze 704b directed towards user interface 712a and hand 706b performing an upward hand movement including an air pinch (or other selection input). In response to detecting the inputs in FIG. 7C, the computer system 101 updates the display of user interface 712a to include additional content such as content 713g through 713i, shown in FIG. 7D.

FIG. 7D illustrates the user interface 712a with additional content 713g through 713i. After detecting (or while detecting) the input in FIG. 7C, the computer system 101 updates the user interface 712a to display content 713g through 713i while ceasing displaying content 713d and portions of content 713e and 713f. Content 713h is text (a block of text) and content 713i is an image. In FIG. 7D, the computer system 101 detects another scroll input including gaze 704c directed towards user interface 712a and hand 706c performing an upward hand movement including an air pinch (or other selection input). In response to detecting the inputs in FIG. 7D, the computer system 101 updates the display of user interface 712a to include additional content such as content 713j, shown in FIG. 7E.

In FIG. 7E, the computer system 101 displays additional portions of the website (e.g., content 713h through content 713j) while ceasing display of other portions of the website (e.g., content 713e and 713f) in response to or while detecting the input illustrated in FIG. 7D. In FIG. 7E, the computer system 101 detects another scroll input including gaze 704d directed towards user interface 712a and hand 706d performing an upward hand movement including an air pinch (or other selection input). In response to detecting (or while detecting) the inputs in FIG. 7E, the computer system 101 updates the display of user interface 712a to include additional content such as content 713k through 713m, shown in FIG. 7F.

FIG. 7F illustrates the user interface 712a including content 713k through 713m. In response to the input detected in FIG. 7E, the computer system 101 updates the content in the webpage displayed in user interface 712a. For example, in response to or while detecting the input in FIG. 7E, the computer system 101 ceases displaying content 713h through 713j and displays content 713k through 713m. In some embodiments, in FIGS. 7C-7F, the rate at which the computer system 101 displays and ceases displaying content corresponds to the speed of the upward hand movement. Additionally, in some embodiments, the amount of content that is being displayed and no longer displayed is based on the distance of the hand movement (e.g., from the initiation of the air pinch (or other selection input) to the end of the air pinch (or other selection input)). In FIG. 7F, the computer system 101 displays content 713k through 713m. Content 713k is text, content 713l is a graphic (e.g., an image), and content 713m is a pop up (e.g., an advertisement in a pop up display). In FIG. 7F, the computer system 101 detects scroll input including gaze 704e directed towards the top of user interface 712a and hand 706e performing a downward hand movement including an air pinch (or other selection input). In response to detecting (or while detecting) the inputs in FIG. 7F, the computer system 101 updates the display of user interface 712a to include previously displayed content because the input corresponds to a request to scroll upward on the webpage.

FIG. 7G illustrates the computer system 101 displaying the webpage including content 713a through 713c in response to the scroll input in FIG. 7F. In FIG. 7G, the computer system 101 ceases displaying content 713k through 713m. In FIG. 7G, the computer system 101 detects a gaze input directed towards the navigation bar 710a (e.g., specifically option 711d) using gaze 704f. In response to detecting the gaze input in FIG. 7G, the computer system 101 displays additional options on the navigation bar 710a, shown in FIG. 7H.

FIG. 7H illustrates the computer system 101 displaying additional options 711j through 711n on the navigation bar 710a. The additional options 711j through 711n correspond to different tabs that are presently open in the web browser application (e.g., tabs represent a separate instance of a webpage and the computer system 101 can display a plurality of tabs in a single web browser view (e.g., user interface 712a)). In some embodiments, the tabs correspond to webpages and/or web addresses. In some embodiments, the options 711j through 711n, when selected, causes the computer system to display a different user interface corresponding to the selected webpage, described in greater detail in method 1200. FIG. 7H illustrates two possible inputs which result in the same outcome. In some embodiments, in FIG. 7H, the computer system 101 detects a selection input corresponding to a request to change the mode of presentation of the content in the user interface 712a from the first mode of presentation to the second mode of presentation. In FIG. 7H, the computer system 101 detects a selection input including gaze 704g directed towards either option 711e or 711f, and hand 706g (e.g., an air pinch (or other selection input) gesture with a hand). In response to detecting the input directed towards option 711f, the computer system 101 ceases displaying user interface 712a and displays portal 712b, shown in FIG. 7J. In response to detecting the input directed towards option 711e, the computer system 101 displays a menu 716, shown in FIG. 7I.

In FIG. 7I, the computer system 101 displays menu 716 including options 718a through 718d. In some embodiments, option 718a, when selected, causes the computer system 101 to display the text in user interface 712a at a smaller size than shown in FIG. 7I. In some embodiments, option 718b, when selected, causes the computer system 101 to display the text in user interface 712a at a larger size than shown in FIG. 7I. In some embodiments, option 718c, when selected, causes the computer system 101 to dictate the content in user interface 712a (e.g., using one or more speakers of the one or more input devices described in FIG. 1). In some embodiments, option 718d, when selected, causes the computer system to display the content in user interface 712a in the second mode of presentation. In FIG. 7I, the computer system 101 detects a selection input including gaze 704h directed towards option 718d and hand 706h performing an air pinch gesture. In response to detecting the input in FIG. 7I, the computer system 101 ceases displaying user interface 712a and displays portal 712b, shown in FIG. 7J.

FIG. 7J illustrates the computer system 101 presenting content in a second mode of presentation. The second mode of presentation is described in greater detail in method 800. In some embodiments, in the second mode of presentation, the computer system 101 displays content with a higher level of immersion (e.g., a greater spatial experience) than in the first mode of presentation. In FIG. 7J, the computer system 101 ceases presenting user interface 712a and beings presenting virtual environment 777b, which is displayed through portal 712b. The virtual environment 777b optionally has a dimension that is larger than the dimension of the physical environment 700 (e.g., potentially an infinite dept, for example, if the virtual environment 777b is a landscape that extends to the horizon). In some embodiments, the computer system 101 replaces portions of the three-dimensional environment 702 with the virtual environment 777b. For example, as shown in the overhead view 708, portions of the back wall of the physical environment 700 and portions of table 703a no longer exist (e.g., are no longer displayed) in the three-dimensional environment 702 (e.g., as indicated by the dotted lines), and in their place is a view of the content in virtual environment 777b displayed through the portal 712b. As shown in FIG. 7J, the virtual environment 777b includes content 713a-b through 713a-c, which correspond to content 713a through 713c, shown in FIG. 7I. While in the second mode of presentation, the computer system 101 presents different types of content at different depths and/or distances relative to the viewpoint of the user. As shown in the overhead view 708 in FIG. 7J, content 713a-b is displayed in front of content 713b-b and 713c-b. Content 713b-b and 713b-c are displayed in line with each other and are therefore overlapping in the overhead view 708. In some embodiments, content 713c-b is an embedded video that does not satisfy the criteria needed to generate one or more spatial elements in the second mode of presentation, as described in method 800. Therefore, the content 713c-b does not include spatial elements and is displayed in line with content 713b-b. In some embodiments, some videos do satisfy the criteria needed to generate one or more spatial elements in the second mode of presentation, which is described below, with reference to FIG. 7W. Alternatively, in some embodiments, embedded videos, such as content 713c-b are displayed in front of text, such as content 713b-b. The portal is described in greater detail in method 800 and 1000.

Additionally, in the second mode of presentation, shown in FIG. 7J, the computer system 101 displays navigation bar 710b, which has one or more characteristics of navigation bar 710a. The navigation bar 710b is displayed in front of the portal 712b, as shown in the overhead view 708 of FIG. 7J. Navigation bar 710b includes selectable options 720a through 720e. In some embodiments, option 720a, when selected, causes the computer system 101 to cease displaying content in the second mode of presentation and display the content in the first mode of presentation. In some embodiments, option 720b, when selected, causes the computer system 101 to display a menu including one or more options to change an appearance of the portal 712b. In some embodiments, option 720c, when selected, displays a menu including one or more options to share the content. In some embodiments, option 720d, when selected, causes the computer system 101 to display a user interface element including information about the content in the portal 712b. In some embodiments, option 720e, when selected, causes the computer system 101 to display an option to change the web address (and navigate to a different web address).

In FIG. 7J, a virtual environment 777b within the portal 712b includes a background including color 728a (e.g., shown as a pattern). In some embodiments, the patterns shown herein (such as in FIG. 7J) represent colors or other visual characteristics, as described in greater detail in method 1000. The color 728a is a representative color found in visual media (e.g., content 713c-b) presently displayed virtual environment 777b, which is displayed through in portal 712b. As described in method 1000, the appearance of the virtual environment 777b is based on colors and/or patterns of visual media such as images and/or videos. Additionally, as described in method 800, the portal 712b casts a shadow and/or glow on the three-dimensional environment, as shown by glow 726a. The glow 726a corresponds to the key patterns and/or colors of color 728a. In FIG. 7J, the computer system 101 detects a scroll input including gaze 704i (e.g., a gaze directed towards the content in portal 712b) and hand 706i performing an upward hand movement including an air pinch (or other selection input). In response to detecting (or while detecting) the inputs in FIG. 7J, the computer system 101 updates the portal 712b to include content from the webpage located below content 713a-b through 713a-c. Alternatively, the computer system 101 detects a scroll input only including gaze 704i (e.g., a gaze directed towards the bottom of the content in portal 712b). In some embodiments, scroll inputs described herein can be gaze only scroll inputs or gaze and hand movement scroll inputs.

In FIG. 7K, the computer system 101 fades out (e.g., decreasing opacity and/or decreasing brightness) content 713c-b as the computer system 101 (or after the computer system 101) detects the scroll input in FIG. 7J. Fading out images while the computer system 101 detects a scrolling input is described in greater detail in method 800 and 1200. FIG. 7K includes content 713c-b through 713e-b, which correspond to content 713c through 713e shown in FIGS. 7A and 7C. Because the computer system 101 is displaying content in the second mode of presentation, the computer system 101 forgoes displaying content such as advertisements (e.g., content 713f, shown in FIG. 7C does not have a counterpart in the portal 712b in the second mode of presentation). How different types of content are displayed in the second mode of presentation is described in additional detail in method 800 and 900. In FIG. 7K, the computer system 101 displays content 713e-b with spatial elements 724a and 724b. Content 713e, shown in FIG. 7C and corresponding to content 713e-b, is an image that is able to be converted into an image including a three-dimensional appearance (e.g., including spatial elements) in accordance with the criteria described in method 800 and 900. As shown in FIG. 7C, the content 713e includes a rectangle and a circle corresponding to elements 742a and 742b, shown in FIG. 7K, respectively. The computer system 101 optionally uses one or more machine learning methods (as described in methods 800 and 900) to generate an image including a three-dimensional appearance (e.g., content 713e-b). The computer system 101 optionally generates a different view of the image such that different images are displayed in different eyes of the user to create the image with the three-dimensional appearance, as described in method 800. Because content 713e-b includes spatial elements 724a and 724b and therefore is an image including a three-dimensional appearance, content 713e-b is shown as a two-dimensional representation that has depth in the overhead view 708. In the overhead view 708 in FIG. 7K, the content 713e-b also includes representations of the spatial elements 724a and 724b. As shown in FIG. 7K, the content 713e-b is displayed at a depth in front of the content 713d-b and 713c-b and extends to a depth behind content 713d-b and 713c-b. Additionally, because content 713e-b is displayed at a depth that starts in front of content 713d-b, content 713e-b casts a shadow 722a (or glow) onto the content 713d-b and/or onto the virtual environment 777b. In some embodiments, the content 713e-b is displayed within its own portal (e.g., frame) which starts in front of content 713d-b and the spatial elements 724a and 724b are displayed within the portal.

In FIG. 7K, the virtual environment 777b includes two colors, color 728a, corresponding to a key color in content 713c-b, and color 728b, corresponding to a key color in content 713e-b. Different portions of virtual environment 777b have different background visual appearances, such as a first visual appearance corresponding to color 728a, and a second visual appearance corresponding to color 728b. In FIG. 7K, the colors 728a and 728b are represented by patterns. In some embodiments, as the computer system 101 displays content, the computer system 101 gradually transition the patterns (and/or colors) of the background based on the key colors of the currently displayed content. Changing the appearance of the background of the portal 712b is described in greater detail in method 1000. As shown in FIG. 7K, the computer system 101 transitions from color 728a to color 728b. Additionally, the glow around the portal 712b and/or virtual environment 777b transitions from glow 726a to glow 726b as the colors and/or patterns change. The patterns used herein (e.g., in the virtual environment 777b or any virtual environment described here, or in any content described herein) are merely visual representations of different colors and/or different visual characteristics, as described herein and with respect to methods 800, 900, 1000, 1100 and/or 1200.

In FIG. 7L, the viewpoint of the user shifts to the left as the user 707 leans their head to the left. As a result, the computer system 101 displays the spatial elements 724a and 724b from a different angle within the content 713e-b in accordance with the new viewpoint. As shown in FIG. 7L, the view of the portal 712b shifts to the right in the user's viewport, and additional portions of the spatial elements 724a and 724b are visible (e.g., due to the updated viewing angle of the spatial elements). In FIG. 7L, the computer system 101 detects a scroll input including gaze 704j directed towards the content inside portal 712b and hand 706j performing an upward hand movement including an air pinch (or other selection input). In response to detecting (or while detecting) the inputs in FIG. 7L, the computer system 101 updates the virtual environment 777b to include content from the webpage located below content 713b-b through 713e-b, as shown in FIG. 7M.

In FIG. 7M, the computer system 101 displays content 713e-b through 713i-b, which correspond to content 713e through content 713i shown in FIGS. 7D and 7E. As described above and with reference to method 1000, the computer system 101 updates the background of virtual environment 777b based on key colors from images and/or videos (e.g., shown as patterns in FIG. 7M). As such, in FIG. 7M, the computer system 101 transitions from color 728b to color 728c, corresponding to a key color in content 713i. In some embodiments, a third visual appearance corresponds to color 728c. Additionally, glow 726b transitions to glow 726c. In some embodiments, in response to displaying an additional image (e.g., content 713i-b) in response to a scroll input, the computer system 101 updates the background of the virtual environment 777b to include the color of the additional image. For example, rather than gradually transitioning from color 728b to 728c in FIG. 7M, the computer system 101 would only display color 728c in FIG. 7M.

In FIG. 7M, the computer system displays a representation of content 713e-b and content 713i-b in the overhead view 708. Because both content 713e-b and 713i-b include spatial content, they are both displayed as two-dimensional representations in the overhead view 708. Content 713i-b includes spatial elements 724c and 724d, which correspond to the seahorse and the seaweed in the content 713i-b, respectively. Additionally, spatial elements 724c and 724d, correspond to the two-dimensional seahorse and the seaweed in the content 713i, shown in FIG. 7E, respectively. In FIG. 7M, the computer system 101 displays the spatial elements 724c and 724d with a three-dimensional appearance that was not displayed in content 713i, shown in FIG. 7E. Additionally, in FIG. 7M, because content 713e-b is displayed at a second location different than the location in FIG. 7L, the spatial elements 724a and 724b shift in accordance with their new location relative to the viewpoint of the user. Because the content 713i-b is located above the viewpoint of the user in the three-dimensional environment 702, the computer system 101 displays additional portions of the spatial elements 724a and 724b below. In FIG. 7M, the computer system 101 detects a scroll input including gaze 704k directed towards the content in portal 712b and hand 706k performing an upward hand movement including an air pinch (or other selection input). In response to detecting (or while detecting) the inputs in FIG. 7M, the computer system 101 updates the virtual environment 777b to include content from the webpage located below content 713e-b through 713i-b, as shown in FIG. 7N.

In FIG. 7N, the computer system 101 ceases displaying content 713e-b through 713i-b and displays content 713k-b through 713l-b in response to detecting or while detecting the scroll input in FIG. 7M. Content 713k-b and 713l-b correspond to content 712k and 713l, shown in FIG. 7F, respectively. In FIG. 7N, the computer system 101 does not display content 713m (or content corresponding to content 713m) because content 713m is not relevant to the other content in the webpage, because content 713m is a popup and/or advertisement. In FIG. 7N, the computer system 101 displays the virtual environment 777b with color 728d because color 728d corresponds to a key color of content 713l-b. In some embodiments, a fourth visual appearance corresponds to color 728d. For example, in FIG. 7N, the color 728d is represented by a pattern. Additionally, since the computer system 101 is not displaying other images and/or videos in FIG. 7N, the computer system 101 only displays color 728d in the background of virtual environment 777b. Additionally, the computer system 101 displays glow 726d, corresponding to color 728d, around the portal 712b in the three-dimensional environment 702. In FIG. 7N, the computer system 101 detects a scroll input including gaze 704l directed towards the content in portal 712b and hand 706l performing a downward hand movement including an air pinch (or other selection input). In response to detecting (or while detecting) the inputs in FIG. 7N, the computer system 101 updates the virtual environment 777b to include content from the webpage located above content 713k-b through 713l-b, as shown in FIG. 7O.

In FIG. 7O, the computer system 101 displays content 713c-b through 713e-b. the display of content 713c-b through 713e-b is described in greater detail in FIG. 7K. In FIG. 7O, the computer system 101 detects a clockwise (or counterclockwise) rotation of a mechanical input element (e.g., crown 732) using hand 730a. In response to detecting the input or while detecting the input in FIG. 7O, the computer system 101 lowers the immersion level of the portal 712b (e.g., such that less of the virtual environment 777b is visible and therefore, the computer system 101 displays less content in the portal 712b), as shown in FIG. 7P.

In FIG. 7P, the computer system 101 reduces the size of portal 712b in accordance with the input in FIG. 7O. Changing the size of the portal and/or the level of immersion of the second mode of presentation is described in greater detail in method 800 and 1000. Because the level of immersion is lower in FIG. 7P, a greater portion of the physical environment, including table 703a, is visible in the three-dimensional environment 702. Additionally, less of the three-dimensional environment 702 is occupied by portal 712b. In FIG. 7P, because the portal 712b is smaller, less of the content is visible through the portal (e.g., content 713c-b through 713e-b). In FIG. 7P, the computer system 101 detects a counterclockwise (or clockwise; the opposite of the rotation detected in FIG. 7O) rotation of the mechanical input element (e.g., crown 732) using hand 730b. In response to detecting the input or while detecting the input in FIG. 7P, the computer system 101 increases the immersion level of the portal 712b (e.g., such that more of the virtual environment 777b is visible), as shown in FIG. 7Q.

In FIG. 7Q, the level of immersion of the portal 712b is greater than shown in FIG. 7P and in FIG. 7O. In some embodiments, the amount of rotational movement of the crown 732 corresponds to the change in immersion levels of portal 712b. For example, a larger rotational movement corresponds to a larger change in immersion levels. In FIG. 7Q, the portal 712b occupies more space in the three-dimensional environment 702 (and in the viewport of the user). As such, more content (e.g., portions of content 713f-b) is visible through portal 712b and less of the representation of the physical environment 700 is visible in the three-dimensional environment 702. In some embodiments, using the crown 732 to change the immersion levels applies to one or more or all portals and/or content presented in the second mode of presentation as described herein. In FIG. 7Q, the computer system 101 detects a selection input including gaze 704m directed towards the content in portal 712b and hand 706m performing an air pinch (or other selection input) directed. Optionally, the selection input is directed towards option 720d in the navigation bar 710b. In response to detecting the selection input in FIG. 7Q, the computer system 101 displays a user interface element 734a including additional information about the content in the portal 712b (and in the website shown in portal 712b), shown in FIG. 7R. The additional information displayed includes supplemental information, such as content that was displayed in the first mode of presentation but not displayed in the second mode of presentation. The supplemental information is described in greater detail in method 800.

In FIG. 7R, the computer system 101 displays element 724a and bar 734b. In some embodiments, bar 734b, when selected and moved (e.g., via an air pinch and air-drag input), causes the computer system 101 to move the element 724a in accordance with the movement of the hand. As shown in the overhead view 708 in FIG. 7R, the element 734a is displayed at an angle facing towards the user 707 and is displayed outside of and in front of the portal 712b. In some embodiments, the angle of the element 734a relative to the three-dimensional environment 702 is different than the angle of the content (e.g., content 713f-b) relative to the three-dimensional environment 702. In FIG. 7R, the computer system 101 detects a scroll input including gaze 704n directed towards element 734a and hand 706n performing an upward hand movement including an air pinch (or other selection input). In response to detecting (or while detecting) the inputs in FIG. 7R, the computer system 101 updates the element 734a to display additional information that is not currently displayed in FIG. 7R, such as shown in FIG. 7S.

FIG. 7S illustrates the element 734a including additional information that was not displayed in FIG. 7R. In some embodiments, element 734a displays information relevant to the content in the portal 712b, such as a summary (e.g., summary of the content created using one or more machine learning methods), related links (e.g., articles, videos, images, or other media), and other supplemental information. In FIG. 7S, the computer system 101 displays options 736a and 736b in element 734a, which correspond to related articles. In some embodiments, option 736a, when selected, causes the computer system 101 to display content from a webpage corresponding to “article A” in the portal 712b. In some embodiments, option 736b, when selected, causes the computer system 101 to display content from a webpage corresponding to “article B” in the portal 712b. In some embodiments, displaying the content from the related webpages and/or articles includes ceasing displaying the content from the current webpage (e.g., www.example.com) in the portal 712b. Switching between content is described in greater detail in method 1200 and in the figures below. In FIG. 7S, the computer system 101 detects a selection input including gaze 7040 directed towards option 720b and hand 7060 performing an air pinch (or other selection input). In response to detecting the selection input in FIG. 7S, the computer system 101 displays a menu 738, shown in FIG. 7T. In some embodiments, the menu 738 has one or more characteristics of the menu 716 shown in FIG. 7I.

FIG. 7T illustrates the computer system 101 displaying menu 738 including options 740a through 740f. Options 740a through 740c correspond to options 718a through 718c shown in FIG. 7I. Option 740d, when selected, causes the computer system 101 to cease displaying portal 712b and redisplay user interface 712a (e.g., transition from the second mode of presentation back to the first mode of presentation). Option 740e, when selected, causes the computer system 101 to automatically convert two-dimensional media to three-dimensional content, as described in greater detail in method 900. Option 740e is presently selected. Option 740f, when selected, causes the computer system 101 to revert previously converted three-dimensional content back to two-dimensional media. Alternatively, option 740f, when selected (e.g., prior to transitioning to the second mode of presentation), causes the computer system 101 to forgo converting two-dimensional media to three-dimensional content when transitioning to the second mode of presentation. In FIG. 7T, the computer system 101 detects a selection input including gaze 704p and hand 706p performing an air pinch (or other selection input) directed towards option 740f of the menu 738. In response to detecting the selection input in FIG. 7T, the computer system 101 ceases displaying content with a three-dimensional appearance corresponding to the two-dimensional media, as shown in FIG. 7U.

In FIG. 7U, the computer system 101 replaces the content with a three-dimensional appearance (e.g., content 713a-c, shown in FIG. 7T) with the corresponding two-dimensional media (e.g., content 713c, shown in FIG. 7U). In some embodiments, and as described in method 900, the computer system 101 includes one or more options to convert one or more content items from content with a three-dimensional appearance to two-dimensional media, or vice versa. In response to replacing the content with a three-dimensional appearance with content without the three-dimensional appearance, the overhead view 708 illustrates that the content 713c is content without the three-dimensional appearance by illustrating content 713c as a line instead of as a rectangle. In some embodiments, the computer system 101 does not convert content 713a-b and/or content 713b-b to two-dimensional media because content 713a-b and 713b-b is already two-dimensional in the second mode of presentation.

FIG. 7V illustrates a different type of webpage displayed in user interface 712a while in the first mode of presentation. The computer system 101 displays content from www.tv.apple.com in the user interface 712a. In some embodiments, www.tv.apple.com is a video player web page wherein the content focuses on the video on the webpage. In FIG. 7V, the computer system 101 displays content 742a (e.g., a video), content 742b (e.g., text corresponding to the video such as a description of the video), and content 742c (e.g., an advertisement). As described above, because user interface 712a and bar 710a do not include depth, FIG. 7V illustrates object 705a (e.g., representing user interface 712a and 710a) as a line in the overhead view 708. In some embodiments, the content 742a is not presenting playing, and in response to detecting a selection input (e.g., with a gaze and an air pinch gesture with the hand) directed towards content 742a, the computer system 101 begins playing the content 742a. In some embodiments, in FIG. 9V, the computer system 101 is playing content 742a. In FIG. 7V, the computer system 101 detects a selection input including gaze 704q and hand 706q performing an air pinch (or other selection input) directed towards option 711f of the navigation bar 710a. In response to detecting the selection input in FIG. 7V, the computer system 101 presents the video content in the second mode of presentation, as described above and with reference to method 800, as shown in FIG. 7W.

FIG. 7W illustrates the computer system 101 presenting the content from the user interface 712a in the second mode of presentation. In some embodiments, when presenting the content in the second mode of presentation, the computer system 101 automatically starts playback of the video (e.g., content 742a-b, shown in FIG. 7W). In some embodiments, the computer system 101 does not automatically start playback of the video (e.g., content 742a-b, shown in FIG. 7W). The computer system 101 optionally starts playback of the video in response to detecting an input to initiate playback of the video, such as a selection input including a gaze and air pinch (or other selection input) hand gesture directed towards content 742a-b. In FIG. 7W, the computer system 101 ceases presenting user interface 712a and begins presenting portal 712c, having one or more characteristics of portal 712b, described above. In some embodiments, portal 712c differs from portal 712b because the type of content from the webpage, www.tv.example.com, is different from the type of content from the webpage, www.example.com. Additionally, in some embodiments, the virtual environment 777c differs from the virtual environment 777b because the type of content being displaying is different. In FIG. 7W, the computer system 101 presents content 742a-b, corresponding to content 742a in FIG. 7V, with a higher amount of immersion than the content in portal 712b shown in FIGS. 7J-7U. For example, the computer system 101 replaces more portions of the three-dimensional environment 702 with virtual environment 777c, displayed in and/or through portal 712c. As shown in the overhead view 708 in FIG. 7W, the virtual environment 777c extends past the dimensions of the physical environment 700 (e.g., the portal 712c and the virtual environment 777c is larger than the room that the user 707 is in). Additionally, the computer system 101 tints and/or displays the background of virtual environment 777c to be darker than the background of virtual environment 777b to better highlight the video of content 714a-b. For example, the portal 712c acts as a “movie theater” mode.

In response to detecting the input in FIG. 7V, the computer system 101 displays user interface element 744, which has one or more characteristics of element 734a shown in FIG. 7S and includes additional information corresponding to content 742a-b. For example, element 744, in FIG. 7W includes text, such as content 742b, displayed in FIG. 7V. In some embodiments, the computer system 101 displays the user interface element 744 in response to detecting an additional input directed towards option 720d, such as described in FIG. 7S. In some embodiments, in response to displaying content in the second mode of presentation, the computer system 101 automatically displays the element 744. Element 744 includes elements 745a through 745d. In some embodiments, element 745a, when selected, causes the computer system 101 to display information related to related videos and/or content. In some embodiments, element 745b, when selected (currently selected in FIG. 7W), causes the computer system to display a description of the content 742a-b. In FIG. 7W, the computer system 101 displays element 745d, which is a description of the video and corresponds to content 742b, shown in FIG. 7V. In some embodiments, element 745c, when selected, causes the computer system 101 to display information relating to comments on the video.

Additionally, in FIG. 7W, the computer system 101 displays control user interface 743 including options 747a through 747g. Control user interface 743 includes controls for controlling the video (e.g., content 742a-b). In some embodiments, option 747a, when selected, causes the computer system 101 to rewind content 742a-b. In some embodiments, option 747a, when selected, causes the computer system 101 to pause content 742a-b (or play content 742a-b depending on the current state of content 742a-b). In some embodiments, option 747c, when selected, causes the computer system 101 to fast forward content 742a-b. In some embodiments, option 747d is a scrubber bar which includes an indication of the current location in time of the frame in the video that is currently playing. In some embodiments, option 747d, when selected (e.g., at the current location in time), causes the computer system 101 to fast forward or rewind based on the direction of input movement. In some embodiments, option 747e, when selected, causes the computer system 101 to display or cease displaying captions for the content 742a-b. In some embodiments, option 747f, when selected, causes the computer system 101 to display a queue including previously played and upcoming videos. In some embodiments, option 747g, when selected, causes the computer system 101 to display a slider bar for adjusting the volume of playback. In some embodiments, the control user interface 743 is displayed in front of portal 712c, as shown in the overhead view 708 in FIG. 7W.

While displaying and/or playing content 742a-b, the computer system 101 displays a glow (e.g., glow 749a through 749d) in the portal 712c. For example, the content 742a-b “casts” (e.g., virtually casts) a glow onto the virtual environment 777c in one or more or all directions (e.g., up, down, left, and/or right). Optionally, the content 742a-b casts the glow only in the up and down directions (e.g., glow 749b and 749d). As shown in FIG. 7W, the glow 749a through 749d includes a pattern (or color) from the content 742a-b. The glow is described in greater detail in method 800 and 1000. In some embodiments, the location of the patterns (or colors) displayed in glow 749a through 749d are based on the locations of the respective patterns (or colors) in the content 742a-b, as shown in FIG. 7W. In some embodiments, the glow virtually emitted from a portion of the content 742a reflects the visual appearance (e.g., colors and/or patterns) of the respective portion of the content 742a-b. For example, if a portion of the content includes a first color (pattern), then the glow emitted from that portion of the content includes and/or is based on the first color (pattern).

In FIG. 7W, the computer system 101 detects a selection input including gaze 704r and hand 706r performing an air pinch (or other selection input) directed towards content 742a-b. Alternatively, the computer system 101 detects a gaze 704r directed towards content 742a-b for a threshold amount of time (e.g., 0.1 seconds, 1 second, or 5 seconds). In response to detecting the selection input in FIG. 7V, the computer system 101 ceases displaying element 744, control user interface 743, and navigation bar 710b, as shown in FIG. 7X.

In FIG. 7X, the video (content 742a-b) continues playing and the computer system 101 updates glow 749a through 749d to reflect the patterns (e.g., colors) in the current frame of the video. In FIG. 7X, the computer system 101 detects a selection input including gaze 704s and hand 706s performing an air pinch (or other selection input) directed towards content 742a-b. Alternatively, the computer system 101 detects gaze 704s directed towards content 742a-b for a threshold amount of time (e.g., 0.1 seconds, 1 second, or 5 seconds). In response to detecting the selection input in FIG. 7X, the computer system 101 redisplays element 744, control user interface 743, and navigation bar 710b, as shown in FIG. 7Y.

In FIG. 7Y, the video (content 742a-b) continues playing and the computer system 101 updates glow 749a through 749d to reflect the patterns (e.g., colors) in the current frame of the video. In FIG. 7Y, the computer system 101 detects a selection input including gaze 704t and hand 706t performing an air pinch (or other selection input) directed towards element 745a. In response to detecting the selection input in FIG. 7Y, the computer system 101 updates element 745d to element 745e, as shown in FIG. 7Z. The selection input corresponds to a request to display different content in the element 744. In FIG. 7Y, element 744 is displaying a description of the content 742a-b (e.g., element 745d). In FIG. 7Z, the element 744 is displaying a related video of the content 742a-b (e.g., element 745e). In FIG. 7Z, the computer system 101 detects a scroll input including gaze 704u and hand 706u performing an upward hand movement including an air pinch (or other selection input) directed towards element 744. In response to detecting the input in FIG. 7Z, the computer system 101 updates the display of element 744 to include additional content, shown in FIG. 7AA.

In FIG. 7AA, the computer system 101 display additional related content including element 745f in element 744, such that element 744 includes elements 745e and 745f. In some embodiments, element 745e, when selected, causes the computer system 101 to navigate to the web page corresponding to element 745e including displaying the video corresponding to element 745e in the portal 712c. Similarly, in some embodiments, element 745f, when selected, causes the computer system 101 to navigate to the web page corresponding to element 745f including displaying the video corresponding to the element 745f in the portal 712c. In some embodiments, displaying the respective videos in the portal 712c has one or more characteristics of displaying the video corresponding to content 742a-b, shown in FIGS. 7W and 7X.

FIG. 7BB illustrates a different type of webpage displayed in user interface 712a while in the first mode of presentation. The computer system 101 displays content from www.example.com/shop in the user interface 712a. In some embodiments, www.example.com/shop is a webpage from a shopping website including information about a respective product (e.g., content 746a). In FIG. 7BB, the computer system 101 displays content 746a (e.g., a representation of a three-dimensional object that is optionally two-dimensional), options 748a through 748d (e.g., options to change one or more visual characteristics of the three-dimensional object), and content 750a (e.g., text corresponding to the three-dimensional object such as a description of the three-dimensional object). In FIG. 7BB, option 748a is presently selected, as indicated by the bolding around option 748a, and by the visual characteristics shown on content 746a (e.g. the chair does not have a patterned fabric). As described above, because user interface 712a and bar 710a do not include depth, FIG. 7BB illustrates object 705a (e.g., representing user interface 712a and 710a) as a line in the overhead view 708. In FIG. 7BB, the computer system 101 detects a selection input including gaze 704v and hand 706v performing an air pinch (or other selection input) directed towards option 748d. In response to detecting the selection input in FIG. 7BB, the computer system 101 updates the representation of the three-dimensional object (e.g., content 746a) to include the visual characteristics from option 748d, as shown in FIG. 7CC.

In FIG. 7CC, the computer system 101 updates content 746a to include the visual characteristic selected in FIG. 7BB. Specifically, the computer system 101 updates the fabric material to include the fabric type (e.g., represented by the pattern) in option 748d. Additionally, the computer system 101 bolds the border of option 748d to indicate that the option 748d is currently selected. In FIG. 7CC, the computer system 101 detects a selection input including gaze 704w and hand 706w performing an air pinch (or other selection input) directed towards option 711f of the navigation bar 710a. In response to detecting the selection input in FIG. 7CC, the computer system 101 presents the content in the second mode of presentation, as described above and with reference to method 800, as shown in FIG. 7DD.

In FIG. 7DD, the computer system 101 ceases displaying user interface 712a and displays portal 712d, which includes the content and options shown in user interface 712a in FIG. 7CC. In some embodiments, portal 712d includes one or more characteristics of portals 712b and 712c, described above. In some embodiments, portal 712d differs from portal 712b and 712c because the type of content from the webpage, www.example.com/shop, is different from the type of content from the webpages www.example.com and www.tv.apple.com (e.g., the portal 712d is a different size and/or shape than portal 712b and 712c). For example, for www.example.com/shop, the main focus of the website is content 746a; as such, in portal 712d, the content 746b, corresponding to content 746a, is highlighted (e.g., the main focus in the portal 712d). In FIG. 7DD, the computer system 101 presents content 746b, corresponding to content 746a in FIG. 7CC. In some embodiments, content 746b is a three-dimensional representation of content 746a. In some embodiments, and as described in method 1100, the computer system 101 generates content 746b using one or more two-dimensional views and/or specifications of the three-dimensional object. As shown in FIG. 7DD, in the overhead view 708, content 746b is represented as a two-dimensional object within portal 712d, indicating that content 746b includes dimensionality. In FIG. 7DD, the portal 712d has a more of a square shape than other portals described herein (e.g., portals 712b, 712c, and/or 712e). In some embodiments, portals have different shapes based on the content and/or virtual environments presented in the portals, as described in greater detail in method 800.

In FIG. 7DD, the portal 712d includes a glow 752, which has one or more characteristics of the glow described with reference to portals 712b and/or 712c. In some embodiments, the portal 712d casts a shadow and/or glow 752 on or into the three-dimensional environment 702. In some embodiments, the glow 752 has a color and/or pattern (e.g., the pattern represents a visual characteristic) corresponding to the content 746b and/or from other portions of the content in portal 712d or from the website www.example.com/shop. In FIG. 7DD, the computer system 101 displays a selectable option 754a, that when selected, causes the computer system to display the content 746b outside of portal 712d. In FIG. 7DD, the computer system 101 detects a selection input including gaze 704x and hand 706x performing an air pinch (or other selection input) directed towards option 754a. In response to detecting the selection input in FIG. 7DD, the computer system 101 displays the content 746b outside of portal 712d, as shown in FIG. 7EE.

FIG. 7EE illustrates the computer system 101 presenting the content 746b outside of portal 712d. As shown in the overhead view 708 in FIG. 7EE, the computer system 101 displays content 746b outside of and in front of portal 712d. In FIG. 7EE, the content 746b retains the same visual characteristics as the content 746b prior to the computer system 101 detecting the input in FIG. 7DD. In some embodiments, in response to detecting the input directed towards option 754a in FIG. 7DD, the computer system 101 displays content 746b with the actual dimensions and/or measurements of the object that content 746b represents. Displaying the content 746b outside of the portal 712d is described in greater detail in method 1100. In FIG. 7EE, the computer system 101 also displays option 754b, which, when selected, causes the computer system 101 to cease displaying the content 746b outside of the portal 712d and redisplay the content 746b within the portal 712d. In FIG. 7EE, the computer system 101 detects a selection input including gaze 704y and hand 706y performing an air pinch (or other selection input) directed towards option 720d. In response to detecting the selection input in FIG. 7EE, the computer system 101 displays a user interface element 757, as shown in FIG. 7FF.

In FIG. 7FF, the computer system 101 displays element 757 including additional information about content 746b. Element 757 has one or more characteristics of element 744 shown in FIG. 7Y, and element 734a shown in FIG. 7R. As shown in the overhead view 708, the element 757 is displayed at an angle relative to the content in the portal 712d (e.g., has a different angle relative to the three-dimensional environment). In some embodiments, the additional information shown in element 757 corresponds to content other that content 746b shown in FIG. 7BB. For example, element 757 includes options 748a-b through 748d-b, which correspond to options 748a through 748d shown in FIG. 7BB. Similarly to options 748a through 748d, options 748a-b through 748a-d, shown in FIG. 7FF, are selectable to change the fabric material of content 746b. In FIG. 7FF, element 757 also includes content 750b, which corresponds to content 750a, shown in FIG. 7BB. In FIG. 7FF, the computer system 101 detects a selection input including gaze 704z and hand 706z performing an air pinch (or other selection input) directed towards option 748d-b. In response to detecting the selection input in FIG. 7FF, the computer system 101 updates content 746b to include the fabric material indicated by option 748d-b, shown in FIG. 7GG.

In FIG. 7GG, the computer system 101 updates content 746b to include the pattern, texture, and/or color of the fabric corresponding to option 748d-b. Additionally, the computer system 101 updates element 757 to include highlighting around option 748d-b to indicate that option 748d-b is presently selected, and the associated fabric is currently shown on content 746b. In FIG. 7GG, the computer system 101 detects an input including gaze 704aa and hand 706aa performing and maintaining an air pinch (or other selection input), while performing the actions described in FIGS. 7HH and 7II, directed towards content 746b. In response to detecting the input in FIG. 7GG, the computer system 101 selects content 746b to receive additional inputs, as shown in FIG. 7HH. In some embodiments, after detecting the air pinch (or other selection input) with hand 706aa and the maintaining of the air pinch (or other selection input), the gaze 704aa no longer needs to be directed towards the content 746b to perform the actions described in FIG. 7HH and 7II.

In FIG. 7HH, the computer system 101 continues to receive the input including the air pinch (or other selection input) performed by hand 706bb directed towards content 746b. While receiving the input, the user rotates their hand 706bb, as shown in FIG. 7HH, and in response to the rotational input, the computer system 101 rotates content 746b in the three-dimensional environment 702 with a magnitude and/or in a direction corresponding to the magnitude and/or direction of the rotation of the hand. Changing the position and/or orientation of the content 746b is described in greater detail in method 1100.

In FIG. 7II, the computer system 101 receives an additional rotational input with hand 706cc while continuing to detect the hand 706cc performing the air pinch (or other selection input). In response to receiving the additional rotational input, the computer system 101 rotates the content 746b (e.g., as the hand 706cc rotates) in accordance with the magnitude and/or direction of rotation of the hand 706cc.

In FIG. 7JJ, the computer system 101 stops detecting the selection and/or rotational inputs directed towards content 746b (e.g., the computer system detects termination of the input, such as detecting release of the air pinch gesture). After no longer detecting the input, the computer system 101 continues to display content 746b in the orientation and/or position dictated by the last movement and/or rotational input directed towards content 746b. In FIG. 7JJ, the computer system 101 detects a selection input including gaze 704dd directed towards a region of element 757 including options 748a-b through 748a-d and hand706dd performing an air pinch (or other selection input). In response to detecting the selection input in FIG. 7JJ, the computer system 101 updates element 757 to include additional selectable options 748e-b through 748h-b, as shown in FIG. 7KK.

In FIG. 7KK, the computer system 101 displays options 748e-b through 748h-b. Options 748e-b through 748h-b represent different views of the content 746b (and the content 746a, shown in FIG. 7BB). As described in method 1100, the computer system 101 optionally uses the different views (e.g., two-dimensional views) of the content 746a to generate the content 746b in the portal 712d. In FIG. 7KK, the options 748e-b through 748h-b, when selected, cause the computer system 101 to update the position and/or orientation of content 746b to correspond to the position and/or orientation of the chair corresponding to the selected option. In FIG. 7KK, the computer system 101 detects a scroll input including gaze 704ee and hand 706ee performing an upward hand movement including an air pinch (or other selection input) directed towards element 757. In response to detecting the input in FIG. 7KK, the computer system 101 updates the display of element 746 to include additional text of content 750b, shown in FIG. 7LL. In some embodiments, the additional text can be found on the webpage and the computer system 101 reproduces the text in element 746 to be easily accessible by the user.

In FIG. 7LL, the user directs their attention back to content 746b. In FIG. 7LL, the computer system 101 receives an input including gaze 704ff and hand 706ff performing an air pinch (or other selection input) and continuing to maintain the air pinch (or other selection input) position while performing the actions described in FIG. 7 MM directed towards content 746b. In FIG. 7 MM, the computer system 101 receives a movement input using hand 706ff while continuing to detect the hand 706ff in the air pinch (or other selection input) gesture (e.g., and optionally no longer detecting the gaze 704ff directed towards the content 746b). In some embodiments, the movement input includes a movement of the hand 706ff. In some embodiments, and as described in method 1100, the content 746b changes position and/or orientation in the three-dimensional environment in accordance with movement and/or rotation of the hand 706ff. In FIG. 7LL, as the user moves their hand 706ff, the computer system 101 updates the position and/or orientation of content 746b in the three-dimensional environment. In FIG. 7LL, the computer system 101 is moving the content 746b to a different location in the three-dimensional environment 702 based on the movement input provided by the user.

In FIG. 7NN, the computer system 101 displays the content 746b in the three-dimensional environment 702 based on where the computer system 101 stops detecting the air pinch (or other selection input) with hand 706ff directed towards content 746b. Prior to no longer detecting the input, the computer system 101 moves and/or rotates the content 746b in accordance with the inputs. As described in method 1100, the user is able to move the content 746b outside of the virtual environment (e.g., including the portal 712d) and into other portions of the three-dimensional environment (e.g., a representation of the physical environment). In FIG. 7NN, the overhead view 708 indicates that the content 746b is placed in the three-dimensional environment 702, outside of the portal.

FIG. 7OO illustrates a different type of webpage displayed in user interface 712a while in the first mode of presentation. The computer system 101 displays content from www.example.com/travel in the user interface 712a. In some embodiments, www.example.com/travel is a travel webpage in which the content focuses primarily on visual media (e.g., photos) on the webpage. In FIG. 7OO, the computer system 101 displays content 756a and 756c, which are photos. The computer system 101 also displays content 756b and 756d, which are text descriptions of the respective photos (content 756a and 756c). The computer system 101 also displays content 756e and 756f, which are advertisements and/or popups on the webpage. As described above, because user interface 712a and navigation bar 710a are two-dimensional in the three-dimensional environment 702, they are displayed as lines (e.g., object 705a), which overlap each other, in the overhead view 708. In FIG. 7OO, the computer system 101 detects a selection input including gaze 704gg and hand 706gg performing an air pinch (or other selection input) directed towards option 711f of the navigation bar 710a. In response to detecting the selection input in FIG. 7OO, the computer system 101 presents content in the second mode of presentation, as described above and with reference to method 800, as shown in FIG. 7PP.

Because the webpage shown in FIG. 7OO is an image focused webpage, the computer system 101 presents content in the second mode of presentation focusing on the images in FIG. 7PP. In FIG. 7PP, the computer system 101 ceases displaying user interface 712a and displays portal 712e including content 756a-b, which corresponds to content 756a, shown in FIG. 700. Portal 712e has one or more characteristics of the portals described above such as portals 712b, 712c, and/or 712d. In some embodiments, portal 712e differs from portals 712b, 712c, and/or 712d because the type of content and/or the layout of the content from the webpage, www.example.com/travel, is different from the type of content from the webpage, www.example.com, www.tv.apple.com, and www.example.com/shop. For example, for www.example.com/travel, the main focus of the website is the images (e.g. content 756a and 756c), and as such, in portal 712e, the three-dimensional representations of the images are in focus, as such, the size and/or shape of portal 712e differs from the other portals (e.g., portal 712b through 712d).

In FIG. 7PP, the computer system 101 displays content 756a-b, corresponding to content 756a in FIG. 7OO. In some embodiments, content 756a-b is a three-dimensional representation of content 756a-b including one or more spatial elements, as described in greater detail in method 800. In some embodiments, the content 756a-b is generated from content 756a, as described in method 900. As shown in the overhead view 708 in FIG. 7PP, the content 756a-b includes a plurality of spatial elements 759a, which correspond to portions of the image (e.g., the trees in content 756a-b). In FIG. 7PP, the computer system 101 also displays a portion of content 756b-b, which corresponds to content 756b, shown in FIG. 7OO. In FIG. 7PP, the computer system 101 displays color 762a (e.g., shown as a pattern) in a portion of the virtual environment 777e, shown through portal 712e. In some embodiments, and as described in method 800 and 1000, the color 762a is based on a key color of content 756a-b. While shown as a pattern herein, the color 762a represents a key color or other visual characteristic. Additionally, the computer system 101 also displays glow 760a around a portion of the portal 712e. Glow 760a has one or more characteristics of glow 726a through 726d, described above. In FIG. 7PP, the glow 760a includes the same color as color 762a (or the same pattern). In FIG. 7PP, the computer system 101 also displays color 762b and glow 760b. Color 762b and glow 760b both includes a key pattern (or key color or other visual characteristic) of content 756b-b. In some embodiments, between the portion of the background including colors 762a and 762b, the computer system 101 displays a gradient and/or a third color that is a combination of the color 762a and 762b (e.g., shown as patterns in FIG. 7PP) to indicate a transition between content 756a-b and content 756b-b. In FIG. 7PP, the computer system 101 detects a scroll input including gaze 704hh directed towards the content in portal 712e and hand706hh performing a leftward hand movement including an air pinch (or other selection input). In response to detecting the input in FIG. 7PP, the computer system 101 displays content 756b-b in place of content 756a-b in portal 712e, shown in FIG. 7QQ.

FIG. 7QQ illustrates computer system 101 displaying content 756b-b in the center of portal 712e. In FIG. 7QQ, the computer system 101 displays a portion of content 756a-b to the left of content 756b-b and a portion of content 756c-b to the right of content 756b-b. In some embodiments, the content 756c-b corresponds to a content item displayed below content 756b shown in FIG. 7OO. In some embodiments, if the computer system 101 receives a scroll input to scroll down the webpage in FIG. 7OO, then the computer system 101 would display the two-dimensional content item corresponding to content 756c-b. As shown in the overhead view 708 in FIG. 7QQ, the content 756b-b includes a plurality of spatial elements 759b, which correspond to portions of the image (e.g., the moose in content 756b-b). The plurality of spatial element 759b gives the content 756b-b the three-dimensional appearance.

In FIG. 7QQ, the computer system updates the background of the virtual environment 777e and/or the glow around the portal 712e such that the color associated with content 756b-b (e.g., color 762b) is displayed in the area that was previously displayed with the color associated with content 756a-b and the glow 760b corresponding to color 762b is displayed around the portions of the portal 712e where the color 762b is present. In some embodiments, while colors 762b and 762c are shown as patterns, they represent different visual characteristics such as a color. In FIG. 7QQ, the computer system 101 displays portions of the background and surrounding areas of portal 712a with color 762a and glow 760a near content 756a-b. The computer system 101 also displays portions of the background and surrounding areas of portal 712a with color 762c and 760c near content 756a-c in FIG. 7QQ. As shown in FIG. 7QQ, the computer system 101 transitions between each color in response to scrolling through the content in the portal 712e. Changing patterns (or colors) based on updating content is described in greater detail in method 1000. In FIG. 7QQ, the computer system 101 detects a selection input including gaze 704ii and hand 706ii performing an air pinch (or other selection input) directed towards content 756b-b. In response to detecting the selection input in FIG. 7QQ, the computer system 101 presents additional details about content 756b-b, shown in FIG. 7RR.

In FIG. 7RR, the computer system 101 displays user interface element 758 including additional details about content 756b-b. In some embodiments, the computer system 101 also displays element 758 in response to detecting a selection input directed towards option 711f of the navigation bar 710a, as described in greater detail above. As shown in the overhead view 708, the element 758 is displayed at an angle relative to the content in portal 712e (e.g., the content and element 758 have different orientations relative to the three-dimensional environment). Element 758 has one or more characteristics of elements 757, 744, and/or 734, described above. In some embodiments, while displaying element 758, if the computer system 101 receives a scroll input such as shown in FIG. 7PP, the computer system 101 would update the element 758 to include additional information about the content displayed in the center of the portal 712e and/or virtual environment 777e. Element 758 includes additional information about the image (e.g., content 756b-b). In some embodiments, the additional information was previously displayed in the user interface 712a and is found on the webpage, www.example.com/travel. In some embodiments, the computer system generates portions of the additional information using one or more machine leaning methods, as described in method 800. In FIG. 7RR, the computer system 101 displays a description and a map corresponding to content 756b-b.

Additionally, in FIG. 7RR, the computer system 101 enlarges content 756b-b in the three-dimensional environment in response to detecting the selection input. As shown in the overhead view 708, content 756b-b is larger in FIG. 7RR than previously, such as shown in FIG. 7QQ. Because the content 756b-b is larger, the other content (e.g., content 756a-b and 756c-b) to the left and right of content 756b-b are pushed further to the left and right, respectively, within the portal, therefore, the computer system 101 displays less of content 756a-b and 756c-b because they are cut off by the portal. In FIG. 7RR, the computer system 101 detects a scroll input including gaze 704jj directed towards element 758 and hand 706jj performing an upward hand movement including an air pinch (or other selection input). In response to detecting the input in FIG. 7RR, the computer system 101 scrolls element 758 downward to display additional information relating to content 756b-b, as shown in FIG. 7SS.

In FIG. 7SS, the computer system 101 displays additional information in element 758 including selectable options 764a through 764c. In some embodiments, the options 764a through 764c, when selected, cause the computer system 101 to display content from the webpage associated with the selected option. Displaying content from different webpages while remaining in the second mode of presentation is described in greater detail in method 1200.

In FIG. 7TT, the viewpoint of the user changes as the user turns to face a different wall in the room, as shown in the overhead view 708. In response to the viewpoint of the user changing, the computer system 101 does not move the portal 712e in the three-dimensional environment 702 (e.g., portal 712e remains at least partially or fully outside of the viewport of the user).

FIG. 7UU-7OOO illustrate additional and/or alternative embodiments of displaying content in a second mode of presentation, as described previously. In FIG. 7UU, the computer system 101 displays portal 712b wherein the content 713e-b, 713f-b, 713h-b, and 713i-b is displayed within the portal 712b. FIG. 7UU has one or more characteristics of FIG. 7M described above. In FIG. 7UU, the computer system 101 detects an input including gaze 704kk directed towards the navigation bar 710a. In response to detecting the input, the computer system 101 displays additional selectable options in navigation bar 710a, as shown in FIG. 7VV.

In response to detecting the gaze 704kk directed at the navigation bar 710a in FIG. 7UU, the computer system 101 displays tabs 720f through 720j in FIG. 7VV, while attention is still directed at the navigation bar 710a. As described in method 1200, the tabs 720f through 720j correspond to different websites (e.g., optionally from different content sources), that when selected, cause the computer system 101 to display respective content from the respective website in the three-dimensional environment 702. In FIG. 7VV, the computer system 101 detects a selection input including gaze 704ll and hand 706ll performing an air-pinch gesture directed towards tab 720j. In response to detecting the selection input, the computer system 101 displays user interface container 770a including content relating to the website, www.example.com/blog, shown in FIG. 7WW.

FIG. 7WW illustrates the content relating to a blog website, www.example.com/blog. The blog website includes content 772a, a title header including text that is selectable to navigate to different webpages from the same content source (e.g., “Andy's Blog”). The blog website includes content 772b, an image including a caption, and content 772c, a different image including a different caption. In some embodiments, content 772b and 772c, when selected, cause the computer system 101 to display a respective webpage (e.g., within the portal 712b, as described below) that are related to the respective images. In FIG. 7WW, the computer system 101 is not able to display content from the blog website as content with a three-dimensional appearance (e.g., the content in the blog website does not have corresponding content with spatial elements), such as in the manners described previously in method 900. Therefore, computer system 101 displays the content of the website within container 770a, and as two-dimensional content. In the overhead view 708, the user interface container 770a is illustrated as a line because the user interface container 770a and the content within the container 770a are displayed as two-dimensional in the three-dimensional environment 702. As described in method 1200, content that does not satisfy the one or more first criteria is not displayed in the second mode of presentation with one or more spatial elements. As such, the computer system 101 displays the content from the blog website in a user interface container 770a in the portal 712b. Because, prior to receiving the selection input with gaze 70411 and hand 70611, the computer system 101 was displaying content in the portal 712b, the computer system 101 continues to display content in the portal 712b in FIG. 7WW, rather that displaying content from the blog website in the first mode of presentation, as described in greater detail in method 1200. In some embodiments, the computer system 101 displays content in user interface container 770a the same way as if the content were displayed in the first mode of presentation. Because the content in the user interface container 770a is not able to be displayed with one or more spatial elements, the computer system 101 darkens option 720d, that when selected, displays a user interface element with supplemental information about the content in the portal 712b. While displaying the content from the blog website, the option 720d is not selectable.

In FIG. 7WW, the computer system 101 displays the virtual environment 777b with a color (e.g., represented as pattern 728e) and a glow (e.g., represented by pattern 726e) surrounding the virtual environment 777b and/or portal 712b. The color (e.g., represented as pattern 728e) and a glow (e.g., represented by pattern 726e) correspond to one or more key colors of the content (e.g., content 772a through 772c) in the user interface container 770a. Displaying a color and/or glow in and/or outside of the virtual environment 777b based on one or more key colors of the content within the portal 712b is described in greater detail in method 800 and/or 1000.

In FIG. 7WW, the computer system 101 detects a selection input including gaze 704mm and hand 706mm performing an air-pinch gesture directed towards tab 720f, corresponding to the webpage displayed previously in FIG. 7VV. In response to detecting the selection input, the computer system 101 ceases displaying the container 770a and redisplays the content of website “www.example.com” in the second mode of presentation, as shown in FIG. 7XX. Because, prior to receiving the selection input with gaze 704mm and hand 706mm, the computer system 101 was displaying content from the blog website in the portal 712b, the computer system 101 continues to display content in the portal 712b in FIG. 7XX, rather that displaying the content in the first mode of presentation, as described in greater detail in method 1200.

FIG. 7XX has one or more characteristics of FIG. 7VV, shown above. For example, FIG. 7XX includes the content 713f-b, 713h-b, and 713i-b, described above. In FIG. 7XX, the computer system 101 detects a selection input including gaze 704nn and hand 706nn performing an air-pinch gesture directed towards option 720d. In response to detecting the input shown in FIG. 7XX, the computer system 101 displays element 734a, shown in FIG. 7YY. Element 734a is described in greater detail in FIG. 7R. Element 734a includes additional information about the content in the portal 712b (and optionally in the website shown in portal 712b). In FIG. 7YY, the computer system 101 detects a selection input including gaze 70400 and hand 70600 performing an air-pinch gesture directed towards option 720b. In response to detecting the input in FIG. 7YY, the computer system displays menu 738, shown in FIG. 7ZZ. The computer system 101 displays the menu 738 outside of the portal 712b in the three-dimensional environment 702. Menu 738 is shown and described in greater detail in FIG. 7T.

In FIG. 7ZZ, the computer system 101 detects a selection input including gaze 704pp and hand 706pp performing an air-pinch gesture directed towards option 740d. In response to detecting the selection input shown in FIG. 7ZZ, the computer system 101 ceases displaying the content including spatial elements, shown in FIG. 7ZZ, and displays the content in the user interface 712a (e.g., displayed like in the first mode of presentation), while in the portal 712b, shown in FIG. 7AAA.

In FIG. 7AAA, the computer system 101 displays user interface 712a within portal 712b. While the content within the user interface 712a is able to be displayed in the second mode of presentation with one or more spatial elements, the computer system 101 displays the content without the one or more spatial elements based on the input directed towards option 740d, in FIG. 7ZZ. In other words, the computer system 101 displays the user interface 712a including the content without the one or more spatial elements in the portal 712b. The layout of the content displayed in user interface 712a is described in greater detail in FIGS. 7A-7F. As described with reference to “Andy's Blog” in FIG. 7WW, the computer system 101 displays the virtual environment 777b with a color, represented as pattern 728f, corresponding to one or more key colors of the content in user interface 712a, shown in FIG. 7AAA. Additionally, in FIG. 7AAA, the computer system 101 displays a glow with a color, represented as pattern 726f, surrounding portal 712b. The color of the glow corresponds to one or more key colors of the content in user interface 712a, such as a key color of content 713i, shown in FIG. 7AAA. In FIG. 7AAA, the gaze 714qq of the user is directed towards navigation bar 710a, so the computer system 101 displays the tabs 720f through 720j. In FIG. 7BBB, the computer system 101 ceases displaying the tabs 720f through 720j because the gaze 704rr is no longer directed towards the navigation bar 710a.

In FIG. 7CCC, the gaze 704ss of the user is redirected towards navigation bar 710a so the computer system 101 displays the tabs 720f through 720j in FIG. 7CCC. In FIG. 7CCC, the computer system detects a selection input including gaze 704ss and hand 706ss performing an air-pinch gesture directed towards tab 720g. In response to detecting the input, the computer system 101 displays content from the website, www.tv.apple.com, in the second mode of presentation, shown in FIG. 7DDD. The view of the content in portal 712c corresponds to the view of the content in portal 712c shown in FIG. 7W. In FIG. 7DDD, the computer system 101 displays element 744 including supplemental information about the content in the portal 712c. The element 744 is described in greater detail in FIG. 7S. In FIG. 7DDD, the computer system 101 detects a selection input including gaze 704tt and hand 706tt performing an air-pinch gesture directed towards option 745a. In response to detecting the selection input, the computer system 101 displays related content, element 745e, shown in FIG. 7EEE. As described in greater detail in FIGS. 7Y and 7Z and in method 1200, the computer system 101 displays the related content because the input detected in FIG. 7DDD corresponds to a request to change the view of the supplemental information in element 744. Element 745e is shown and described in greater detail in FIG. 7Z.

In FIG. 7EEE, the computer system 101 updates the content 742a-b because the video is continuing to play. In FIG. 7EEE, the computer system 101 updates the appearance of content 742a-b (e.g., the computer system 101 displays a different frame of the video corresponding to content 742a-b), and changes the colors of glow 749a through 749d based on the key colors of the appearance of the content 742a-b shown in FIG. 7EEE. Updating the color (e.g., represented as patterns) of glow 749a through 749d is described in greater detail in FIGS. 7W-7AA. In FIG. 7EEE, the computer system detects a selection input including gaze 704uu and hand 706uu performing an air-pinch gesture directed towards element 745e (e.g., a related video). In response to detecting the input, the computer system 101 displays content from the content source of element 745e in portal 712c, shown in FIG. 7FFF. In some embodiments, the computer system 101 replaces content 742a-b in portal 712c, shown in FIG. 7EEE, with content 742a-c, corresponding to element 745e, in FIG. 7FFF.

In FIG. 7FFF, the computer system 101 displays content 742a-c. In response to displaying different content (e.g., different than content 742a-b), the computer system 101 updates the description (e.g., shown in element 745g) from the description of the content 742a-b, shown in FIG. 7DDD, to a description of content 742a-c, shown in FIG. 7FFF. In some embodiments, as described in method 1200, the computer system 101 updates element 744 to include information about the currently displayed content (e.g., content 742a-c in FIG. 7FFF). Additionally, the computer system 101 updates glow 749a through 749d to reflect the colors (e.g., represented by different fill patterns in FIG. 7FFF) in the current frame of the video. In FIG. 7FFF, the computer system 101 displays a first appearance (e.g., a first frame of the video corresponding to content 742a-c) and one or more colors in the glow 749a through 749d corresponding to the key colors of the frame. In FIG. 7FFF, the computer system 101 automatically begins playing the content 742a-c after displaying the content 742a-c in the portal 712c. In FIG. 7FFF, the computer system 101 does not detect an input (e.g., a gaze, hand gesture, or a combination of inputs) directed towards the content 742a-c or the navigation bar 710b. Optionally, the computer system 101 does not detect the input for a threshold amount of time (e.g., 1 second, 5 seconds, 10 seconds, 30 seconds, or 1 minute), as described in method 1200. Therefore, in FIG. 7GGG, the computer system 101 ceases displaying navigation bar 710b, element 744, and control user interface 743.

In FIG. 7GGG, the computer system updates glow 749a through 749d to reflect the colors (e.g., represented by different fill patterns in FIG. 7GGG) in the current frame of the video. The computer system 101 updates the frame of the video since the video is continuing to be played between FIGS. 7FFF and 7GGG. In FIG. 7GGG, the computer system 101 detects an input including gaze 704vv and/or hand 706vv performing an air-pinch gesture directed towards content 742a-c. In response to detecting the input in FIG. 7GGG, the computer system 101 redisplays navigation bar 710b, element 744, and control user interface 743, shown in FIG. 7HHH.

In FIG. 7HHH, the computer system updates glow 749a through 749d to reflect the colors (e.g., represented by different fill patterns in FIG. 7HHH) in the current frame of the video. The computer system 101 updates the frame of the video since the video is continuing to be played between FIGS. 7GGG and 7HHH. In FIG. 7HHH, the computer system detects a selection input including gaze 704ww and hand 706ww performing an air-pinch gesture directed towards tab 720f. In response to detecting the input, the computer system 101 redisplays user interface 712a in the portal 712b, shown in FIG. 7III. Because the computer system 101 had detected an input to display the content as original content in FIG. 7ZZ, the computer system 101 had displayed the content as original content in FIG. 7AAA. Further, because the computer system 101 has not detected an input to redisplay the content with the one or more spatial elements (e.g., in the immersive mode) since detecting the input to display the content without the one or more spatial elements in FIG. 7ZZ, the computer system 101 redisplays the content in FIG. 7III without the one or more spatial elements (e.g., as user interface 712a), as described in greater detail in method 1200.

In FIG. 7III, the computer system 101 detects a selection input including gaze 704xx and hand 706xx performing an air-pinch gesture directed towards element 720b. In response to detecting the input in FIG. 7III, the computer system displays menu 738 in FIG. 7JJJ. In FIG. 7JJJ, the computer system 101 updates option 740d to include the text “show immersive reader” rather than the text “show original page”, as shown in FIG. 7ZZ, because the computer system 101 is currently displaying the content in user interface 712a in portal 712b as two-dimensional content, instead of displaying the content of user interface 712a in portal 712b including the one or more spatial elements. In FIG. 7JJJ, the computer system 101 detects a selection input including gaze 704yy and hand 706yy performing an air-pinch gesture directed towards element 740d. In response to detecting the input in FIG. 7JJJ, the computer system ceases displaying user interface 712a and displays the content in the spatial mode with the one or more spatial elements in portal 712b, shown in FIG. 7KKK. FIG. 7KKK has one or more characteristics of FIG. 7UU, described above. In FIG. 7KKK, the computer system 101 detects a scroll input directed to the content, including gaze 704zz and hand 706zz in an air-pinch position moving upward. In response to detecting and/or while detecting the scroll input, the computer system 101 begins scrolling the content in portal 712b in accordance with the scroll input. Scrolling the content is described in greater detail in FIGS. 7J to 7O and in method 800.

FIG. 7LLL illustrates an embodiment of the computer system 101 displaying the content in portal 712b while detecting the scrolling input including gaze 704zz and hand 706zz. In FIG. 7LLL, the computer system 101 decreases the visual prominence of content (e.g., content 713e-b, content 713h-b, content 713i-b, and content 713k-b) currently displayed while the scrolling is occurring. Decreasing the visual prominence of the content is described in greater detail in method 1200, and optionally includes deceasing the saturation, opacity, and/or intensity of the color of the content in portal 712b.

FIG. 7MMM illustrates an embodiment of the computer system 101 displaying the content in portal 712b while detecting the scrolling input including gaze 704zz and hand 706zz. In FIG. 7MMM, the computer system 101 decreases the visual prominence of content near (e.g., within a threshold distance of, such as within 0.01 cm, 0.1 cm, 1 cm, 10 cm, 100, or 500 cm of) the top and bottom of the boundaries of the portal 712b, such as content 713e-b, and 713k-b, while the computer system 101 detects the scrolling input. In some embodiments, while the computer system 101 detects the scrolling input, the computer system 101 maintains the visual prominence of the content that is not within the threshold distance of the top and bottom boundaries of portal 712b.

FIG. 7NNN illustrates an embodiment of the computer system 101 displaying the content in portal 712b while detecting the scrolling input including gaze 704zz and hand 706zz. In FIG. 7NNN, the computer system 101 decreases the visual prominence of content differently for different parts of the content as the computer system 101 detects the scrolling input based on the locations of the different parts of the content within portal 712b (e.g., the computer system 101 controls the visual prominence of different parts of the content based on a gradient from one boundary of the portal, such as the top boundary, to another boundary of the portal, such as the bottom boundary). For example, the computer system 101 decreases the saturation, opacity, and/or intensity of the color of the content in portal 712b differently for different portions of the content depending on the locations of those portions within the portal 712b. In FIG. 7NNN, the content near the top boundary of the portal 712b is displayed with a visual prominence lower than the visual prominence of the content displayed near the bottom boundary of the portal 712b, because the computer system 101 detects that the scrolling input is an input to scroll down in the content (e.g., the content is moving upward in the portal 712b to display additional content from below). In some embodiments, the visual prominence of the content displayed between the top and bottom boundaries of the portal 712b varies according to a gradient between the visual prominence of the content at the top boundary and the visual prominence of the content at the bottom boundary. In some embodiments, if the scrolling input included a downward motion with the hand 706zz (e.g., an input to scroll up in the content, where the content is moving downward in the portal 712b to display additional content from above), then the computer system 101 would display content near the bottom boundary of the portal 712b with a visual prominence that is lower than the visual prominence of the content displayed near the top boundary of the portal 712b. In some embodiments, the visual prominence of the content displayed between the top and bottom boundaries of the portal 712b varies according to a gradient between the visual prominence of the content at the top boundary and the visual prominence of the content at the bottom boundary.

In FIG. 7OOO, the computer system 101 stops detecting the scrolling input (e.g., detects an end or termination of the scrolling input) including the gaze 704zz and the hand 706zz. In response to no longer detecting the scrolling input, the computer system 101 stops scrolling the content and displays the content in the portal 712b without reducing the visual prominence of the content (e.g., the computer system 101 increases the visual prominence of the content to display the content with the visual prominence that the content had prior to detecting the scrolling input).

FIG. 8 is a flowchart illustrating an exemplary method 800 of transitioning from a first mode of presentation to a second mode of presentation in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processing units 202 (e.g., processors) of computer system 101 (e.g., control unit 110 in FIG. 1A). Some operations in method 800 are, optionally, combined and/or the order of some operations is, optionally, changed.

In some embodiments, method 800 is performed at a computer system that is in communication with one or more display generation components and one or more input devices, such as computer system 101 shown in FIG. 7A. For example, a mobile device (e.g., a tablet, a smartphone, a media player, or a wearable device), or a computer or other computer system. In some embodiments, the display generation component is a display integrated with the computer system (optionally a touch screen display), external display such as a monitor, projector, television, or a hardware component (optionally integrated or external) for projecting a user interface or causing a user interface to be visible to one or more users. In some embodiments, the one or more input devices include an computer system or component capable of receiving a user input (e.g., capturing a user input, and/or detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor), microphone for capturing voice commands or other audio input. In some embodiments, the computer system is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while a three-dimensional environment is visible, via the one or more display generation components, from a first viewpoint of a user (e.g., the first viewpoint of the user is optionally based on a location and/or orientation of the user in the physical environment and/or a position and/or orientation of the computer system relative to the user), the computer system displays (802a), via the one or more display generation components, content of a respective website (e.g., a shopping website, a news website, a travel website, or other websites on the world wide web) in a first mode of presentation in a three-dimensional environment, wherein the content is displayed in a web browser application that is capable of displaying content from multiple different websites (e.g., displaying in separate windows or in separate tabs), such as the content displayed in user interface 712a shown in FIG. 7A.

In some embodiments, the computer system displays the user interface within a three-dimensional environment (e.g., in a manner similar to displaying a virtual object in a three-dimensional environment as described with reference to the scene 105 in FIG. 1A). For example, the three-dimensional environment is optionally generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., optical passthrough). In some embodiments, a representation of the physical environment is displayed in the three-dimensional environment via the display generation component (e.g., virtual or video passthrough). In some embodiments, the computer system displays the user interface in the three-dimensional environment that is in the field of view of a user of the computer system from a viewpoint of the user of the three-dimensional environment. In some embodiments, the first mode of presentation includes displaying content without a variability in depth (e.g., without spatial elements, as described below). Alternatively, in some embodiments, the first mode of presentation includes displaying content with a variability in depth less than the variability in depth of the second mode of presentation. For example, the computer system displays content, such as user interfaces of various applications and/or content of a respective user interface, in one spatial plane. For example, the content includes one or more media items such as text (two-dimensional and/or three-dimensional text), images (two-dimensional and/or three-dimensional images), and/or videos (two-dimensional and/or three-dimensional video). In some embodiments, the variability in depth is the depth (e.g., in the z axis) that the respective content occupies in the three-dimensional environment (e.g., across its longest dimension, in depth—for example, along the z axis). In some embodiments, the variability in depth is 0.1 cm in depth, 1 cm in depth, 10 cm in depth, 50 cm in depth, or 1 m in depth. In some embodiments, the content includes a combination of different types of content. In some embodiments, displaying content without a variability in depths includes displaying the user interface (and the respective content) on one or more spatial plane. For example, the three-dimensional environment includes a plurality of planes (e.g., in the x-y plane, y-z plane, and x-z plane). In some embodiments, contents of the user interface are on the same spatial plane (e.g., the same x-y plane) such that the content is two-dimensional in the three-dimensional environment. Alternative, in some embodiments, contents of the user interface are not on the same spatial plane (e.g., photos are on a different plane than text). In some embodiments, the first mode of presentation includes displaying content without immersion. In some embodiments, the first mode of presentation includes display content with a first level of immersion less than the level of immersion of the second mode of presentation. In some embodiments, a level of immersion includes an associated degree to which the content displayed by the computer system (e.g., the virtual environment) obscures background content (e.g., content other than the virtual environment such as the representation of the physical environment) around and/or behind the virtual environment, optionally including the number of items of background content displayed and the visual characteristics (e.g., colors, contrast, opacity) with which the background content is displayed, and/or the angular range of the content displayed via the display generation component (e.g., 60 degrees of content displayed at low immersion, 120 degrees of content displayed at medium immersion, 180 degrees of content displayed at high immersion), and/or the proportion of the field of view displayed via the display generation components consumed by the virtual environment (e.g., 33% of the field of view consumed by the virtual environment at low immersion, 66% of the field of view consumed by the virtual environment at medium immersion, 100% of the field of view consumed by the virtual environment at high immersion). In some embodiments, the background content is included in a background over which the virtual environment is displayed, such as a representation of a physical environment, as described above with reference to the representation of the physical environment and the virtual environment. In some embodiments, the background content includes user interfaces (e.g., user interfaces generated by the computer system corresponding to applications including or other than the web browser application), virtual objects (e.g., files and/or representations of other users generated by the computer system) not associated with or included in the virtual environment, and/or real objects (e.g., pass-through objects representing real objects in the physical environment around a viewpoint of a user that are displayed by the computer system such that they are visible via the display generation components and/or a visible via a transparent or translucent display generation components because the computer system does not obscure and/or prevent visibility of them through the display generation component). In some embodiments, at a first (e.g., low) level of immersion, the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a second (e.g., higher) level of immersion, the background, virtual and/or real objects are displayed in an obscured manner (e.g., dimmed, blurred, and/or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, displayed with increased transparency) more than one or more second background objects, and one or more third background objects cease to be displayed.)

In some embodiments, while displaying the content in the first mode of presentation from the first viewpoint of the user, the computer system detects (702b), via the one or more input devices, an input corresponding to a request to display the content from the respective website in a second mode of presentation, such as the input with gaze 704h and hand 706h directed towards option 718d, shown in FIG. 7I. In some embodiments, the input is optionally a selection input such as a tap input, a gaze input, an air pinch input (or other selection input), and/or a voice input corresponding to a request to display the content in the second mode of presentation. For example, the input includes an input directed towards a selectable option, that is selectable to display the content in the second mode of presentation, such as an air pinch gesture or air tap gesture (e.g., a multi-pinch or multi-tap air gesture) performed by a hand of the user, optionally while the attention of the user (e.g., including gaze) is directed to the selectable option in the environment.

In some embodiments, in response to detecting the input (702c), the computer system ceases (702d) displaying the content in the first mode of presentation, such as user interface 712a no longer being displayed in FIG. 7J. In some embodiments, the computer system ceasing displaying the content in a first spatial plane, the first set of spatial planes, or the first level of immersion, as described above with reference to how content is displayed on spatial planes. In some embodiments, while the computer system ceases displaying the content in the first mode of presentation, the computer system does not stop displaying the content. For example, the computer system continuously displays the content in response to detecting the input (e.g., while transitioning between the first mode of presentation and the second mode of presentation for that content).

In some embodiments, in response to detecting the input (702c), the computer system displays (702e) the content in the second mode of presentation, wherein in the second mode of presentation, the content is displayed with one or more spatial elements (e.g., elements that are distributed at different depths relative to a viewpoint of the user) that are related to the content (e.g., elements that are part of the content or generated based on the content) and are not displayed when the content is displayed in the first mode of presentation, such as the content being displayed in portal 712b, shown in FIG. 7J. The content 713e-b includes spatial elements 724a and 724b, shown in FIG. 7K. In some embodiments, the second mode of presentation includes displaying spatial elements that correspond to the content (e.g., the same text, images, and/or videos displayed in the user interface while in the first mode of presentation) in the first mode of presentation with a greater variability in depth. For example, while the images in the first mode of presentation and the second mode of presentation have the same components, the computer system displays the image in the second mode of presentation as spatial elements with greater variability in depth. In some embodiments, the second mode of presentation includes displaying one or more components of the content on different and/or a plurality of spatial planes. For example, content such as text is displayed in two-dimensions on a first spatial plane, and content such as photos and/or videos are displayed as photos and/or videos with a three-dimensional appearance on one or more second spatial planes (e.g., a different depths relative to the viewpoint of the user). Additionally, in some embodiments, media such as photos and/or videos are displayed with more variability in depth in the second mode of presentation than the first mode of presentation. For example, components of the media items are shown with more variability in depth such that the respective media item appears and/or is displayed three-dimensional, described in greater detail in method 1000. In some embodiments, and as described above, the computer system displays the content with a higher level of immersion while in the second mode of presentation than while in the first mode of presentation. In some embodiments, in response to displaying the content in the second mode of presentation, the computer system ceases displaying one or more content items of the content that were previously displayed in the first mode of presentation. For example, the computer system ceases displaying one or more content items that are not relevant in the second mode of presentation (e.g., advertisements and/or links to other content). In some embodiments, in response to the user changing the viewpoint from the first viewpoint to a second viewpoint, the computer system updates the display of the content (in the first mode of presentation or the second mode of transportation) to be displayed from the second viewpoint of the user. For example, the content is not anchored to a specific location in the three-dimensional environment. Alternatively, in some embodiments, the computer system continues to display the content from the same location in the first viewpoint while the user changes to the second viewpoint. For example, the content is anchored to a specific location in the three-dimensional environment and while the computer system changes viewpoints (e.g., the user of the computer system moves locations), the content remains in the same location. For example, while in the second viewpoint, the computer system displays the content at an angle. In some embodiments, the computer system displays the content in the center of the user's respective viewpoint. In some embodiments, the computer system moves the location of the content in the three-dimensional environment, whether in the first mode or the second mode, in response to one or more inputs corresponding to a request to move the content. For example, the input includes an input such as an air pinch and drag gesture (e.g., toward a second location in the environment) performed by a hand of the user, optionally while attention (e.g., including gaze) of the user is directed to the user interface including the content in the environment. Presenting content in the second mode of presentation in response to receiving an input reduces the resources needed to display content by only displaying the content in the second mode of presentation when needed, thereby reducing user discomfort (from the immersive environment) and saving battery life and/or computing resources.

In some embodiments, displaying the content in the second mode of presentation includes displaying one or more content items with a three-dimensional appearance that was not displayed in the first mode of presentation, such as content 713e, shown in FIG. 7C, being displayed as content 713e-b with spatial elements 724a and 724b in the second mode of presentation, shown in FIG. 7K. In some embodiments, the one or more content items with a three-dimensional appearance correspond to two-dimensional content items that were displayed in the first mode of presentation. In some embodiments, the three-dimensional content items include videos and/or photos. In some embodiments, the one or more content items with a three-dimensional appearance are related to other content items in the content. In some embodiments, the content item with a three-dimensional appearance is a representation of a real-world object depicted by one or more two-dimensional content items in the first mode of presentation. In some embodiments, the one or more content items with a three-dimensional appearance are three-dimensional content items. Displaying additional content with a three-dimensional appearance while in the second mode of presentation allows the user to view additional content while in a spatial experience (e.g., the second mode of presentation), thereby increasing the speed and efficiency of using the computer system which saves battery life and/or computing resources.

In some embodiments, the one or more content items with a three-dimensional appearance includes a panorama content item that is displayed with a simulated curve (e.g., a curve that is based on a field of view of a camera or a path that the camera moved while capturing the panorama), such as if the content displayed in portal 712b, shown in FIG. 7K includes a panorama. In some embodiments, a panorama content item is a photo and/or video (e.g., with or without spatial elements) that is presented such that the content item encompasses a larger area of the user's viewpoint. In some embodiments, the panorama content item is presented as a curved content item (e.g., curving around the viewpoint of the user). Displaying a panorama content item while in the second mode of presentation reduces distractions while in a spatial experience (e.g., the second mode of presentation), therefore enhancing user experience with the computer system.

In some embodiments, the one or more content items with a three-dimensional appearance include one or more photos with a three-dimensional appearance and/or one or more videos with a three-dimensional appearance (that are optionally automatically generated from the two-dimensional visual content), such as content 713e-b including spatial elements 724a and 724b, shown in FIG. 7K. In some embodiments, the one or more content items with a three-dimensional appearance have one or more characteristics of the content items with a three-dimensional appearance described in method 900. In some embodiments, automatically generating the content items with a three-dimensional appearance includes using one or more autonomous processes such as artificial neural networks and/or machine learning, such as described in method 900. In some embodiments, the photos and/or videos with the three-dimensional appearance include one or more spatial elements. Displaying photos and/or videos with a three-dimensional appearance while in the second mode of presentation allows the computer system to reduce distractions in a spatial experience (e.g., the second mode of presentation), therefore increasing the speed and efficiency of using the computer system which saves battery life and/or computing resources.

In some embodiments, the one or more content items with a three-dimensional appearance include one or more virtual three-dimensional representations of three-dimensional objects, such as content 746b, which is a three-dimensional representation of a chair, shown in FIG. 7DD. In some embodiments, the virtual three-dimensional representation is described in greater detail in method 1100. In some embodiments, the virtual three-dimensional representation is based on one or more two-dimensional content items of the object. In some embodiments, the three-dimensional object is a real-world object (e.g., furniture, decorations, and/or other objects found in the physical world). Displaying a three-dimensional object in the second mode of presentation reduces distractions while in a spatial experience (e.g., the second mode of presentation), therefore increasing the speed and efficiency of using the computer system which saves battery life and/or computing resources.

In some embodiments, displaying the content in the first mode of presentation includes replacing a first portion of the three-dimensional environment with virtual content (e.g., the content (e.g., text, images, videos, graphs, and/or other media), and/or a user interface and/or frame including the content, such as a web browser user interface), such as displaying user interface 712a in the three-dimensional environment 702, shown in FIG. 7A. In some embodiments, displaying the content in the second mode of presentation includes replacing a second portion of the three-dimensional environment with virtual content, wherein the second portion of the three-dimensional environment is larger than the first portion of the three-dimensional environment, such as virtual environment 777b and/or portal 712b occupying more space in the three-dimensional environment 702, as shown in FIG. 7K. In some embodiments, the second portion includes the first portion. In some embodiments, the virtual content is the content (e.g., text, images, videos, graphs, and/or other media). In some embodiments, the virtual content is a portal including the content. In some embodiments, the virtual content includes one or more immersion properties and/or viewer properties, as described below. In some embodiments, displaying the content in the three-dimensional environment includes obscuring background content with the virtual content, such that the user is unable to see the background content from the first viewpoint. In some embodiments, and as described above, the background content includes representation(s) of the physical environment of the user. Replacing a larger portion of the three-dimensional environment when displaying the content in the second mode of presentation allows the computer system to reduce distractions in the three-dimensional environment while in a spatial experience (e.g., the second mode of presentation), therefore increasing the speed and efficiency of using the computer system which saves battery life and/or computing resources.

In some embodiments, displaying the content in the first mode of presentation includes displaying, via the one or more display generation components, the content with a first visual edge characteristic, such as user interface 712a shown in FIG. 7A including defined edges. In some embodiments, displaying the content in the second mode of presentation includes displaying, via the one or more display generation components, the content with a second visual edge characteristic different than the first visual edge characteristic, such as portal 712b including glow 726a, shown in FIG. 7J. For example, in the second mode of presentation, the portal 712b does not include defined edges and instead, the portal 712b gradually fades into the three-dimensional environment using the glow 726a. In some embodiments, a respective visual edge characteristic includes a characteristic of a border between the content and the three-dimensional environment. For example, the visual edge characteristic is the characteristic of the border between the user interface and the three-dimensional environment. In some embodiments, the first visual edge characteristic includes a defined edge and/or border between the content (e.g., a user interface displaying the content) and the three-dimensional environment. For example, the first visual edge characteristic includes a change in color and/or lighting, or a line border to transition between the content (e.g., or a user interface including the content) and the three-dimensional environment. In some embodiments, the first visual edge characteristic includes displaying a first virtual lighting characteristic, as described below. In some embodiments, the first visual edge characteristic includes an unblurred edge (e.g., unblurred line between the content and the three-dimensional environment), and/or a step transition between the content and the three-dimensional environment. In some embodiments, the second visual edge characteristic includes a blurred edge (e.g., the border between the content and the three-dimensional environment is not as precisely defined), and/or a gradient (e.g., of color) between the content and the three-dimensional environment. For example, the second visual edge characteristic includes a gradient of color and/or lighting to transition between the content (e.g., or a user interface including the content) and the three-dimensional environment. In some embodiments, the second visual edge characteristic includes displaying a second virtual lighting characteristic, as described below. Displaying the content with a blurred edge in the second mode of presentation allows the computer system to reduce distractions in the three-dimensional environment while in a spatial experience (e.g., the second mode of presentation), therefore increasing the speed and efficiency of using the computer system which saves battery life and/or computing resources.

In some embodiments, displaying the content in the first mode of presentation includes displaying, via the one or more display generation components, the content with a first virtual lighting characteristic, such as the user interface 712a not including a glow, shown in FIG. 7A. In some embodiments, displaying the content in the second mode of presentation includes displaying, via the one or more display generation components, the content with a second virtual lighting characteristic different than the first virtual lighting characteristic, such as content 713e-b including shadow 722a, shown in FIG. 7R. In some embodiments, a respective virtual lighting characteristic is a simulated lighting effect extending out from the edges of the content (or a user interface including the content). In some embodiments, the first virtual lighting characteristic includes forgoing displaying a lighting effect (e.g., glow effect) corresponding to the one or more colors of the content, and forgoing displaying a lighting effect that extends past the edges and/or border of the content into the three-dimensional environment. In some embodiments, the second virtual lighting characteristic includes displaying a lighting effect corresponding to the one or more colors of the content that extends out from the edges of the content into the three-dimensional environment, optionally virtually cast onto one or more surfaces in the three-dimensional environment. Displaying the content with simulated light extending from the edges of the content in the second mode of presentation allows the computer system to remove external distractions in the spatial experience, therefore increasing the speed and efficiency of using the computer system which saves battery life and/or computing resources.

In some embodiments, the content includes text and one or more media items (e.g., videos, graphics, images, graphs, and/or audio), such as content 713a through 713c in the first mode of presentation, shown in FIG. 7A, which corresponds to content 713a-b through 713a-c in the second mode of presentation, shown in FIG. 7J.

In some embodiments, displaying the content in the first mode of presentation includes displaying, via the one or more display generation components, the text and the one or more media items with a first spatial relationship (e.g., a first relative position and/or orientation relative to each other), such as the content 713a through 713c being displayed at the same depth relative to the viewpoint of the user, as shown in the overhead view 708 in FIG. 7A. In some embodiments, the first spatial relationship includes displaying the text and the media items in line with each other. For example, the text and media items are displayed on the same plane (e.g., at the same depth) in the three-dimensional environment relative to the viewpoint of the user, as described above.

In some embodiments, displaying the content in the second mode of presentation includes displaying, via the one or more display generation components, the text and the one or more media items with a second spatial relationship, different than the first spatial relationship (e.g., a second relative position and/or orientation relative to each other), such as content 713a-b through 713a-c being displayed at different depths relative to the viewpoint of the user, as shown in the overhead view 708 in FIG. 7J. In some embodiments, the second spatial relationship includes displaying the text and the media items with a variance in depth relative to the viewpoint of the user, as described below. In some embodiments, the text is displayed at the same depth relative to the viewpoint in the first mode of presentation and the second mode of presentation. In some embodiments, the media items are displayed at a different depth than the text in the second mode of presentation as compared to the media items and the text in the first mode of presentation. Displaying the content with different spatial relationships in the second mode of presentation allows the computer system to reduce external distractions while in a spatial experience (e.g., the second mode of presentation) by increasing visual appeal of the content, therefore increasing the speed and efficiency of using the computer system which saves battery life and/or computing resources.

In some embodiments, the first spatial relationship and the second spatial relationship differ in depth of the text relative to the one or more media items relative to the viewpoint of the user, such as content 713b-b (e.g., text) shown in FIG. 7A being at a different depth than corresponding content 713b-b (e.g., text), shown in FIG. 7J. The variance and/or difference in depth is described in greater detail above. In some embodiments, the first spatial relationship includes a lower (or no) variance in depth of the text relative to the media items and the second spatial relationship includes a higher variance in depth of the text relative to the media items. In some embodiments, the one or more media items are displayed at a depth closer to the viewpoint than the text while in the second mode of presentation. In some embodiments, while in the second mode of presentation, some media items are displayed at the same depth as the text while other media items are displayed at a depth different than the depth of the text. Displaying the content with different depths for different portions of the content in the second mode of presentation allows the computer system to reduce distractions in the environment while in a spatial experience (e.g., the second mode of presentation) by increasing visual appeal of the content, therefore increasing the speed and efficiency of using the computer system which saves battery life and/or computing resources.

In some embodiments, while displaying a first portion of the content without displaying a second portion of the content, detecting, via the one or more input devices, a respective input including a gaze of the user (optionally, without detecting an input from a portion of the user other than one or more eyes of the user concurrently with the input including the gaze of the user and/or without detecting a scrolling input that incudes hand movement), such as gaze 704i, shown in FIG. 7J. In some embodiments, the computer system receives a gaze input directed towards the first portion of the content and/or a selectable option on the first portion of the content (or the user interface including the first portion of the content). In some embodiments, the input is a gaze-only or attention-only input.

In some embodiments, in response to detecting the respective input (e.g., or while detecting the respective input) and in accordance with a determination that one or more criteria are satisfied (e.g., a criterion that is satisfied when the gaze is directed at the first portion of the content and/or the selectable option for a threshold amount of time (e.g., 1 second, 5 seconds, 10 seconds, or 30 seconds), a criterion that is satisfied when the gaze input includes a movement of the eyes up or down), and/or a criterion that is satisfied when the gaze is detected at a particular region (or directed towards a selectable option such as a scroll bar) of the first portion of the first content, the computer system scrolls the content away from the first portion of the content to the second portion of the content based on the gaze of the user (e.g., based on a movement, location, and/or duration of the gaze of the user), including ceasing display of the first portion of the content, such as scrolling between the first portion of the content shown in FIG. 7J to a second portion of the content, shown in FIG. 7K, when the computer system 101 detects only gaze 704i directed towards the bottom portion of the content in portal 712b. In some embodiments, the direction of scroll is based on whether the gaze input is directed towards a first particular region or a second particular region of the first portion of the content. In some embodiments, the direction of the scroll is based on the direction that the eyes move. For example, if the eyes include a movement of the pupils upward, then the computer system scrolls the content downward and if the eyes include a movement of the pupils downward, then the computer system scrolls the content upward. Alternatively, in some embodiments, the direction of the scroll is based on the location to which the gaze is directed. For example, if the gaze is directed towards the top of the content, then the computer system scrolls the content upward, and if the gaze is directed towards the bottom of the content, then the computer system scrolls the content downward. Alternatively, in some embodiments, scrolling the content includes displaying the second portion of the content while still displaying the first portion of the content (or a portion of the first portion of the content). In some embodiments, in response to no longer detecting the respective input, the computer system ceases scrolling the content. Automatically scrolling via gaze allows the user to more efficiently view content since they are able to scroll while using their hands for other actions, thereby increasing the speed and efficiency of using the computer system which saves battery life and/or computing resources.

In some embodiments, the one or more criteria include a criterion that is satisfied when the content is displayed in the second mode of presentation, such as shown by the virtual environment 777b and portal 712b, shown in FIG. 7J. In some embodiments, the one or more criteria include a criterion that is not satisfied when the content is displayed in the first mode of presentation. For example, the computer system 101 does not perform scrolling using only gaze when user interface 712a is displayed in FIG. 7A. In some embodiments, the computer system is able to scroll the content using gaze-only input while in the second mode of presentation and not while in the first mode of presentation. Alternatively, in some embodiments, the computer system scrolls the content using gaze while in both the first and second modes of presentation. In some embodiments, while in the first mode of presentation, the computer system detects the gaze-only input directed towards the particular region(s), as described above, and in response to detecting the gaze-only input, the computer system does not automatically scroll the content. Automatically scrolling via gaze while in the second mode of presentation allows the user to view content more efficiently and be more immersed in their environment since they are able to scroll without using their hands (e.g., without additional distractions), thereby increasing the speed and efficiency of using the computer system which saves battery life and/or computing resources.

In some embodiments, while displaying the content in the second mode of presentation (or optionally, while displaying the content in the first mode of presentation), the computer system detects, via the one or more input devices, a respective input corresponding to a request to change one or more characteristics of a font of the content, such as if an input were detected towards option 740a or 740b shown in FIG. 7T. In some embodiments, the respective input is optionally a selection input such as a tap input, a gaze input, an air pinch input (or other selection input), and/or a voice input corresponding to a request to change one or more characteristics of a font. For example, the respective input includes an input directed towards a selectable option, that is selectable to change a characteristic of the font, such as an air pinch gesture or air tap gesture (e.g., a multi-pinch or multi-tap air gesture) performed by a hand of the user, optionally while the attention of the user (e.g., including gaze) is directed to the selectable option in the environment.

In some embodiments, in response to detecting the respective input, the computer system changes the one or more characteristics of the font of the content in accordance with the respective input, such as decreasing a font size in response to detecting an input directed towards option 740a or increasing a font size in response to detecting an input directed towards option 740b, shown in FIG. 7T. In some embodiments, the one or more characteristics includes text font, text size, text color, text thickness, and/or other font characteristics. Allowing the user to change a characteristic of the font to ensures the font is at a size, shape, color, or other characteristic desired by the user, thereby improving user device interaction which saves battery life and/or computing resources and enhancing user experience with the computer system

In some embodiments, while displaying the content in the second mode of presentation, the computer system detects, via the one or more input devices, a first respective input directed towards the content, such as the input including gaze 704m and hand 706m, shown in FIG. 7Q. In some embodiments, the first respective input is a selection input such as a tap input, a gaze input, an air pinch input (or other selection input), and/or a voice input corresponding to a request to display supplement content. For example, the first respective input includes an input directed towards a selectable option, that is selectable to display a user interface element including supplemental content and/or information that is related to the content, such as an air pinch gesture or air tap gesture (e.g., a multi-pinch or multi-tap air gesture) performed by a hand of the user, optionally while the attention of the user (e.g., including gaze) is directed to the selectable option in the environment. In some embodiments, the selectable option is on a user interface of the content. In some embodiments, the selectable option is a content item of the content (e.g., an image and/or video).

In some embodiments, in response to detecting the first respective input, the computer system displays, via the one or more display generation components, a user interface element including one or more supplemental elements corresponding to the content, wherein the user interface element is displayed to a side (e.g., the left, the right, above, or below the content as described below) of the content in the three-dimensional environment, such as element 734a, shown in FIG. 7R, element 744 shown in FIG. 7Y, element 757, shown in FIG. 7FF, and/or element 758, shown in FIG. 7RR. In some embodiments, the supplemental elements include one or more content items that are no longer displayed (e.g., the supplemental elements as described above) in response to the computer system changing from the first mode of presentation to the second mode of presentation. In some embodiments, the supplemental elements include second content related to the content (e.g., a related video or website). In some embodiments, the supplemental elements include a detailed description of a content item of the content. In some embodiments, the supplemental elements are selectable to display a second content (e.g., in place of the content) that corresponds to the respective supplemental element, as described in greater detail in method 1200. Displaying additional content in a user interface element allows the user to efficiently view the relevant content in the second mode of presentation without additional distractions, thereby increasing the speed and efficiency of using the computer system which saves battery life and/or computing resources and enhancing user experience in the spatial mode on the computer system.

In some embodiments, the user interface element includes one or more navigational elements for navigating content that is displayed in the second mode of presentation (e.g., selectable options that are selectable to change the content that is displayed), such as element 745e, shown in FIG. 7AA. In some embodiments, while displaying the user interface element, the computer system detects, via the one or more input devices, a second respective input directed towards the one or more navigational elements, such as if the computer system detects an input including a gaze and/or an air pinch (or other selection input) with a hand directed towards element 745e, shown in FIG. 7AA. In some embodiments, the second respective input is optionally a selection input such as a tap input, a gaze input, an air pinch input (or other selection input), and/or a voice input directed towards one or more navigational elements. For example, the second respective input includes an input directed towards a selectable option, that is selectable to update the content in accordance with the navigational element, such as an air pinch gesture or air tap gesture (e.g., a multi-pinch or multi-tap air gesture) performed by a hand of the user, optionally while the attention of the user (e.g., including gaze) is directed to the navigational element in the environment. In some embodiments, the navigational elements are additional photos, videos, and/or other media displayed on the user interface element. In some embodiments, the navigational element is a link to a different web page (e.g., a web page relevant to the content). In some embodiments, the navigational elements include a pause/play, fast forward, and/or rewind button. In some embodiments the navigational elements include selectable options to change the mode of presentation.

In some embodiments, in response to detecting the second respective input: in accordance with a determination that the second respective input is directed towards a first navigational element (e.g., a first photo, video, link, and/or other selectable option), the computer system updates the content to include first content, such as if in response to detecting the input, the computer system changes the content in portal 712c to be the content corresponding to element 745e in FIG. 7AA. In some embodiments, the first content is displayed in front of the content and/or the user interface element. In some embodiments, the computer system ceases displaying the content and/or the user interface element and displays the first content in the place of the content (e.g., at the same position and/or orientation relative to the three-dimensional environment and/or viewpoint). In some embodiments, the first content includes additional information about the content (e.g., a content item of the content or a portion of the content). In some embodiments, the first content is related to the content and/or a portion of the content.

In some embodiments, in response to detecting the second respective input: in accordance with a determination that the second respective input is directed towards a second navigational element (e.g., a second photo, video, link, and/or other selectable option), updating the content to include second content, different from the first content, such as if the input was directed towards element 745f, the computer system changes the content in portal 712c to be the content corresponding to element 745f. In some embodiments, the second content is displayed in front of the content and/or the user interface element. In some embodiments, the computer system ceases displaying the content and/or the user interface element and displays the second content in place of the content (e.g., at the same position and/or orientation relative to the three-dimensional environment and/or viewpoint). In some embodiments, the second content includes additional information about the content (e.g., a content item of the content or a portion of the content). In some embodiments, the second content is related to the content and/or a portion of the content. In some embodiments, in response to detecting an input towards a respective navigation element, the computer system navigates away from the content and displaying a system user interface (e.g., a home screen including a plurality of applications or a control center user interface for changing one or more computer system settings). In some embodiments, in response to detecting an input towards a respective navigational element, the computer system updates the display of the content in the second mode of presentation to the first mode of presentation. Allowing a user to navigate between content using a navigational element simplifies interactions with the computer system by reducing errors in interaction with the content which increases the speed and efficiency of using the computer system which saves battery life and/or computing resources.

In some embodiments, displaying the content in the second mode of presentation includes displaying the content at a first orientation relative to the three-dimensional environment, such as content 742a-b being displayed in the first orientation, as shown in FIG. 7Y. In some embodiments, the user of the computer system determines the orientation of the content in the second mode of presentation. In some embodiments, the computer system determines the orientation of the content in the second mode of presentation. For example, the computer system displays the content such that the content is orientated towards the viewpoint of the user. In some embodiments, in response to one or more inputs including a selection input such as a tap input, a gaze input, an air pinch input (or other selection input), and/or a voice input corresponding to a request to change the orientation of the content, the computer system changes the orientation of the content based on the input.

In some embodiments, displaying the user interface element includes displaying the user interface element at a second orientation relative to the three-dimensional environment (e.g., and/or relative to the first orientation of the content), different from the first orientation, such as element 744 being displayed in a second orientation, which is different than the orientation of content 742a-b, shown in FIG. 7Y. In some embodiments, the second orientation is at an angle relative to the first orientation. In some embodiments, the computer system displays the user interface element at an angle to the right or left of the content. In some embodiments, the angle is +/−15 degrees, 30 degrees, 45 degrees, or 90 degrees relative to the content. In some embodiments, the computer system displays the user interface element at an angle such that the user interface element is billboarded towards the viewpoint of the user (e.g., which is different from the first orientation, because the user interface element is located at a different position in the three-dimensional environment than the content and thus needs to be turned to a different orientation to face the viewpoint of the user). In some embodiments, billboarding allows the user interface element to always face the viewpoint of the user (e.g., such that the user interface element is normal to a vector from the viewpoint of the user to a point on the user interface element). In some embodiments, the user interface element is displayed at the first orientation. Displaying the supplemental information at an angle allows the user to view the content and the supplemental informational from the viewpoint of the user, thereby reducing the number of inputs needed to view additional content which saves battery life and/or computing resources.

In some embodiments, the one or more supplemental elements correspond to additional content relevant to the content (e.g., relevant webpages, images, videos, comments, reviews, and/or other media), such as element 745d, 745e, and/or 745f, shown in FIGS. 7Y-7AA. In some embodiments, while displaying the user interface element including the one or more supplemental elements, the computer system detects, via the one or more input devices, a second respective input directed towards a first supplemental element of the one or more supplemental elements, such as if the computer system detects an input directed towards element 745e, shown in FIG. 7AA. In some embodiments, the second respective input is optionally a selection input such as a tap input, a gaze input, an air pinch input (or other selection input), and/or a voice input directed towards the first supplemental element. For example, the second respective input includes an input directed towards a selectable option, that is selectable to update the content in accordance with the first supplemental element, such as an air pinch gesture or air tap gesture (e.g., a multi-pinch or multi-tap air gesture) performed by a hand of the user, optionally while the attention of the user (e.g., including gaze) is directed to the first supplemental element in the environment. In some embodiments, the first supplemental element is a photo, video, and/or other media displayed on the user interface element. In some embodiments, the first supplemental element is a link to a different web page (e.g., a web page relevant to the content).

In some embodiments, in response to detecting the second respective input, the computer system displays, via the one or more display generation components, second content corresponding to the first supplemental element in the second mode of presentation, such as if the computer system displays the content corresponding to element 745e in place of content 742a-b in the portal 712c, shown in FIG. 7AA. As described above, in some embodiments the second content is displayed in front of or adjacent to the content, or the second content item is displayed in place of the content (e.g., the computer system ceases displaying the content). Displaying additional relevant content that can be displayed in the user interface element allows the user to easily navigate to other relevant content thereby reducing the number of inputs needed to view additional content which saves battery life and/or computing resources.

In some embodiments, while displaying the user interface element including one or more supplement elements at a first location in the three-dimensional environment (and/or relative to the viewpoint of the user), the computer system detects, via the one or more input devices, a second respective input corresponding to a request to move the user interface element in the three-dimensional environment, such as if the computer system detects an input directed towards bar 734b, shown in FIG. 7R. In some embodiments, the second respective input is a selection input and a movement input such as a tap and drag input, a gaze and drag (e.g., with the eyes or hands) input, an air pinch (or other selection input) and air-drag input, and/or a voice input directed towards the user interface element or a portion of the user interface element. For example, the second respective input includes an input directed towards a selectable option, that is selectable to move the user interface element, such as an air pinch gesture or air tap gesture (e.g., a multi-pinch or multi-tap air gesture) and an air-drag gesture performed by a hand of the user, optionally while the attention of the user (e.g., including gaze) is directed to the selectable option and/or user interface element in the environment.

In some embodiments, in response to detecting the second respective input, the computer system updates a location of the user interface element in the three-dimensional environment from the first location to a second location, different from the first location, such as if element 734a were moved to a different location in the three-dimensional environment 702 in response to an input directed towards bar 734b, shown in FIG. 7R. In some embodiments, the computer system updates the location (and/or orientation) of the user interface element based on the movement of the hand and a location in which the computer system ceases detecting the input. For example, the location where the user releases the air pinch (or other selection input) gesture. In some embodiments, moving the user interface element does not include moving the content not in the user interface element. In some embodiments, the second location is a location outside of the portal where the content is display. The portal is described in greater detail below and with reference to method 1000 and 1100. Moving the user interface element in response to a select and drag input allows the user to customize their viewpoint easily thereby reducing the number of inputs needed to reposition content which saves battery life and/or computing resources.

In some embodiments, displaying the content in the second mode of presentation includes displaying the content in a portal in the three-dimensional environment, such as shown by the content in the portal 712b, shown in FIG. 7R. Displaying the content in the portal is described in additional detail below and with reference to methods 1000 and 1100. In some embodiments, the content is bound to the boundaries of the portal. In some embodiments, displaying the user interface element including the one or more supplemental elements includes displaying, via the one or more display generation components, the user interface element at a location outside of the portal in the three-dimensional environment, such as element 734a being displayed outside of the portal 712b and/or virtual environment 777b, shown in FIG. 7R. In some embodiments, the user interface element is not bound to the boundaries of the portal. In some embodiments, in response to an input to move the user interface element (e.g., moving the user interface as described above with reference to detecting an input to move the user interface element), the computer system moves the user interface element to a location within the three-dimensional environment including within or outside of the portal (e.g., the user interface element can be moved into and/or out of the portal based on user input). Displaying the user interface element outside of the portal allows the computer system to display necessary/requested information utilized more space in the three-dimensional environment (e.g., not confined to the boundaries of the portal), therefore allowing the user to view necessary information without additional inputs, which increases the speed and efficiency of using the computer system which saves battery life and/or computing resources.

In some embodiments, detecting the input corresponding to the request to display the content from the respective website in the second mode of presentation includes detecting the input directed towards a selectable option in a menu bar of the web browser application, such as an input directed towards option 710e, shown in FIG. 7H. In some embodiments, the input is a selection input such as described in greater detail above. In some embodiments, the menu bar is displayed at the top of the user interface including the content. In some embodiments, the menu bar includes one or more selectable options to navigate to different web pages in the web browser application.

In some embodiments, in response to detecting the input directed towards the selectable option in the menu bar of the web browser application, the computer system displays, via the one or more display generation components, one or more menu options, including a menu option for displaying the content in the second mode of presentation, such as menu 716, shown in FIG. 7I. In some embodiments, the menu options include an option to change the mode of presentation to the second mode of presentation. In some embodiments, the menu options additionally or alternatively include accessibility options (e.g., change font size or font type, and/or presenting the content in the web browser application via audio). Displaying the selectable option to cause the computer system to display content in the second mode of presentation on a menu bar with other selectable options allows the user to easily find the selectable option thereby reducing errors in interaction with the computer system which saves battery life and/or computing resources.

In some embodiments, while displaying the one or more menu options, the computer system detects, via the one or more input devices, a respective input corresponding to a request to select the menu option to display the content in the second mode of presentation, such as the input directed towards option 718d, shown in FIG. 7I. In some embodiments, the respective input is optionally a selection input such as a tap input, a gaze input, an air pinch input (or other selection input), and/or a voice input corresponding to a request to display the content in the second mode of presentation. For example, the respective input includes an input directed towards the menu option, that is selectable to display the content in the second mode of presentation, such as an air pinch gesture or air tap gesture (e.g., a multi-pinch or multi-tap air gesture) performed by a hand of the user, optionally while the attention of the user (e.g., including gaze) is directed to the selectable option in the environment.

In some embodiments, in response to detecting the respective input, the computer system displays, via the one or more display generation components, the content in the second mode of presentation, such as shown by the content being displayed in the portal 712b, shown in FIG. 7J. In some embodiments, displaying the content in the second mode of presentation is as described above. Displaying the content in the second mode of transportation in response to receiving an input directed towards the selectable option allows the user to easily transition the computer system to the second mode of presentation thereby reducing errors in interaction with the computer system which saves battery life and/or computing resources.

In some embodiments, displaying the content in the second mode of presentation includes displaying a first image (e.g., with spatial elements or without spatial elements, as described above), such as content 713e-b, shown in FIG. 7L. In some embodiments, while displaying the first image in the content in the second mode of presentation, the computer system detects, via the one or more input devices, a respective input corresponding to a request to scroll the content, such as the scrolling input including gaze 704j and hand 706j, shown in FIG. 7L. In some embodiments, the scrolling input includes scrolling using an input device (e.g., a mouse), a gaze, an air pinch (or other selection input) and air-drag, a tap (e.g., with a finger) and drag, and/or a voice input. In some embodiments, the respective input is directed towards a user interface element for scrolling, and/or directed towards a portion of the content in the second mode of presentation. In some embodiments, the input is an input to scroll downwards or upwards. In some embodiments, the computer system ceases scrolling after no longer detecting the scrolling input.

In some embodiments, in response to (and/or while) detecting the respective input, the computer system scrolls the content in accordance with the respective input, including decreasing a visual prominence of at least the first image while scrolling the content in accordance with the respect input, such as the prominence of content 713e-b decreasing as the content 713e-b reaches the edge of the portal 712b, shown in FIG. 7M. In some embodiments, decreasing the visual prominence includes decreasing the opacity or brightness of the first image (e.g., by 5%, 10%, 25%, 50%, 75%, or 90%). In some embodiments, the computer system decreases the visual prominence of the content displayed in the portal at the time of the scrolling input and during the scrolling input. In some embodiments, the computer system decreases the visual prominence of a portion of the content/a portion of the first image that are within a given distance from the boundaries of the portal (e.g., within 0.1 cm, 1 cm, or 10 cm). In some embodiments, after no longer detecting the respective input, the computer system increases the visual prominence to the visual prominence prior to detecting the respective input. Changing the visual prominence of the first image in response to receiving a scroll input allows the computer system to visually indicate that the computer system has received a scroll input, thereby reducing errors in interaction with the computer system. Additionally, changing the visual prominence of the first image while scrolling reduces user discomfort and/or disorientation as the focus of the content changes.

In some embodiments, displaying the content in the second mode of presentation includes displaying the one or more spatial elements in a portal (e.g., within a boundary, such as the boundary of the image, also called a portal herein), such as spatial elements 724a and 724b, shown in FIG. 7L. In some embodiments, the one or more spatial elements are part of an image (e.g., the spatial elements are elements of the image. In some embodiments, the spatial elements are portions of the image that are two-dimensional while the computer system is presenting in the first mode of presentation.).

In some embodiments, while displaying the one or more spatial elements in the frame, the computer system detects, via the one or more input devices, a respective input corresponding to a request to scroll the content, such as the scrolling input including gaze 704j and hand 706j, shown in FIG. 7LIn some embodiments, the respective input has one or more characteristics of the scrolling inputs described above. In some embodiments, the scrolling input includes scrolling using an input device (e.g., a mouse), a gaze, an air pinch (or other selection input) and drag, a tap (e.g., with a finger) and drag, and/or a voice input. In some embodiments, the respective input is directed towards a user interface element for scrolling, and/or directed towards the content in the second mode of presentation.

In some embodiments, in response to (and/or while) detecting the respective input, the computer system scrolls the content in accordance with the respective input, including updating, via the one or more display generation components, a position of the one or more spatial elements in the portal (e.g., relative to the portal) in accordance with a direction and/or magnitude of the request to scroll the content, such as spatial elements 724a and 724b changing appearances based on the position of the spatial elements relative to the viewpoint of the user, shown in FIG. 7M. In some embodiments, and as described above, an upward motion (e.g., using gaze or hand gestures (air pinch (or other selection input) and drag)) includes scrolling the content downwards (e.g., the image is moving towards the top of the user interface) and a downward motion includes scrolling the content upward (e.g., the image is moving towards the bottom of the user interface). In some embodiments, in response to detecting an upward motion, the one or more spatial elements shift such that the viewpoint of the user is below the one or more spatial elements (e.g., the user is looking up at the image). For example, the one or more spatial elements casts a shadow towards the bottom of the frame. In some embodiments, in response to detecting a downward motion, the one or more spatial elements within and/or relative to the portal. For example, the one or more spatial elements casts a shadow towards the top of the frame in response to the downward scroll. In some embodiments, the spatial elements shift without the computer system detecting a scrolling input. For example, in response to a shift in the viewpoint of the user (e.g., a user wearing and/or using the computer system leans to the left or right), the spatial elements shift accordingly. For example, in response to a leftward lean, the spatial elements shift right, and vice versa. Shifting spatial elements in an image based on where the image is relative to the viewpoint of the user reduces distractions while in a spatial experience (e.g., the second mode of presentation), therefore increasing the speed and efficiency of using the computer system which saves battery life and/or computing resources.

In some embodiments, displaying the portal includes displaying the portal with a virtual shadow in the three-dimensional environment, such as the glow 726b and 726c, shown in FIG. 7M. In some embodiments, the shadow shifts as the portal is moved in the three-dimensional environment (e.g., via scroll input as described above, movement inputs, or a shift in a location of the computer system). In some embodiments, the portal casts a shadow onto the three-dimensional environment. In some embodiments, the shadow is localized to the portal. For example, the portal does not cast a shadow on other objects or content in the three-dimensional environment. Casting a shadow with the portal allows the computer system to highlight a focus point (the content) while in a spatial experience (e.g., the second mode of presentation), therefore increasing the speed and efficiency of using the computer system by reducing distractions which saves battery life and/or computing resources.

In some embodiments, displaying the one or more spatial elements includes displaying the one or more spatial element behind the portal relative to a viewpoint of the user, such as the spatial elements 724a and 724b being displayed behind the portal 712b, shown in the overhead view 708 in FIG. 7L. In some embodiments, the one or more spatial elements are displayed at a depth behind the portal relative to the viewpoint of the user. In some embodiments, the one or more spatial elements and the non-spatial elements of the image are displayed at a depth behind the portal. For example, the spatial elements are further from the viewpoint of the user than the portal is. In some embodiments, when the viewpoint of the user is directly facing the portal and the one or more spatial elements, all elements of the image are visible. In some embodiments, the portal encapsulates the image including the one or more spatial elements. In some embodiments, in response to the user tilting their head and/or moving their head such that the viewpoint of the user shifts relative to the portal, different portions of the one or more spatial elements and/or the content within the portal become visible or no longer visible in accordance with the shift in viewpoint. Displaying the spatial elements behind the frame allows computer system to display the image with a three-dimensional appearance and adds depth while in a spatial experience (e.g., the second mode of presentation), therefore enhancing user experience with the computer system which increases the speed and efficiency of using the computer system which saves battery life and/or computing resources.

In some embodiments, the content includes video content and non-video content (e.g., one or more text, images, graphics, and/or charts), such as content 742a through 742c, shown in FIG. 7V. In some embodiments, displaying the content in the second mode of presentation includes displaying, via the one or more display generation components, the video content in a video frame that is separate from the non-video content, such as content 742a-b being displayed in the portal 712c, while the other content (e.g., content 742c in FIG. 7V corresponds to element 745d in FIG. 7W) is displayed in the element 744, shown in FIG. 7W. In some embodiments, the video frame (and the content) occupies more space (e.g., area and/or volume) in the three-dimensional environment in the second mode of presentation than the content while in the first mode of presentation. In some embodiments, the computer system displays the non-video content in the user interface element including supplemental elements, described in greater detail above. In some embodiments, the computer system displays the non-video content concurrently with the video content. In some embodiments, the video frame does not include non-video content. In some embodiments, the video frame is displayed with a different spatial arrangement (e.g., position and/or orientation) relative to the viewpoint than the non-video content. Displaying the video separately from the non-video content allows the user to view the video without distractions, thereby increasing the speed and efficiency of using the computer system which saves battery life and/or computing resources and enhancing user experience.

In some embodiments, while displaying the video content in the second mode of presentation, the computer system detects, via the one or more input devices, a respective input directed towards the video content, such as the input including gaze 704s and hand 706s, shown in FIG. 7X. In some embodiments, the respective input is optionally a selection input such as a tap input, a gaze input, an air pinch input (or other selection input), and/or a voice input corresponding to a request to display additional information relating to the video content. For example, the respective input includes an input directed towards the video content or a selectable option near the video content, that is selectable to display additional information relating to the video content, such as an air pinch gesture or air tap gesture (e.g., a multi-pinch or multi-tap air gesture) performed by a hand of the user, optionally while the attention of the user (e.g., including gaze) is directed to the selectable option or video content in the environment.

In some embodiments, in response to detecting the respective input, the computer system displays, via the one or more display generation components, a user interface element including additional information associated with the video, such as in response to the input in FIG. 7X, the computer system 101 displays control user interface 743 and element 744, shown in FIG. 7Y. In some embodiments, the computer system also displays one or more video controls (e.g., rewind, fast forward, pause, play, volume, and/or video settings buttons) in response to detecting the respective input. In some embodiments, the additional information includes the non-video content that is displayed separately from the video content. In some embodiments, the additional information includes comments, links, related videos, and/or video analytics (e.g., views, likes, number of streams, and other data). In some embodiments, if the computer system is playing the video content prior to detecting the respective input, then the computer system continues to play the video content after detecting the respective input. In some embodiments, the user interface element is displayed with a different spatial arrangement (e.g., position and/or orientation) relative to the viewpoint of the user than the spatial arrangement (e.g., position and/or orientation) of the video content. In some embodiments, displaying the video content in the second mode of presentation includes converting two-dimensional content into content with a three-dimensional appearance. Alternatively, in some embodiments, the computer system does not convert the video content into content with a three-dimensional appearance in the second mode of presentation. Allowing the user to access additional information while continuing to display the video ensures that the additional information is visible to the user and/or displayed in an easily accessible manner, thereby reducing errors in interaction with the content, which increasing the speed and efficiency of using the computer system which saves battery life and/or computing resources.

In some embodiments, displaying the content in the second mode of presentation includes displaying the content using one or more viewer properties (e.g., immersion levels, portal size, content layout, and/or portal shape), such as the one or more properties of the content in the portal 712c, shown in FIG. 7Y. In some embodiments, in accordance with a determination that the content satisfies one or more first criteria, the computer system displays the content in the second mode of presentation using a first set of one or more viewer properties (e.g., a first immersion level including a first portal size, a first content layout, and/or a first portal shape), such as the content in user interface 712a, shown in FIG. 7V, being predominantly focused on video content, and as a result, the computer system 101 displays the content 742a-b in portal 712c with a first immersion level, shown in FIG. 7W. In some embodiments the one or more first criteria are based on the type of content. For example, video content (e.g., from a video streaming website), travel content and/or photo heavy content (e.g., from a travel website), articles, and/or shopping content optionally satisfy the one or more first criteria. In some embodiments, the one or more first criteria include a criterion that is satisfied when the content includes a combination of media (e.g., videos, text, graphics, images, and/or audio). In some embodiments, the one or more first criteria include a criterion that is satisfied when the content is a video. In some embodiments, the one or more first criteria include a criterion that is satisfied when the content includes one or more purchasable products. In some embodiments, the one or more first criteria include a criterion that is satisfied when the content includes a plurality of images (e.g., user submitted or developer submitted images). In some embodiments, the one or more first criteria include a criterion that is satisfied when the content includes a combination of images, text, videos, and/or other media items.

In some embodiments, in accordance with a determination that the content satisfies one or more second criteria, different from the one or more first criteria, the computer system displays the content in the second mode of presentation using a second set of one or more viewer properties (e.g., a second immersion level including a second portal size, a second content layout, and/or a second portal shape), different from the first set of one or more viewer properties, such as the content in user interface 712a, shown in FIG. 7I, including a plurality of different types of content, and as a result, the computer system 101 displays the content 713a-b through 712a-c in portal 712b with a second immersion level, shown in FIG. 7J. In some embodiments, the second criterion is a different criterion of the criterion listed above. For example, if the one or more first criteria includes the criterion that is satisfied when the content is a video, then the one or more second criteria include a different criterion that is not the criterion that is satisfied wen the content is a video. In some embodiments, based on the type of content, the computer system displays the content with a different set of viewer properties. Using different viewer properties for different types of content allows the computer system to optimize the display of content in the second mode of presentation based on the type of content thereby reducing errors in interaction with the content, which increases the speed and efficiency of using the computer system which saves battery life and/or computing resources.

In some embodiments, displaying the content in the second mode of presentation using the first set of one or more viewer properties includes displaying the content within a portal (e.g., immersion portal) having first one or more immersion properties, such as portal 712c, shown in FIG. 7W. Immersion is described in greater detail above. In some embodiments, the portal is displayed within a representation of the physical environment (as described above with reference to what is displayed in the three-dimensional environment) of the user that is visible via the one or more display generation components in a three-dimensional environment. In some embodiments, the portal is displayed within a virtual environment that is optionally part of the three-dimensional environment. In some embodiments, the three-dimensional environment includes a virtual environment that is displayed within the three-dimensional environment, optionally instead of the representation of the physical environment (e.g., full immersion) or optionally concurrently with the representation of the physical environment (e.g., partial immersion). In some embodiments, the virtual environment includes the content in the second mode of presentation.

In some embodiments, the portal is a portal or view into the content (e.g., analogous to how a glass window in a building is a portal or view into the three-dimensional, physical world outside of the glass window). As will be described in greater detail below, the size and/or shape of the portal optionally determines how much and/or which portion of the content is visible and/or displayed through the portal. In some embodiments, the first set of immersion properties include a first current size (e.g., the size of the portal relative to the three-dimensional environment when first displaying the content in the second mode of presentation), a first maximum portal size, a first minimum portal size, and/or a first lighting condition (e.g., described in greater detail above).

In some embodiments, displaying the content in the second mode of presentation using the second set of one or more viewer properties includes displaying the content within the portal having second one or more immersion properties, different from the first one or more immersion properties, such as portal 712b in FIG. 7J having different immersion properties than portal 712b in FIG. 7W. In some embodiments, the first set of immersion properties includes a second current size (e.g., the size of the portal relative to the three-dimensional environment when first displaying the content in the second mode of presentation), a second maximum portal size, a second minimum portal size, and/or a second lighting condition (e.g., described in greater detail above). Using different immersion properties for different types of content allows the computer system to optimize the display of content in the second mode of presentation based on the type of content thereby reducing errors in interaction with the content, which increases the speed and efficiency of using the computer system which saves battery life and/or computing resources.

In some embodiments, while displaying the content in the second mode of presentation with a first immersion level (e.g., a first size of the portal, a first layout, and/or a first portal shape) corresponding to the portal having the first one or more immersion properties, the computer system detects, via the one or more input devices, a respective input corresponding to a request to change an immersion level of the content, such as the input including hand 730a, shown in FIG. 7O. In some embodiments, the input is detecting using a mechanical input element. In some embodiments, the mechanical input element is rotatable to modify the immersion level of the portal and is depressible to perform a different operation at the computer system (e.g., to display a collection of icons of available applications at the computer system, such as displaying a home user interface of the computer system). In some embodiments, the mechanical input element is a rotatable mechanical input element. In some embodiments, changing the level of immersion occurs in response to detecting rotation of the mechanical input element clockwise or counterclockwise (e.g., corresponding to increasing or decreasing, respectively, the level of immersion). In some embodiments, the respective input includes a tap, an air pinch (or other selection input), a voice input, and/or a gaze input.

In some embodiments, in response to detecting the respective input, the computer system displays, via the one or more display generation components, the content in the second mode of presentation with a second level of immersion based on the respective input and the first level of immersion, corresponding to the portal having third one or more immersion properties, different from the first one or more immersion properties, such as shown by the portal 712b shown in FIG. 7P. In some embodiments, in response to the input, the portal is a second size and/or shape, and/or the content has a second layout. In some embodiments, in response to the input, the portal does not change layouts (e.g., continues to be in the first layout) and changing the immersion level includes changing the amount of content displayed through the portal. For example, a higher level of immersion includes displaying more content while in the first layout and a lower level of immersion includes displaying less content while in the first layout. In some embodiments, the amount of change in immersion level (from the first to second immersion level) is based on the amount of rotation directed towards the mechanical input element. In some embodiments, the second immersion level is based on a rotation of the mechanical input element relative to the first immersion level and the maximum and/or minimum immersion level based on the respective immersion properties. Changing the immersion level based on the current immersion level allows the user to visually see the change in immersion level proportional to the amount of rotation of the mechanical input element, thereby reducing erroneous inputs to the computer system, which increasing the speed and efficiency of using the computer system which saves battery life and/or computing resources.

In some embodiments, displaying the content in the second mode of presentation using the first set of one or more viewer properties includes displaying the content with a first layout, such as the layout of the content in portal 712c, shown in FIG. 7W. In some embodiments, the layout includes positioning of video and/or image content and the non-video and/or non-image content based on the content type (e.g., relative to the portal, the three-dimensional environment and/or the viewpoint of the user). In some embodiments, the first layout includes positioning the videos and/or images as a slideshow. In some embodiments, the first layout includes positioning a three-dimensional representation of a three-dimensional object, as described below in method 1100, at a depth in front of the other content. In some embodiments, the first layout includes positioning a video in the portal and removing the non-video content from the viewpoint of the user. In some embodiments, the first layout includes positioning videos and/or images with non-image content (e.g., text) similarly to how the content was presented in the first mode of presentation.

In some embodiments, displaying the content in the second mode of presentation using the second set of one or more viewer properties includes displaying the content with a second layout, different from the first layout, such as the layout of the content in portal 712b, shown in FIG. 7J. In some embodiments, the second layout is different than the first layout. In some embodiments, based on the type of content (and/or based on the type of layout), different components (e.g., text, images, headers, footers and/or navigation bars) of the content have different positions and/or orientations relative to each other and/or relative to the viewpoint. Thus, in the first layout, the different components of the content optionally have first relative positions and/or orientations relative to each other and/or the viewpoint of the user than they do in the second layout. In some embodiments, the second layout has one or more characteristics of the first layout. Using different layouts for different types of content allows the computer system to optimize the display of content in the second mode of presentation based on the type of content thereby reducing errors in interaction with the content, which increasing the speed and efficiency of using the computer system which saves battery life and/or computing resources.

In some embodiments, displaying the content using the first set of one or more viewer properties includes displaying the content in front of background content (e.g., as described above, the background content is the content other than the virtual content (e.g., the content in the portal)) with a first degree of saturation, such as the saturation of the virtual environment 777c in portal 712c, shown in FIG. 7W. In some embodiments, the first degree of saturation is an intensity of the color of the background of the portal. In some embodiments, the less saturation, the more muted the color is, and vice versa. For example, the first degree of saturation is 10%, 15%, 30%, 50%, 75%, or 100% saturation. In some embodiments, saturation is described in greater detail in method 1000.

In some embodiments, displaying the content in the second mode of presentation using the second set of one or more viewer properties includes displaying the content in front of the background content with a second degree of saturation, different from the first degree of saturation, such as the saturation of the virtual environment 777b in portal 712b, shown in FIG. 7J. For example, the second degree of saturation is 10%, 15%, 30%, 50%, 75%, or 100% saturation. In some embodiments, the second degree of saturation is different than the first degree of saturation. In some embodiments, and as described above, the degree of saturation of the portal (e.g., the saturation of the color of the background in the portal over which the content is displayed) is based on the type of content that is displayed. In some embodiments, the degree of saturation changes as the content changes (e.g., displaying content from different applications, receiving a scroll input to scroll through the content, or by a user changing a saturation setting). Using color saturation for different types of content allows the computer system to optimize the display of content in the second mode of presentation based on the type of content thereby reducing errors in interaction with the content, which increasing the speed and efficiency of using the computer system which saves battery life and/or computing resources.

In some embodiments, displaying the content in the second mode of presentation includes displaying the content within a portal (e.g., the portal is described in greater detail above), such as portal 712b, shown in FIG. 7J. In some embodiments, in accordance with a determination that the content satisfies one or more first criteria (e.g., a criterion that is satisfied when the content is focused on a video (e.g., a webpage including a video and other content relating to the video such as comments, related videos, and/or description of the video), a criterion that is satisfied when the content includes a three-dimensional object or content including a three-dimensional appearance, a criterion that is satisfied when the content includes a series of images and optionally corresponding text, a criterion that is satisfied when the content includes mostly text, and/or a criterion that is satisfied when the content includes a combination of text, images, graphics, and/or videos), the computer system displays the content in the second mode of presentation within the portal having a first portal shape, such as the shape of portal 712b, shown in FIG. 7J. In some embodiments, the shape of the portal is rectangular, circular, oval, spherical or any other shape. In some embodiments, the shape of a portal is planar. In some embodiments, the shape of a portal is curved. In some embodiments, the size of the shape and the type of shape determines how much content is displayed and/or visible in the portal. In some embodiments, the computer system automatically determines a shape of the portal based on the content displayed in the portal. In some embodiments, a user can change the shape of the portal by changing a shape setting.

In some embodiments, in accordance with a determination that the content satisfies one or more second criteria (e.g., such as one of the criterion described above), different from the one or more first criteria, the computer system displays the content in the second mode of presentation within the portal having a second portal shape, different than the first portal shape, such as the shape of portal 712c, shown in FIG. 7W. In some embodiments, if the one or more first criteria are satisfied when the content is focused on a video, then the one or more second criteria are satisfied when a different criterion is satisfied of the criterion described above. For example, the one or more first criterion includes the criterion that is satisfied when the content includes a three-dimensional object or content with a three-dimensional appearance and the one or more second criteria include the criterion that is satisfied when the content includes a video. In some embodiments, the second portal shape has one or more characteristics of the first portal shape. In some embodiments, the shape of the portal is rectangular, circular, oval, spherical or any other shape. In some embodiments, the shape of a portal is planar. In some embodiments, the shape of a portal is curved. Using different portal shapes for different types of content allows the computer system to optimize the display of content in the second mode of presentation based on the type of content thereby reducing errors in interaction with the content, which increasing the speed and efficiency of using the computer system which saves battery life and/or computing resources.

In some embodiments, while displaying the content in the second mode of presentation with one or more spatial elements at a first level of immersion, the computer system receives an input including rotation of a mechanical input element on the computer system, such as the input directed towards element 732, shown in FIG. 7O. In some embodiments, the mechanical input element is rotatable to modify the immersion level of the portal, and is depressible to perform a different operation at the computer system (e.g., to display a collection of icons of available applications at the computer system, such as displaying a home user interface of the computer system). In some embodiments, the mechanical input element is a rotatable mechanical input element. In some embodiments, the first respective input includes a tap, an air pinch (or other selection input), a voice input, and/or a gaze input.

In some embodiments, in response to receiving the input including the rotation of the mechanical input element of the computer system, in accordance with a determination that the rotation is in a first direction (e.g., clockwise rotation), the computer system increases a level of immersion of the one or more spatial elements from a first level of immersion to a second level of immersion that is greater than the first level of immersion, such as shown in FIG. 7Q, where in response to the input to the element 732 in FIG. 7P, the computer system 101 increases the immersion level of portal 712b. In some embodiments, a clockwise turn increases the level of immersion and a counterclockwise turn decreases the level of immersion. Alternatively, in some embodiments, a clockwise turn causes the computer system to decrease the level of immersion and a counterclockwise turn increases the level of immersion. In some embodiments, increasing the level of immersion causes the portal to increase in size (e.g., while maintaining the portal shape). In some embodiments, increasing the level of immersion causes the portal to have a higher saturation, a different layout, and/or a different portal shape, as described above.

In some embodiments, in response to receiving the input including the rotation of the mechanical input element of the computer system, in accordance with a determination that the rotation is in a second direction that is different from the first direction (e.g., counterclockwise rotation), the computer system decreases the level of immersion of the one or more spatial elements to a third level of immersion that is less than the first level of immersion (e.g., and optionally the second level of immersion). In some embodiments, the third level of immersion is the same as or different from the first level of immersion. In some embodiments, decreasing the level of immersion causes the portal to decrease in size (e.g., while maintaining the portal shape), such as shown in FIG. 7P, where in response to the input to the element 732 in FIG. 7O, the computer system 101 decreases the immersion level of portal 712b. In some embodiments, decreasing the level of immersion causes the portal to have a lower saturation, a different layout, and/or a different portal shape, as described above. Facilitating modification of the level of immersion based on manipulation of a mechanical input element of the computer system ensures efficient ability to modify the immersion level irrespective of what is displayed by the computer system and across different experiences, thereby reducing errors in interaction with the content, which increasing the speed and efficiency of using the computer system which saves battery life and/or computing resources.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects and/or operations of method 800 may be interchanged, substituted, and/or added between these methods. For example, various techniques to display content in a first and second mode of presentation of method 800 is optionally interchanged, substituted, and/or added between these methods. For brevity, these details are not repeated here.

FIG. 9 is a flowchart illustrating an exemplary method 900 of displaying two-dimensional content as automatically generated content with a three-dimensional appearance in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processing units 202 (e.g., processors) of computer system 101 (e.g., control unit 110 in FIG. 1A). Some operations in method 900 are, optionally, combined and/or the order of some operations is, optionally, changed.

In some embodiments, method 900 is performed at a computer system (e.g., computer system 101, shown in FIG. 7A) that is in communication with one or more display generation components and one or more input devices. For example, the computer system is or corresponds to a mobile device (e.g., a tablet, a smartphone, a media player, or a wearable device), or a computer or other electronic device. In some embodiments, the computer system has one or more characteristics of the computer system in method 800. In some embodiments, the one or more display generation components have one or more characteristics of the one or more display generation components in method 800. In some embodiments, the one or more input devices have one or more characteristics of the one or more input devices in method 800.

In some embodiments, the computer system detects, via the one or more input devices, a first input corresponding to a request to display content in a three-dimensional environment, wherein the content includes a first portion of the content including two-dimensional visual media (e.g., one or more images, illustrations, and/or videos) and a second portion of the content when the first input is detected, such as the input shown in in FIG. 7I. In some embodiments, the first input includes one or more characteristics of the input described in method 800. In some embodiments, the first input is a selection input such as a tap input, a gaze input, an air pinch input (or other selection input), and/or a voice input corresponding to a request to display the content in the second mode of presentation. In some embodiments, the first input is directed toward a selectable option that is selectable to display the content in the second mode of presentation. In some embodiments, the second portion of the content also includes two-dimensional visual media (e.g., text, images, illustrations, and/or videos).

In some embodiments, in response to detecting the first input, the computer system displays, via the one or more display generation components, the content in the three-dimensional environment (e.g., in the portal 712b, shown in FIG. 7J) including concurrently displaying: three-dimensional content that corresponds to the first portion of the content, including content including a three-dimensional appearance that was automatically generated from the two-dimensional visual media (e.g., such as content 713e-b, shown in FIG. 7K), the second portion of the content that has not been converted into three-dimensional content, such as content 713c-b and 713c-d, shown in FIG. 7K. In some embodiments, the computer system uses data from the one or more content items to create three-dimensional content (or content with a three-dimensional appearance) from the two-dimensional content. For example, the computer system uses one or more measurements relating to a content item (e.g., which is optionally found on the content and/or the user interface) to convert the content item from a two-dimensional object to a three-dimensional object, as described below. In some embodiments, the computer system uses metadata and/or machine-learning and/or artificial intelligence methods to create depth in respective two-dimensional content to create three-dimensional content. In some embodiments, the computer system displays the three-dimensional content with more variability in depth than two-dimensional content (e.g., text, tables, and other two-dimensional content). In some embodiments, automatically generating the three-dimensional content includes using one or more autonomous processes such as artificial neural networks and/or machine learning. For example, the computer system uses the two-dimensional content and/or metadata associated with the two-dimensional content to generate the three-dimensional content. In some embodiments, the three-dimensional content corresponds to the media produced by a machine program that uses foundational models (FMs) (e.g., neural networks trained using data sourced from a variety of methods) to generate the media, optionally without user input providing metadata and/or additional data to be used to generate the three-dimensional content. Optionally one or more or all visual portions of the content are generated by the machine program, and not by a user providing such visual portions. In some embodiments, in response to the input, the computer system displays two-dimensional visual content that is able to be converted to three-dimensional content as three-dimensional content. In some embodiments, three-dimensional content has one or more characteristics of the spatial content described in method 800. In some embodiments, the second portion of the content does not include convertible two-dimensional content. For example, the second portion of the content includes text, images, illustrations, and/or videos that cannot be converted to three-dimensional content. In some embodiments, the second portion of the content includes convertible two-dimensional content, and in response to the input, the computer system converts the convertible tow-dimensional content into three-dimensional content. Automatically presenting two-dimensional content as three-dimensional content in response to an input reduces the number of inputs needed to view three-dimensional content, thereby reducing erroneous inputs to the computer system.

In some embodiments, prior to detecting the first input, the computer system displays, via the one or more display generation components, the content in a first mode of presentation, wherein the content is displayed in the first mode of presentation when the first input is detected, such as displaying the content in user interface 712a, shown in FIG. 7I. In some embodiments, the first mode of presentation includes one or more characteristics of the first mode of presentation described in method 800.

In some embodiments, after detecting the first input (e.g., the first input is optionally an input to switch from the first mode of presentation to the second mode of presentation, such as the input described in method 800), the computer system displays, via the one or more generation components, the content in a second mode of presentation, wherein in the second mode of presentation, the content is displayed with one or more spatial elements (e.g., elements that are distributed at different depths relative to a viewpoint of the user, and described in greater detail in method 800) that are related to the content (e.g., elements that are part of the content or generated based on the content) and are not displayed when the content is displayed in the first mode of presentation, such as displaying the content in portal 712b, shown in FIG. 7J. In some embodiments, the second mode of presentation includes one or more characteristics of the second mode of presentation described in method 800. In some embodiments, the computer system converts two-dimensional visual media to content including a three-dimensional appearance after and/or in response to detecting an input to transition the computer system from the first mode of presentation to the second mode of presentation. In some embodiments, the computer system automatically converts two-dimensional visual media to content including a three-dimensional appearance without transitioning from the first mode of presentation to the second mode of presentation. Displaying the content with the three-dimensional appearance only in the second mode of presentation reduces the resources needed to display three-dimensional content by only displaying the three-dimensional content when needed, thereby reducing user discomfort (from the immersive environment) and saving battery life and/or computing resources.

In some embodiments, the two-dimensional visual media is a two-dimensional image, such as content 713e, shown in FIG. 7C. In some embodiments, the two-dimensional image is an image of the real world (e.g., an image taken using a camera and/or camera application), digital art, digitized art, a graphic, and/or other types of two-dimensional images.

In some embodiments, the three-dimensional content a version of the two-dimensional visual media with a three-dimensional appearance (e.g., a three-dimensional model of the two-dimensional visual media or a simulated three-dimensional appearance due to a stereoscopic effect where different two-dimensional images are displayed to different eyes of the user to create a three-dimensional appearance), such as content 713e-b including spatial elements 724a and 724b, shown in FIG. 7K. In some embodiments, and as described in method 800 and above, the computer system generates the three-dimensional content using one or more autonomous processes such as artificial neural networks and/or machine learning. In some embodiments, the computer system uses the autonomous processes to determine a focal point of the two-dimensional image to be displayed at a depth closer to the viewpoint of the user than the background of the two-dimensional image. In some embodiments, the three-dimensional version retains all (or most) of the components and/or aspects of the two-dimensional image. Alternatively, in some embodiments, the computer system generates the content with the three-dimensional appearance by generating a second (optionally two-dimensional image) image from a slightly different viewpoint than the two-dimensional visual media and displaying the two different images to the two eyes of the user (e.g., the left eye views the first image and the right eye views the second image). Converting two-dimensional images to three-dimensional images reduces distractions while in a spatial experience, which increases the speed and efficiency of using the computer system which saves battery life and/or computing resources.

In some embodiments, the two-dimensional visual media is a two-dimensional video, such as content 742a, shown in FIG. 7V. In some embodiments, the two-dimensional video includes displaying components/aspects of the video at the same depth away from a viewpoint of the user. In some embodiments, the two-dimensional video is a video of the real world (e.g., a video taken using a camera/camera application), a video including computer generated or user generated graphics, a video including digital art, and/or other two-dimensional videos.

In some embodiments, the three-dimensional content is a version of the two-dimensional visual media that has a three-dimensional appearance while the video is playing, such as if content 742a-b includes a three-dimensional appearance in portal 712c, shown in FIG. 7W. In some embodiments, and as described in method 800 and above, the computer system generates the three-dimensional content using one or more autonomous processes such as artificial neural networks and/or machine learning. In some embodiments, the computer system uses the autonomous processes to determine a focal point (or focal points) of the two-dimensional video to be displayed at a depth closer to the viewpoint of the user than the background of the two-dimensional video. In some embodiments, the three-dimensional version retains all (or most) of the components/aspects of the two-dimensional video. Converting two-dimensional videos to three-dimensional videos reduces distractions while in a spatial experience, which increases the speed and efficiency of using the computer system which saves battery life and/or computing resources.

In some embodiments, the content includes a third portion (e.g., the first portion, second portion, or other portion of the content) including two-dimensional visual media, such as the portion of the content shown in user interface 712a, shown in FIG. 7C.

In some embodiments, in response to detecting the first input: in accordance with a determination that the two-dimensional visual media in the third portion of the content satisfies one or more criteria, including a criterion that is satisfied based on a property of the two-dimensional visual media, the computer system displays, in the three-dimensional environment, three-dimensional content (e.g., content including a three-dimensional appearance) that corresponds to the two-dimensional visual media in the third portion of the content, such as displaying content 713e-b corresponding to 713e, shown in FIG. 7K. In some embodiments, the computer system converts two-dimensional visual media to three-dimensional content if the two-dimensional visual media satisfies the one or more criteria. In some embodiments, the computer system converts based on the criteria for the first portion, second portion, and/or other portions of the content. For example, the computer system converts the two-dimensional visual media in the first portion of the content (and the third portion of the content) but not the second portion of the content because the two-dimensional visual media in the first portion of the content satisfies the one or more criteria. In some embodiments, the property of the two-dimensional visual media includes an aspect ratio, resolution, and/or semantic meaning, as described below. In some embodiments, the one or more criteria also includes a criteria that is satisfied based on data associated with a two-dimensional visual media, as described below.

In some embodiments, in response to detecting the first input, in accordance with a determination that the two-dimensional visual media in the third portion of the content does not satisfy the one or more criteria, the computer system forgoes displaying, in the three-dimensional environment, the three-dimensional content that corresponds to the two-dimensional visual media in the first portion of the content (and optionally maintaining display of the two-dimensional visual media), such as content 713l in user interface 712a shown in FIG. 7F remaining two-dimensional (content 713l corresponds to content 713l-b in FIG. 7N) while being displayed in portal 712b, shown in FIG. 7N. In some embodiments, the computer system does not convert two-dimensional visual media to three-dimensional content if the two-dimensional visual media does not satisfy the one or more criteria. For example, the computer system does not convert the two-dimensional visual media in the second portion of the content (and the third portion of the content) because the two-dimensional visual media in the second portion of the content does not satisfy the one or more criteria. In some embodiments, a section of the content contains more than one two-dimensional visual media content item, and the computer system evaluates each two-dimensional visual media content item based on the one or more criteria to determine whether to convert the respective two-dimensional visual media content item to three-dimensional content. Only converting two-dimensional visual media to three-dimensional content that satisfy the one or more criteria reduces the resources needed to display the content by only converting necessary content into three-dimensional content, thereby saving battery life and/or computing resources.

In some embodiments, the property is an aspect ratio of the two-dimensional visual media, such as the aspect ratio of content 713a, shown in FIG. 7A. For example, the property is a ratio of height to width of the two-dimensional visual media. In some embodiments, the one or more criteria are satisfied in accordance with a determination that the aspect ratio of the two-dimensional visual media is smaller than a threshold aspect ratio, such as the content 713a, shown in FIG. 7A, having the aspect ratio smaller than the threshold aspect ratio. In some embodiments, the criteria are satisfied when the two-dimensional visual media has an aspect ratio within an acceptable range of aspect ratios. For example, the computer system does not convert two-dimensional visual media to three-dimensional content when the two-dimensional visual media is too tall or too wide. For example, the threshold aspect ratio is 1:1, 3:2, 2:3, 4:3, 3:4, 5:7, 7:5, 4:5, or 5:4.

In some embodiments, the one or more criteria are not satisfied in accordance with a determination that the aspect ratio of the two-dimensional visual media is larger than the threshold aspect ratio, such as if the content 713a, shown in FIG. 7A, has the aspect ratio larger than the threshold aspect ratio, then the computer system 101 does not display the spatial elements 724a and 724b in the portal 712b, shown in FIG. 7K. In some embodiments, the aspect ratio is taller or wider than the threshold aspect ratio. For example, the aspect ratio is 21:9, 9:21, 2.39:1, 1:2.39, 1.85:1, 1:1.85, 9:16, 16:9, which are taller or wider than the threshold aspect ratio. Converting two-dimensional visual media to three-dimensional content that satisfy an aspect ratio criteria reduces the resources needed to display the content by only converting content that is not too tall or too wide into three-dimensional content, thereby saving battery life and/or computing resources.

In some embodiments, the property is a resolution of the two-dimensional visual media, such as the resolution of content 713a, shown in FIG. 7A. For example, the resolution is the amount of detail and/or clarity in the two-dimensional visual media. For example, the resolution of the image is the amount of pixels or dots per inch (or centimeter). In some embodiments, the higher the density of pixels or dots, the higher the resolution of the two-dimensional visual media.

In some embodiments, the one or more criteria are satisfied in accordance with a determination that the resolution of the two-dimensional visual media is above a threshold resolution, such as content 713a, shown in FIG. 7A, having the resolution greater than the threshold resolution. In some embodiments, the criteria are satisfied when the two-dimensional visual media is a high enough resolution. For example, the first resolution is a resolution greater than 30 pixels per inch (PPI), 100 PPI, or 300 PPI (e.g., the threshold resolution).

In some embodiments, the one or more criteria are not satisfied in accordance with a determination that the resolution of the two-dimensional visual media is below the threshold resolution, such as if the content 713a, shown in FIG. 7A, has a resolution lower than the threshold resolution, then the computer system 101 does not display the spatial elements 724a and 724b in the portal 712b, shown in FIG. 7K. In some embodiments, the second resolution is a lower resolution than the first resolution. For example, the second resolution is a resolution lower than 30 PPI, 100 PPI, or 300 PPI. Converting two-dimensional visual media to three-dimensional content that satisfy the resolution criteria reduces the resources needed to display the content by only converting content that is of high enough resolution into three-dimensional content, thereby saving battery life and/or computing resources.

In some embodiments, the property is based on a type of the two-dimensional visual media, such as content 713a, shown in FIG. 7A, being a first type of content and content 713l, shown in FIG. 7F, being a second type of content. In some embodiments, the semantic meaning of the two-dimensional visual media is the intention of the two-dimensional visual media. In some embodiments, the computer system converts two-dimensional visual media that are photos, images, drawings, and/or videos but not two-dimensional visual media that are tables and/or diagrams.

In some embodiments, the one or more criteria are satisfied in accordance with a determination that the two-dimensional visual media is a first type of visual media, such as content 713a being converted to content 713a-b with the spatial elements 724a and 724b, shown in FIG. 7K. In some embodiments, the first type of visual media includes a first illustration including one or more subjects. For example, the first type of visual media includes an image and/or video of aspects of the real world or an imaginary world. In some embodiments, computer system automatically determines the type of visual media based on analyzing the content in the visual media (e.g., whether the content is a flowchart and/or diagram or a table (the computer system does not convert) or a photo or other analogous visual media (the computer system does convert)).

In some embodiments, the one or more criteria are not satisfied in accordance with a determination that the two-dimensional visual media is a second type of visual media different from the first type of visual media, such as content 713l being converted to 713l-b, which does not include a three-dimensional appearance, shown in FIG. 7N. In some embodiments, the second type of visual media includes graphs, tables, and/or diagrams. In some embodiments, the second type of visual media does not depict imagery and/or subjects of a real world or imaginary world. Converting two-dimensional visual media to three-dimensional content that satisfy the type of visual media criteria reduces the resources needed to display the content by only converting appropriate content into three-dimensional content (e.g., converting an image of the real-world but not an image and/or screenshot of a graph), thereby saving battery life and/or computing resources.

In some embodiments, automatically generating the three-dimensional content includes generating the three-dimensional content based on data associated with the two-dimensional visual media, wherein the data associated with the two-dimensional visual media is not included in the two-dimensional visual media, such as generating content 746b based on data associated with the content 746a, shown in FIG. 7CC. In some embodiments, the computer system generates a virtual representation of a three-dimensional object, as described in method 1100. In some embodiments, the computer system uses metadata associated with the two-dimensional visual media, such as measurements corresponding to the object, computer-aided design data (e.g. STL file or other computer aided design file), and or additional images (e.g., images of different views of the object) to generate the three-dimensional content. In some embodiments, the computer system retrieves the metadata from a server, such as a server of the computer system, a server of the application including the two-dimensional visual media, and/or a server of a web developer for the website including the two-dimensional visual media, and the computer system optionally retrieves the metadata from a source other than the source of the two-dimensional visual media. Converting two-dimensional visual media to three-dimensional content that include additional data reduces the resources needed to display the content by reducing the computational power needed to convert the two-dimensional visual media into three-dimensional content (since the computer system needs to fill in less holes using autonomous processes, thereby saving battery life and/or computing resources.

In some embodiments, while displaying the three-dimensional content that corresponds to the first portion of content (e.g., including content including a three-dimensional appearance and three-dimensional representations of two-dimensional visual media), including the three-dimensional content that was automatically generated from the two-dimensional visual media, the computer system detects, via the one or more input devices, a second input corresponding to a request to revert the three-dimensional content back to the two-dimensional visual media, such as the input shown in FIG. 7T. In some embodiments, the second input is a selection input such as a tap input, a gaze input, an air pinch input (or other selection input), and/or a voice input corresponding to a request to revert the three-dimensional content back to two-dimensional visual media. In some embodiments, the second input includes an air pinch gesture or air tap gesture (e.g., a multi-pinch or multi-tap air gesture) performed by a hand of the user, optionally while the attention of the user is directed to a selectable option in the environment. In some embodiments, the computer system detects the second input directed towards a selectable option to revert three-dimensional content back to two-dimensional visual media. In some embodiments, the computer system detects one or more second inputs directed towards one or more selectable options to convert one or more three-dimensional content items back to their respective two-dimensional visual media items.

In some embodiments, in response to detecting the second input, the computer system displays, in the three-dimensional environment, the content including the two-dimensional visual media and not including the three-dimensional content that was automatically generated, such as redisplaying content 713e, shown in FIG. 7U. In some embodiments, the computer system replaces the three-dimensional content with its corresponding two-dimensional visual media. In some embodiments, the second input is directed towards one or more three-dimensional content items and in response to the second input, the respective one or more three-dimensional content items are reverted to their respective two-dimensional visual media items, while other three-dimensional content items that were not selected remain as three-dimensional content items. Providing an option to revert three-dimensional content into two-dimensional visual media allows the user to determine how the computer system displays content, thereby improving user-device interaction and saving battery life and/or computing power by not displaying unnecessary three-dimensional content.

In some embodiments, while displaying the content in the three-dimensional environment, the computer system detects, via the one or more input devices, a second input corresponding to a request to convert the first portion of the two-dimensional visual media into three-dimensional content, such as if the computer system 101 detected an input to convert a portion of the content in user interface 712a to three-dimensional content, in FIG. 7I. In some embodiments, the second input is a selection input such as a tap input, a gaze input, an air pinch input (or other selection input), and/or a voice input corresponding to a request to convert the first portion of the two-dimensional visual media into three-dimensional content. In some embodiments, the second input includes an air pinch gesture or air tap gesture (e.g., a multi-pinch or multi-tap air gesture) performed by a hand of the user, optionally while the attention of the user is directed to a selectable option in the environment. In some embodiments, the computer system receives the second input directed towards a selectable option to convert the first portion of the two-dimensional visual media into three-dimensional content.

In some embodiments, in response to detecting the second input, the computer system displays, via the one or more display generation components, the content in the three-dimensional environment including concurrently displaying the three-dimensional content (e.g., content including a three-dimensional appearance, or three-dimensional representations of two-dimensional content as described above) that corresponds to the first portion of the two-dimensional visual media, including three-dimensional content that was automatically generated from the first portion of the two-dimensional visual content, such as content 713e-b, shown in FIG. 7K, and a second portion of the content that has not been converted into three-dimensional content, such as if content 713c-b satisfied the one or more first criteria and the computer system 101 did not display the corresponding content including the three-dimensional appearance because of the second input. In some embodiments, in response to detecting the second input, the computer system displays three-dimensional content corresponding to the two-dimensional visual content. In some embodiments, prior to detecting the second input (and optionally, after detecting the first input), the computer system displays the content including the two-dimensional visual media but not including the three-dimensional visual media. The first portion and the second portion of the content are described in greater detail above. In some embodiments, if the computer system detects the first input (described above), optionally instead of the second input, the computer system converts the first and second portions of the content into three-dimensional content. In some embodiments, if the computer system detects the second input directed towards the second portion of the content instead of the first, the computer system displays the second portion of the content with converted three-dimensional content without converting the first portion of the content into three-dimensional content. Providing an option to convert two-dimensional visual media into three-dimensional content reduces the resources needed to display content by only displaying the three-dimensional content when requested, thereby reducing user discomfort (from the immersive environment) and saving battery life and/or computing resources.

In some embodiments, the two-dimensional visual media includes a first two-dimensional content item and a second two-dimensional content item (e.g., satisfying the one or more criteria as described above), such as content 713e and 713i, shown in FIG. 7D, and in response to detecting the first input: the computer system 101 displays (e.g., concurrently displaying), via the one or more display generation components, a first three-dimensional content item automatically generated from the first two-dimensional content item and a second three-dimensional content item automatically generated from the second two-dimensional content item, such as content 713e-b, and 713i-b, shown in FIG. 7M. In some embodiments, in response to the first input (or optionally in response to the second input to convert the first portion of the three-dimensional visual media into three-dimensional content), the computer system converts a plurality two-dimensional content items that satisfy the one or more criteria into their corresponding three-dimensional visual media. Alternatively, in some embodiments, the computer system converts the two-dimensional content items one by one. For example, the computer system converts the two-dimensional content items as they are made visible in the viewpoint of the user. The viewpoint of the user is described in greater detail in method 800. In some embodiments, the first input is a single input selecting a single option (e.g., directed towards the first two-dimensional content item or the second two-dimensional content item). In some embodiments, in response to the first input, only the selected content item would have a respective three-dimensional content item automatically generated. Automatically converting a plurality of two-dimensional visual media into three-dimensional content reduces the inputs needed to convert two-dimensional visual media thereby reducing erroneous inputs and saving battery life and/or computing resources.

In some embodiments, while displaying the three-dimensional content including the first three-dimensional content item and the second three-dimensional content item, the computer system detects, via the one or more input devices, a second input corresponding to a request to revert the three-dimensional content back to the two-dimensional visual media, such as the input shown in FIG. 7T. In some embodiments, the second input is a selection input such as a tap input, a gaze input, an air pinch input (or other selection input), and/or a voice input corresponding to a request to revert the three-dimensional content back to the two-dimensional visual media. In some embodiments, the second input includes an air pinch gesture or air tap gesture (e.g., a multi-pinch or multi-tap air gesture) performed by a hand of the user, optionally while the attention of the user is directed to a selectable option in the environment. In some embodiments, the computer system receives the second input directed towards a selectable option to revert the three-dimensional content back to the two-dimensional visual media. In some embodiments, the second input is directed towards a specific three-dimensional content item to be reverted back to the corresponding two-dimensional visual media item. For example, the second input is a single input directed towards a selectable option and/or a specific three-dimensional content item.

In some embodiments, in response to detecting the second input, the computer system displays (e.g., concurrently displaying), via the one or more display generation components, in the three-dimensional environment, the content including the first two-dimensional content item and the second two-dimensional content item and not including the three-dimensional content that was automatically generated. In some embodiments, the computer system ceases displaying the three-dimensional content corresponding to the first two-dimensional content item and the second two-dimensional content item. In some embodiments, the computer system reverts multiple and/or all three-dimensional content that was previously converted back to their corresponding two-dimensional content item. Providing an option to revert multiple three-dimensional content to two-dimensional visual media reduces the inputs needed to revert a plurality of three-dimensional content to two-dimensional visual media thereby reducing erroneous inputs and saving battery life and/or computing resources.

In some embodiments, the first input is detected while an automatic three-dimensional content conversion setting is active (e.g., a setting that is changeable in a settings user interface of the computer system or of the three-dimensional environment), such as the input detected in FIG. 7I. In some embodiments, while displaying the content in the three-dimensional environment, wherein the content includes the first portion of the content including the two-dimensional visual media (e.g., one or more images, illustrations, and/or videos such as the first two-dimensional content item and the second two-dimensional content item, as described above) and the second portion of the content (e.g., not including content items that are convertible to three-dimensional content), the computer system detects, via the one or more input devices, a second input corresponding to a request to display the content in the three-dimensional environment, such as the input detected in FIG. 7I. In some embodiments, the second input is a selection input such as a tap input, a gaze input, an air pinch input (or other selection input), and/or a voice input corresponding to a request to display the content in the three-dimensional environment. In some embodiments, the second input includes an air pinch gesture or air tap gesture (e.g., a multi-pinch or multi-tap air gesture) performed by a hand of the user, optionally while the attention of the user is directed to a selectable option in the environment. In some embodiments, the computer system receives the second input directed towards a selectable option to display the content in the three-dimensional environment. In some embodiments, the second input has one or more or all of the characteristics of the first input described above.

In some embodiments, in response to detecting the second input: in accordance with a determination that the automatic three-dimensional content conversion setting is active, the computer system displays, via the one or more display generation components, the content in the three-dimensional environment, including generating three-dimensional content based on the two-dimensional visual media, such as shown in FIG. 7J. Generating three-dimensional content (e.g., content including a three-dimensional appearance or three-dimensional representations of two-dimensional visual media) is described in greater detail above and with reference to method 800.

In some embodiments, in response to detecting the second input, in accordance with a determination that the automatic three-dimensional content conversion setting is inactive, the computer system displays, via the one or more display generation components, the content in the three-dimensional environment, including the two-dimensional visual media (e.g., one or more images, illustrations, and/or videos), without generating three-dimensional content from the two-dimensional visual media, such as if the content in portal 712b does not include content including a three-dimensional appearance in FIG. 7K. In some embodiments, the computer system receives a third input corresponding to a request to deactivate the automatic three-dimensional content conversion setting prior to receiving the second input. In some embodiments, the third input is a selection input, such as a tap input, a gaze input, an air pinch input (or other selection input), and/or a voice input corresponding to a request to deactivate the automatic three-dimensional content conversion setting. In some embodiments, the third input includes an air pinch gesture or air tap gesture (e.g., a multi-pinch or multi-tap air gesture) performed by a hand of the user, optionally while the attention of the user is directed to a selectable option in the environment. In some embodiments, the automatic three-dimensional content conversion setting is in a settings user interface of the three-dimensional environment or in a system settings user interface. In some embodiments, in response to detecting the second input, the computer system displays the content including two-dimensional visual media and not including automatically converted three-dimensional content. Providing an option to disable automatic conversion of two-dimensional visual media into three-dimensional content reduces the resources needed to display content by only displaying the three-dimensional content when requested, thereby reducing user discomfort (from the immersive environment) and saving battery life and/or computing resources.

In some embodiments, wherein displaying the content in the three-dimensional environment in response to detecting the first input includes displaying a third portion of the content (or the first portion, second portion, or other portions of the content) and a first portion of the three-dimensional environment surrounding the content with a first visual appearance corresponding to the third portion of the content (e.g., the first portion of the three-dimensional environment includes the background content (e.g., a portion of a representation of the physical environment), such as described in method 800), such as color 728b in the virtual environment 777b corresponding to the content 713e-b, shown in in FIG. 7M.

In some embodiments, while displaying the third portion of the content and the first portion of the three-dimensional environment surrounding the content with the first visual appearance corresponding to the third portion of the content (e.g., a first color, first saturation, and/or first brightness), the computer system detects, via the one or more input devices, a second input corresponding to a request to scroll the content, such as the input shown in FIG. 7M. In some embodiments, the first visual appearance has one or more characteristics of the first visual appearance described in method 1000. In some embodiments, the second input is a scrolling input including a selection input. In some embodiments, the selection input has one or more characteristics of the selection input described in method 800 and 1000. For example, the selection input is a tap input, a gaze input, an air pinch input (or other selection input), and/or a voice input. In some embodiments, the selection input is directed towards a selectable option to scroll the content. In some embodiments, the scroll input is a selection input (e.g., directed towards a selectable option such as a scroll bar) and then a drag input (e.g., to move the scroll bar). For example, a gaze selection input and then a movement of the hand (or gaze) to scroll a respective direction, an air pinch (or other selection input) and drag input (e.g., detecting an air pinch gesture and a movement of the hand while maintaining the air pinch hand shape), a scroll input using a mouse, and/or a tap input and a movement input.

In some embodiments, in response to detecting the second input (or while detecting the second input), scrolling through the content in accordance with the second input, includes ceasing displaying the third portion of the content, such as the computer system 101 no longer displaying content 713e-b in FIG. 7N. In some embodiments, the computer system continues displaying a portion of the third portion of the content.

In some embodiments, scrolling through the content includes displaying, via the one or more display generation components, a fourth portion of the content, different from the third portion of the content, such as content 713l-b, shown in FIG. 7M. In some embodiments, the fourth portion of the content includes two-dimensional visual media and/or automatically converted three-dimensional content. In some embodiments, the fourth portion of the content is a different portion of the content based on the magnitude and/or direction of the scroll input.

In some embodiments, scrolling through the content includes displaying, via the one or more display generation components, the first portion of the three-dimensional environment surrounding the content with a second visual appearance, different from the first visual appearance, corresponding to the fourth portion of the content, such as the computer system 101 displaying color 728d in the virtual environment 777b, which corresponds to content 713l-b, shown in FIG. 7N. For example, the second visual appearance includes a second color, a second saturation, and/or a second brightness corresponding to the fourth portion of the content. In some embodiments, the second visual appearance has one or more characteristics of the second visual appearance described in method 1000 Basing the appearance of the three-dimensional environment on the portion of the content allows the computer system to reduce distractions in the environment and draw attention to the respective portion of the content, thereby reducing errors in interaction with the computer system.

In some embodiments, while displaying the content in the three-dimensional environment in response to detecting the first input, the computer system detects, via the one or more input devices, a second input corresponding to a request to scroll the content, such as the input shown in FIG. 7L. In some embodiments, the second input is a scrolling input including a selection input. In some embodiments, the selection input has one or more characteristics of the selection input described in method 800 and 1000. For example, the selection input is a tap input, a gaze input, an air pinch input (or other selection input), and/or a voice input. In some embodiments, the selection input is directed towards a selectable option to scroll the content. In some embodiments, the scroll input is a selection input (e.g., directed towards a selectable option such as a scroll bar) and then a drag input (e.g., to move the scroll bar). For example, a gaze selection input and then a movement of the gaze to scroll a respective direction, an air pinch (or other selection input) and drag input (e.g. detecting an air pinch gesture and a movement of the hand while maintaining the air pinch hand shape), a scroll input using a mouse, and/or a tap input and a movement input.

In some embodiments, in response to detecting the second input, the computer system scrolls the content in accordance with the second input, including ceasing displaying the first portion and the second portion of the content, such as shown by content 713e-b being partially displayed in FIG. 7M. In some embodiments, a portion of the first portion and/or second portion of the content is still displayed.

In some embodiments, in response to detecting the second input, the computer system scrolls the content in accordance with the second input, including displaying, via the one or more display generation components, a third portion of the content, different than the first portion and the second portion of the content, including displaying second three-dimensional content that was automatically generated from two-dimensional visual media (e.g., content including a three-dimensional appearance or a three-dimensional representation of two-dimensional visual media), such as displaying content 713i-b, shown in FIG. 7M. In some embodiments, the third portion of the content is a different portion of the content based on the magnitude and/or direction of the scroll input. In some embodiments, in response to the second input, the computer system displays additional content of the content (e.g., the third content), which includes displaying automatically generated three-dimensional content corresponding to two-dimensional visual media in the third content. In some embodiments, if the third portion has convertible two-dimensional content items, then the computer system converts the respective two-dimensional content items into three-dimensional content items. In some embodiments, the third portion includes two-dimensional visual media that does not satisfy the one or more criteria, described above, to be converted into three-dimensional content. In some embodiments, the computer system automatically converts two-dimensional visual media of the third portion into three-dimensional content in response to detecting or while detecting the second input. Alternatively, in some embodiments, the computer system converts two-dimensional visual media of the third portion into three-dimensional content in response to detecting or while detecting the first input. In some embodiments, the second three-dimensional content includes corresponding two-dimensional content that the computer system is able to scroll to prior to the computer system detecting the first input. Directional scrolling to view additional and/or different three-dimensional content allows the user to easily navigate through the content, thereby reducing erroneous inputs and improving user-device interaction.

In some embodiments, displaying the third portion of the content includes displaying two-dimensional content that was not automatically generated into the second three-dimensional content, such as scrolling to display content 713l-b, shown in FIG. 7N. As described above, two-dimensional visual media that does not satisfy the one or more criteria is not converted into three-dimensional content. In some embodiments, the third portion of the content includes convertible and non-convertible two-dimensional visual media. Directional scrolling to view additional and/or different two-dimensional visual media allows the user to easily navigate through the content, thereby reducing erroneous inputs and improving user-device interaction.

In some embodiments, before detecting the first input, the computer system displays, via the one or more display generation components, the content in the three-dimensional environment (e.g., prior to automatically converting two-dimensional visual media into three-dimensional content), such as in user interface 712a, shown in FIG. 7A.

In some embodiments, in accordance with a determination that the first portion of the content is a first type of content (e.g., one of text, images, videos, graphics, illustrations, graphs, charts, and/or headings), the computer system displays the first portion of the content with a first layering relationship relative to the second portion of the content, wherein the first layering relationship is automatically determined (e.g., based on the type of content), such as the layering relationship between content 713a-b through 713a-c, shown in the overhead view 208 shown in FIG. 7J. In some embodiments, and as described below, the layering relationship includes how far (deep) a portion of the content is displayed relative to a different portion of the content and/or relative to the viewpoint of the user.

In some embodiments, in accordance with a determination that the first portion of the content is a second type of content, different from the first type of content (e.g., a different one of text, images, videos, graphics, illustrations, graphs, charts, and/or headings), the computer system displays the first portion of the content with a second layering relationship, different from the first layering relationship, relative to the second portion of the content, wherein the second layering relationship is automatically determined (e.g., based on the type of content), such as the layering relationship between content 713a-b through 713a-c, shown in the overhead view 208 shown in FIG. 7J. In some embodiments, types of content have a pre-defined layering relationship to other types of content. For example, each type of content has a predefined depth relative to the other types content such that there is a predefined layering relationship. For example, headings are displayed closer to the viewpoint of the user that photos or text. For example, the layering relationship (e.g., from closest to the viewpoint of the user to furthest) includes headings, three-dimensional content, two-dimensional content, and text. In some embodiments, the types of content are separated by 0.01 cm, 0.1 cm, or 1 cm of depth. In some embodiments, the first layering relationship includes displaying the first portion of the content in front of the second portion of content and the first portion of the content is 0.01 cm, 0.1 cm, or 1 cm in front of the second portion of content. In some embodiments, the second layering relationship includes displaying the second portion of the content in front of the first portion of content and the second portion of the content is 0.01 cm, 0.1 cm, or 1 cm in front of the first portion of content. Displaying the content with a layering relationship based on the type of content increasing visual appeal of the content that is in a more forward layer therefore allowing the user to efficiently identify important information which increasing the speed and efficiency of using the computer system which saves battery life and/or computing resources.

In some embodiments, displaying the first portion of the content with the first layering relationship relative to the second portion of the content includes displaying the first portion of the content with a first depth relative to the second portion of the content, such as shown by the layering relationship between content 713a-b through 713a-c, shown in the overhead view 208 shown in FIG. 7J. In some embodiments, the depth of the first portion of the content (e.g., the first depth) and the depth of the second portion of the content are both relative to the viewpoint of the user. In some embodiments, the depth is an elevation relative to a background or a z-height relative to a reference plane that is parallel to the plane in which content is displayed. In some embodiments, the content includes a back plane over which the first and/or second portions of the content are displayed. In some embodiments, the z-height is relative to the back plane. In some embodiments, based on the layering relationship, the first portion of the content is displayed in front of, at the same depth as, or behind the second portion of the content. In some embodiments, the first layering relationship is a relationship where the first portion of the content is displayed in front of the second portion of the content. For example, three-dimensional content is displayed in front of text, and/or two-dimensional visual media. In other examples, a heading (e.g., of a website and/or including text) is displayed in front of three-dimensional content, two-dimensional visual media (e.g., unconverted two-dimensional visual media such as advertisements, graphics, graphs, tables, images, videos, and other content as described above), and text. In some embodiments, if the first portion of the content and the second portion of the content include the same type of content (e.g., both portions are text), then they are displayed at the same depth.

In some embodiments, displaying the first portion of the content with the second layering relationship relative to the second portion of the content includes displaying the first portion of the content with a second depth relative to the second portion of the content, such as shown by the layering relationship between content 713a-b through 713a-c, shown in the overhead view 208 shown in FIG. 7J. In some embodiments, the second layering relationship is a relationship where the first portion of the content is displayed behind the second portion of the content. For example, the text is displayed behind a heading, three-dimensional content, and/or two-dimensional visual media. In other examples, the two-dimensional visual media is displayed behind the three-dimensional content but in front of the text. In some embodiments, some two-dimensional visual media, such as advertisements, are displayed behind text, other two-dimensional visual media, and/or three-dimensional content. Displaying the content with different depth on the type of content increasing visual appeal of certain content that is closer to the user, therefore increasing the speed and efficiency of using the computer system by allowing the user to focus on specific content which saves battery life and/or computing resources.

In some embodiments, displaying the first portion of the content with the first depth includes displaying the first portion of the content with a corresponding virtual shadow (optionally virtually casted onto the second portion of the content), such as the shadow shown behind content 714c, shown in FIG. 7B or the shadow 722a shown in FIG. 7O. In some embodiments, the shadow is casted on a background of the content. For example, the portions of content are displayed at depths relative to a background of the content and types of content that are displayed in front of the background cast a shadow on the background (e.g., two-dimensional visual media such as photos and videos, three-dimensional content, and/or headers) and types of content that are displayed behind or in line with the background (e.g., two-dimensional visual media such as advertisements, graphs, tables, graphics and/or text) are not displayed with a shadow. In some embodiments, the first portion of the content casts a shadow onto a second portion of the content. In some embodiments, the first portion of the content includes photos (e.g., two-dimensional and/or three-dimensional images) and videos and the second portion of the content includes text. In some embodiments, the first portion of the content casts a shadow on the second portion of the content. In some embodiments, the shadow includes a decrease in saturation, or brightness of a background color and/or color associated with the first portion of the content. In some embodiments, displaying the first portion of the content with the second depth (e.g., such as the second depth described above with reference to the second layering relationship of the first portion relative to the second portion) includes displaying the second portion of the content with a shadow casted on the first portion of the content. In some embodiments, the second portion of the content includes photos (e.g., two-dimensional and/or three-dimensional images) and videos and the first portion of the content includes text. In some embodiments, prior to detecting the first input, the first portion and/or the second portion of the content do not cast and/or include virtual shadows. In some embodiments, the virtual shadows are different (e.g., different sizes, intensities, blurs, or colors) based on the layering relationship, as described above. Adding shadows based on type of content increasing visual appeal of certain content that is closer to the user, therefore enhancing user experience with the computer system by allowing the user to focus on specific content which increasing the speed and efficiency of using the computer system which saves battery life and/or computing resources.

In some embodiments, when the first input is detected, the content is not displayed in the three-dimensional environment, such as shown in FIG. 7B. In some embodiments, prior to and when the first input is detected, the computer system has an automatic three-dimensional content conversion setting active (such as described above with reference to automatically converting one or more two-dimensional content items to three-dimensional content). In some embodiments, in response to detecting the first input, the computer system automatically converts potions of the content into three-dimensional content, as described above. Therefore, the first input is optionally an input to display the content in the first instance, as opposed to an input to convert already displayed content into three-dimensional content. In some embodiments, in response to detecting the first input, the computer system does not change a layout of the content (e.g., changing from a first mode of presentation to a second mode of presentation, as described in method 800). Automatically presenting two-dimensional content as three-dimensional content in response to an input reduces the number of inputs needed to view three-dimensional content, thereby reducing erroneous inputs to the computer system which increasing the speed and efficiency of using the computer system which saves battery life and/or computing resources.

In some embodiments, when the first input is detected, the content is displayed in a first mode of presentation, such as shown in FIG. 7A, and the content is displayed in a second mode of presentation, different from the first mode of presentation, in response to detecting the first input, such as shown in FIG. 7J. In some embodiments, the first mode of presentation and the second mode of presentation is described in greater detail in method 800. In some embodiments, the first mode of presentation does not include displaying three-dimensional content that is automatically generated from the two-dimensional visual media. In some embodiments, the second mode of presentation includes displaying three-dimensional content (including spatial elements, as described in method 800) that has been automatically converted from two-dimensional visual media. In some embodiments, the first mode of presentation has a first layout, and the second mode of presentation has a second layout, as described in method 800. Displaying the three-dimensional content only in the second mode of presentation reduces the resources needed to display three-dimensional content by only displaying the three-dimensional content when needed, thereby reducing user discomfort (from the immersive environment) and saving battery life and/or computing resources.

It should be understood that the particular order in which the operations in methods 800 and/or 900 have been described is merely exemplary and is not intended to indicate that the described order is the only order in which the operations could be performed. One of ordinary skill in the art would recognize various ways to reorder the operations described herein. In some embodiments, aspects and/or operations of methods 800, and/or 900 may be interchanged, substituted, and/or added between these methods. For example, the first or second modes of presentation in methods 800 and/or 900, and/or the display of content as content with a three-dimensional appearance in methods 800 and/or 900 are optionally interchanged, substituted, and/or added between these methods. For brevity, these details are not repeated here.

FIG. 10 is a flowchart illustrating an exemplary method 1000 of changing an appearance of the three-dimensional environment based on content displayed in the three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processing units 202 (e.g., processors) of computer system 101 (e.g., control unit 110 in FIG. 1A). Some operations in method 1000 are, optionally, combined and/or the order of some operations is, optionally, changed.

In some embodiments, method 1000 is performed at a computer system that is in communication with one or more display generation components and one or more input devices, such as computer system 101 shown in FIG. 7A. For example, the computer system is or corresponds to a mobile device (e.g., a tablet, a smartphone, a media player, or a wearable device), or a computer or other electronic device. In some embodiments, the computer system has one or more characteristics of the computer system in method 800 and/or 1000. In some embodiments, the one or more display generation components have one or more characteristics of the one or more display generation components in method 800 and/or 1000. In some embodiments, the one or more input devices have one or more characteristics of the one or more input devices in method 800 and/or 1000.

In some embodiments, the computer system displays, in a three-dimensional environment, a first content item, such as content 756a-b, shown in FIG. 7PP. In some embodiments, the first content item has one or more characteristics of the content described in methods 800 and 1000. Optionally, the first content item has one or more characteristics of the content in the first mode of presentation described in method 800 and 1000 or the content in the second mode of presentation described in method 800 and 1000, Optionally, the first content item has one or more characteristics of the content in the second mode of presentation and not the first mode of presentation. In some embodiments, the first content item is content in a user interface of a respective application. For example, the first content item is a portion of a webpage, a photo album, or news article. In some embodiments, the first content item includes media content item such as photos and/or videos, and non-media items such as text. In some embodiments, the three-dimensional environment outside of the first content item includes the environment surrounding the first content item. In some embodiments, at least a portion of the three-dimensional environment, other than the first content item, is visible via the one or more display generation components, and visibility of the three-dimensional environment outside of the first content item includes visibility of at least a part of the physical environment outside of the first content item. In some embodiments, the three-dimensional environment has one or more characteristics of the three-dimensional environment described in methods 800 and 1000. In some embodiments, the three-dimensional environment is a currently visible three-dimensional environment that includes at least a portion of a virtual environment, a representation of the physical environment of the user (e.g., via an optical passthrough), and/or virtual content (e.g., additional virtual objects, virtual environments, and/or immersive virtual content) such as the user interface described herein. In some embodiments, a virtual environment is based on a real physical location, such as a museum and/or an aquarium, or is based on an artist-designed location. In some embodiments, the virtual environment includes a presentation of the content while the content is visible in the three-dimensional environment, but not in the physical environment. In some embodiments, the representation of the physical environment includes one or more objects (e.g., animate and/or inanimate objects) in the real world in the viewport of the computer system. In some embodiments, viewport is described in greater detail in method 800.

In some embodiments, while displaying the first content item in the three-dimensional environment, the computer system detects a first event for displaying a second content item in place of the first content item, wherein the second content item is different from the first content item, such as the input shown in FIG. 7PP. In some embodiments, the first event is an input such as a selection input or a scrolling input. For example, the first event is changing the first content item to the second content item by changing user interfaces (e.g., by changing applications), by changing webpages (e.g., going to a different website), and/or by scrolling up or down on a user interface to display the second content item (e.g., to display a different portion of the user interface). In some embodiments, the selection input has one or more characteristics of the selection input described in method 800 and 900. For example, the selection input is a tap input, a gaze input, an air pinch input (or other selection input), and/or a voice input. In some embodiments, the selection input is directed towards a selectable option to change the content (e.g., a back button on a web browser user interface, a selectable option to change web pages, and/or a selectable option to change applications). In some embodiments, the scroll input is a selection input and then a drag input. For example, a gaze selection input and then a movement of the gaze to scroll a respective direction, an air pinch (or other selection input) and drag input, a scroll input using a mouse, and/or a tap input and a movement input. In some embodiments, the first content item is media such as text, images, and/or videos. In some embodiments, the second content item is also media such as text, images, and/or videos. In some embodiments, the second content item is content on a user interface that is displayed below and/or above the first content item.

In some embodiments, in response to detecting the first event, the computer system displays, in the three-dimensional environment, via the one or more display generation components, the second content item in place of the first content item, such as displaying content 756b-b, shown in FIG. 7QQ. For example, ceasing display of the first content item and displaying the second content item.

In some embodiments, in response to detecting the first event, the computer system changes an appearance of at least a respective portion of the three-dimensional environment outside of the second content item to an appearance that is based on the second content item (e.g., a second visual appearance), such as changing the background of the virtual environment 777e to color 762b, shown in FIG. 7QQ. In some embodiments, changing the appearance of at least the respective portion of the three-dimensional environment includes changing the appearance of the virtual environment but not the background environment. The virtual environment and the background environment are described in greater detail in method 800. For example, the first content item is a first image which causes the three-dimensional environment to have a first visual appearance and in response to the scroll input or the selection input, the computer system displays the second content item such as a second image that the second visual appearance is based on. In some embodiments, the second visual appearance has one or more characteristics of the first visual appearance. For example, the second visual appearance includes a color, saturation, and/or brightness based on the second content. In some embodiments, the appearance of the three-dimensional environment is in addition to or in place of a virtual lighting effect that is displayed from the second content item. In some embodiments, the virtual lighting effect is a glow and/or reflection that emanates from the second content item into and/or onto the environment outside of the second content item. In some embodiments, a portion of the three-dimensional environment outside of the second content item remains visible, and optionally includes at least a part of the physical environment outside of the second content item. Updating the visual appearance of the three-dimensional environment based on the content being displayed allows a user to be immersed in the presentation experience by allowing the user to gather information from the content more efficiently, for example by reducing distractions in the environment outside of the content, which are optionally reduced due to the change in the visual appearance of the environment based on the content, thereby reducing errors in interaction with the computer system.

In some embodiments, changing the appearance of the respective portion of the three-dimensional environment (e.g., displaying at least a portion of a virtual environment) includes displaying the respective portion of the three-dimensional environment with a first appearance that is based on the second content item, such as displaying color 762b based on content 756b-b, shown in FIG. 7QQ. In some embodiments, the first appearance includes a color, saturation, and/or brightness based on the second content item. For example, and as described below, the computer system displays the first appearance based on one or more colors from the second content item. Prior to detecting the first event, the computer system displays the respective portion of the three-dimensional environment with a second appearance that is based on the first content item. For example, the second appearance includes a color, saturation, and/or brightness based on the first content item. Displaying a first appearance based on the first content item reduces the distractions in the three-dimensional environment outside of the content and allows the user to focus on the first content item, thereby reducing errors in interacting with the computer system which increasing the speed and efficiency of using the computer system which saves battery life and/or computing resources.

In some embodiments, the first event comprises a scrolling input directed to the first content item, such as the scrolling input shown in FIG. 7PP. In some embodiments, the scrolling input is directed towards the portal and/or the content in the portal. In some embodiments, and as described in method 800, the three-dimensional environment includes a virtual environment and a representation of a physical environment. In some embodiments, the scrolling input includes scrolling using an input device (e.g., a mouse), a gaze, attention, an air pinch (or other selection input) and drag, a tap (e.g., with a finger) and drag, and/or a voice input. In some embodiments, the scrolling input is an upward movement or a downward movement of the hand while in the air pinch (or other selection input) shape. In some embodiments, an upward scrolling input (e.g., the hand moving upward while in the air pinch shape) results a downward scroll of the content (e.g., the upward scrolling input moves the first content item and/or the second content item upward and the computer system displays additional content items below the first content item and/or the second content item), and a downward scrolling input (e.g., the hand moving downward while in the air pinch shape) results in an upward scroll of the content (e.g., the downward scrolling input moves the first content item and/or the second content item downward and the computer system displays additional content items above the first content item and/or the second content item), as described below. Scrolling to view additional and/or different content items allows the user to easily navigate through content items, thereby reducing erroneous inputs which increasing the speed and efficiency of using the computer system which saves battery life and/or computing resources and improving user-device interaction.

In some embodiments, the first event comprises the scrolling input associated with a first direction of scrolling (e.g., a downward motion using an air pinch and drag, a gaze, and/or a movement of a contact such as a cursor, finger, or stylus. Scrolling inputs are described in greater detail above.), such as the leftward movement shown in FIG. 7PP or the upward movement shown in FIG. 7M. In some embodiments, while displaying the first content item in the three-dimensional environment, the computer system detects a second event including a scrolling input associated with a second direction of scrolling, different from the first direction of scrolling, such as a downward movement shown in FIG. 7N. In some embodiments, the first direction of scrolling is an upward motion and the second direction of scrolling is a downward motion. In some embodiments, the first direction of scrolling is a downward motion, and the second direction of scrolling is an upward motion, or vice versa. In some embodiments, the first direction of scrolling is a leftward motion and the second direction of scrolling is a rightward motion, or vice versa. In some embodiments, the first direction of scrolling is a direction of scrolling to scroll downward in the content and the second direction of scrolling is a direction of scrolling to scroll upward in the content.

In some embodiments, in response to detecting the second event, the computer system displays, in the three-dimensional environment, via the one or more display generation components, a third content item (e.g., having one or more characteristics of the first or second content items) in place of the first content item (optionally without displaying the second content item), wherein the third content item is different from the second content item, such as the content 713c-b through 713e-b shown in FIG. 7O, which is different than content 713l-b shown in FIG. 7N. In some embodiments, in response to detecting the second event, the computer system scrolls the content to display the third content item, which is displayed above (and/or before) the first content item, structurally, in the full collection of content that is displayable in the three-dimensional environment. In some embodiments, in response to detecting the second event, the computer system does not cease displaying the first content item. For example, the third content item is not displayed at the same location as the first content item although the user is able to scroll such that the third content item is at the same location as the first content item was previously. In some embodiments, the computer system gradually ceases displaying the first content item as the user scrolls. In some embodiments, the computer system displays the first content item and the third content item together.

In some embodiments, the computer system changes an appearance of the respective portion of the three-dimensional environment (e.g., changing the appearance of the portion of the virtual environment) outside of the third content item to an appearance that is based on the third content item (and optionally not based on the second content item), such as changing color 728c in FIG. 7N to color 728a and 728b shown in FIG. 7O. In some embodiments, the visual appearance includes a color, saturation, and/or brightness based on the third content item. For example, and as described below, the computer system displays the visual appearance based on one or more colors from the third content item. In some embodiments, the computer system displays the visual appearance based on the one or more colors from the first and third content items, similarly to how the computer system displays the visual appearance based on the second content item, described above. Directional scrolling to view additional and/or different content items allows the user to easily navigate through content items, thereby reducing erroneous inputs which increasing the speed and efficiency of using the computer system which saves battery life and/or computing resources and improving user-device interaction.

In some embodiments, the three-dimensional environment includes a virtual environment (e.g., virtual environment 777b) including the first content item, wherein the virtual environment occupies a first portion of the viewport (e.g., the virtual environment as described above and with reference to method 800), such as the virtual environment occupying a first portion of the three-dimensional environment 702 shown in FIG. 7O. In some embodiments, the computer system detects, via the one or more input devices, an input corresponding to a request to change a level of immersion of the virtual environment, such as the input directed towards element 732, shown in FIG. 7O. In some embodiments, the level of immersion includes a size of the portal of the virtual environment. In some embodiments, the portal is described in greater detail in method 800. In some embodiments, the portal contains the content including the first content item and the second content item. Immersion is described in greater detail in method 800. In some embodiments, a level of immersion includes an associated degree to which the content displayed by the computer system (e.g., the virtual environment including the content item(s)) obscures background content (e.g., content other than the virtual environment such as the representation of the physical environment) around and/or behind the virtual environment. In some embodiments, the input is a rotational input directed towards a mechanical input element of the computer system, as described in greater detail in method 800. In some embodiments, a turn in a first direction increases the level of immersion and a turn in a second direction decreases the level of immersion.

In some embodiments, in response to detecting the input, the computer system updates the virtual environment to occupy a second portion of the viewport, different than the first portion, such as shown by the virtual environment 777b occupying a smaller portion of the three-dimensional environment 702, shown in FIG. 7P. In some embodiments, based on the input (e.g., the direction of the input, as described below), the computer system increases or decreases the level of immersion. In some embodiments, in response to an input to increase the level of immersion, the computer system updates the virtual environment to occupy the second portion of the viewport (e.g., optionally including the first portion of the viewport), that is larger than the first portion of the viewport. In some embodiments, in response to an input to decrease the level of immersion, the computer system updates the virtual environment to occupy the second portion of the viewport (e.g., optionally including a portion of the first portion of the viewport), that is smaller than the first portion of the viewport. In some embodiments, in response to decreasing the level of immersion, the computer system displays less of the content item(s) in the virtual environment through the portal and increasing the level of immersion includes displaying more of the content item(s) in the virtual environment through the portal. Increasing or decreasing an immersion level based on an input allows the user to customize how to view the content and how much of the background environment is visible, thereby improving user-device interaction which increasing the speed and efficiency of using the computer system which saves battery life and/or computing resources.

In some embodiments, the input includes input from a mechanical input element of the computer system, such as element 732, shown in FIG. 7O. In some embodiments, the mechanical input element is rotatable to modify the immersion level of the virtual environment and is depressible to perform a different operation at the computer system (e.g., to display a collection of icons of available applications at the computer system), as described in method 800. In some embodiments, a clockwise turn increases the level of immersion, and a counterclockwise turn decreases the level of immersion. Alternatively, in some embodiments, a turn in a first direction causes the computer system to decrease the level of immersion and a turn in a second direction, different from the first direction, causes the computer system to decrease the level of immersion. In some embodiments, the magnitude of the turn corresponds to the amount that the level of immersion increases or decreases. For example, the greater the magnitude of the turn (e.g., the more rotational distance the element rotates), the greater the amount that the level of immersion increases (e.g., a turn in the first direction) or decreases (e.g., a turn in the second direction). Increasing or decreasing an immersion level based on an input directed towards a physical control allows the user to easily and efficiently customize how to view the content regardless of what is being displayed in the three-dimensional environment, thereby improving user-device interaction. Additionally, increasing or decreasing the immersion level based on an input directed towards a physical input device (rather than a virtual input) reduces risk of accidental change of immersion levels which increasing the speed and efficiency of using the computer system which saves battery life and/or computing resources.

In some embodiments, the first content item and the second content item can be displayed in one of a plurality of different modes of presentation including a first mode of presentation and a second mode of presentation that is different from the first mode of presentation, such as the first mode shown in FIG. 7OO and the second mode shown in FIG. 7PP. In some embodiments, displaying the first content item and the second content item includes displaying the first content item and the second content item in the second mode of presentation (e.g., corresponding to the second mode of presentation described in method 800), such as content 756a-b and 756b-b shown in FIGS. 7PP and 7QQ. In some embodiments, before displaying the first content item and the second content item in the second mode of presentation, the computer system displays, via the one or more display generation components, the first content item in the first mode of presentation (e.g., corresponding to the first mode of presentation described in method 800), such as content 756a shown in FIG. 7OO.

In some embodiments, while displaying the first content item in the first mode of presentation, the computer system detects, via the one or more input devices, a first input corresponding to a request to display the first content item in the second mode of presentation, such as the input directed towards option 711f, shown in FIG. 7OO. In some embodiments, the first input has one or more characteristics of the inputs described in method 800 for changing from the first mode to the second mode. In some embodiments, the input is a selection input such as a tap input, a gaze input, an air pinch input (or other selection input), and/or a voice input corresponding to a request to display the content in the second mode of presentation. For example, the input includes an input directed towards a selectable option, that is selectable to display the content in the first mode of presentation, such as an air pinch gesture or air tap gesture (e.g., a multi-pinch or multi-tap air gesture) performed by a hand of the user, optionally while the attention of the user (e.g., including gaze) is directed to the selectable option in the environment.

In some embodiments, in response to detecting the first input, the computer system displays, via the one or more display generation components, the first content item in the second mode of presentation, wherein in the second mode of presentation, the first content item is displayed with one or more spatial elements that are related to the first content item and are not displayed when the first content item is displayed in the first mode of presentation, such as content 756a-b, which corresponds to content 756a shown in FIG. 7OO, being displayed with a plurality of spatial elements 759a, shown in FIG. 7PP. Displaying the content with one or more spatial elements is described in greater detail in method 800. In some embodiments, displaying the content in the second mode of presentation includes displaying one or more content items including three-dimensional appearances corresponding to two-dimensional content in the second mode of presentation, as described in method 800. Changing the appearance of the three-dimensional environment while in the first mode of presentation allows the user to distinguish the mode of presentation, thereby improving user-device interaction which increasing the speed and efficiency of using the computer system which saves battery life and/or computing resources.

In some embodiments, while displaying the first content item in the second mode of presentation (e.g., corresponding to the second mode of presentation described in method 800), the computer system detects, via the one or more input devices, a second input corresponding to a request to display the first content item in the first mode of presentation (e.g., corresponding to the first mode of presentation described in method 800), such as if the computer system detects a selection input including a gaze and a hand gesture directed towards option 720a, shown in FIG. 7PP, In some embodiments, the second input has one or more characteristics of the inputs described in method 800 for switches from the second mode to the first mode in method 800. In some embodiments, the second input is a selection input such as a tap input, a gaze input, an air pinch input (or other selection input), and/or a voice input corresponding to a request to display the content in the second mode of presentation. For example, the input includes an input directed towards a selectable option, that is selectable to display the content in the first mode of presentation, such as an air pinch gesture or air tap gesture (e.g., a multi-pinch or multi-tap air gesture) performed by a hand of the user, optionally while the attention of the user (e.g., including gaze) is directed to the selectable option in the environment.

In some embodiments, in response to detecting the second input, the computer system displays, via the one or more display generation components, the first content item in the first mode of presentation and ceases display of the one or more spatial elements that are related to the first content item, such as if the computer system redisplayed the user interface 712a, shown in FIG. 7OO. In some embodiments, the computer system redisplays the two-dimensional content that corresponds to the three-dimensional representation of the content that was previously displayed in the second mode of presentation. In some embodiments, the computer system continues to display at least the respective portion of the three-dimensional environment with the appearance that is based on the first content item. In some embodiments, the computer system ceases to display the appearance based on the first content item (e.g., the appearance of the respective portion of the three-dimensional environment ceases to be based on the first content item). In some embodiments, in the first mode of presentation, the computer system displays the virtual environment at a level of immersion less than in the second mode of presentation. In some embodiments, in response to detecting the second input, the computer system at least partially or fully reverses the first to second mode of presentation changes described in method 800 (e.g., the first mode of presentation corresponds to the first mode of presentation in method 800 and the second mode of presentation corresponds to the second mode of presentation in method 800). Allowing the user to choose the mode of presentation allows the user to choose the level of immersion of the content, thereby allowing the user to gather information more efficiently and improving user-device interaction which increasing the speed and efficiency of using the computer system which saves battery life and/or computing resources.

In some embodiments, in accordance with a determination that the second content item includes a first key color (and optionally does not include a second key color), the appearance of the respective portion of the three-dimensional environment is based on the first key color (and optionally not based on the second key color), such as content 756a-b including a key color that is the same as color 762a, which is displayed in the virtual environment shown in FIG. 7PP.

In some embodiments, in accordance with a determination that the second content item includes a second key color (and optionally does not include the first key color), different from the first key color, the appearance of the respective portion of the three-dimensional environment is based on the second key color and not the first key color, such as content 756b-b including a key color corresponding to color 762b, shown in FIG. 7QQ. In some embodiments, the respective key color is the most frequent color (e.g., the mode of all the colors in the respective content item) and/or most prominent color (e.g., the most saturated color and/or the brightest color) found in the content item. In some embodiments, the respective key color is a median color of all the colors in the respective content item. In some embodiments, the key color is an average color of the colors of the content item. For example, the key color is an average of each of the red, green, blue values of the content item. In some embodiments, the computer system determines a different and/or independent key color for more than one and/or each content item in the virtual environment. Basing the appearance of the respective portion of three-dimensional environment on a key color from the respective content item allows the computer system to reduce distractions in the environment and draw attention to the respective content item, thereby reducing errors in interaction with the computer system which increasing the speed and efficiency of using the computer system which saves battery life and/or computing resources.

In some embodiments, displaying the respective portion of the three-dimensional environment with the appearance based on the first key color includes displaying, via the one or more display generation components, the respective portion of the three-dimensional environment with a color based on a desaturated version of the first key color, such as color 762a being desaturated compared to the color in content 756a-b, shown in FIG. 7PP.

In some embodiments, displaying the respective portion of the three-dimensional environment with the appearance based on the second key color includes displaying, via the one or more display generation components, the respective portion of the three-dimensional environment with a color based on a desaturated version of the second key color, such as color 762b being desaturated compared to the color in content 756b-b, shown in FIG. 7QQ. In some embodiments, the computer system determines a key color from the content item, as described above, and desaturates the key color displayed in the three-dimensional environment outside of the respective content item. In some embodiments, desaturating the key color includes removing color (e.g., adding grey to the key color, adding white to the key color, adding black to the key color, or diluting the key color using its complementary color). In some embodiments, the computer system desaturates the color by 5%, 10%, 15%, 25%, 50%, or 75%. Desaturating the key color allows the appearance of the respective portion of the three-dimensional environment to be more subtle and less harsh, therefore drawing attention to the content item, thereby reducing errors in interaction with the computer system.

In some embodiments, in accordance with a determination that the second content item includes the first key color and a third key color (e.g., and optionally does not include the second key color), the appearance of the respective portion of the three-dimensional environment is based on the first key color and the third key color (e.g., and not based on the second key color), such as if content 756a-b has two key colors and the color 762b includes the respective two key colors, shown in FIG. 7QQ.

In some embodiments, in accordance with a determination that the second content item includes the second key color and the third key color (e.g., and optionally does not include the first key color), the appearance of the respective portion of the three-dimensional environment is based on the second key color and the third key color and not the first key color, such as if content 756a-b has two key colors and the color 762b includes the respective two key colors, shown in FIG. 7QQ. In some embodiments, the computer system averages the key colors (e.g., the first and third key color or the second and third key color) to determine a single effective key color that the appearance of the respective portion of the three-dimensional environment is based on (e.g., the single effective key color that is displayed in the environment). In some embodiments, the computer system does not change the colors of the respective content item; the computer system changes the appearance of the respective portion of the three-dimensional environment outside of the respective content item using the single effective key color. In some embodiments, the computer system displays the respective key colors (e.g., the first and third key color or the second and third key color) separately in the respective portion of the three-dimensional environment (e.g., in a pattern such as blobs of color, swirls of color, gradients of color, or other patterns of color). In some embodiments, the computer system displays the respective key colors in a desaturated manner in the respective portion of the three-dimensional environment and does not change the key colors in the respective content item. Basing the respective portion of the appearance of the three-dimensional environment on multiple key colors from the respective content item allows the computer system to reduce distractions in the environment and draw attention to the respective content item, thereby reducing errors in interaction with the computer system.

In some embodiments, displaying the respective portion of the three-dimensional environment with the appearance based on the first key color and the third key color (e.g., and optionally does not include the second key color) includes displaying the respective portion of the three-dimensional environment with a gradient between the first key color and the third key color (e.g., and optionally not the second key color), such as the gradient between color 762a and 762b, shown in FIG. 7QQ. In some embodiments, displaying a gradient includes displaying a gradual transition between the first key color and the third key color. In some embodiments, the computer system desaturates the colors of the gradient. In some embodiments, the computer system displays a gradient of colors based on a plurality of colors of the content item. In some embodiments, the computer system changes the appearance of the respective portion of the three-dimensional environment outside of the respective content item using the gradient and/or the desaturation of colors of the gradient. In some embodiments, the computer system does not change the appearance of the content items.

In some embodiments, displaying the respective portion of the three-dimensional environment with the appearance based on the second key color and the third key color (e.g., and optionally does not include the first key color) includes displaying the respective portion of the three-dimensional environment with a gradient between the second key color and the third key color (e.g., and optionally not the first key color), such as the gradient between color 762b and 762c, shown in FIG. 7QQ. In some embodiments, displaying a gradient includes displaying a gradual transition between the second key color and the third key color. In some embodiments, the computer system changes the appearance of the respective portion of the three-dimensional environment outside of the content items using the gradient. Basing the appearance of the respective portion of the three-dimensional environment on a gradient of multiple key colors from the respective content item allows the computer system to reduce distractions in the environment and draw attention to the respective content item, thereby reducing errors in interaction with the computer system.

In some embodiments, while concurrently displaying the second content item and a third content item, the computer system displays the respective portion of the three-dimensional environment outside of the second content item and the third content item with an appearance that is based on one or more colors of the second content item and the third content item, such as if the computer system 101 displayed a third color that is a combination of the color 728a and 728b, shown in FIG. 7Q, throughout the entirety of the virtual environment 777b. In some embodiments, while, before and/or after scrolling (described in greater detail above) through the content, such as scrolling from the second content item to the third content item, the computer system displays both the second content item and the third content item in the virtual environment (e.g., at the same time). While displaying both the second content item and the third content item, the computer system optionally displays the respective portion of the three-dimensional environment with an appearance based on one or more key colors of the second content item and one or more key colors of the third content item, as described above. For example, the computer system averages the red, green, blue colors (RGB) of the second content item with the RGB colors of the third content item to determine the color to display. In some embodiments, the computer system interpolates (e.g., linear, polynomial, spline, and/or nearest neighbor interpolation) one or more key colors from the second and third content item. In some embodiments, the respective portion of the three-dimensional environment has an appearance based on one or more key colors of the second content item and one or more key colors of the third content item while the computer system is not displaying the second content item and not displaying all portions of the third content item. For example, the third content item is not fully in the viewport of the user. In some embodiments, the appearance based on the one or more key colors is a gradient of the key colors, as described above. Basing the appearance of the respective portion of the three-dimensional environment on one or more colors from the second and third content items allows the computer system to reduce distractions in the environment and draw attention to the respective content item, thereby reducing errors in interaction with the computer system.

In some embodiments, displaying the first content item includes displaying the respective portion of the three-dimensional environment with an appearance based on the first content item (e.g., based on one or more key colors of the first content item, as described above), such as color 762a corresponding to content 756a-b, shown in FIG. 7PP.

In some embodiments, in response to detecting the first event (e.g., the scrolling input, as described above), the computer system updates the appearance of the respective portion of the three-dimensional environment (e.g., changing the appearance of the virtual environment but not the background environment) to have an appearance that is based on the second content item and not based on the first content item, such as color 762b based on content 756b-b, shown in FIG. 7QQ. In some embodiments, the computer system gradually changes the appearance while detecting or after detecting the first event (e.g., after the scrolling input has ended) as described below. In some embodiments, the computer system changes the appearance of the respective portion of the three-dimensional environment by updating the appearance from being based on the one or more key colors of the first content item to being based on the one or more key colors of the second content item while detecting or after detecting the first event, as described above. In some embodiments, the computer system changes the appearance of the respective portion of the three-dimensional environment if the second content item is in the viewport of the user (e.g., regardless of whether the first content item is still in the viewport of the user). Transitioning the appearance of the respective portion of the three-dimensional environment while transitioning between content items allows the computer system to visually indicate a change in display of content items, thereby reducing errors in interaction with the computer system.

In some embodiments, updating the appearance of the respective portion of the three-dimensional environment includes gradually changing the appearance of the respective portion of the three-dimensional environment in accordance with progress of the first content item changing to the second content item, such as transitioning between color 728a and 728b, shown in FIG. 7K. In some embodiments, if and while the computer system displays both the first content item and the second content item while or after detecting the first event, the computer system displays a gradient including the key colors of the first content item and the key colors of the second content item in the three-dimensional environment. In some embodiments, the transition between the key colors of the first content item and the key colors of the second content item begins at the point in the virtual environment where the first content item ends. For example, at the location of the first content item, the computer system displays the key colors of the first content item and at the location of the second content item, the computer system displays the key colors of the second content item. In between the content items, the computer system optionally gradually transitions from the key colors of the first content item to the key colors of the second content item (e.g., via a gradient). In some embodiments, the computer system gradually changes appearance of the respective portion of the three-dimensional environment by displaying an average key color (e.g., a single color) based on the key colors of the first content item and the key colors of the second content item as the first event progresses. For example, while more of the first content item is displayed (e.g., rather than the second content item), the computer system displays an appearance in the respective portion of the three-dimensional environment corresponding more closely to the first content item. As more of the second content item is displayed (and less of the first content item is displayed), the computer system displays an appearance (e.g., a single color in the three-dimensional environment) corresponding more closely to the second content item. For example, the computer system performs a weighted average to the RGB color values (e.g., weighted based on how much of the respective content item is displayed) to determine the single color. While the computer system displays the first content item and not the second content item, the computer system displays the appearance based on the key colors of the first content item. While the computer system displays the second content item and not the first content item, the computer system displays the appearance based on the key colors of the second content item. In some embodiments, if the input is slower (e.g., a slow scroll), the time to transition between the first content item to the second content item takes a longer amount of time. In some embodiments, if the input is faster (e.g., a fast scroll), the time to transition between the first content item to the second content item takes a shorter amount of time. In some embodiments, if there is a greater magnitude of progress of change from the first content item to the second content item, then there is a greater magnitude of change in appearance of the three-dimensional environment. In some embodiments, if there is a smaller magnitude of progress of change from the first content item to the second content item, then there is a smaller magnitude of change in appearance of the three-dimensional environment. Transitioning the appearance of the respective portion of the three-dimensional environment gradually while transitioning between content items allows the computer system to visually indicate a change in display of content items without harsh lines (e.g., between key colors of the content items), thereby reducing errors in interaction with the computer system.

In some embodiments, the respective portion of three-dimensional environment includes a virtual environment displayed from a viewpoint of a user of the computer system, and the virtual environment is displayed with a three-dimensional shape surrounding at least a portion of the viewpoint of the user, such as portal 712b, shown in FIG. 7K. In some embodiments, the virtual environment includes and/or is displayed within a portal, as described in method 800. In some embodiments, the portal is displayed with a three-dimensional shape, such as being a portion of a sphere, ellipsoid, ovoid, prism, or other shape. In some embodiments, the shape of the portal is based on the type of content displayed in the virtual environment, as described in method 800. In some embodiments, an input at the mechanical input element, described above and with reference to method 800, changes the size of the shape (e.g., changes a size of the portal), which causes the computer system to display more or less of the content. Displaying content in a portal with a specific shape allows the computer system to optimize the display of content in the second mode of presentation based on the portal shape thereby reducing errors in interaction with the content.

It should be understood that the particular order in which the operations in methods 800, 900, and/or 1000 have been described is merely exemplary and is not intended to indicate that the described order is the only order in which the operations could be performed. One of ordinary skill in the art would recognize various ways to reorder the operations described herein. In some embodiments, aspects and/or operations of methods 800, 900, and/or 1000 may be interchanged, substituted, and/or added between these methods. For example, the first or second modes of presentation in methods 800, 900, and/or 1000, the display of content as content with a three-dimensional appearance in methods 800, 900, and/or 1000, and/or the changing of appearances in a virtual environment based on the content being displayed in the virtual appearance in methods 800, 900, and/or 1000 are optionally interchanged, substituted, and/or added between these methods. For brevity, these details are not repeated here.

FIG. 11 is a flowchart illustrating an exemplary method 1100 of displaying a virtual representation of a three-dimensional object in accordance with some embodiments. In some embodiments, the method 1100 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processing units 202 (e.g., processors) of computer system 101 (e.g., control unit 110 in FIG. 1A). Some operations in method 1100 are, optionally, combined and/or the order of some operations is, optionally, changed.

In some embodiments, method 1100 is performed a computer system that is in communication with one or more display generation components and one or more input devices, such as computer system 101, shown in FIG. 7A. For example, the computer system is or corresponds to a mobile device (e.g., a tablet, a smartphone, a media player, or a wearable device), or a computer or other electronic device. In some embodiments, the computer system has one or more characteristics of the computer system in method 800, 1000, and/or 1200. In some embodiments, the one or more display generation components have one or more characteristics of the one or more display generation components in method 800, 1000, and/or 1200. In some embodiments, the one or more input devices have one or more characteristics of the one or more input devices in method 800, 1000, and/or 1200.

In some embodiments, while a three-dimensional environment is visible via the one or more display generation components, the computer system displays, via the one or more display generation components, a user interface including a plurality of options associated with one or more appearance parameters of a three-dimensional object, such as options 748a through 748d, shown in FIG. 7BB. In some embodiments, the three-dimensional environment has one or more characteristics of the three-dimensional environment described in methods 800, 1000, and/or 1200. In some embodiments, the user interface corresponds to the content described in methods 800, 1000, and/or 1200. In some embodiments, the plurality of options includes options to change a color, pattern, size, texture, and/or other appearance parameters of the object. In some embodiments, the user interface is web-browser user interface. In some embodiments, the three-dimensional object corresponds to a real-world object, such as a furniture (e.g., chair, lamp, and/or table), water bottle, picture frames, or other real-world objects. In some embodiments, in response to receiving an input directed towards an option from the plurality of options, the computer system updates the representation of the three-dimensional object to include the respective appearance characteristics. For example, the input is a selection input such as a tap input, a gaze input, an air pinch input (or other selection input), and/or a voice input. For example, the computer system receives an input to select a particular fabric texture and in response to the input, the computer system displays the three-dimensional object with the respective fabric texture. In some embodiments, prior to or while detecting the input to display the virtual representation of the three-dimensional object, described below, the computer system displays the three-dimensional object as a two-dimensional representation. In some embodiments, the three-dimensional object is a two-dimensional image of a real-world object, such as furniture. In some embodiments, the three-dimensional object is displayed within and/or behind the spatial plane of the user interface and/or the portal, as described in greater detail in method 800. In some embodiments, the object is not independently movable relative to the user interface. In some embodiments, the spatial content and variability in depth is described in greater detail in method 800 and 1000.

In some embodiments, while displaying the user interface including the plurality of options associated with the one or more appearance parameters of the three-dimensional object, the computer system detects, via the one or more input devices, a first input corresponding to a request to display a virtual representation of the three-dimensional object (e.g., including the likeness of the corresponding real-world object. For example, the virtual representation is three-dimensional, and the representation includes the dimensions of the three-dimensional object), such as the input shown in FIG. 7CC directed towards option 711f. In some embodiments, the first input is a selection input such as a tap input, a gaze input, an air pinch input (or other selection input), and/or a voice input corresponding to a request to display a virtual representation of the object. In some embodiments, the first input includes an air pinch gesture or air tap gesture (e.g., a multi-pinch or multi-tap air gesture) performed by a hand of the user, optionally while the attention of the user is directed to a selectable option in the environment. In some embodiments, the computer system receives the first input directed towards a selectable option to display the virtual representation of the three-dimensional object. In some embodiments, the computer system receives the first input directed towards a selectable option to change the presentation of the content from the first mode of presentation to the second mode of presentation, wherein the first mode of presentation includes presenting the three-dimensional object and the second mode of presentation includes presenting the virtual representation of three-dimensional object. In some embodiments, the first mode of presentation and the second mode of presentation are described in greater detail in method 800. In some embodiments, the computer system receives the input directed towards a selectable option while in the second mode of presentation (e.g., a button to convert a two-dimensional or spatial representation of the three-dimensional object to the virtual representation of the three-dimensional object).

In some embodiments, in response to detecting the first input, the computer system displays, via the one or more display generation components in the three-dimensional environment, the virtual representation of the three-dimensional object and a plurality of options for adjusting the one or more appearance parameters of the virtual representation of the three-dimensional object, such as content 746b and options 748a through 748d, shown in FIG. 7FF. In some embodiments, in response to detecting the input, the computer system ceases displaying the two-dimensional representation of the three-dimensional object. In some embodiments, in response to the input, the computer system continues to display the user interface include the plurality of options. In some embodiments, the virtual representation of the three-dimensional object is displayed at a different depth relative to the viewpoint of the user than the user interface (e.g., closer to the viewpoint of the user than the user interface). For example, the virtual representation of the object is displayed outside and/or in front of the user interface or portal including the plurality of options, described above. In some embodiments, portals are described in greater detail in method 800. In some embodiments, the virtual representation is displayed outside of the boundaries of the user interface and/or portal. For example, the virtual representation of the three-dimensional object is displayed separated from the user interface and/or portal, at a different location relative to the user interface than before detecting the input, and/or independently movable relative to the user interface. In some embodiments, the virtual representation of the three-dimensional object includes the dimensions of the respective real-world object. In some embodiments, and as described below, the computer system uses one or more known measurements and/or two-dimensional views of the three-dimensional object to generate the virtual representation of the three-dimensional object. In some embodiments, in response to one or more inputs directed towards the virtual representation of the object, the computer system updates the angle of view of the virtual representation of the three-dimensional object, as described below. Optionally, updating the angle of view does not include changing the viewpoint of the computer system in the three-dimensional environment. For example, the plurality of options includes options to change a color, pattern, size, texture, and other appearance parameters of the virtual representation of the object (or a portion of the virtual representation of the object). In some embodiments, the plurality of options are described in greater detail above. In some embodiments, in response to receiving an input directed towards an option from the plurality of options, the computer system updates the virtual representation of the three-dimensional object to include the respective appearance characteristics. For example, the input is a selection input such as a tap input, a gaze input, an air pinch input (or other selection input), and/or a voice input. For example, the computer system receives an input to select a particular fabric texture and/or color and in response to the input, the computer system displays virtual representation of the three-dimensional object with the respective fabric texture and/or color. Displaying a virtual representation of the three-dimensional object allows a user to quickly and efficiently gather information about the object by allowing the user to view the three-dimensional object without distractions, thereby improving user-device interaction which increasing the speed and efficiency of using the computer system which saves battery life and/or computing resources.

In some embodiments, displaying the virtual representation of the three-dimensional object includes generating the virtual representation of the three-dimensional object based on one or more two-dimensional images of the three-dimensional object, such as based on the two-dimensional images shown in options 748e through 748h, shown in FIG. 7KK. In some embodiments, the user interface associated with the three-dimensional object includes one or images showing one or more different views of the three-dimensional object. For example, the user interface is a web page of a store and the three-dimensional object is a purchasable item (e.g., furniture, home décor, and/or other physical objects). In some embodiments, the user interface includes a description of the three-dimensional object such as dimension of the three-dimensional object and/or images of the three-dimensional object from different angles. In some embodiments, in response to detecting the first input, the computer system uses autonomous processes such as artificial neural networks and/or machine learning to generate a virtual representation of the three-dimensional object using the information provided by the user interface and/or a developer of the user interface (e.g., two-dimensional images and/or dimensions). In some embodiments, a developer of the user interface provides a virtual representation of the three-dimensional object. In some embodiments, the two-dimensional images are used in the user interface (e.g., displayed in the website corresponding to the user interface). In some embodiments, the two-dimensional images are not shown in the user interface (e.g., the computer system retrieves the two-dimensional images used to generate the virtual representation of the three-dimensional object somewhere other than the user interface and/or web page such as from a server of the computer system or of a developer of the webpage and/or user interface). Generating the virtual representation of the three-dimensional object based one or more two-dimensional images of the three-dimensional object allows the computer system to generate an accurate representation of the object even if the user interface does not have a pre-generated virtual representation of the respective three-dimensional object, therefore allowing the user to gather accurate information about the object, thereby improving user-device interaction which increasing the speed and efficiency of using the computer system which saves battery life and/or computing resources.

In some embodiments, while displaying the virtual representation of the three-dimensional object, the computer system detects, via the one or more input devices, a second input correspond to a request to change an angle from which the virtual representation of the three-dimensional object represents the three-dimensional object, such as the input shown in FIG. 7HH. In some embodiments, the second input includes a selection input and a movement input. For example, the second input includes an air pinch gesture or air tap gesture (e.g., a multi-pinch or multi-tap air gesture) performed by a hand of the user and a rotation of the hand corresponding to the changing of the angle (e.g., a greater rotation of the hand corresponds to a greater change in angle and a smaller rotation of the hand corresponds to a smaller change in angle, and a direction of rotation of the hand corresponds to a direction of rotation of the object), optionally while the attention of the user is directed to a representation of the three-dimensional object in the environment. In some embodiments, the second input is a tap using an input device (e.g., a mouse, stylus, or finger) and a rotation using the respective input device.

In some embodiments, in response to detecting the second input, the computer system updates the virtual representation of the three-dimensional object to represent a view of the three-dimensional object from an angle determined based on the second input (e.g., based on a direction and/or magnitude of movement associated with the second input), such as the view of content 746b shown in FIG. 7II. In some embodiments, the second input results in a rotation in any of or a combination of the x, y, and z directions, wherein the point of rotation is the center of the virtual representation of the three-dimensional object. In some embodiments, in response to detecting the second input, the computer system updates the virtual representation of the three-dimensional object to be at an angle corresponding to the movement of the hand of the second input. In some embodiments, the computer system displays the virtual representation of the three-dimensional object at the angle until the computer system detects another input directed towards rotating the virtual representation of the three-dimensional object. In some embodiments, the computer system updates the virtual representation of the three-dimensional object to represent the view from the angle of the second input while detecting the second input, and after no longer detecting the second input (e.g., the user releases the air-tap or air pinch), the computer system displays the virtual representation of the three-dimensional object at the angle prior to receiving the second input. Allowing the user to change the angle from which the computer system is displaying the virtual representation of the three-dimensional object allows a user to quickly and efficiently gather information about the object by allowing the view the three-dimensional object without distractions, thereby improving user-device interaction which increasing the speed and efficiency of using the computer system which saves battery life and/or computing resources.

In some embodiments, while displaying the virtual representation of the three-dimensional object having a visual appearance based on a first value for a first appearance parameter (e.g., a property and/or characteristics of the appearance of the three-dimensional object) of the virtual representation of the three-dimensional object, the computer system detects, via the one or more input devices, a second input directed towards a first option (e.g., selectable option) of the plurality of options corresponding to a second value for the first appearance parameter of the virtual representation of the three-dimensional object, such as the input directed towards option 748c shown in FIG. 7FF. In some embodiments, the one or more options includes options to change a characteristic of the three-dimensional object other than the angle of viewing of the three-dimensional object. For example, the options include changing a color, a texture, a material, a size, a shape, and/or other characteristics of the three-dimensional object. In some embodiments, the first value is a first color, first texture, first material, first size, and/or first shape of the three-dimensional object. In some embodiments, the second input is a selection input such as a tap input, a gaze input, an air pinch input (or other selection input), and/or a voice input corresponding to a request to select a second value for the first appearance parameter. In some embodiments, the second input includes an air pinch gesture or air tap gesture (e.g., a multi-pinch or multi-tap air gesture) performed by a hand of the user, optionally while the attention of the user is directed to a selectable option in the environment.

In some embodiments, in response to detecting the second input, the computer system updates, via the one or more display generation components, an appearance of the virtual representation of the three-dimensional object to have a visual appearance based on the second value for the first appearance parameter associated with the first option (which is optionally different from the visual appearance based on the first value for the first appearance parameter), such as updating the appearance of content 746b shown in FIG. 7GG. In some embodiments, updating the virtual representation to have the visual appearance based on the second value includes maintaining the angle of viewing of the three-dimensional object. In some embodiments, displaying the virtual representation of the three-dimensional object with the second value for the first appearance parameter includes no longer displaying the virtual representation with the first value for the first appearance parameter. In some embodiments, the one or more options include options for each respective appearance parameter. In some embodiments, changing a value of one appearance parameter does not affect the value of the other appearance parameters. Allowing the user to change one or more properties of the three-dimensional object while viewing the virtual representation of the three-dimensional object reduces the number of inputs needed to change the appearance of the three-dimensional object, thereby reducing erroneous inputs to the computer system and improving user-device interaction, which increasing the speed and efficiency of using the computer system which saves battery life and/or computing resources.

In some embodiments, the first appearance parameter corresponds to a virtual material of a component of the three-dimensional object, such as the fabric material shown in FIG. 7FF. For example, changing the value of the first appearance parameter includes changing a material of a component of the three-dimensional object (e.g., the fabric of a cushion, a type of wood, a stain of the wood, a material of a water bottle (e.g., metal or plastic), and/or other materials of components of a three-dimensional object). In some embodiments, the computer system detects an input corresponding to a selection of a selectable option, and in response if the selectable option is a first selectable option corresponding to a first virtual material, then the computer system updates the virtual material of the component of the three-dimensional object to the first virtual material. In some embodiments, if the selectable option is a second selectable option corresponding to a second virtual material, different from the first virtual material, then the computer system updates the virtual material of the component of the three-dimensional object to the second virtual material. In some embodiments, the input is a selection input such as a tap input, a gaze input, an air pinch input (or other selection input), and/or a voice input corresponding to a request to change the virtual material of the component. For example, the input includes an input directed towards a selectable option, that is selectable to update the virtual material to the first (or second) virtual material, such as an air pinch gesture or air tap gesture (e.g., a multi-pinch or multi-tap air gesture) performed by a hand of the user, optionally while the attention of the user (e.g., including gaze) is directed to the selectable option in the three-dimensional environment. Allowing the user to change the material of the virtual representation of the object allows the user to quickly and efficiently view different versions of the object without distractions, thereby improving user-device interaction which increasing the speed and efficiency of using the computer system which saves battery life and/or computing resources.

In some embodiments, updating the appearance of the virtual representation of the three-dimensional object to have the visual appearance based on the second value for the first appearance parameter includes updating a visual appearance of first component of the three-dimensional object based on the second value for the first appearance parameter without updating a visual appearance of a second component of the three-dimensional object, such as changing the fabric material shown in FIG. 7GG does not change a material of the wood of the content 746b. In some embodiments, and as described above, the one or more options include options for one or more or each respective appearance parameter. In some embodiments, changing a value of one appearance parameter does not affect the value of the other appearance parameters. In some embodiments, options of the one or more options correspond to changing a characteristic of a respective component of the three-dimensional object. For example, changing the fabric of a representation of a chair does not include changing the type or color of wood of the chair and vice versa. Allowing the user to change the material of the virtual representation of the object without changing other characteristics of the object allows the user to quickly and efficiently view different versions of the object modularly, thereby improving user-device interaction which increasing the speed and efficiency of using the computer system which saves battery life and/or computing resources.

In some embodiments, before detecting the second input directed towards the first option, the computer system displays, via the one or more display generation components, the virtual representation of the three-dimensional object having a first spatial arrangement relative to the three-dimensional environment, such as the content 746b being in the first spatial arrangement relative to the three-dimensional environment, shown in FIG. 7FF. In some embodiments, the spatial arrangement includes a location, orientation and/or angle of viewing of the virtual representation of the three-dimensional object relative to the viewpoint of the user and/or relative to the three-dimensional environment.

In some embodiments, in response to detecting the second input directed towards the first option, the computer system continues to display the virtual representation of the three-dimensional object with the first spatial arrangement relative to the three-dimensional environment, such as the content 746b continuing to be in the first spatial arrangement relative to the three-dimensional environment, shown in FIG. 7GG. In some embodiments, changing one or more visual appearances of the three-dimensional object does not include changing the spatial arrangement of the three-dimensional object relative to the three-dimensional environment. Alternatively, in some embodiments, in response to detecting the second input (e.g., after detecting the second input), the computer system updates the spatial arrangement of the virtual representation of the three-dimensional object. Changing an appearance parameter of the virtual representation of the three-dimensional object without changing the spatial arrangement of the three-dimensional object allows the user to change portions of the three-dimensional object while reducing the number of inputs needed to achieve a desired view of the virtual representation, and improving user-device interaction which increasing the speed and efficiency of using the computer system which saves battery life and/or computing resources.

In some embodiments, the user interface can be displayed in one of a plurality of different modes of presentation including a first mode of presentation and a second mode of presentation that is different from the first mode of presentation, such as the first mode shown in FIG. 7CC and the second mode shown in FIG. 7DD.

In some embodiments, displaying the virtual representation of the three-dimensional object includes displaying, via the one or more display generation components, the virtual representation of the three-dimensional object in the second mode of presentation (e.g., corresponding to the second mode of presentation, described in greater detail in method 800) wherein the second mode of presentation includes one or more spatial elements corresponding to content in the user interface (e.g., the one or more spatial elements are described in greater detail in method 800. In some embodiments, the content includes the three-dimensional object and other content in the user interface such as text, images, and/or other content), such as content 746b in the portal 712d shown in FIG. 7CC.

In some embodiments, before detecting the first input, the computer system displays, via the one or more display generation components, the user interface in the first mode of presentation, different than the second mode of presentation (e.g., the first mode of presentation corresponds to the first mode of presentation described in greater detail in method 800), such as user interface 712a, shown in FIG. 7CC. For example, before detecting the first input, the computer system displays the three-dimensional object as a two-dimensional representation of the three-dimensional object, such as a two-dimensional image on a website. In some embodiments, before detecting the first input, the computer system does not display one or more spatial elements corresponding to content on the user interface.

In some embodiments, in response to detecting the first input (e.g., the first input is an input to change the mode of presentation from the second mode of presentation to the first mode of presentation without the need for further inputs), the computer system displays, via the one or more display generation components, the user interface in the second mode of presentation including displaying the virtual representation of the three-dimensional object, such a displaying content 746b in portal 712e, shown in FIG. 7DD. In some embodiments, after detecting the first input, the computer system displays one or more portion of the user interface at varying depths relative to the viewpoint of the user, as described in greater detail in method 800. As described below, the computer system optionally displays the virtual representation at a location that is closer to the viewpoint of the user than other content on the user interface. Displaying the virtual representation of the three-dimensional object while in the second mode of presentation allows the user to view the virtual representation while in the spatial experience (e.g., the first mode of presentation), which reduces distractions in the three-dimensional environment, thereby improving user-device interaction which increasing the speed and efficiency of using the computer system which saves battery life and/or computing resources.

In some embodiments, displaying the user interface in the first mode of presentation includes displaying, via the one or more display generation components, one or more content items and a respective representation of the three-dimensional object (e.g., a two-dimensional representation of the three-dimensional object), such as user interface 712a including content 746a, content 750a, and options 748a through 748d, shown in FIG. 7CC. In some embodiments, the two-dimensional representation of the three-dimensional object represents the object from a first angle of viewing. In some embodiments, the one or more content items include options to change one or more visual appearance parameters of the three-dimensional object and/or one or more views of the three-dimensional object (e.g., two-dimensional photos of the three-dimensional object at different angles of viewing). In some embodiments, the one or more content items include text (e.g., relating to the three-dimensional object such as a description, reviews, specifications, and/or questions and answers), links and/or selectable options to display related items, and/or selectable options to purchase the three-dimensional object. In some embodiments, in response to selecting a different angle of viewing (e.g., a second angle of viewing), the computer system updates the representation of the three-dimensional object to be a two-dimensional representation representing the second angle of viewing.

In some embodiments, displaying the user interface in the second mode of presentation includes continuing to display, via the one or more display generation components, the one or more content items and the virtual representation of the three-dimensional object, such as the computer system 101 displaying content 746b (corresponding to content 746a), content 750b (corresponding to content 750a), and options 748a through 748d, shown in FIG. 7GG. In some embodiments, the computer system displays the three-dimensional object as a three-dimensional representation (e.g., the virtual representation). In some embodiments, the one or more content items remain the same as they are displayed in the first mode of presentation (e.g., as two-dimensional representations). In some embodiments, the one or more content items are displayed with different visual appearances in the second mode of presentation as compared to the first mode of presentation. For example, the one or more content items are displayed at a different size, position, orientation, and/or depth relative to the viewpoint of the user in the first mode of presentation. In some embodiments, the computer system displays the one or more content items in the second mode of presentation in response to detecting a selection input directed towards a selectable option in the second mode of presentation to display additional information. Displaying additional information is described in method 800. Continuing to display the one or more content items in the second mode of presentation allows the user to quickly and efficiently view relevant information while maintaining user interface context for the user, thereby reducing erroneous inputs to the computer system and improving user-device interaction which increasing the speed and efficiency of using the computer system which saves battery life and/or computing resources.

In some embodiments, displaying the virtual representation of the three-dimensional object includes displaying, via the one or more display generation components, the virtual representation of the three-dimensional object at a location that is closer to a viewpoint of the user than the plurality of options, such as content 746b being closer than options 748a through 748d, shown in the overhead view 708 in FIG. 7CC. In some embodiments, the virtual representation of the three-dimensional object is displayed at a location closer to the viewpoint of the user than other content (e.g., photos, videos, and/or text) that is concurrently displayed with the virtual representation of the three-dimensional object, such as two-dimensional content. In some embodiments the other content includes the one or more content items described above such as the visual appearance options, gallery of photos, text, and/or selectable options. Displaying a virtual representation of the three-dimensional object in front of other content allows a user to quickly and efficiently gather information about the object by allowing the user to view the three-dimensional object without distractions, thereby improving user-device interaction.

In some embodiments, while displaying the virtual representation of the three-dimensional object, wherein the virtual representation of the three-dimensional object is displayed within a virtual environment (e.g., the virtual environment includes the portal), the computer system detects, via the one or more input devices, a second input corresponding to a request to display the virtual representation of the three-dimensional outside of the virtual environment in the three-dimensional environment, such as the input shown in FIG. 7 MM. In some embodiments, the second input is a select and move input such as a tap input, a gaze input, an air pinch input (or other selection input), and/or a voice input corresponding to a request to select the virtual representation of the object and a movement of the hand to a location outside of the virtual environment. In some embodiments, the second input includes an air pinch gesture or air tap gesture (e.g., a multi-pinch or multi-tap air gesture) performed by a hand of the user, optionally while the attention of the user is directed to the virtual representation of the three-dimensional object and a movement of the hand while continuing to make the air pinch or air tap gesture.

In some embodiments, in response to detecting the second input, the computer system displays the virtual representation of the three-dimensional object outside of the virtual environment in the three-dimensional environment, such as the content 746b being displayed outside of the virtual environment shown in FIG. 7NN. In some embodiments, the computer system displays the virtual representation in the representation of the physical environment. In some embodiments, the computer system displays the virtual representation at a respective angle of viewing. In some embodiments, while displaying the virtual representation outside of the virtual environment, the computer system receives one or more inputs directed towards the one or more options, and as a result, the computer system updates the virtual representation of the three-dimensional object in accordance with the selected option, while the virtual representation of the three-dimensional object is outside of the virtual environment. In some embodiments, the computer system receives one or more inputs directed towards the virtual representation of the three-dimensional object to change the angle of viewing, and as a result, the computer system updates the virtual representation of the three-dimensional object in accordance with the angle of viewing, while the virtual representation of the three-dimensional object is outside of the virtual environment. Being able to place the virtual representation of the three-dimensional object in the representation of the physical environment allows the user to see how the three-dimensional object would fit and/or look in the physical environment, thereby improving user-device interactions by allows the user to easily view the three-dimensional object in a designated space which increasing the speed and efficiency of using the computer system which saves battery life and/or computing resources.

In some embodiments, in response to detecting the first input, the computer system concurrently displays, via the one or more display generation components, in the three-dimensional environment the virtual representation of the three-dimensional object and the plurality of options, such as displaying content 746b and options 748a through 748d, shown in FIG. 7JJ. In some embodiments, the computer system displays the plurality of options in response to receiving an input directed towards a selectable option to display the plurality of options. In some embodiments, the plurality of options is displayed at an orientation relative to the viewpoint of the user different than the orientation of the virtual representation of the three-dimensional object. For example, the plurality of options are displayed to the right or to the left of the virtual representation of the three-dimensional object.

In some embodiments, in response to detecting the first input, the computer system concurrently displays, via the one or more display generation components, in the three-dimensional environment the virtual representation of the three-dimensional object and one or more images with a three-dimensional appearance, wherein the one or more images with the three-dimensional appearance correspond to one or more images that were displayed when the first input was detected (e.g., and before the first input was detected), such as displaying content 746b and options 748e through 748h, shown in FIG. 7KK. In some embodiments, the one or more images with a three-dimensional appearance include one or more spatial elements (e.g., as described in method 800). In some embodiments, the one or more images with a three-dimensional appearance are displayed at a location in line with (e.g., at the same depth as) the virtual representation of the three-dimensional object relative to the viewpoint of the user. Alternatively, in some embodiments, the one or more images with a three-dimensional appearance are displayed at a location behind the virtual representation of the three-dimensional object relative to the viewpoint of the user (e.g., at a depth greater than the virtual representation relative to the viewpoint of the user). In some embodiments, the one or more images with a three-dimensional appearance were previously two-dimensional images that were converted (e.g., automatically) in response to detecting the first input. Converting two-dimensional images to images with a three-dimensional appearance is described in greater detail in method 800. Continuing to display the one or more images in the first mode of presentation allows the user to quickly and efficiently view relevant information, thereby reducing erroneous inputs to the computer system and improving user-device interaction which increasing the speed and efficiency of using the computer system which saves battery life and/or computing resources.

In some embodiments, displaying the virtual representation of the three-dimensional object in the three-dimensional environment in response to detecting the first input includes displaying, via the one or more display generation components, the virtual representation of the three-dimensional object in a portal (e.g., within the virtual environment; the virtual environment and/or portal are described in greater detail in method 800 and 1000) and a selectable option to display the virtual representation of the three-dimensional object outside the portal, such as option 754a shown in FIG. 7DD. In some embodiments, displaying the virtual representation of the three-dimensional object outside of the portal includes displaying the virtual representation in a representation of a physical environment of the user, as described below. In some embodiments, the selectable option is displayed within the portal. Displaying the virtual representation of the three-dimensional object with a selectable option to display the representation in a representation of the user's physical environment improves user-device interaction by allowing a user to view the object as part of their physical environment without physically having the object which increasing the speed and efficiency of using the computer system which saves battery life and/or computing resources.

In some embodiments, while displaying the virtual representation of the three-dimensional object in the portal and the selectable option, detecting, via the one or more input devices, a second input directed towards the selectable option to display the representation of the three-dimensional object outside the portal (e.g., the selectable option described above), such as the input shown in FIG. 7DD directed towards option 754a. In some embodiments, the second input is a selection input such as a tap input, a gaze input, an air pinch input (or other selection input), and/or a voice input corresponding to a request to display the virtual representation of the object outside of the portal. In some embodiments, the second input includes an air pinch gesture or air tap gesture (e.g., a multi-pinch or multi-tap air gesture) performed by a hand of the user, optionally while the attention of the user is directed to the selectable option in the environment. In some embodiments, the computer system receives the second input directed towards the selectable option to display the virtual representation of the three-dimensional object outside of the portal.

In some embodiments, in response to detecting the second input, the computer system ceases displaying the virtual representation of the three-dimensional object in the portal, such as displaying content 746b outside of the portal 712d, as shown in the overhead view 708 in FIG. 7EE. In some embodiments, the computer system continues to display the virtual representation of the three-dimensional object in the portal.

In some embodiments, in response to detecting the second input, the computer system displays, via the one or more display generation components, the virtual representation of the three-dimensional object outside of the portal in the three-dimensional environment, wherein displaying the virtual representation of the three-dimensional object outside of the portal includes displaying the virtual representation of the three-dimensional object in a representation of a physical environment of a user of the computer system in the three-dimensional environment, such as displaying content 746b outside of the portal 712d, as shown in the overhead view 708 in FIG. 7EE. For example, the computer system displays the virtual representation of the three-dimensional object amongst the representation(s) of real object(s) in the physical environment. In some embodiments, the computer system displays the virtual representation in a location determined by the user of the computer system. For example, the computer system receives a movement input directed towards the virtual representation of the three-dimensional object (e.g., an air pinch (or other selection input) and an air-drag and/or a selection input using a contact such as a mouse, stylus, or finger and a movement of the contact), optionally while the virtual representation of the three-dimensional object is displayed in the portal. In some embodiments, the computer system displays the virtual representation of the three-dimensional object at a location in the representation of the physical environment defined by the end of the movement input (e.g., at a location and/or orientation in the representation of the physical environment defined by the movement input). Displaying the virtual representation of the three-dimensional object in the representation of the physical environment allows the user to receive visual feedback of how the object looks in their physical environment, thereby improving user-device interaction which increasing the speed and efficiency of using the computer system which saves battery life and/or computing resources.

FIG. 12 is a flowchart illustrating an exemplary method 1200 of displaying content in a second mode of presentation in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processing units 202 (e.g., processors) of computer system 101 (e.g., control unit 110 in FIG. 1A). Some operations in method 1200 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Maintaining the mode of presentation while changing content if the new content satisfies one or more criteria reduces the computing power necessary to display content because the computer system does not need to expend computing power transitioning between modes of presentation and reduces the need for unnecessary inputs and/or steps to switch to a different mode of presentation. Providing improved feedback (such as by reducing a visual prominence of portions of the content while detecting a scroll input) enhances the operability of the device by reducing accidental and mistaken inputs, reducing energy usage by the device. Maintaining display of a supplemental user interface element when the computer system detects a request to display different content that satisfies the one or more first criteria when the supplemental user interface element is presently display without requiring further user input enhances the operability of the device by reducing unnecessary inputs and/or steps to navigate through different user interfaces or sets of controls, reducing energy usage by the device.

In some embodiments, method 1200 is performed at a computer system that is in communication with one or more display generation components and one or more input devices. In some embodiments, the computer system has one or more characteristics of the computer system in methods 800, 900, 1000, 1100, and/or 1200. In some embodiments, the one or more display generation components have one or more characteristics of the one or more display generation components in methods 800, 900, 1000, 1100, and/or 1200. In some embodiments, the one or more input devices have one or more characteristics of the one or more input devices in methods 800, 900, 1000, 1100, and/or 1200.

In some embodiments, while a three-dimensional environment is visible (the three-dimensional environment is described in greater detail in methods 800, 900, 1000, and/or 1100), via the one or more display generation components, the computer system displays (1202a), in the three-dimensional environment, first content (e.g., having one or more characteristics of the content described in methods 800 and 900, and/or content items described in method 1000) from a first content source via a first application, such as computer system 101 displaying content shown in FIG. 7UU. In some embodiments, the first content is content from a respective webpage. For example, the first content is content of a first webpage of a web browser application and the first content source is a source of the first webpage (e.g., a web developer, company, other owners/creators of the first webpage, a server, or a uniform resource locator (URL)). For example, the first content is video content, and the source of the content is an associated production company and/or content distribution server.

In some embodiments, the first content can be displayed (1202b) in one of a plurality of different modes of presentation including a first mode of presentation and a second mode of presentation that is different from (and, optionally, includes more spatial elements than) the first mode of presentation, such as the first mode of presentation shown in FIG. 7A and the second mode of presentation shown in FIG. 7UU. The first mode of presentation corresponds to the first mode of presentation described in greater detail in method 800. The second mode of presentation corresponds to the second mode of presentation described in greater detail in method 800.

In some embodiments, the first content is displayed (1202c) in the second mode of presentation, and in the second mode of presentation, the first content is displayed (1202d) with one or more first spatial elements that are related to the first content and that are not displayed while the first content is displayed in the first mode of presentation, such as the spatial elements 724a and 724b, shown in FIG. 7K. Spatial elements are described in additional detail in method 800 and 900. In some embodiments, the computer system displays the first content with the one or more spatial elements in accordance with the criteria described in method 800 and 900. In some embodiments, the first content includes corresponding two-dimensional content (e.g., not including spatial elements) that corresponds to the content including one or more spatial elements that are displayed when the first content is displayed in the first mode of presentation. In some embodiments, the first content includes three-dimensional content, content including a three-dimensional appearance, two-dimensional content, and/or a combination of three-dimensional and two-dimensional content (e.g., while being displayed in the second mode of presentation). Content including a three-dimensional appearance is described in greater detail in method 800 and 900.

In some embodiments, while displaying the first content in the second mode of presentation, the computer system detects (1202e), via the one or more input devices, a first input corresponding to a request to display second content from a second content source (optionally of the first content source) via the first application, different from the first content source, in the three-dimensional environment, such as the input shown in FIG. 7VV. For example, the first input is a request to display a second webpage in the web browser application. For example, the first input is a request to open a different tab of the web browser application. In some embodiments, the second content has a second content source (e.g., a different web developer, company, owner/creator, server, or URL than the first content source). In some embodiments, the second content and the first content share a content source. For example, a newspaper website has two articles on two webpages, a company has two websites, or a production company has two movies/videos. In some embodiments, the first input is a selection input such as a tap input, a gaze input, an air-pinch input, and/or a voice input corresponding to a request to display the second content. For example, the first input includes an input directed towards a selectable option, that is selectable to display the second content in the second mode of presentation, such as an air pinch gesture or air tap gesture (e.g., a multi-pinch or multi-tap air gesture) performed by a hand of the user, optionally while the attention of the user (e.g., based on gaze) is directed to the selectable option in the environment. In some embodiments, the first input does not include specifying a particular mode of presentation (e.g., the first or second mode) for the second content.

In some embodiments, in response to detecting the first input (1202f), in accordance with a determination that the second content (e.g., having one or more characteristics of the content described in methods 800 and 900, and/or content items described in method 1000) satisfies one or more first criteria, the computer system displays (1202g), via the one or more display generation components, the second content from the second content source via the first application in the second mode of presentation, including one or more second spatial elements that are related to the second content that are not displayed while the second content is displayed in the first mode of presentation, such as the content shown in FIG. 7VV. In some embodiments, the one or more first criteria includes a requirement that the second content is able to be presented in the second mode of presentation in order for the one or more first criteria to be satisfied. For example, the web developer of the second content developed content for the second mode of presentation and/or the second content has two-dimensional content this is able to be converted into three-dimensional content (e.g., having one or more spatial elements, as described in greater detail in methods 800 and 900). In some embodiments, displaying the second content in the second mode of presentation includes displaying content that is two-dimensional while in the first mode of presentation as three-dimensional content (and/or content that includes a three-dimensional appearance) in the second mode of presentation. In some embodiments, displaying the second content in the second mode of presentation includes displaying the second content with a specific layout, as described in greater detail in methods 800, and displaying a specific visual characteristic in the three-dimensional environment as described in method 1100.

In some embodiments, in response to detecting the first input (1202f), in accordance with a determination that the second content does not satisfy the one or more first criteria, the computer system forgoes displaying (1202h) the second content including the one or more second spatial elements that are related to the second content in the second mode of presentation (e.g., displaying the second content in the first mode of presentation corresponding to the first mode of presentation described in additional detail in method 800), such as the content shown in FIG. 7UU not including one or more spatial elements. For example, the computer system displays the second content including two-dimensional content that is included in the webpage corresponding to the second content. In some embodiments, the computer system continues to display the second content in the second mode of presentation but forgoes automatic conversion of two-dimensional content into three-dimensional content (and/or content including a three-dimensional appearance) including spatial elements (e.g., the computer system displays a two-dimensional version of the second content, as opposed to the partial and/or fully three-dimensional version of the second content displayed with the one or more second spatial elements that are related to the second content, but does so while maintaining display of the first application in the second mode of presentation). In some embodiments, the second content does not include content that is able to be converted into three-dimensional content with spatial elements. In some embodiments, the computer system displays the second content in the second mode of presentation with the same layout that is used to display the second content in the first mode of presentation.

In some embodiments, detecting the first input corresponding to the request to display the second content from the second content source includes detecting the first input directed towards a link (e.g., a URL, a hyperlink, and/or a representation of the second content including an embedded link to the second content) to display the second content, wherein the link is included in the first content, such as if the content in portal 712b shown in FIG. 7VV included a link and the input in FIG. 7VV was directed towards the link. In some embodiments, the link includes an address for the computer system to locate the second content (e.g., a URL is an address for the computer system to locate the second content in the world wide web). In some embodiments, the link includes a local address (e.g., an address for a local or cloud directory associated with the computer system).

In some embodiments, while displaying the first content in the second mode of presentation, the computer system displays, in the three-dimensional environment, a content navigation bar for navigating content that is accessible via the first application, wherein detecting the first input corresponding to the request to display the second content from the second content source includes detecting, via the one or more input devices, the first input directed towards the content navigation bar displayed in the second mode of presentation (e.g., directed towards a tab associated with the second content item), such as the input shown in FIG. 7VV directed towards tab 720j in the navigation bar 710a. In some embodiments, the first input is an entry (e.g., text entry) of a new web address or source location in a text entry field in the content navigation bar (e.g., in a URL entry field). In some embodiments, the content navigation bar includes a plurality of selectable options for navigating to different content (e.g., tabs to navigate to different content such as the second content or a third content item). In some embodiments, the content navigation bar includes one or more selectable options to perform actions directed towards the currently displayed content (e.g., the first content or the second content), such as refreshing the content item, a text entry field for entering an address to navigate to different content, navigating to a previously display content, and other actions. In some embodiments, the content navigation bar is described in greater detail in method 800.

In some embodiments, displaying the content navigation bar in the three-dimensional environment includes displaying one or more selectable options that correspond to different content from one or more content sources (e.g., tabs on a web browser application), and the first input is directed towards a first selectable option of the one or more selectable options that corresponds to the second content, such as the tabs 720f through 720j shown in FIG. 7VV and the input directed towards tab 720j shown in FIG. 7VV. In some embodiments, the one or more selectable options includes a second selectable option that corresponds to a third content, different than the second content. In some embodiments, the one or more selectable options also includes a third selectable option corresponding to the first content. In some embodiments, prior to detecting the first input, the third selectable option is selected, and after detecting the first input, the first selectable option is selected. In some embodiments, the computer system displays one or more selectable options when the computer system detects attention (e.g., based on gaze) directed towards the content navigation bar and the computer system ceases displaying the one or more selectable options when the computer system ceases detecting the attention directed to the content navigation bar, as described in greater detail below.

In some embodiments, before displaying the one or more selectable options that correspond to different content from one or more content sources in the three-dimensional environment and while displaying the content navigation bar, wherein the content navigation bar includes information about the first content source (e.g., the address (URL) corresponding to the first content, an indication corresponding to the first content source, webpage name corresponding to the first content and/or other information), the computer system detects, via the one or more input devices, a second input including attention (e.g., based on gaze) of a user of the computer system directed to the content navigation bar, such as the input directed towards the navigation bar 710a shown in FIG. 7UU. In some embodiments, the computer system detects that the attention of the user is directed towards the content navigation bar. For example, the computer system detects that the user's one or more eyes are looking at the content navigation bar. In some embodiments, the second input is a gaze only input.

In some embodiments, in response to detecting the second input, the computer system displays, via the one or more display generation components, the content navigation bar including the one or more selectable options, such as the navigation bar 710a including the tabs 720f through 720j shown in FIG. 7VV. In some embodiments, while detecting the second input or after detecting the second input, the computer system displays the one or more selectable options. In some embodiments, the one or more selectable options are not displayed before the attention of the user is directed towards the navigation bar. The one or more selectable options are described in greater detail above with respect to the selectable options displayed by the navigation bar. In some embodiments, in response to no longer detecting the second input (e.g., the attention of the user is no longer directed towards the navigation bar—for example, the computer system detects the attention of the user move away from the navigation bar and/or detects the attention of the user is no longer directed to the navigation bar), the computer system ceases displaying the one or more selectable options.

In some embodiments, the second content is video content (e.g., a short form video, a movie, or other video content, such as described in method 800, 900, 1000, and/or 1100), such as content 742a-b, shown in FIG. 7DDD. In some embodiments, while displaying the content navigation bar and while displaying the second content in the second mode of presentation in response to detecting the first input, the computer system detects that one or more second criteria are satisfied, including a requirement that the second content is playing in order for the one or more second criteria to be satisfied, such as the content 742a-c actively playing in FIG. 7FFF. In some embodiments, the computer system detects a selection input such as a tap input, a gaze input, an air-pinch input, and/or a voice input directed towards the second content corresponding to a request to play the second content. In some embodiments, the one or more second criteria include a requirement that the computer system no longer detects a gaze input directed towards the content navigation bar in order for the one or more second criteria to be satisfied, as described below. In some embodiments, the one or more second criteria include a requirement that the computer system does not detect an input (e.g., selection input, attention input (e.g., based on gaze), inputs directed towards mechanical input elements, or other inputs) directed towards the second content and/or the computer system for a threshold amount of time (e.g., 1 second, 5 seconds, 10 seconds, 30 seconds, or 1 minute) in order for the one or more second criteria to be satisfied. In some embodiments, the second content begins playing automatically in response to the computer system detecting the first input.

In some embodiments, in response to detecting that the one or more second criteria are satisfied, the computer system reduces a visual prominence of (e.g., cease to display and/or gradually ceasing to display) the content navigation bar (e.g., and gradually ceasing displaying the one or more selectable options in the content navigation bar) relative to a visual prominence of the second content in the second mode of presentation and while the second content continues to play (e.g., ceasing to display the content navigation bar while maintaining display of the second content), such as the navigation bar 710a, control user interface 743, and element 744 no longer being displayed in FIG. 7GGG. In some embodiments, gradually ceasing displaying includes gradually reducing the visual prominence of the navigation bar. For example, reducing the visual prominence includes fading the content navigation bar (optionally including the one or more selectable options) over a predetermined period of time (e.g., such as fading over 0.1, 0.2, 0.5, 1, 5, or 10 seconds). In some embodiments, reducing the visual prominence includes reducing an opacity and/or color saturation of the content navigation bar until it is no longer visible.

In some embodiments, the one or more second criteria include a requirement that attention (e.g., based on gaze) of the user is not directed to the content navigation bar while the content navigation bar is displayed in order for the one or more second criteria to be satisfied, such as the computer system 101 no longer detecting a gaze directed towards content 742a-c in FIG. 7FFF. In some embodiments, prior to gradually ceasing displaying the content navigation bar, the computer system detects the attention of the user directed towards the content navigation bar and in response to no longer detecting the attention directed to the content navigation bar, the computer system gradually ceases displaying the content navigation bar. In some embodiments, the user directed their attention to the video content and/or other portions of the three-dimensional environment.

In some embodiments, the one or more second criteria include a requirement that an input directed towards the second content is detected while the content navigation bar is displayed in order for the one or more second criteria to be satisfied, such as if the computer system 101 detected an input directed towards the content 742a-c in FIG. 7FFF. In some embodiments, the input is a selection input such as a tap input, a gaze input, an air-pinch input, and/or a voice input directed towards the second content. For example, the input includes an input directed towards the representation of the second content (e.g., the video content), such as an air pinch gesture or air tap gesture (e.g., a multi-pinch or multi-tap air gesture) performed by a hand of the user, optionally while the attention of the user (e.g., based on gaze) is directed to the second content. In some embodiments, in response to detecting the input, the computer system ceases displaying the content navigation bar. In some embodiments, the input corresponds to a request to pause, play, fast forward, rewind the second content, or change the volume of the computer system.

In some embodiments, concurrently displaying the content navigation bar with one or more user interface elements other than the second content (e.g., a user interface element including content playback controls (e.g. the one or more controls include one or more controls that are selectable to rewind, fast forward, pause, or play the second content) and/or a supplemental user interface element to display additional information about the second content.) while displaying the second content in the second mode of presentation, such as control user interface 743 and element 744 displayed in FIG. 7FFF. The supplemental user interface element has one or more characteristics of the supplemental elements described in method 800. In some embodiments, the one or more user interface elements are displayed next to or near the second content.

In some embodiments, reducing a visual prominence of (e.g., ceasing to display or gradually ceasing to display) the content navigation bar further includes reducing a visual prominence of (e.g., ceasing to display or gradually ceasing to display) the one or more user interface elements, such as no longer displaying the control user interface 743 and element 744 in FIG. 7GGG. Reducing a visual prominence of the one or more user interface elements is described in greater detail above with respect to reducing the visual prominence of the content navigation bar. For example, reducing the visual prominence includes fading the one or more user interface elements over a predetermined period of time (e.g., a first rate of time such as fading over 1 second, 5 seconds, or 10 seconds). In some embodiments, the one or more user interface elements reduces in visual prominence at the same rate as the content navigation bar (e.g., a first rate, described above) or at a different rate of time as the content navigation bar (e.g., at a second rate instead of a first rate) such that the one or more user interface elements reduces in visual prominence before or after the content navigation bar. In some embodiments, reducing the visual prominence includes reducing an opacity and/or color saturation of the content navigation bar until it is no longer visible. In some embodiments, the second rate of time is fading over 1 second, 5 seconds, or 10 seconds.

In some embodiments, while displaying the content navigation bar while displaying the second content in the second mode of presentation in response to detecting the first input, in accordance with a determination that the second content is video content, the computer system displays, via the one or more display generation components, one or more video playback controls, wherein the video playback controls are separate from the second content and the content navigation bar, such as option 747a through 747g, shown in FIG. 7FFF and in FIG. 7W. In some embodiments, the one or more video playback controls include controls that are selectable to pause, play, fast forward, rewind, and scrub to a particular time in the video. In some embodiments, the video playback controls are displayed in a different location and/or with a different orientation in the three-dimensional environment than the content navigation bar and/or the second content.

In some embodiments, while displaying the one or more video playback controls, the computer system detects, via the one or more input devices, a second input directed towards a first control of the one or more video playback controls, such as if the computer system 101 detected an input directed towards option 747a in FIG. 7FFF. In some embodiments, the second input is a selection input such as a tap input, a gaze input, an air-pinch input, and/or a voice input directed towards the first control, such as an air pinch gesture or air tap gesture (e.g., a multi-pinch or multi-tap air gesture) performed by a hand of the user, optionally while the attention of the user (e.g., based on gaze) is directed to the first control. In some embodiments, in response to detecting the second input, the computer performs the operation based on the first control. In some embodiments, in response to detecting the second input, the computer system performs an operation corresponding to the first control, such as rewinding the content 742a-c in response to detecting the input directed towards option 747a. In some embodiments, the operation includes pausing, playing, fast forwarding, rewinding the second content, or changing the volume of the computer system depending on which video playback control is selected.

In some embodiments, displaying the content navigation bar includes displaying, via the one or more display generation components, one or more content management controls for controlling display of content (e.g., the first content, the second content, and/or other content displayed via the first application, and optionally not content displayed by other applications) that is displayed concurrently with the content navigation bar, such as menu 738, shown in FIG. 7ZZ. In some embodiments, the one or more content management controls include controls for searching the second content (e.g., for a specified word, phrase, image, and/or other specified content), refreshing the second content, changing a font of the second content, and/or controls for changing a layout of the second content. In some embodiments, the one or more content management controls are selectable options, that when selected (e.g., using a selection input such as a tap, air-pinch and gaze, or a voice command) cause the computer system to perform those various functions.

In some embodiments, while displaying the one or more content management controls, the computer system detects, via the one or more input devices, a second input directed towards a first control of the one or more content management controls, such as an input directed towards option 740d, shown in FIG. 7ZZ. In some embodiments, the second input is a selection input such as a tap input, a gaze input, an air-pinch input, and/or a voice input directed towards the first control, such as an air pinch gesture or air tap gesture (e.g., a multi-pinch or multi-tap air gesture) performed by a hand of the user, optionally while the attention of the user (e.g., based on gaze) is directed to the first control. In some embodiments, in response to detecting the second input, the computer performs the operation based on the first control. In some embodiments, in response to detecting the second input, performing an operation corresponding to the first control, such as displaying user interface 712a in portal 712b, shown in FIG. 7AAA. In some embodiments, the operation includes searching for a specified content in the second content, refreshing the second content, changing a font of the second content, and/or changing a layout of the second content depending on which content management control is selected.

In some embodiments, displaying the content navigation bar includes displaying a selectable option to cease displaying the second content in the second mode of presentation (e.g., and display the second content in the first mode of presentation or cease displaying the second content all together), such as option 720a, shown in FIG. 7J. In some embodiments, while displaying the content navigation bar including the selectable option, the computer system detects, via the one or more input devices, a second input corresponding to a request to select the selectable option, such as if the computer system detects an input directed towards option 720a shown in FIG. 7J. In some embodiments, the second input is a selection input such as a tap input, a gaze input, an air-pinch input, and/or a voice input corresponding to a request to select the selectable option. For example, the second input includes an input directed towards a selectable option, that is selectable to display the second content in the first mode of presentation, such as an air pinch gesture or air tap gesture (e.g., a multi-pinch or multi-tap air gesture) performed by a hand of the user, optionally while the attention of the user (e.g., based on gaze) is directed to the selectable option in the environment. In some embodiments, the second input does not include specifying a particular mode of presentation (e.g., the first or second mode) for the second content.

In some embodiments, in response to detecting the second input, the computer system ceases displaying the second content in the second mode of presentation, and displays, via the one or more display generation components, the second content in the first mode of presentation, such as if the computer system 101 displays the content in user interface 712a in the first mode of presentation in response to detecting the input. The first mode of presentation is described in greater detail in methods 800, 900, 1000, and/or 1100. In some embodiments, the computer system redisplays the two-dimensional content that corresponds to the one or more spatial elements of the second content previously displayed in the second mode of presentation. In some embodiments, in response to detecting the second input, the computer system at least partially or fully reverses the first to second mode of presentation changes described in method 800.

In some embodiments, displaying the navigation bar includes displaying a supplemental element option (e.g., having one or more characteristics of the selectable option to display the one or more supplemental elements described in method 800), such as option 720d, shown in FIG. 7XX. In some embodiments, while displaying the content navigation bar including the supplemental element option, the computer system detects, via the one or more input devices, a second input corresponding to a request to select the supplemental element option, such as the input shown in FIG. 7XX. In some embodiments, the second input is a selection input such as a tap input, a gaze input, an air-pinch input, and/or a voice input corresponding to a request to select the supplemental element option. For example, the second input includes an input directed towards a selectable option, that is selectable to display a user interface element including supplement content/information that is related to the second content, such as an air pinch gesture or air tap gesture (e.g., a multi-pinch or multi-tap air gesture) performed by a hand of the user, optionally while the attention of the user (e.g., based on gaze) is directed to the supplemental element option in the environment.

In some embodiments, in response to detecting the second input, the computer system concurrently displays, via the one or more display generation components, the second content (e.g., the content in portal 712b shown in FIG. 7YY) and a user interface element including supplemental information generated based on the second content, such as element 734a shown in FIG. 7YY. The user interface element including supplemental information has one or more characteristics of the supplemental elements described in method 800. In some embodiments, the supplement information includes one or more content items that are no longer displayed (e.g., as described in method 800) in response to the computer system changing from the first mode of presentation to the second mode of presentation. In some embodiments, the supplemental information includes third content related to the second content (e.g., a related video or website). In some embodiments, the supplemental information includes a detailed description of portions of the second content. In some embodiments, the supplemental elements are selectable to display third content (e.g., in place of the second content). In some embodiments, if the computer system was displaying the third content prior to detecting the second input (and/or when the second input was detected), then the computer system displays supplemental information generated based on the third content in response to detecting the second input, which is analogous to the supplemental information generated based on the second content.

In some embodiments, displaying the second content in the second mode of presentation includes displaying the second content within a portal (e.g., described in greater detail in method 800, 1000, and/or 1100) in the three-dimensional environment and at a first depth relative to a viewpoint of a user, such as the content in portal 712b, shown in FIG. 7XX, which is at a first depth relative to the user 707 shown in the overhead view 708. In some embodiments, different content items of the second content are displayed at varying depths relative to the viewpoint of the user. The variance and/or difference in depth for the content is described in greater detail in method 800. In some embodiments, displaying the second content within a portal includes displaying the second content within the confinements of the portal (e.g., the portal optionally cuts off portions of the second content based on the size and shape of the portal and the size and shape of the second content and optionally based on the relative location of the viewpoint relative to the portal). In some embodiments, the portal is a portal or view into the content (e.g., analogous to how a glass window in a building is a portal or view into the three-dimensional, physical world outside of the glass window), as described above and with reference to methods 800, 1000 and/or 1100.

In some embodiments, displaying the content navigation bar in the second mode of presentation includes displaying the content navigation bar outside of the portal in the three-dimensional environment at a second depth, different than the first depth, that is closer to the viewpoint of the user, such as navigation bar 710b being closer in depth to the user 707 in the overhead view 708, shown in FIG. 7XX. In some embodiments, the second depth is closer to the viewpoint of the user than the first depth. Alternatively, in some embodiments, the content navigation bar is displayed within the portal in the virtual environment. In some embodiments, the content navigation bar is moveable independently of the second content and/or the portal. For example, an input to move the second content and/or the portal moves the second content and/or the portal, but does not also move the content navigation bar. In some embodiments, an input to move the second content and/or the portal moves the second content and/or the portal, and also moves the content navigation bar. In some embodiments, an input to move the portal moves the portal, the second content and the content navigation bar. In some embodiments, the content navigation bar is displayed in front of (e.g., overlaying) at least a portion of the portal and/or the second content from the viewpoint of the user. In some embodiments, an input to move the portal moves the portal, the second content and the content navigation bar.

In some embodiments, in response to detecting the first input and in accordance with the determination that the second content satisfies the one or more first criteria and that the first content was displayed concurrently with a supplemental user interface element (e.g., described in greater detail above with reference to the user interface element displaying the supplemental information displayed in response to an input directed towards the selectable element option and with reference to method 800) that includes information generated based on the first content (e.g., described in greater detail above with reference to the supplemental information), the computer system displays the second content in the second mode of presentation including updating the supplemental user interface element to include information generated based on the second content (e.g., described in greater detail above with reference to displaying analogous supplemental information about a third content if a third content was displayed prior to the computer system detecting the input to display the supplemental information), such as updating element 744 including information about content 742a-b in FIG. 7DDD to include information about content 742a-c in FIG. 7FFF. In some embodiments, the computer system does not cease displaying the supplemental user interface element in response to detecting an input to display the second content and while ceasing displaying the first content and displaying the second content. In some embodiments, if the computer system was not displaying the supplemental user interface element before detecting the input to display the second content, then the computer system does not display the supplemental user interface element when displaying the second content in response to the first input. In some embodiments, if the second content does not satisfy the one or more first criteria, then the computer system does not display the supplemental user interface element when displaying the second content.

In some embodiments, forgoing displaying the second content including the one or more second spatial elements that are related to the second content in the second mode of presentation includes displaying the second content within a portal (e.g., described in greater detail above with reference to the portal displayed in the second mode of presentation) in the three-dimensional environment without displaying the one or more second spatial elements (and optionally with the same layout as in the first mode of presentation), such as displaying the content in the portal 712b without spatial elements in FIG. 7WW. In some embodiments, the second content does not include two-dimensional content that can be converted into three-dimensional content (and/or content including a three-dimensional appearance, as described in method 800 and 900) including the one or more second spatial elements. In some embodiments, the second content source of the second content does not include data relating to the one or more spatial elements and/or data relating to displaying the second content differently in the second mode of presentation. For example, if the second content does not satisfy the one or more first criteria, the computer system displays the second content with the same layout and presentation as the first mode of presentation (e.g., in the user interface of the first mode of presentation) while also displaying the portal (e.g., part of the second mode of presentation), with the second content displaying within the portal, described above.

In some embodiments, displaying the second content within the portal in the three-dimensional environment without displaying the one or more second spatial elements includes in accordance with a determination that a first visual property (e.g., having one or more characteristics of the visual appearances described in method 800) of the second content has a first value (e.g., a first color, first saturation, and/or first brightness), displaying, via the one or more display generation components, a virtual environment within the portal (e.g., having one or more characteristics of the virtual environment within the portal described in method 800) with a first visual appearance based on the first value of the first visual property, wherein the second content is displayed overlaying the virtual environment (e.g., described above with reference to displaying the second content without the one or more second spatial elements within the portal), such as displaying glow 726e and color 728e with a key color of the content in “Andy's blog” shown in FIG. 7WW. Displaying the portal and/or a portion of the virtual environment surrounding the second content with the first value of the first visual property corresponding to the second content is described in greater detail in method 800, 900, 1000, and/or 1100. For example, the second content has a first key color (e.g., key colors are described in greater detail in method 800), so the virtual environment within the portal is displayed with the first key color (e.g., and optionally with a different saturation and/or brightness than the key color of the second content).

In some embodiments, displaying the second content within the portal in the three-dimensional environment without displaying the one or more second spatial elements includes in accordance with a determination that the first visual property of the second content has a second value (e.g., a second color, second saturation, and/or second brightness), different from the first value, displaying, via the one or more display generation components, the virtual environment within the portal (e.g., having one or more characteristics of the virtual environment within the portal described in method 800) with a second visual appearance, different from the first visual appearance, based on the second value of the first visual property, wherein the second content is displayed overlaying the virtual environment (e.g., described above with reference to displaying the second content without the one or more second spatial elements within the portal), such as displaying glow 726e and color 728e with a different key color of if the content in “Andy's blog” shown in FIG. 7WW has a different key color. For example, the second content has a second key color (e.g., key colors are described in greater detail in method 800), so the virtual environment within the portal is displayed with the second key color (e.g., and optionally with a different saturation and/or brightness than the key color of the second content).

In some embodiments, displaying the second content within the portal includes displaying the second content with a virtual glow effect behind the second content, such as glow 726e, shown in FIG. 7WW. In some embodiments, the virtual glow effect is virtually cast onto the portal and/or the virtual environment within the portal. In some embodiments, the virtual glow effect is virtually cast on a background of the content. For example, portions of second content are displayed at a depth relative to a background of the content. In some embodiments, types of content that are displayed in front of the background (e.g., content items having one or more spatial elements) cast a glow effect onto the background (e.g., two-dimensional visual media such as photos and videos, three-dimensional content, content including a three-dimensional appearance, and/or headers) and types of content items that are displayed behind or in line with the background (e.g., two-dimensional visual media such as advertisements, graphs, tables, graphics and/or text) do not cast a glow effect onto the background (e.g., are not displayed with the glow effect). In some embodiments, the computer system displays the virtual glow effect behind the second content if the second content satisfies the one or more first criteria and/or if the second content does not satisfy the one or more first criteria. In some embodiments, the computer system displays the virtual glow effect behind the user interface displaying the second content (e.g., when the second content does not satisfy the one or more first criteria), but does not display the virtual glow effect when the second content does satisfy the one or more first criteria. In some embodiments, the virtual glow effect includes the first visual property based on the second content item. For example, the virtual glow effect includes a key color corresponding to a key color of the second content. Virtual lighting effects are described in greater detail in methods 800, 900, 1000, and/or 1100.

In some embodiments, while displaying the first content including the one or more first spatial elements (e.g., three-dimensional content (e.g., content that includes a three-dimensional appearance) that is generated based on the two-dimensional content of the first content that is displayed in the first mode of presentation, described in greater detail in methods 800, 900, 1000, and/or 1100) in the second mode of presentation, the computer system detects, via the one or more input devices, a second input corresponding to a request to display the first content without the one or more first spatial elements (optionally while still in the second mode of presentation), such as the input directed towards option 740d shown in FIG. 7ZZ. In some embodiments, the second input is a selection input such as a tap input, a gaze input, an air-pinch input, and/or a voice input corresponding to a request to display the first content without the one or more first spatial elements. For example, the second input includes an input directed towards a selectable option, that is selectable to display the first content without the one or more first spatial elements (e.g., and display the first content with the two-dimensional content items corresponding to the one or more first spatial elements), such as an air pinch gesture or air tap gesture (e.g., a multi-pinch or multi-tap air gesture) performed by a hand of the user, optionally while the attention of the user (e.g., based on gaze) is directed to the selectable option.

In some embodiments, in response to detecting the second input, the computer system ceases display of the one or more first spatial elements while continuing to display the first content in the second mode of presentation, such as shown by displaying user interface 712a in portal 712b shown in FIG. 7AAA. For example, the computer system displays the corresponding two-dimensional content. In some embodiments, the computer system displays the first content with one or more characteristics of the first content in the first mode of presentation (e.g., the same layout) in the portal of the second mode of presentation. The portal is described in greater detail above and with reference to methods 800, 900, 1000, and/or 1100. In some embodiments, in the first mode of presentation, the first content is displayed in a user interface in the three-dimensional environment. In some embodiments, in response to detecting the second input, the computer system displays the user interface including the first content in the portal of the second mode of presentation, which has one or more characteristics of displaying the second content without the one or more second spatial elements in the second mode of presentation described herein.

In some embodiments, displaying the first content within the portal in the three-dimensional environment without displaying the one or more first spatial elements includes (e.g., the portal is described in greater detail above and with reference to methods 800, 900, 1000, and/or 1100 and displaying the first content without the one or more first spatial elements has one or more characteristics of displaying the second content without the one or more second spatial elements in the second mode of presentation described herein), in accordance with a determination that a first visual property (e.g., having one or more characteristics of the visual appearances described in method 800) of the first content has a first value (e.g., a first color, first saturation, and/or first brightness), displaying, via the one or more display generation components, a virtual environment within the portal with a first visual appearance based on the first value of the first visual property, wherein the first content is displayed overlaying the virtual environment (e.g., described above with reference to displaying the second content without the one or more second spatial elements within the portal), such as color 728f having a key color of the content in user interface 712a, shown in FIG. 7AAA. Displaying the portal and/or a portion of the three-dimensional environment surrounding the second content with the first value of the first visual property corresponding to the first content is described in greater detail in method 800, 900, 1000, and/or 1100. For example, the first content has a first key color (e.g., key colors are described in greater detail in method 800), so the portal is displayed with the first key color (e.g., and optionally with a different saturation and/or brightness than the key color of the second content).

In some embodiments, displaying the first content within the portal in the three-dimensional environment without displaying the one or more first spatial elements includes, in accordance with a determination that the first visual property of the first content has a second value (e.g., a second color, second saturation, and/or second brightness), displaying, via the one or more display generation components, the virtual environment (e.g., having one or more characteristics of the virtual environment within the portal described in method 800) within the portal with a second visual appearance, different from the first visual appearance, based on the second value of the first visual property, wherein the first content is displayed overlaying the virtual environment, such as if the color 728f had a different key color if the content in user interface 712a had a different key color shown in FIG. 7AAA. For example, the first content has a second key color (e.g., key colors are described in greater detail in method 800), so the portal is displayed with the second key color (e.g., and optionally with a different saturation and/or brightness than the key color of the first content). In some embodiments, in response to detecting the first input, the computer system updates the portal based on the visual property of the second content.

In some embodiments, displaying the first content within the portal in the three-dimensional environment without displaying the one or more first spatial elements includes displaying, via the one or more display generation components, the first content overlaying the virtual environment with a virtual glow effect behind the first content (e.g., displaying the first content with a virtual glow effect behind the first content has one or more characteristics of displaying the second content with the virtual glow effect, described above), such as glow 726f, shown in FIG. 7AAA. The visual glow effect is described in greater detail above. In some embodiments, the first content is displayed in a user interface within the portal and the virtual glow effect is an effect behind and/or around the user interface in the portal. In some embodiments, in response to detecting an input to display the first content with the one or more spatial elements in the second mode of presentation, the computer system ceases displaying the virtual glow effect behind the first content.

In some embodiments, while displaying the first content in the second mode of presentation, the computer system detects, via the one or more input devices, a third input corresponding to a request to display third content, such as the input shown in FIG. 7CCC. In some embodiments, the third input is a selection input such as a tap input, a gaze input, an air-pinch input, and/or a voice input corresponding to a request to display the third content. For example, the third input includes an input directed towards a selectable option (e.g., a tab in the content navigation bar), that is selectable to display the third content, such as an air pinch gesture or air tap gesture (e.g., a multi-pinch or multi-tap air gesture) performed by a hand of the user, optionally while the attention of the user (e.g., based on gaze) is directed to the selectable option (e.g., a selectable option in the content navigation bar, as described above). In some embodiments, the third input is a text entry input to enter a new web address (e.g., a URL) corresponding to the third content in the content navigation bar. The content navigation bar includes one or more characteristics of the content navigation bar described above with reference to the second mode of presentation.

In some embodiments, in response to detecting the third input and in accordance with a determination that the third content satisfies the one or more first criteria, in accordance with a determination that the first content was displayed with the one or more first spatial elements in the second mode of presentation when the third input was detected, the computer system displays, via the one or more display generation components, the third content in the three-dimensional environment, including one or more third spatial elements that are related to the third content that are not displayed while the third content is displayed in the first mode of presentation, such as displaying content 742a-b including the one or more spatial elements (e.g., if the content 742a-b included spatial elements), shown in FIG. 7DDD. In some embodiments, if the content displayed prior to the third input is displayed with one or more spatial elements (e.g., and the content satisfies the one or more first criteria), then in response to detecting the third input, the computer system displays the third content in the second mode of presentation with the one or more third spatial elements. In some embodiments, if the content displayed prior to the third input is displayed without one or more spatial elements (e.g., and the content satisfies the one or more first criteria), then in response to detecting the third input, the computer system displays the third content in the second mode of presentation without the one or more third spatial elements. In some embodiments, if the content displayed prior to the third input is displayed without one or more spatial elements (e.g., and the content does not satisfy the one or more first criteria), then in response to detecting the third input, the computer system displays the third content in the second mode of presentation with the one or more third spatial elements.

In some embodiments, in accordance with a determination that the first content (e.g., that satisfied the one or more first criteria) was displayed without the one or more first spatial elements in the second mode of presentation when the third input was detected (e.g., displaying the first content without the one or more first spatial elements occurs in response to the computer system detecting the input directed towards the selectable option to display the respective content without the one or more spatial elements, described above), the computer system displays, via the one or more display generation components, the third content in the three-dimensional environment without displaying the one or more third spatial elements, such as if the computer system displays content 742a-b without the one or more spatial elements (e.g., if the content 742a-b had one or more spatial element), shown in FIG. 7DDD. In some embodiments, the setting to display the content without spatial elements persists when switching between content that satisfies the one or more first criteria. In some embodiments, if the computer system display content that doesn't satisfy the one or more first criteria, then the setting no longer persists. In some embodiments, while displaying the third content without the one or more third spatial elements, the computer system detects an input to redisplay the first content, and in response, the computer system displays the first content without the one or more first spatial elements.

In some embodiments, the first content in the second mode of presentation is displayed within a portal in the three-dimensional environment (e.g., the portal is described in greater detail above and with reference to methods 800, 900, 1000, and 1100), such as in portal 712b, shown in FIG. 7ZZ.

In some embodiments, displaying the first content in the second mode of presentation including the one or more first spatial elements includes displaying, via the one or more display generation components, the first content at least partially clipped (and/or occluded) by the portal, such as the content 713i-b being clipped by the portal 712b, shown in FIG. 7ZZ. In some embodiments, displaying the first content within a portal includes displaying the first content within the confinements of the portal (e.g., the portal optionally cuts off visibility of portions of the first content from the viewpoint of the user based on the size and shape of the portal and the size and shape of the first content). For example, the portal is circular, and the first content is rectangular, so the circular edges of the portal clip the shape of the first content to be circular. In some embodiments, the edges/boundary of the portal cuts off visibility of (clips) the first content and therefore, portions of the first content (e.g., images, videos, text, and/or blocks of text) are optionally partially visible and partially not visible if they span past the boundary of the portal.

In some embodiments, displaying the first content in the second mode of presentation without the one or more first spatial elements includes displaying, via the one or more display generation components, the first content without the first content being clipped (and/or occluded) by the portal, such as the content in user interface 712a not being clipped by the portal 712b, shown in FIG. 7AAA. In some embodiments, displaying the first content without the one or more first spatial elements within a portal includes displaying a user interface container (e.g., the borders of the web browser user interface) including the first content within the confinements of the portal. In some embodiments, the portal does not cut off portions of the first content. In some embodiments, the borders of the user interface container optionally cut off portions of the first content (e.g., the computer system detects scroll inputs, described herein, to display additional portions of the first content) but the entirety of the user interface container is displayed within the portal. In some embodiments, the first content within the user interface container (and/or the user interface container) do not span past the boundary of the portal (therefore, the portal does not clip the user interface container). In some embodiments, portions of the first content (e.g., content items such as images, videos, text, blocks of text, and/or graphics) are optionally partially visible and partially not visible when they span past the boundary of the user interface container, but optionally no content spans the boundary of the portal.

In some embodiments, when the first input is detected, displaying the first content in the second mode of presentation includes displaying, via the one or more display generation components, a portion of the three-dimensional environment (e.g., virtual environment within the portal) outside of the first content with a first visual appearance based on the first content, such as color 728b and 728c, shown in FIG. 7VV. Displaying the portion of the three-dimensional environment outside of the first content with an appearance based on the first content is described in greater detail in method 1000. The portal described is in greater detail above with reference to the portal displayed in the second mode of presentation. In some embodiments, changing the appearance of the three-dimensional environment includes changing the appearance of the virtual environment but not the background environment. The virtual environment and the background environment are described in greater detail in method 800. In some embodiments, the first visual appearance includes a color, saturation, and/or brightness based on the first content. The first visual appearance has one or more characteristics of the first visual appearance described in methods 800 and 1000. In some embodiments, the appearance of the three-dimensional environment is in addition to or in place of a virtual lighting effect (e.g., a glow or shadow as described above) that is displayed from the first content.

In some embodiments, in response to detecting the first input, displaying the second content in the second mode of presentation includes displaying, via the one or more display generation components, the portion of the three-dimensional environment outside of the second content with a second visual appearance, different from the first visual appearance, based on the second content, such as color 728e in FIG. 7WW being different than color 728b and 728c. In some embodiments, the second visual appearance includes a color, saturation, and/or brightness based on the second content. For example, the first and second visual appearances are based on one or more key colors of the first or second content. Key colors are described in greater detail in methods 800 and 1000. The second visual appearance has one or more characteristics of the second visual appearance described in methods 800 and 1000. In some embodiments, a portion of the three-dimensional environment outside of the content (e.g., first and/or second content) remains visible, and optionally includes at least a part of the physical environment outside of the content.

In some embodiments, while displaying the second content in the second mode of presentation and while a first portion of the second content (e.g., the portion of the second content that is currently visible in the portal) has a first visual prominence (e.g., opacity and/or brightness of the content (e.g., the text, images, and/or videos)), the computer system detects, via the one or more input devices, a second input corresponding to a request to scroll the second content, such as input shown in FIG. 7KKK. In some embodiments, the scrolling input includes scrolling using an input device (e.g., a mouse), a gaze, an air-pinch and air-drag, a tap (e.g., with a finger) and drag, and/or a voice input. In some embodiments, the second input is directed towards a user interface element for scrolling, and/or directed towards the second content in the second mode of presentation. In some embodiments, the input is an input to scroll downwards or upwards. In some embodiments, the computer system ceases scrolling after no longer detecting the scrolling input.

In some embodiments, while (and/or in response to) detecting the second input, the computer system scrolls the second content in accordance with the second input, including decreasing a visual prominence of the first portion of the second content, such as shown by the content being displaying with a decrease in visual prominence in FIG. 7LLL. In some embodiments, decreasing the visual prominence includes decreasing the opacity or brightness of the content (e.g., text, images, graphics, videos, or other content) in the first portion of the second content (e.g., by 5%, 10%, 25%, 50%, 75%, or 90%). In some embodiments, the computer system decreases the visual prominence of the second content displayed in the portal at the time of the scrolling input and during the scrolling input. In some embodiments, the computer system decreases a visual prominence of the portion of the second content that is presently displayed while and before detecting the scroll input. In some embodiments, the computer system decreases the visual prominence of portions of the second content based on the location of the content within the portal or relative to the viewpoint of the user (described below). For example, the computer system decreases the visual prominence of portions of the second content that are within a distance (e.g., 0.1 cm, 1 cm, or 10 cm) of the top and/or bottom borders of the portal. In some embodiments, the first portion of the second content remains/is at a location within the portal that is visible from the viewpoint of the user, and/or the first portion of the second content remains at least partially displayed within the portal while detecting and after detecting the scrolling input.

In some embodiments, decreasing the visual prominence of the first portion of the second content includes, in accordance with a determination that the second input corresponds to a request to scroll the second content at a first speed (e.g., based on the speed of the device and/or object performing the scrolling (e.g., speed of the hand moving, speed of the mouse scroll wheel, and/or speed of an eye movement)), decreasing the visual prominence of the first portion of the second content from the first visual prominence to a second visual prominence, such as if the scrolling input shown in FIGS. 7KKK and 7LLL were the first speed and the visual prominence of the content in the portal 712b were the second visual prominence. In some embodiments, the second visual prominence is lower than the first visual prominence. For example, the second visual prominence is 95%, 80%, 50%, 25%, or 10% of the first visual prominence.

In some embodiments, decreasing the visual prominence of the first portion of the second content includes, in accordance with a determination that the second input corresponds to a request to scroll the second content at a second speed, faster than the first speed, decreasing the visual prominence of the first portion of the second content from the first visual prominence to a third visual prominence, less than the second visual prominence, such as if the scrolling input shown in FIGS. 7KKK and 7LLL were the second speed and the visual prominence of the content in the portal 712b were the third visual prominence. For example, the third visual prominence is 95%, 80%, 50%, 25%, or 10% of the second visual prominence. In some embodiments, the speed of the scroll correlates to the decrease in visual prominence. In some embodiments, the first portion of the second content remains/is at a location within the portal that is visible from the viewpoint of the user, and/or the first portion of the second content remains at least partially displayed within the portal while detecting and after detecting the scrolling input.

In some embodiments, decreasing the visual prominence of the first portion of the second content includes, in accordance with a determination that the first portion of the second content is at a first spatial arrangement (e.g., position and/or orientation) relative to a viewpoint of the user (e.g., the first portion of the second content is closer to the viewpoint of the user such as near a location in the portal that is closer to the physical location of the computer system), displaying, via the one or more display generation components, the first portion of the second content with a second visual prominence (optionally first visual prominence); and For example, the portal is centered in the three-dimensional environment and the portion of the second content near the center of the portal is displayed with the second visual prominence. In some embodiments, the first spatial arrangement is a spatial arrangement of the first portion of the second content relative to the portal (e.g., the first portion of the second content is at the center of the portal), such as displaying content 713h-b and 713i-b with a second visual prominence shown in FIG. 7MMM.

In some embodiments, decreasing the visual prominence of the first portion of the second content includes, in accordance with a determination that the first portion of the second content is at a second spatial arrangement (e.g., position and/or orientation) relative to the viewpoint of the user (e.g., the first portion of the second content is further from the viewpoint of the user such as at a location in the portal that is further from the physical location of the computer system), displaying, via the one or more display generation components, the first portion of the second content with a third visual prominence that is lower than the second visual prominence, such as displaying content 713e-b and 713k-b in FIG. 7MMM with a lower visual prominence than content 713h-b and 713i-b. For example, the portal is centered in the three-dimensional environment and the portion of the second content near the edges (e.g., top and bottom) of the portal is displayed with the third visual prominence. In some embodiments, the second spatial arrangement is a spatial arrangement of the first portion of the second content relative to the portal (e.g., the first portion of the second content is towards the edge of the portal). In some embodiments, the first portion of the second content remains/is at a location within the portal that is visible from the viewpoint of the user, and/or the first portion of the second content remains at least partially displayed within the portal while detecting and after detecting the scrolling input.

In some embodiments, while displaying the first portion of the second content with a reduced visual prominence (e.g., the second visual prominence or the third visual prominence), the computer system detects an event corresponding to reduction of a speed of scrolling of the second content, such as a movement of the hand 706ccc slower than in FIG. 7LLL. For example, the computer system detects that the user is moving their hand slower which indicates a slower scroll speed, has ended the input (e.g., which optionally causes scrolling of the content to gradually slow down), or is no longer moving their hand (e.g., to stop scrolling). In some embodiments, in response to detecting the event corresponding to reduction of the speed of scrolling of the second content, the computer system increases the visual prominence of the first portion of the second content (e.g., from the third visual prominence to the second visual prominence or to the first visual prominence), such as if the visual prominence of the content in FIG. 7LLL were increased but not increased to the visual prominence of the content shown in FIG. 7KKK. In some embodiments, as the computer system detects a slowing or a stopping of the scrolling, the computer system increases the visual prominence of the first portion of the second content proportionally to the reduction in the speed of the scrolling (e.g., a decrease in speed by 25%, 50%, 75%, or 100% means an increase in visual prominence by 25%, 50%, 75%, or 100%, respectively). In some embodiments, the first portion of the second content remains/is at a location within the portal that is visible from the viewpoint of the user, and/or the first portion of the second content remains at least partially displayed within the portal while detecting and after detecting the scrolling input.

In some embodiments, increasing the visual prominence of the first portion of the second content includes, in accordance with a determination that the reduction of the speed of the scrolling of the second content is a first reduction of the speed of the scrolling, increasing the visual prominence of the first portion of the second content by a first amount, such as if the computer system detects a movement of the hand 706ccc slower than in FIG. 7LLL. In some embodiments, as the computer system detects a reduction in speed of scrolling, the computer system increases the visual prominence of the first portion of the second content proportionally to the reduction in the speed of the scrolling (e.g., a decrease in speed by 25%, 50%, 75%, or 100% means an increase in visual prominence by 25%, 50%, 75%, or 100%, respectively). In some embodiments, increasing the visual prominence of the first portion of the second content includes, in accordance with a determination that the reduction of the speed of the scrolling of the second content is a second reduction of the speed of the scrolling, greater than the first reduction of the speed of the scrolling, increasing the visual prominence of the first portion of the second content by a second amount, greater than the first amount, such as no longer detecting the input in FIG. 7OOO and increasing the visual prominence of the content as a result. In some embodiments, in response to no longer detecting scrolling (e.g., the computer system no longer detects an air-pinch), the computer system displays the first portion of the second content with the first visual prominence. For example, in response to detecting termination of the scrolling input (e.g., in response to detecting release of the air pinch gesture), the computer system further increases the visual prominence of the first portion of the second content (optionally, back to its full and/or pre-scrolling visual prominence). In some embodiments, the first portion of the second content remains/is at a location within the portal that is visible from the viewpoint of the user, and/or the first portion of the second content remains at least partially displayed within the portal while detecting and after detecting the scrolling input.

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects and/or operations of method 1200 may be interchanged, substituted, and/or added between these methods. For example, various techniques to display content in the second mode of presentation without one or more spatial elements of method 1200 is optionally interchanged, substituted, and/or added between these methods. For brevity, these details are not repeated here.

It should be understood that the particular order in which the operations in methods 800, 900, 1000, 1100, and/or 1200 have been described is merely exemplary and is not intended to indicate that the described order is the only order in which the operations could be performed. One of ordinary skill in the art would recognize various ways to reorder the operations described herein. In some embodiments, aspects and/or operations of methods 800, 900, 1000, 1100, and/or 1200 may be interchanged, substituted, and/or added between these methods. For example, the first or second modes of presentation in methods 800, 900, 1000, 1100, and/or 1200, the display of content as content with a three-dimensional appearance in methods 800, 900, 1000, 1100, and/or 1200, the changing of appearances in a virtual environment based on the content being displayed in the virtual appearance in methods 800, 900, 1000, 1100, and/or 1200, the displaying of a virtual representation of a three-dimensional object, and/or the displaying of content with or without one or more spatial elements in the second mode of presentation in methods 800, 900, 1000, 1100, and/or 1200 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection and/or sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates generated content with a three-dimensional appearance from two-dimensional content on the computer system. For instance, a user may be notified upon viewing a content item their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the conversion process can be used to benefit users. For example, the data can be used to train models that can be deployed to improve performance, accuracy, and/or functionality of applications and/or services. Accordingly, the use of the data enables the conversion process to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the conversion process are also contemplated by the present disclosure.

The present disclosure contemplates that, in some embodiments, data used by conversion process includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with conversion process, should attempt to comply with well-established privacy policies and/or privacy practices.

For example, such entities may implement and consistently follow policies and practices recognized as meeting or exceeding industry standards and regulatory requirements for developing and/or training conversion process. In doing so, attempts should be made to ensure all intellectual property rights and privacy considerations are maintained. Training should include practices safeguarding training data, such as personal information, through sufficient protections against misuse or exploitation. Such policies and practices should cover all stages of the conversion process development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, conversion process may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for conversion process may be kept strictly separated from platforms where the conversion process are deployed and/or used to interact with users and/or process data. In such embodiments, data used for offline training of the conversion process may be maintained in secured datastores with restricted access and/or not be retained beyond the duration necessary for training purposes. In some embodiments, the conversion process may utilize a local memory cache to store data temporarily during a user session. The local memory cache may be used to improve performance of the conversion process. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the conversion process. The conversion process should be monitored for changes in underlying data distribution such as concept drift or data skew that can degrade performance of the conversion process over time.

In some embodiments, the conversion process are trained using a combination of offline and online training. Offline training can use curated datasets to establish baseline model performance, while online training can allow the conversion process to continually adapt and/or improve. The present disclosure recognizes the importance of maintaining strict data governance practices throughout this process to ensure user privacy is protected.

In some embodiments, the conversion process may be designed with safeguards to maintain adherence to originally intended purposes, even as the conversion process adapt based on new data. Any significant changes in data collection and/or applications of [technology descriptor] process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the conversion process and/or for use as input during the inference stage of such systems. In yet another example, the present technology should be configured to allow users to be able to select to limit the length of time data is maintained or entirely prohibit the use of their data for use by the conversion process. In addition to providing “opt in” and “opt out” options, the present disclosure contemplates providing notifications relating to the access or use of personal information. For instance, a user can be notified when their data is being input into the conversion process for training or inference purposes, and/or reminded when the conversion process generate outputs or make decisions based on their data.

The present disclosure recognizes conversion process should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the conversion process. Generated content can be filtered for potentially inappropriate or dangerous material prior to being presented to users, while human oversight and/or ability to override or correct erroneous or undesirable outputs can be maintained as a failsafe.

The present disclosure further contemplates that users of the conversion process should refrain from using the services in any manner that infringes upon, misappropriates, or violates the rights of any party. Furthermore, the conversion process should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The conversion process should not violate, misappropriate, or infringe any copyrights, trademarks, rights of privacy and publicity, trade secrets, patents, or other proprietary or legal rights of any party, and appropriately attribute content as required. Further, the conversion process should not interfere with any security, digital signing, digital rights management, content protection, verification, or authentication mechanisms. The conversion process should not misrepresent machine-generated outputs as being human-generated.

1. A method comprising:
at a computer system that is in communication with one or more display generation components and one or more input devices:
while a three-dimensional environment is visible, via the one or more display generation components, from a first viewpoint of a user, displaying, via the one or more display generation components, content of a respective website in a first mode of presentation in a three-dimensional environment, wherein the content is displayed in a web browser application that is capable of displaying content from multiple different websites;
while displaying the content in the first mode of presentation from the first viewpoint of the user, detecting, via the one or more input devices, an input corresponding to a request to display the content from the respective website in a second mode of presentation; and
in response to detecting the input:
ceasing displaying the content in the first mode of presentation; and
displaying the content in the second mode of presentation, wherein in the second mode of presentation, the content is displayed with one or more spatial elements that are related to the content and are not displayed when the content is displayed in the first mode of presentation.

2. The method of claim 1, wherein displaying the content in the second mode of presentation includes displaying one or more content items with a three-dimensional appearance that was not displayed in the first mode of presentation.

3. The method of claim 2, wherein the one or more content items with a three-dimensional appearance includes a panorama content item that is displayed with a simulated curve.

4. The method of claim 2, wherein the one or more content items with a three-dimensional appearance include one or more photos with a three-dimensional appearance and/or one or more videos with a three-dimensional appearance.

5. The method of claim 2, wherein the one or more content items with a three-dimensional appearance include one or more virtual three-dimensional representations of three-dimensional objects.

6. The method of claim 1, wherein:
displaying the content in the first mode of presentation includes replacing a first portion of the three-dimensional environment with virtual content, and
displaying the content in the second mode of presentation includes replacing a second portion of the three-dimensional environment with virtual content, wherein the second portion of the three-dimensional environment is larger than the first portion of the three-dimensional environment.

7. The method of claim 1, wherein:
displaying the content in the first mode of presentation includes displaying, via the one or more display generation components, the content with a first visual edge characteristic, and
displaying the content in the second mode of presentation includes displaying, via the one or more display generation components, the content with a second visual edge characteristic different than the first visual edge characteristic.

8. The method of claim 1, wherein:
displaying the content in the first mode of presentation includes displaying, via the one or more display generation components, the content with a first virtual lighting characteristic; and
displaying the content in the second mode of presentation includes displaying, via the one or more display generation components, the content with a second virtual lighting characteristic different than the first virtual lighting characteristic.

9. The method of claim 1, wherein:
the content includes text and one or more media items,
displaying the content in the first mode of presentation includes displaying, via the one or more display generation components, the text and the one or more media items with a first spatial relationship, and
displaying the content in the second mode of presentation includes displaying, via the one or more display generation components, the text and the one or more media items with a second spatial relationship, different than the first spatial relationship.

10. The method of claim 9, wherein the first spatial relationship and the second spatial relationship differ in depth of the text relative to the one or more media items relative to the viewpoint of the user.

11. The method of claim 1, further comprising:
while displaying a first portion of the content without displaying a second portion of the content, detecting, via the one or more input devices, a respective input including a gaze of the user; and
in response to detecting the respective input and in accordance with a determination that one or more criteria are satisfied, scrolling the content away from the first portion of the content to the second portion of the content based on the gaze of the user, including ceasing display of the first portion of the content.

12. The method of claim 11, wherein:
the one or more criteria include a criterion that is satisfied when the content is displayed in the second mode of presentation; and
the one or more criteria include a criterion that is not satisfied when the content is displayed in the first mode of presentation.

13. The method of claim 1, further comprising:
while displaying the content in the second mode of presentation, detecting, via the one or more input devices, a respective input corresponding to a request to change one or more characteristics of a font of the content; and
in response to detecting the respective input, changing the one or more characteristics of the font of the content in accordance with the respective input.

14. The method of claim 1, further comprising:
while displaying the content in the second mode of presentation, detecting, via the one or more input devices, a first respective input directed towards the content; and
in response to detecting the first respective input, displaying, via the one or more display generation components, a user interface element including one or more supplemental elements corresponding to the content, wherein the user interface element is displayed to a side of the content in the three-dimensional environment.

15. The method of claim 14, wherein the user interface element includes one or more navigational elements for navigating content that is displayed in the second mode of presentation, the method further comprising:
while displaying the user interface element, detecting, via the one or more input devices, a second respective input directed towards the one or more navigational elements; and
in response to detecting the second respective input:
in accordance with a determination that the second respective input is directed towards a first navigational element, updating the content to include first content; and
in accordance with a determination that the second respective input is directed towards a second navigational element, updating the content to include second content, different from the first content.

16. The method of claim 14, wherein:
displaying the content in the second mode of presentation includes displaying the content at a first orientation relative to the three-dimensional environment; and
displaying the user interface element includes displaying the user interface element at a second orientation relative to the three-dimensional environment, different from the first orientation.

17. The method of claim 14, wherein the one or more supplemental elements correspond to additional content relevant to the content, the method further comprising:
while displaying the user interface element including the one or more supplemental elements, detecting, via the one or more input devices, a second respective input directed towards a first supplemental element of the one or more supplemental elements; and
in response to detecting the second respective input, displaying, via the one or more display generation components, second content corresponding to the first supplemental element in the second mode of presentation.

18. The method of claim 14, further comprising:
while displaying the user interface element including one or more supplement elements at a first location in the three-dimensional environment, detecting, via the one or more input devices, a second respective input corresponding to a request to move the user interface element in the three-dimensional environment; and
in response to detecting the second respective input, updating a location of the user interface element in the three-dimensional environment from the first location to a second location, different from the first location.

19. The method of claim 14, wherein:
displaying the content in the second mode of presentation includes displaying the content in a portal in the three-dimensional environment; and
displaying the user interface element including the one or more supplemental elements includes displaying, via the one or more display generation components, the user interface element at a location outside of the portal in the three-dimensional environment.

20. The method of claim 1, wherein detecting the input corresponding to the request to display the content from the respective website in the second mode of presentation includes detecting the input directed towards a selectable option in a menu bar of the web browser application; and
in response to detecting the input directed towards the selectable option in the menu bar of the web browser application, displaying, via the one or more display generation components, one or more menu options, including a menu option for displaying the content in the second mode of presentation.

21. The method of claim 20, further comprising:
while displaying the one or more menu options, detecting, via the one or more input devices, a respective input corresponding to a request to select the menu option to display the content in the second mode of presentation; and
in response to detecting the respective input, displaying, via the one or more display generation components, the content in the second mode of presentation.

22. The method of claim 1, wherein displaying the content in the second mode of presentation includes displaying a first image, the method further comprising:
while displaying the first image in the content in the second mode of presentation, detecting, via the one or more input devices, a respective input corresponding to a request to scroll the content; and
in response to detecting the respective input, scrolling the content in accordance with the respective input, including decreasing a visual prominence of at least the first image while scrolling the content in accordance with the respect input.

23. The method of claim 1, wherein displaying the content in the second mode of presentation includes displaying the one or more spatial elements in a portal, and the method further comprising:
while displaying the one or more spatial elements in the frame, detecting, via the one or more input devices, a respective input corresponding to a request to scroll the content; and
in response to detecting the respective input, scrolling the content in accordance with the respective input, including updating, via the one or more display generation components, a position of the one or more spatial elements in the portal in accordance with a direction and/or magnitude of the request to scroll the content.

24. The method of claim 23, wherein displaying the portal includes displaying the portal with a virtual shadow in the three-dimensional environment.

25. The method of claim 23, wherein displaying the one or more spatial elements includes displaying the one or more spatial element behind the portal relative to a viewpoint of the user.

26. The method of claim 1, wherein:
the content includes video content and non-video content; and
displaying the content in the second mode of presentation includes displaying, via the one or more display generation components, the video content in a video frame that is separate from the non-video content.

27. The method of claim 26, further comprising:
while displaying the video content in the second mode of presentation, detecting, via the one or more input devices, a respective input directed towards the video content; and
in response to detecting the respective input, displaying, via the one or more display generation components, a user interface element including additional information associated with the video.

28. The method of claim 1, wherein:
displaying the content in the second mode of presentation includes displaying the content using one or more viewer properties, including:
in accordance with a determination that the content satisfies one or more first criteria, displaying the content in the second mode of presentation using a first set of one or more viewer properties; and
in accordance with a determination that the content satisfies one or more second criteria, different from the one or more first criteria, displaying the content in the second mode of presentation using a second set of one or more viewer properties, different from the first set of one or more viewer properties.

29. The method of claim 28, wherein:
displaying the content in the second mode of presentation using the first set of one or more viewer properties includes displaying the content within a portal having first one or more immersion properties; and
displaying the content in the second mode of presentation using the second set of one or more viewer properties includes displaying the content within the portal having second one or more immersion properties, different from the first one or more immersion properties.

30. The method of claim 29, wherein:
while displaying the content in the second mode of presentation with a first immersion level corresponding to the portal having the first one or more immersion properties, detecting, via the one or more input devices, a respective input corresponding to a request to change an immersion level of the content; and
in response to detecting the respective input, displaying, via the one or more display generation components, the content in the second mode of presentation with a second level of immersion based on the respective input and the first level of immersion, corresponding to the portal having third one or more immersion properties, different from the first one or more immersion properties.

31. The method of claim 28, wherein:
displaying the content in the second mode of presentation using the first set of one or more viewer properties includes displaying the content with a first layout; and
displaying the content in the second mode of presentation using the second set of one or more viewer properties includes displaying the content with a second layout, different from the first layout.

32. The method of claim 28, wherein:
displaying the content using the first set of one or more viewer properties includes displaying the content in front of background content with a first degree of saturation; and
displaying the content in the second mode of presentation using the second set of one or more viewer properties includes displaying the content in front of the background content with a second degree of saturation, different from the first degree of saturation.

33. The method of claim 1, wherein displaying the content in the second mode of presentation includes displaying the content within a portal, including:
in accordance with a determination that the content satisfies one or more first criteria, displaying the content in the second mode of presentation within the portal having a first portal shape; and
in accordance with a determination that the content satisfies one or more second criteria, different from the one or more first criteria, displaying the content in the second mode of presentation within the portal having a second portal shape, different than the first portal shape.

34. The method of claim 1, further comprising:
while displaying the content in the second mode of presentation with one or more spatial elements at a first level of immersion, receiving an input including rotation of a mechanical input element on the computer system;
in response to receiving the input including the rotation of the mechanical input element of the computer system:
in accordance with a determination that the rotation is in a first direction, increasing a level of immersion of the one or more spatial elements from a first level of immersion to a second level of immersion that is greater than the first level of immersion;
in accordance with a determination that the rotation is in a second direction that is different from the first direction, decreasing the level of immersion of the one or more spatial elements to a third level of immersion that is less than the first level of immersion.

35. A computer system that is in communication with one or more display generation components and one or more input devices, the computer system comprising:
one or more processors;
memory; and
one or more programs, wherein the one or more programs are stored in the memory and configured to be executed by the one or more processors, the one or more programs including instructions for:
while a three-dimensional environment is visible, via the one or more display generation components, from a first viewpoint of a user, displaying, via the one or more display generation components, content of a respective website in a first mode of presentation in a three-dimensional environment, wherein the content is displayed in a web browser application that is capable of displaying content from multiple different websites;
while displaying the content in the first mode of presentation from the first viewpoint of the user, detecting, via the one or more input devices, an input corresponding to a request to display the content from the respective website in a second mode of presentation; and
in response to detecting the input:
ceasing displaying the content in the first mode of presentation; and
displaying the content in the second mode of presentation, wherein in the second mode of presentation, the content is displayed with one or more spatial elements that are related to the content and are not displayed when the content is displayed in the first mode of presentation.

36. A non-transitory computer readable storage medium storing one or more programs, the one or more programs comprising instructions, which when executed by one or more processors of a computer system that is in communication with one or more display generation components and one or more input devices, cause the computer system to perform a method comprising:
while a three-dimensional environment is visible, via the one or more display generation components, from a first viewpoint of a user, displaying, via the one or more display generation components, content of a respective website in a first mode of presentation in a three-dimensional environment, wherein the content is displayed in a web browser application that is capable of displaying content from multiple different websites;
while displaying the content in the first mode of presentation from the first viewpoint of the user, detecting, via the one or more input devices, an input corresponding to a request to display the content from the respective website in a second mode of presentation; and
in response to detecting the input:
ceasing displaying the content in the first mode of presentation; and
displaying the content in the second mode of presentation, wherein in the second mode of presentation, the content is displayed with one or more spatial elements that are related to the content and are not displayed when the content is displayed in the first mode of presentation.
